(19) United States
(12) Patent Application Publication
(10) Pub. No.: US 2006/0116167 A1
(43) Pub. Date: Jun. 1, 2006

(54) Selectable functionality communication system and methodologies

(76) Inventors: Roni Raviv, Nes Ziona (IL); Douglas York Malawsky, Ramat Gan (IL); Amihay Ben-David, Tel Aviv (IL)

Correspondence Address: BROWDY AND NEIMARK, P.L.L.C.;624 NINTH STREET, NW, SUITE 300, WASHINGTON, DC, 20001-5303, US

(21) Appl. No.: 10/526,232

(22) PCT Filed: Sep. 1, 2003
(86) PCT No.: PCT/IL03/00719

§ 371 Date: Mar. 1, 2005

Related U.S. Application Data
(63) Continuation-in-part of application No. 10/367,603, filed on Feb. 14, 2003.
(60) Provisional application No. 60/471,875, filed on May 19, 2003.

(30) Foreign Application Priority Data
Sep. 2, 2002 (IL) 151573

(51) Int. Cl. H04B 1/38; H04M 1/00

(52) U.S. Cl. 455/558

(57) ABSTRACT

A user-interface card for use in the context of an existing call between a voice communications device and a server, the user-interface card including a plurality of information modules each operative to actuate an application on the server, a user selectable transmitter for transmitting a selected one of the plurality of information modules to the server, via the voice communications device, in response to application specific actuation of the card by a user and an audio transducer driven by the transmitter for transmitting the selected one of the plurality of information modules to the voice communications device as sound.

### REFERENCE TO CO-PENDING APPLICATIONS

Applicant hereby claims priority of Israel Patent Application Serial No. 151573, filed on Sep. 2, 2002, entitled “Device for Transfer of Mobile Data and Content to Mobile Handsets”, U.S. patent application Ser. No. 10/367,603, filed Feb. 14, 2003, entitled “Selectable Functionality Communication System and Methodologies” and U.S. Provisional Patent Application Ser. No. 60/471,875, filed on May 19, 2003, entitled “Selectable Functionality Communication System and Methodologies”.

### FIELD OF THE INVENTION

The present invention relates to selectable functionality mobile communication systems generally and to user interfaces and user interface cards for use therein.

### BACKGROUND OF THE INVENTION

The following patents documents are believed to represent the current state of the art:

U.S. Pat. Nos. 5,524,072; 6,481,623; 6,434,648 and 6,037,933.

Published U.S. patent applications Ser. Nos. 09/853,017; 09/860,660; 09/725,713; 09/773,091; 09/908,213; 10/168,231 and 10/087,098.

### SUMMARY OF THE INVENTION

The present invention seeks to provide an improved selectable functionality mobile communication system, user interfaces and user interface cards for use therein.

There is thus provided in accordance with a preferred embodiment of the present invention a user-interface card for use in the context of an existing call between a voice communications device and a server, the user-interface card including a plurality of information modules each operative to actuate an application on the server, a user selectable transmitter for transmitting a selected one of the plurality of information modules to the server, via the voice communications device, in response to application specific actuation of the card by a user and an audio transducer driven by the transmitter for transmitting the selected one of the plurality of information modules to the voice communications device as sound.

There is also provided in accordance with another preferred embodiment of the present invention a selectable functionality mobile communication system including a voice enabled server, a voice communication device capable of actuating a call between the voice communication device and the server and a user-interface card including a plurality of information modules each operative to actuate an application on the server, a user selectable transmitter for transmitting a selected one of the plurality of information modules to the server, via the voice communications device, in response to application specific actuation of the card by a user and an audio transducer driven by the transmitter for transmitting the selected one of the plurality of information modules to the voice communications device as sound.

There is further provided in accordance with yet another preferred embodiment of the present invention a selectable functionality mobile communication system including a function actuation card and a mobile device, the function actuation card containing at least one audio and visual actuating information module which interacts with the mobile device.

There is yet further provided in accordance with another preferred embodiment of the present invention a selectable functionality mobile communication system including a server, a mobile device and a function actuation card interacting with the server, via the mobile device, the function actuation card containing at least one audio and visual actuating information module which interacts with the server, via the mobile device. Preferably, the function actuation card includes a user selectable transmitter for transmitting the at least one audio and visual actuating information module to the server, via the mobile device, in response to application specific actuation of the card by a user and an audio transducer driven by the transmitter for transmitting the at least one information module to the mobile device as sound.

There is still further provided in accordance with yet another preferred embodiment of the present invention a selectable functionality mobile communication system including a function actuation card and a mobile device, the function actuation card containing at least one information module which interacts with the mobile device and causes the mobile device to interact with an external source.

There is even further provided in accordance with still another preferred embodiment of the present invention a selectable functionality mobile communication system including a server, a mobile device and a function actuation card interacting with the server, via the mobile device, the function actuation card containing at least one information module which interacts with the mobile device and causes the mobile device to interact with an external source. Preferably, the function actuation card includes a user selectable transmitter for transmitting the at least one information module to the server, via the mobile device, in response to application specific actuation of the card by a user and an audio transducer driven by the transmitter for transmitting the at least one information module to the mobile device as sound.

There is also provided in accordance with another preferred embodiment of the present invention a selectable functionality mobile communication system including a function actuation card and a mobile device, the function actuation card containing at least one information module which interacts with the mobile device and causes the mobile device to obtain content from an external source.

There is further provided in accordance with yet another preferred embodiment of the present invention a selectable functionality mobile communication system including a server, a mobile device and a function actuation card interacting with the server, via the mobile device, the function actuation card containing at least one information module which interacts with the mobile device and causes the mobile device to obtain content from the server. Preferably, the function actuation card includes a user selectable transmitter for transmitting the at least one information module to the server, via the mobile device, in response to application specific actuation of the card by a user and an audio transducer driven by the transmitter for transmitting the at least one information module to the mobile device as sound.

There is yet further provided in accordance with still another preferred embodiment of the present invention a selectable functionality mobile communication system including a server, a mobile communicator, a function actuation card interacting with the server, via the mobile communicator and a television set-top box, the function actuation card containing at least one information module which interacts with the server, via the mobile communicator, and with the set-top box and causes the set-top box to receive information from an external source. Preferably, the function actuation card includes a user selectable transmitter for transmitting the at least one information module to the server, via the mobile communicator, in response to application specific actuation of the card by a user and an audio transducer driven by the transmitter for transmitting the at least one information module to the mobile communicator as sound.

There is even further provided in accordance with still another preferred embodiment of the present invention a user-interface card for use with a voice communications device, the user-interface card including a plurality of information modules each operative to actuate an application on the voice communications device, a user selectable transmitter for transmitting a selected one of the plurality of information modules to the voice communications device, in response to application specific actuation of the card by a user and an audio transducer driven by the transmitter for transmitting the selected one of the plurality of information modules to the voice communications device as sound.

There is still further provided in accordance with another preferred embodiment of the present invention a user-interface card for use with a voice communications device, the user-interface card including a plurality of information modules each operative to actuate an application on the voice communications device, a user selectable transmitter for transmitting a selected one of the plurality of information modules to the voice communications device, in response to application specific actuation of the card by a user and an IR transducer driven by the transmitter for transmitting the selected one of the plurality of information modules to the voice communications device as sound.

In accordance with another preferred embodiment of the present invention the server is a voice enabled server. Additionally or alternatively, the server is an IVR enabled server.

In accordance with yet another preferred embodiment of the present invention the card is sound communication enabled. Alternatively, the card is sound and IR communication enabled.

In accordance with yet another preferred embodiment of the present invention the plurality of information modules includes video content. Alternatively or additionally, the plurality of information modules includes audio content. The plurality of information modules may also include computer programs. Additionally or alternatively, the plurality of information modules may include games. In accordance with still another preferred embodiment of the present invention the plurality of information modules includes entertainment content. Alternatively or additionally, the plurality of information modules includes security information. The plurality of information modules may also include gaming programs. Additionally or alternatively, the plurality of information modules includes a message. In accordance with another preferred embodiment of the present invention the plurality of information modules includes transactional information. Alternatively or additionally, the plurality of information modules includes mobile commerce data.

In accordance with yet another preferred embodiment of the present invention the user-interface card also includes user actuable programming functionality. Additionally or alternatively, the user-interface card also includes user actuable personalization functionality.

In accordance with still another preferred embodiment of the present invention the card includes a bottom substrate, an electronic circuit and a top substrate. Preferably, the bottom substrate is printed on an inside surface thereof so as to present application specific visual graphics on an outside surface thereof. Alternatively or additionally, the top substrate is printed on an inside surface thereof so as to present application specific visual graphics on an outside surface thereof.

In accordance with a further preferred embodiment of the present invention the plurality of information modules are selectably accessible in response to actuation by a user of a plurality of user-actuable contact locations. Additionally or alternatively, the user-interface card also includes functionality which changes information modules which are accessible in response to user actuation of at least one of the plurality of user-actuable contact locations. In accordance with yet another preferred embodiment of the present invention the user-interface card also includes functionality which changes the content of at least one of the plurality of information modules in response to user actuation of at least one of the plurality of user-actuable contact locations. Alternatively or additionally, the user-interface card also includes functionality which limits the number of times at least one of a plurality of information modules are accessible in response to user actuation of a corresponding at least one of the plurality of user-actuable contact locations.

There is also provided in accordance with another preferred embodiment of the present invention a communications method for communicating in the context of an existing call between a voice communications device and a server including providing a user-interface card including a plurality of information modules each operative to actuate an application on the server, transmitting a selected one of the plurality of information modules to the server, via the voice communications device, as sound, in response to application specific actuation of the card by a user.

There is further provided in accordance with yet another preferred embodiment of the present invention a mobile communications method including providing a voice enabled server, providing a user-interface card including a plurality of information modules each operative to actuate an application on the server, actuating a voice communications device to call the server and transmitting a selected one of the plurality of information modules to the server, via the voice communications device, as sound, in response to application specific actuation of the card by a user.

There is yet further provided in accordance with still another preferred embodiment of the present invention a mobile communications method including providing a mobile device, providing a function actuation card containing at least one audio and visual actuating information module and interacting with the mobile device by actuating the at least one audio and visual actuating information module.

There is still further provided in accordance with another preferred embodiment of the present invention a mobile communications method including providing a server and a mobile device, providing a function actuation card containing at least one audio and visual actuating information module and interacting with the server, via the mobile device, by actuating the at least one audio and visual actuating information module.

There is even provided in accordance with yet another preferred embodiment of the present invention a mobile communications method including providing a function actuation card and a mobile device and interacting with an external source, via the mobile device, by actuating a function actuation card containing at least one information module which interacts with the mobile device.

There is also provided in accordance with still another preferred embodiment of the present invention a mobile communications method including providing a server, providing a mobile device, interacting with the server, via the mobile device, by actuating a function actuation card containing at least one information module and interacting with an external source, via the mobile device, by actuating the information module which interacts with the mobile device.

There is further provided in accordance with another preferred embodiment of the present invention a mobile communications method including providing a mobile device, providing a function actuation card containing at least one information module and obtaining content from an external source, via the mobile device, by interaction of the at least one information module with the mobile device.

There is yet further provided in accordance with yet another preferred embodiment of the present invention a mobile communications method including providing a server, providing a mobile device, providing a function actuation card containing at least one information module and obtaining content from the server, via the mobile device, by interaction of the at least one information module with the mobile device.

There is still further provided in accordance with still another preferred embodiment of the present invention a communications method for communicating with a voice communications device including providing a user interface card including a plurality of information modules each operative to actuate an application on the voice communications device and transmitting a selected one of the plurality of information modules to the voice communications device, as sound, in response to application specific actuation of the card by a user.

There is even further provided in accordance with another preferred embodiment of the present invention a communications method for communicating with a voice communications device including providing a user interface card including a plurality of information modules each operative to actuate an application on the voice communications device and transmitting a selected one of the plurality of information modules to the voice communications device, employing IR communication, in response to application specific actuation of the card by a user.

There is also provided in accordance with yet another preferred embodiment of the present invention a method for distributing content including providing a user interface card having at least one user-actuable contact location and at least one information module selectably accessible in response to actuation by a user of the at least one user-actuable contact location, the at least one information module enabling user-independent access to content sought to be distributed and employing the user interface card in association with a mobile communications device to access the content.

In accordance with yet another preferred embodiment of the present invention the transmitting includes transmitting video content. Alternatively or additionally, the transmitting includes transmitting audio content. The transmitting may also include transmitting computer programs. Additionally or alternatively, the transmitting includes transmitting games. In accordance with still another preferred embodiment of the present invention the transmitting includes transmitting entertainment content. Alternatively or additionally, the transmitting includes transmitting security information. The transmitting may also include transmitting gaming programs. Additionally or alternatively, the transmitting includes transmitting a message. In accordance with another preferred embodiment of the present invention the transmitting includes transmitting transactional information. Alternatively or additionally, the transmitting includes transmitting mobile commerce data.

There is also provided in accordance with a preferred embodiment of the present invention a user-interface card for use with an interactive communications device, the user-interface card including a plurality of user-actuable contact locations, a plurality of information modules selectably accessible in response to actuation by a user of the plurality of user-actuable contact locations and a communications interface providing communication of the information modules to the interactive communications device in response to the actuation.

There is also provided in accordance with another preferred embodiment of the present invention a user-interface subsystem for use with an interactive communications device, the user-interface subsystem including a user-interface card including a plurality of user-actuable contact locations, a plurality of information modules selectably accessible in response to actuation by a user of the plurality of user-actuable contact locations and a communications interface providing communication of the information modules to the interactive communications device in response to the actuation and a user-interface card intermediary operative to communicate with the communications interface of the user-interface card and with the interactive communications device.

There is further provided in accordance with yet another preferred embodiment of the present invention a physical hyperlink system including a user-selectable function operative device and a user-interface card including a plurality of user-actuable contact locations, a plurality of information modules selectably accessible in response to actuation by a user of the plurality of user-actuable contact locations and a communications interface providing communication of the information modules to the user-selectable function operative device in response to the actuation.

In accordance with another preferred embodiment of the present invention, the communications interface includes a plurality of ports. Additionally, a first one of the plurality of ports communicates contact location actuation data and a second one of the plurality of ports communicates information module data.

In accordance with yet another preferred embodiment of the present invention the user-interface card includes a contact location actuation data processor which provides information module selection inputs operative to cause communication of selected information modules via the communications interface. Additionally or alternatively, the user-interface card also includes contact location actuation feedback functionality operative to provide feedback to the user in response to the actuation of at least one of the plurality of user-actuable contact locations. Preferably, the contact location actuation feedback functionality includes tactile feedback functionality associated with at least some of the plurality of user-actuable contact locations.

In accordance with yet another preferred embodiment of the present invention the user-interface card also includes at least one visually sensible information module indicator associated with each of the plurality of user-actuable contact locations.

Preferably, the plurality of information modules includes at least one information string. Alternatively, the plurality of information modules includes video content. In accordance with another preferred embodiment the plurality of information modules includes audio content. Additionally or alternatively, the plurality of information modules includes computer programs. Preferably, the plurality of information modules includes games. In accordance with still another preferred embodiment the plurality of information modules includes entertainment content. Alternatively, the plurality of information modules includes security information. In accordance with yet another preferred embodiment the plurality of information modules includes gaming programs. In accordance with another preferred embodiment the plurality of information modules includes a message. In accordance with still another preferred embodiment the plurality of information modules includes transactional information. Additionally, the plurality of information modules includes a request to be sent by a mobile device to a remote server to download information from the server. Alternatively, the plurality of information modules includes mobile commerce data.

In accordance with another preferred embodiment of the present invention the user-interface card does not contain a source of electrical power.

In accordance with yet another preferred embodiment of the present invention the user-interface card also includes user actuable programming functionality. Alternatively, the user-interface card also includes user actuable personalization functionality.

In accordance with still another preferred embodiment of the present invention the user-interface card also includes functionality which limits the number of times at least one of a plurality of information modules are accessible in response to user actuation of a corresponding at least one of the plurality of user-actuable contact locations. Additionally, the user-interface card also includes functionality which changes information modules which are accessible in response to user actuation of at least one of the plurality of user-actuable contact locations. Alternatively, the user-interface card also includes functionality which changes the content of at least one of the plurality of information modules in response to user actuation of at least one of the plurality of user-actuable contact locations.

In accordance with yet another preferred embodiment of the present invention the device is a television set-top box. Additionally, the communications interface providing communication in response to the actuation also provides communication to another interactive communications device operating as a back-channel communicator.

In accordance with another preferred embodiment of the present invention the intermediary includes an information module receiver operative to receive the information modules from the user-interface card and an information module transmitter operative to transmit received information modules to the device. Additionally, the intermediary also includes an information module processor for processing at least some of the received information modules.

In accordance with still another preferred embodiment of the present invention the intermediary includes an information receiver operative to receive information from the device and an information transmitter operative to transmit received information to the user-interface card. Additionally, the user-interface card intermediary also includes an information processor for processing at least some of the received information.

In accordance with yet another preferred embodiment of the present invention the intermediary includes at least one wireless communications link. Additionally or alternatively, the intermediary includes a plurality of intermediary ports. Preferably, a first one of the plurality of intermediary ports communicates contact location actuation data and a second one of the plurality of intermediary ports communicates information module data. Additionally, the at least one wireless link interconnects the intermediary and the device.

In accordance with still another preferred embodiment of the present invention the physical hyperlink system also includes an intermediary for communicating with the user-interface card and with the user-selectable function operative device.

Preferably, the user-selectable function operative device is operative in response to user actuation of at least one of the plurality of user-actuable contact locations on the user-interface card to cause information to be downloaded to the user-selectable function operative device. Additionally, the information to be downloaded is downloaded from the user-interface card. Alternatively, the information to be downloaded is downloaded from an external information source.

In accordance with a preferred embodiment of the present invention the user-selectable function operative device includes a communicator. Alternatively, the user-selectable function operative device includes a game device. In accordance with still another preferred embodiment of the present invention the user-selectable function operative device includes a television and associated set-top box. Alternatively, the user-selectable function operative device includes a communicator connected to a communications network.

There is still further provided in accordance with still another preferred embodiment of the present invention a selectable functionality mobile communication system including a function actuation card, a function actuation card/mobile device intermediary and a function selectable mobile device, the function actuation card containing at least one audio-visual information module which interacts with at least one of the intermediary and the mobile device.

There is also provided in accordance with yet another preferred embodiment of the present invention a selectable functionality mobile communication system including a function actuation card, a function actuation card/mobile device intermediary and a function selectable mobile device, the function actuation card containing at least one information module which interacts with at least one of the intermediary and the mobile device and causes the at least one of the intermediary and the mobile device to download information from an external source.

There is even further provided in accordance with still another preferred embodiment of the present invention a selectable functionality mobile communication system including a function actuation card, a function actuation card/mobile device intermediary and a television set-top box, the function actuation card containing at least one information module which interacts with at least one of the intermediary and the set-top box and causes the at least one of the intermediary and the set-top box to download information from an external source.

Preferably, the function actuation card includes a plurality of user-actuable contact locations, a plurality of information modules selectably accessible in response to actuation by a user of the plurality of user-actuable contact locations and a communications interface providing communication of the information modules to the function selectable mobile device in response to the actuation.

In accordance with another preferred embodiment of the present invention, the intermediary and the mobile device communicate with each other in a wireless manner. Additionally or alternatively, the intermediary and the mobile device communicate with each other in a bidirectional communications manner.

In accordance with still another preferred embodiment of the present invention the at least one information module is modifiable through communication between the function actuation card and at least one of the intermediary and the mobile device.

Preferably, the intermediary includes a user interface. In accordance with a preferred embodiment the user interface includes selection buttons. Alternatively or additionally, the user interface includes a ringer. Additionally or alternatively, the user interface includes an LED.

In accordance with another preferred embodiment of the present invention the intermediary includes an information module receiver operative to receive the information modules from the function actuation card and an information module transmitter operative to transmit received information modules to the function selectable mobile device. Additionally, the intermediary also includes an information module processor for processing at least some of the received information modules.

In accordance with still another preferred embodiment of the present invention the intermediary includes an information receiver operative to receive information from the function selectable mobile device and an information transmitter operative to transmit received information to the function actuation card. Additionally, the user-interface card intermediary also includes an information processor for processing at least some of the received information.

In accordance with another preferred embodiment of the present invention, the communications interface includes a plurality of ports. Additionally, a first one of the plurality of ports communicates contact location actuation data and a second one of the plurality of ports communicates information module data.

Preferably, the function actuation card also includes a contact location actuation data processor which provides information module selection inputs operative to cause communication of selected information modules via the communications interface. Additionally or alternatively, the function actuation card also includes contact location actuation feedback functionality operative to provide feedback to the user in response to the actuation of at least one of the plurality of user-actuable contact locations. Preferably, the contact location actuation feedback functionality includes tactile feedback functionality associated with at least some of the plurality of user-actuable contact locations.

In accordance with yet another preferred embodiment of the present invention the function actuation card also includes at least one visually sensible information module indicator associated with each of the plurality of user-actuable contact locations.

Preferably, the plurality of information modules includes at least one information string. Alternatively, the plurality of information modules includes video content. In accordance with another preferred embodiment the plurality of information modules includes audio content. Additionally or alternatively, the plurality of information modules includes computer programs. Preferably, the plurality of information modules includes games. In accordance with still another preferred embodiment the plurality of information modules includes entertainment content. Alternatively, the plurality of information modules includes security information. In accordance with yet another preferred embodiment the plurality of information modules includes gaming programs. In accordance with another preferred embodiment the plurality of information modules includes a message. In accordance with still another preferred embodiment the plurality of information modules includes transactional information. Additionally, the plurality of information modules includes a request to be sent by a mobile device to a remote server to download information from the server. Alternatively, the plurality of information modules includes mobile commerce data.

In accordance with a preferred embodiment of the present invention the function actuation card does not contain a source of electrical power. Alternatively, the function actuation card contains at least one information module providing electrical power.

In accordance with yet another preferred embodiment of the present invention the function actuation card also includes user actuable programming functionality. Alternatively, the function actuation card also includes user actuable personalization functionality.

In accordance with yet another preferred embodiment of the present invention the intermediary includes at least one wireless communications link. Additionally or alternatively, the intermediary includes a plurality of intermediary ports. Preferably, a first one of the plurality of intermediary ports communicates contact location actuation data and a second one of the plurality of intermediary ports communicates information module data. Additionally, the at least one wireless link interconnects the intermediary and the function selectable mobile device.

In accordance with still another preferred embodiment of the present invention the function actuation card also includes functionality which limits the number of times at least one of a plurality of information modules are accessible in response to user actuation of a corresponding at least one of the plurality of user-actuable contact locations. Additionally, the function actuation card also includes functionality which changes information modules which are accessible in response to user actuation of at least one of the plurality of user-actuable contact locations. Alternatively, the function actuation card also includes functionality which changes the content of at least one of the plurality of information modules in response to user actuation of at least one of the plurality of user-actuable contact locations.

In accordance with another preferred embodiment of the present invention the function actuation card contains at least one information module actuating functionality of the mobile device. Alternatively or additionally, the function actuation card contains at least one information module providing a mobile device ringtone.

In accordance with yet another preferred embodiment of the present invention the function actuation card also contains at least one information module which interacts with a communications device providing back-channel functionality in association with the set-top box.

There is further provided in accordance with another preferred embodiment of the present invention a communication method including providing a user-selectable function operative device and a user-interface card including a plurality of user-actuable contact locations and a plurality of information modules, actuating, by user selection, at least one of the plurality of user-actuable contact locations and communicating at least one of the plurality of information modules from the user interface card to the user-selectable function operative device.

There is even further provided in accordance with still another preferred embodiment of the present invention a selectable functionality mobile communication method including providing a function selectable mobile device, a function actuation card/mobile device intermediary and a function actuation card containing at least one audio-visual information module and communicating information from the at least one audio-visual information module to at least one of the intermediary and the mobile device.

There is still further provided in accordance with yet another preferred embodiment of the present invention a selectable functionality mobile communication method including providing a function selectable mobile device, a function actuation card/mobile device intermediary and a function actuation card containing at least one information module, communicating information from the at least one information module to at least one of the intermediary and the mobile device; and downloading information from an external source to the at least one of the intermediary and the mobile device, in response to the communicating.

There is yet further provided in accordance with still another preferred embodiment of the present invention a selectable functionality mobile communication method including providing a television set-top box, a function actuation card/mobile device intermediary and a function actuation card containing at least one information module, communicating information from the at least one information module to at least one of the intermediary and the set-top box and downloading information from an external source to the at least one of the intermediary and the set-top box, in response to the communicating.

In accordance with another preferred embodiment of the present invention the communication method also includes communicating information between the card and the device. Additionally or alternatively, the method also includes downloading information to the device. Preferably, the downloading includes downloading information from the card. Additionally or alternatively, the downloading includes downloading information from an external information source.

In accordance with yet another preferred embodiment of the present invention the communicating includes receiving the at least one of the plurality of information modules from the user-interface card and transmitting received information modules to the user-selectable function operative device. Additionally, the communicating also includes processing at least some of the received information modules.

In accordance with still another preferred embodiment of the present invention the communicating information includes receiving information from the user-selectable function operative device and transmitting received information to the user-interface card. Additionally, the communicating information also includes processing at least some of the received information.

In accordance with another preferred embodiment of the present invention the communicating includes communicating contact location actuation data and communicating information module data.

Preferably, the method also includes providing feedback to a user in response to the actuating. Additionally, the providing feedback includes providing tactile feedback.

In accordance with yet another preferred embodiment of the present invention the communicating includes communicating via a wireless communications link.

In accordance with still another preferred embodiment the method also includes limiting the number of times at least one of the plurality of information modules are accessible in response to user actuation of a corresponding at least one of the plurality of user-actuable contact locations. Additionally or alternatively, the method also includes changing information modules which are accessible in response to the actuating. Additionally or alternatively, the method also includes changing the content of at least one of the plurality of information modules in response to the actuating.

In accordance with another preferred embodiment of the present invention the communicating also includes communicating to another user-selectable function operating device operating as a back-channel communicator.

In accordance with another preferred embodiment of the present invention the communicating also includes communicating to a user-selectable function operating device operating as a back-channel communicator.

### BRIEF DESCRIPTION OF THE DRAWINGS

The present invention will be understood and appreciated more fully from the following detailed description, taken in conjunction with the drawings in which:

FIGS. 1A, 1B, 1C and 1D are, taken together, a simplified pictorial illustration of operation of a selectable functionality mobile communication system constructed and operative in accordance with a preferred embodiment of the present invention;

FIGS. 2A and 2B are, taken together, a simplified pictorial illustration of operation of a selectable functionality mobile communication system constructed and operative in accordance with another preferred embodiment of the present invention;

FIGS. 3A, 3B, 3C and 3D are, taken together, a simplified pictorial illustration of operation of a selectable functionality mobile communication system constructed and operative in accordance with yet another preferred embodiment of the present invention;

FIGS. 4A and 4B are, taken together, a simplified pictorial illustration of operation of a selectable functionality mobile communication system constructed and operative in accordance with still another preferred embodiment of the present invention;

FIGS. 5A, 5B and 5C are, taken together, a simplified pictorial illustration of operation of a selectable functionality mobile communication system constructed and operative in accordance with a further preferred embodiment of the present invention;

FIGS. 6A and 6B are, taken together, a simplified pictorial illustration of operation of a selectable functionality mobile communication system constructed and operative in accordance with a yet further preferred embodiment of the present invention;

FIGS. 7A and 7B are, taken together, a simplified pictorial illustration of operation of a selectable functionality mobile communication system constructed and operative in accordance with a still further preferred embodiment of the present invention;

FIGS. 8/1 and 8/2 are, taken together, a simplified generalized functional block diagram illustration of operation of the selectable functionality mobile communication system of FIGS. 1A-1D;

FIGS. 9/1 and 9/2 are, taken together, a simplified generalized functional block diagram illustration of operation of the selectable functionality mobile communication system of FIGS. 2A and 2B;

FIGS. 10/1 and 10/2 are, taken together, a simplified generalized functional block diagram illustration of operation of the selectable functionality mobile communication system of FIGS. 3A-3D;

FIGS. 11/1 and 11/2 are, taken together, a simplified generalized functional block diagram illustration of operation of the selectable functionality mobile communication system of FIGS. 4A and 4B;

FIGS. 12A/1 and 12A/2 are, taken together, a simplified generalized functional block diagram illustration of operation of the selectable functionality mobile communication system of FIGS. 5A and 5B;

FIGS. 12B/1 and 12B/2 are, taken together, a simplified generalized functional block diagram illustration of operation of the selectable functionality mobile communication system of FIGS. 5A and SC;

FIGS. 13/1 and 13/2 are, taken together, a simplified generalized functional block diagram illustration of operation of the selectable functionality mobile communication system of FIGS. 6A and 6B;

FIG. 14 is a simplified flowchart of initial steps in the operation of the system of FIGS. 1-13/2;

FIG. 15 is a simplified flowchart of further steps in the operation of the system of FIGS. 1-13/2;

FIG. 16 is a simplified flowchart of additional steps in the operation of the system of FIGS. 1-13/2;

FIG. 17 is a simplified flowchart of optional steps in the operation of the system of FIGS. 1-13/2;

FIG. 18 is a simplified flowchart of additional optional steps in the operation of the system of FIGS. 1-13/2;

FIG. 19 is a simplified flowchart of further optional steps in the operation of the system of FIGS. 1-13/2;

FIG. 20 is a simplified flowchart of still further optional steps in the operation of the system of FIGS. 1-13/2;

FIG. 21 is a simplified flowchart of still further steps in the operation of the system of FIGS. 1-13/2;

FIG. 22 is a simplified illustration of a user interface card constructed and operative in accordance with a preferred embodiment of the present invention;

FIG. 23 is an exploded view illustrating layers of the interface card of FIG. 22;

FIG. 24 is a drawing of the electrical circuitry in the card of FIGS. 22 & 23;

FIG. 25 is a further drawing of the electrical circuitry in the card of FIGS. 22 & 23;

FIGS. 26A, 26B, 26C and 26D are, taken together, a simplified pictorial illustration of operation of a selectable functionality mobile communication system constructed and operative in accordance with a preferred embodiment of the present invention;

FIGS. 27A and 27B are, taken together, a simplified pictorial illustration of operation of a selectable functionality mobile communication system constructed and operative in accordance with another preferred embodiment of the present invention;

FIGS. 28A, 28B and 28C are, taken together, a simplified pictorial illustration of operation of a selectable functionality mobile communication system constructed and operative in accordance with yet another preferred embodiment of the present invention;

FIGS. 29A, 29B, 29C, 29D and 29E are, taken together, a simplified pictorial illustration of operation of a selectable functionality mobile communication system constructed and operative in accordance with still another preferred embodiment of the present invention;

FIGS. 30A, 30B and 30C are, taken together, a simplified pictorial illustration of operation of a selectable functionality mobile communication system constructed and operative in accordance with yet another preferred embodiment of the present invention;

FIGS. 31A and 31B are, taken together, a simplified pictorial illustration of operation of a selectable functionality mobile communication system constructed and operative in accordance with still another preferred embodiment of the present invention;

FIGS. 32A, 32B and 32C are, taken together, a simplified pictorial illustration of operation of a selectable functionality mobile communication system constructed and operative in accordance with yet another preferred embodiment of the present invention;

FIGS. 33A and 33B are, taken together, a simplified pictorial illustration of operation of a selectable functionality mobile communication system constructed and operative in accordance with still another preferred embodiment of the present invention;

FIGS. 34A, 34B, 34C and 34D are, taken together, a simplified pictorial illustration of operation of a selectable functionality mobile communication system constructed and operative in accordance with still another preferred embodiment of the present invention;

FIGS. 35A, 35B, 35C, 35D and 35E are, taken together, a simplified pictorial illustration of operation of a selectable functionality mobile communication system constructed and operative in accordance with still another preferred embodiment of the present invention;

FIGS. 36A, 36B and 36C are, taken together, a simplified generalized information flow diagram illustration of operation of the selectable functionality mobile communication system of FIGS. 26A-26D;

FIG. 37 is a simplified generalized information flow diagram illustration of operation of the selectable functionality mobile communication system of FIGS. 27A and 27B;

FIGS. 38A and 38B are, taken together, a simplified generalized information flow diagram illustration of operation of the selectable functionality mobile communication system of FIGS. 28A-28C;

FIGS. 39A, 39B and 39C are, taken together, a simplified generalized information flow diagram illustration of operation of the selectable functionality mobile communication system of FIGS. 29A-29E;

FIGS. 40A and 40B are, taken together, a simplified generalized information flow diagram illustration of operation of the selectable functionality mobile communication system of FIGS. 30A-30C;

FIGS. 41A and 41B are, taken together, a simplified generalized information flow diagram illustration of operation of the selectable functionality mobile communication system of FIGS. 31A and 31B;

FIGS. 42A and 42B are, taken together, a simplified generalized information flow diagram illustration of operation of the selectable functionality mobile communication system of FIGS. 32A-32C;

FIG. 43 is a simplified generalized information flow diagram illustration of operation of the selectable functionality mobile communication system of FIGS. 33A-33B;

FIGS. 44A and 44B are, taken together, a simplified generalized information flow diagram illustration of operation of the selectable functionality mobile communication system of FIGS. 34A-34D;

FIGS. 45A, 45B and 45C are, taken together, a simplified generalized information flow diagram illustration of operation of the selectable functionality mobile communication system of FIGS. 35A-35E;

FIGS. 46A and 46B are, taken together, a simplified generalized functional block diagram illustration of operation of the selectable functionality mobile communication system of FIGS. 36A-36D;

FIG. 47 is a simplified generalized functional block diagram illustration of operation of the selectable functionality mobile communication system of FIGS. 37A and 37B;

FIG. 48 is a simplified generalized functional block diagram illustration of operation of the selectable functionality mobile communication system of FIGS. 38A-38C;

FIGS. 49A, 49B and 49C are, taken together, a simplified generalized functional block diagram illustration of operation of the selectable functionality mobile communication system of FIGS. 39A-39E;

FIGS. 50A and 50B are, taken together, a simplified generalized functional block diagram illustration of operation of the selectable functionality mobile communication system of FIGS. 40A-40C;

FIG. 51 is a simplified generalized functional block diagram illustration of operation of the selectable functionality mobile communication system of FIGS. 41A and 41B;

FIGS. 52 is a simplified generalized functional block diagram illustration of operation of the selectable functionality mobile communication system of FIGS. 42A-42C;

FIG. 53 is a simplified generalized functional block diagram illustration of operation of the selectable functionality mobile communication system of FIGS. 43A-43B;

FIGS. 54A and 54B are, taken together, a simplified generalized functional block diagram illustration of operation of the selectable functionality mobile communication system of FIGS. 44A-44D;

FIGS. 55A, 55B and 55C are, taken together, a simplified generalized functional block diagram illustration of operation of the selectable functionality mobile communication system of FIGS. 45A-45E;

FIG. 56 is a simplified illustration of a user interface card constructed and operative in accordance with a preferred embodiment of the present invention.

FIG. 57 is an exploded view illustrating four layers of the interface card of FIG. 56;

FIG. 58 is a diagram illustrating the organization of information in the card of FIGS. 56 & 57;

FIG. 59 is a simplified illustration of a user-interface card intermediary constructed and operative in accordance with a preferred embodiment of the present invention;

FIG. 60 is an exploded view illustrating the user-interface card intermediary of FIG. 59 in association with the interface card of FIGS. 56 and 57;

FIGS. 61A, 61B, 61C, 61D, 61E and 61F are drawings of the electrical circuitry in the card of FIGS. 56 & 57 and the intermediary of FIGS. 59 & 60; and

FIG. 62 is a simplified flow chart illustrating the functionality of software incorporated in the circuitry of FIGS. 61A-61F.

### DETAILED DESCRIPTION OF PREFERRED EMBODIMENTS

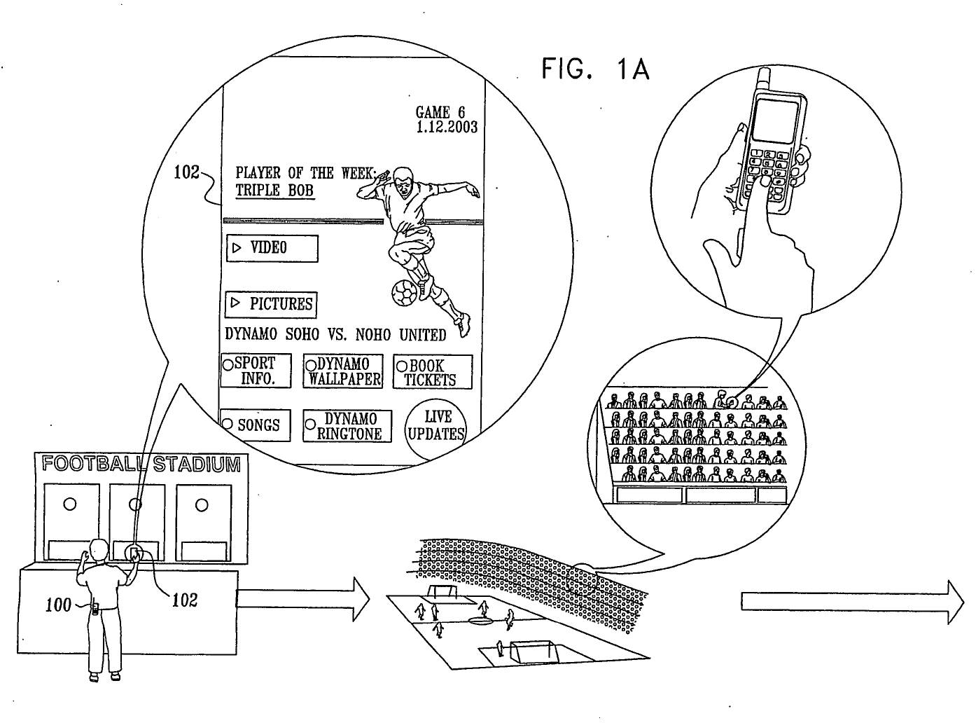

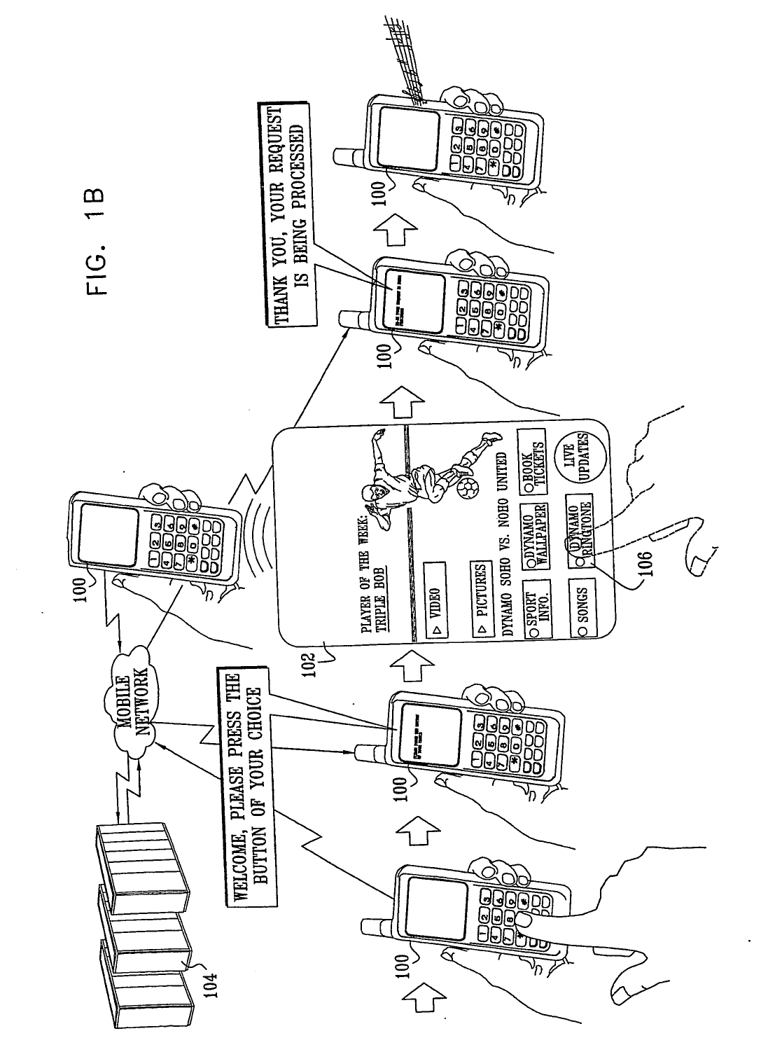

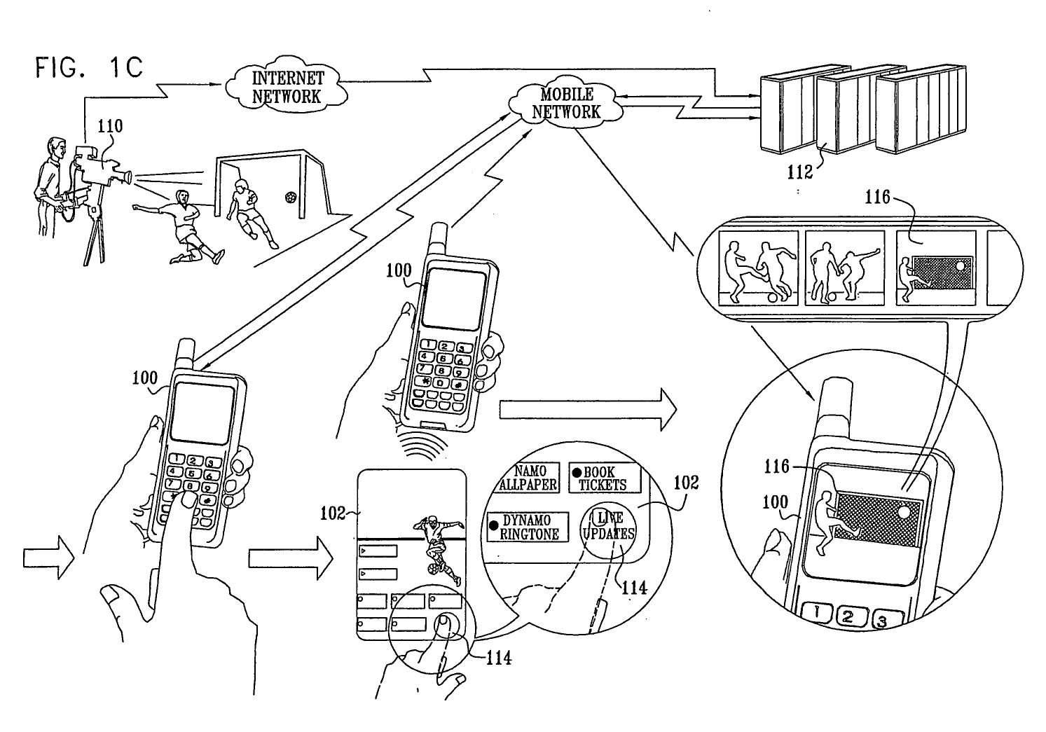

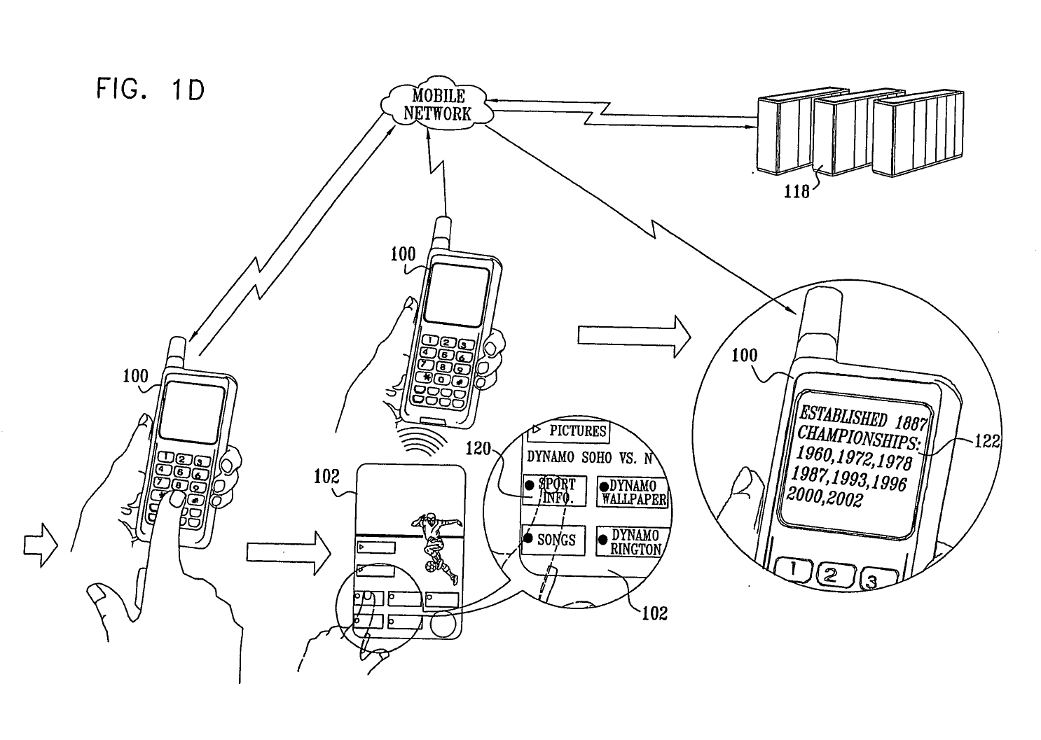

Reference is now made to FIGS. 1A, 1B, 1C and 1D, which are, taken together, a simplified pictorial illustration of operation of a selectable functionality mobile communication system constructed and operative in accordance with a preferred embodiment of the present invention. As seen in FIG. 1A, a typical scenario begins with a sports fan, carrying a mobile telephone 100, purchasing a sound communication enabled mobile communication system user interface card 102, also referred to as a function actuation card, at a ticket window or other retail outlet.

Although the illustrated embodiments show a generally rectangular, two-dimensional, user interface card 102, it is appreciated that the user interface card 102 may be of any shape, such as circular or a geometrically irregular shape, such as a beverage bottle or car. It is further appreciated that the user interface cards described in all of the embodiments contained hereinbelow may also be of any shape.

At any appropriate time thereafter, such as during a game, while seated in the stands, the sports fan may employ the card 102 in one of a number of different functional contexts, three examples of which are described hereinbelow with reference to FIGS. 1B, 1C and 1D, respectively.

Turning to FIG. 1B, it is seen that the sports fan, or any other user, may download a selected ringtone onto his mobile telephone 100 by initially using the mobile telephone to dial to a server 104, via a mobile network. The server 104 provides a voice prompt to the user instructing the user to press a button on the card 102. By pressing on a “RINGTONE” button 106 on card 102, the user causes a ringtone information module to be communicated from card 102 to server 104, via mobile telephone 100 and the mobile network, typically in the form of a tone sequence. The information module includes, inter alia, a request to the server 104 to download a selected ringtone to the mobile telephone 100. The server 104 acknowledges the request, via the mobile telephone 100, as shown, and the ringtone is sent by the server 104 to the mobile telephone 100, via the mobile network. In the illustrated embodiment, sound communication is employed between the card and the mobile telephone 100, it being understood that any other suitable type of communication between the card 102 and the mobile telephone 100 may be employed.

FIG. 1C shows use of the card 102 and the mobile telephone 100 to download a real-time video clip of sports action to the sport fan's mobile telephone 100. The sports action is photographed, typically in real time, by a camera 110, such as a webcam, and is transmitted, typically via the Internet, to a server 112. The sports fan initially uses the mobile telephone 100 to dial to server 112, via a mobile network. The server 112 provides a voice prompt to the user instructing the user to press a button on the card 102. By pressing on a “LIVE UPDATES” button 114 on card 102, the user causes an information module containing a live update request to be communicated from card 102, via the mobile telephone 100 and the mobile network, to the server 112. The requested live update is received, via the mobile network, and displayed on a mobile telephone display, designated by reference numeral 116.

Turning to FIG. 1D, it is seen that card 102 and mobile telephone 100 may be employed to download sports information to the sport fan's mobile telephone 100. The sports information may be stored in a server 118 in a real-time accessible manner. The sports fan initially uses the mobile telephone 100 to dial to server 118, via a mobile network. The server 118 provides a voice prompt to the user instructing the user to press a button on the card 102. By pressing on a “SPORTS INFO” button 120 on card 102, the user typically causes an information module containing a sports information request to be communicated from card 102, via the mobile telephone 100 and the mobile network, to server 118. The requested sports information is received, via the mobile network, and is displayed on a mobile telephone display, designated by reference numeral 122.

It is noted that in an environment wherein an external server is involved, the interaction with the server may be employed additionally to effect payment for functionalities actuated via the user interface card of the present invention. Thus, for example, in such an environment, the card could be distributed for free or a nominal cost and some or all of the user actuable functionalities could be billable through a network-based billing system, preferably a mobile operator or television satellite or cable operator billing system.

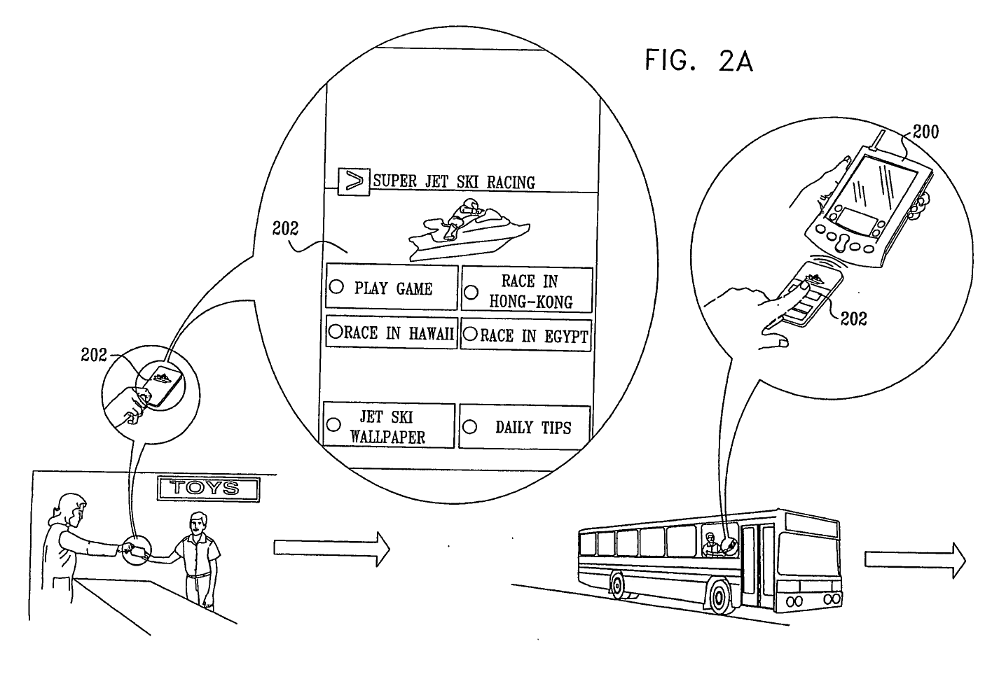

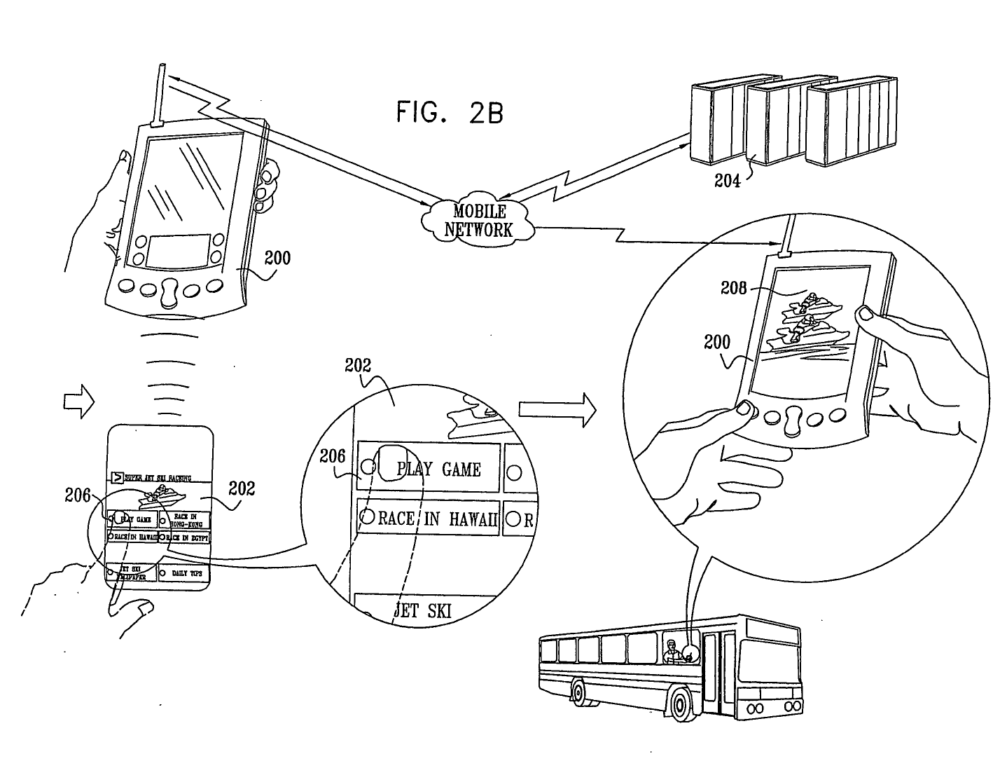

Reference is now made to FIGS. 2A and 2B, which are, taken together, a simplified pictorial illustration of operation of a selectable functionality mobile communication system constructed and operative in accordance with another preferred embodiment of the present invention. As seen in FIG. 2A, a typical scenario begins with a child purchasing a sound and/or IR communication enabled mobile communication system card for use with a mobile device such as a mobile communications enabled PDA (Personal Digital Assistant) 200.

At any appropriate time thereafter, such as during a bus ride, the child may employ a sound and/or IR communication enabled mobile communication system card 202 to download a selected JAVA or BREW game onto his PDA 200 by initially using the PDA 200 to dial to a server 204, via a mobile network, as shown in FIG. 2B. The server 204 provides a voice prompt to the child instructing the child to press a button on the card 202. By pressing on a “PLAY GAME” button 206 on card 202, the child causes a “PLAY GAME” information module to be communicated from card 202 to server 204, via PDA 200 and the mobile network, typically in the form of a tone sequence. Alternatively, the information module may be decoded by the PDA 200. In such a case, the PDA may be actuated by the information module to interact with the server 204 or alternatively the server 204 may be obviated entirely. In this latter case, dialup to the server 204 is also obviated and the card interacts solely with the mobile device.

The information module includes, inter aila, a request to the server 204 to download a selected game to the PDA 200. The server 204 acknowledges the request, via the PDA 200, and the game is sent by the server 204 to the PDA 200, via the mobile network, and is displayed on a PDA display, designated by reference numeral 208.

In the illustrated embodiment, sound and/or IR communication is employed between the card 202 and the PDA 200, it being understood that any other suitable type of communication between the card 202 and the PDA 200 may be employed.

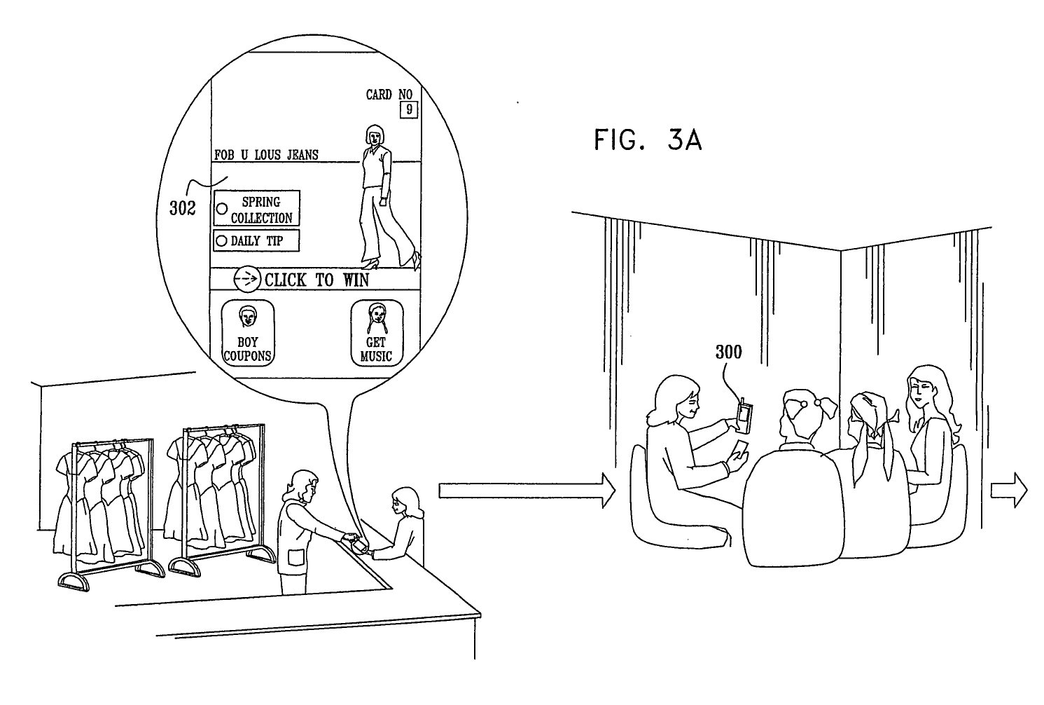

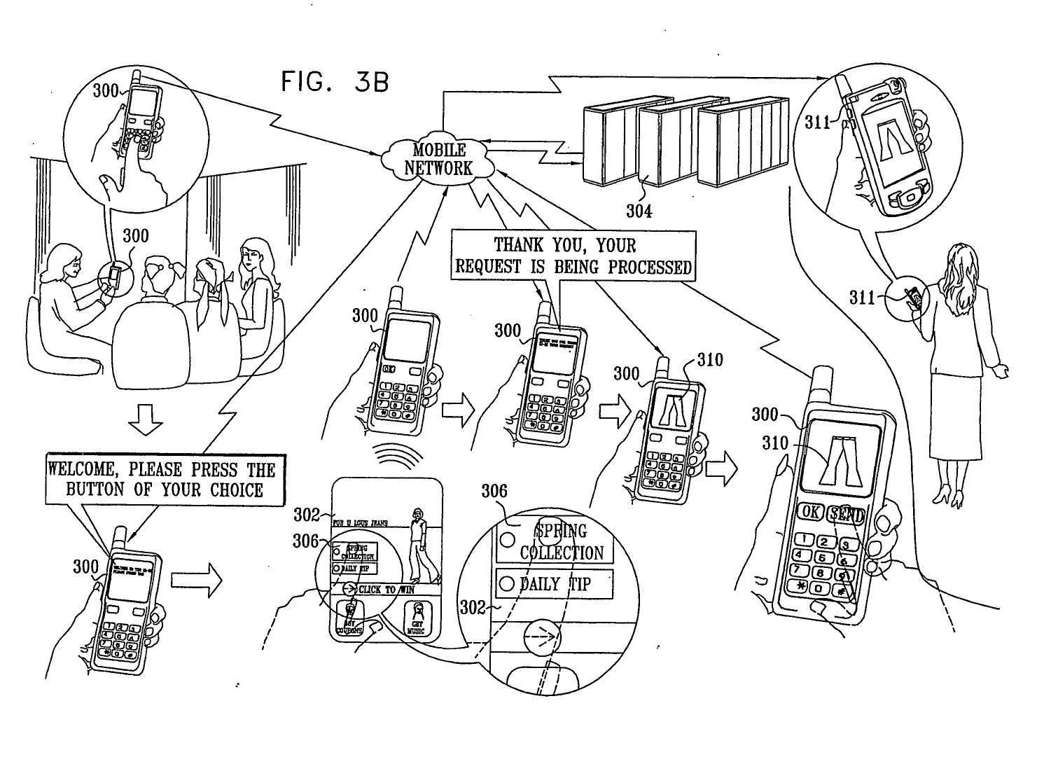

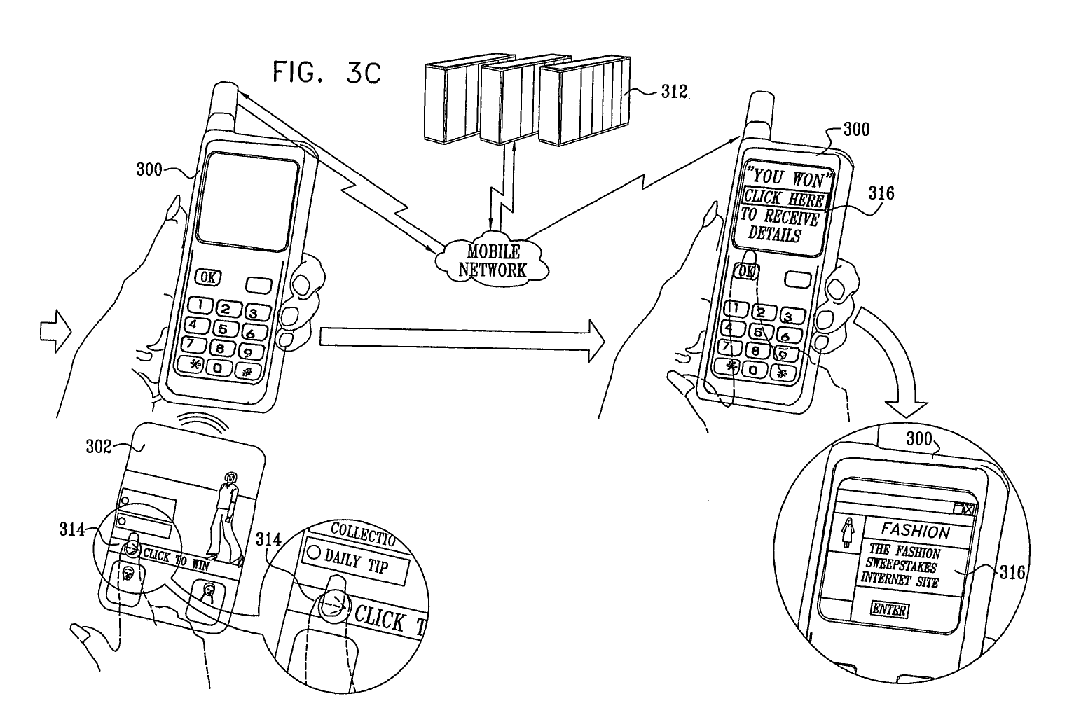

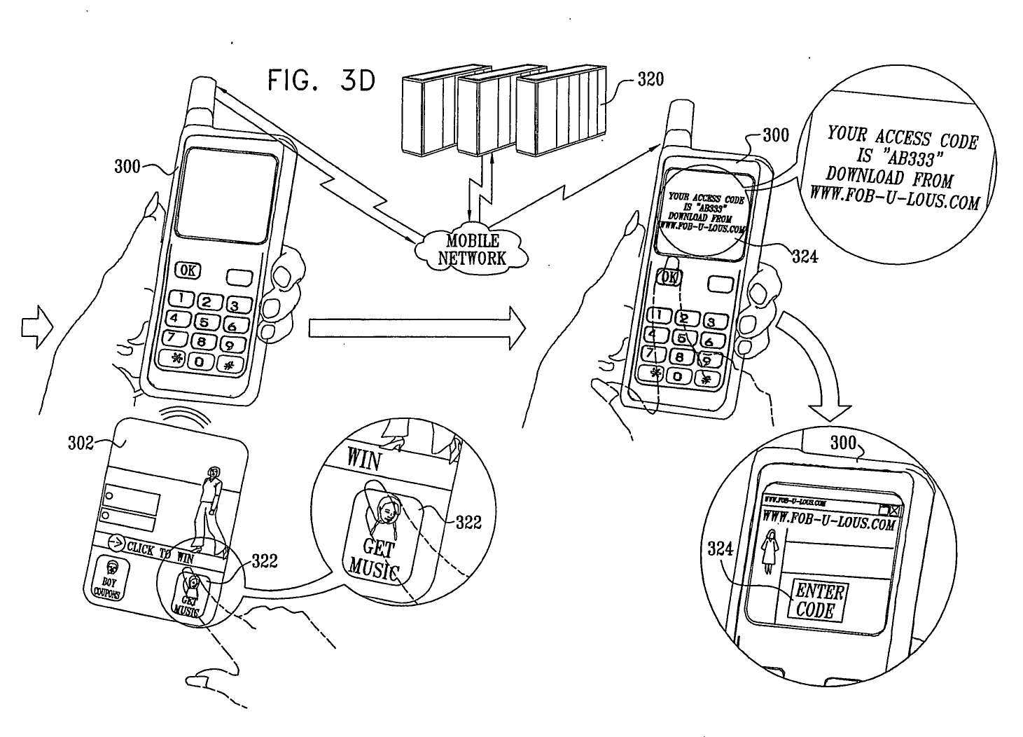

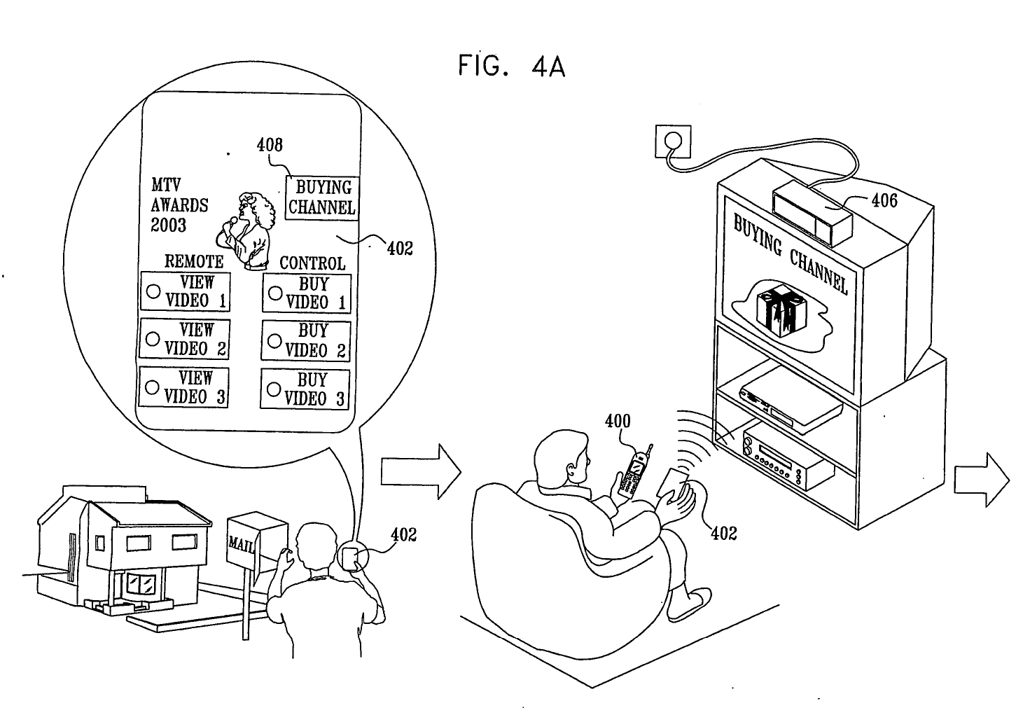

Reference is now made to FIGS. 3A, 3B, 3C and 3D, which are, taken together, a simplified pictorial illustration of operation of a selectable functionality mobile communication system constructed and operative in accordance with yet another preferred embodiment of the present invention. As seen in FIG. 3A, a typical scenario begins with a teenage girl, typically having a mobile telephone 300, purchasing a sound communication enabled mobile communication system user interface card 302 at a clothing store or other retail outlet for use with the mobile telephone 300.

At any appropriate time thereafter, such as during a get-together with girlfriends, the teenage girl may employ card 302 in one of a number of different functional contexts, three examples of which are described hereinbelow with reference to FIGS. 3B, 3C and 3D, respectively.

In FIG. 3B, it is seen that the teenage girl, or any other user, may view a selected display of fashion apparel, such as an item from the latest spring collection, on her mobile telephone 300 by initially using the mobile telephone 300 to dial to a server 304, via a mobile network. The server 304 provides a voice prompt to the girl instructing her to press a button on the card 302. By pressing on a “SPRING COLLECTION” button 306 on the card 302, she causes a “SPRING COLLECTION” request information module to be communicated from the card 302 to server 304, via mobile telephone 300 and the mobile network, typically in the form of a tone sequence. The information module includes, inter alia, a request to the server 304 to download a selected image to the mobile telephone 300. The server 304 acknowledges the request, via the mobile telephone 300, and the image is sent by the server 304 to the mobile telephone 300, via the mobile network, and is displayed on a mobile telephone display, designated by reference numeral 310. As seen in FIG. 3B, the image may then be transmitted, such as in the form of a SMS message, via the mobile network, to a mobile telephone 311 of a recipient other than the user. Alternatively, the image may be transmitted from server 304 directly to the recipient's mobile telephone 311. In such a case, a voice prompt is provided to the user, using mobile telephone 300, requesting the communication contact particulars of the intended recipient.

In the illustrated embodiment, sound communication is employed between the card 302 and the mobile telephone 300, it being understood that any other suitable type of communication between the card 302 and the mobile telephone 300 may be employed.

Turning to FIG. 3C, it is seen that the card 302 and the mobile telephone 300 may be employed to enter a fashion sweepstakes and link up to a fashion sweepstakes internet site. The sweepstakes internet site is linked to a server 312. The teenage girl initially uses the mobile telephone 300 to dial to server 312, via a mobile network. The server 312 provides a voice prompt to the girl instructing her to press a button on the card 302. By pressing on a “CLICK TO WIN” button 314 on the card 302, the girl typically causes an information module containing a “CLICK TO WIN” request to be communicated from the card 302 to the mobile telephone 300. The mobile telephone 300 communicates, via a mobile network, with the server 312 and receives the fashion sweepstakes entry response, which is displayed on a mobile telephone display, designated by reference numeral 316 and enables further browsing of the fashion sweepstakes internet site displayed on the mobile telephone display 316 or alternatively displayed on any other computer accessed by the user.

Turning to FIG. 3D, it is seen that the card 302 and the mobile telephone 300 may be employed to download proprietary music and link up to a music download internet site. The music download internet site is linked to a server 320. The teenage girl initially uses the mobile telephone 300 to dial to server 320, via a mobile network. The server 320 provides a voice prompt to the girl instructing her to press a button on the card 302. By pressing on a “GET MUSIC” button 322 on the card 302, the girl typically causes an information module containing a “GET MUSIC” request to be communicated from the card 302 to the mobile telephone 300. The mobile telephone 300 communicates, via a mobile network, with the server 320 and receives a music download entitlement code, which is displayed on a mobile telephone display, designated by reference numeral 324 and enables access to the music download internet site displayed on the mobile telephone display 324 or alternatively displayed on any other computer accessed by the user.

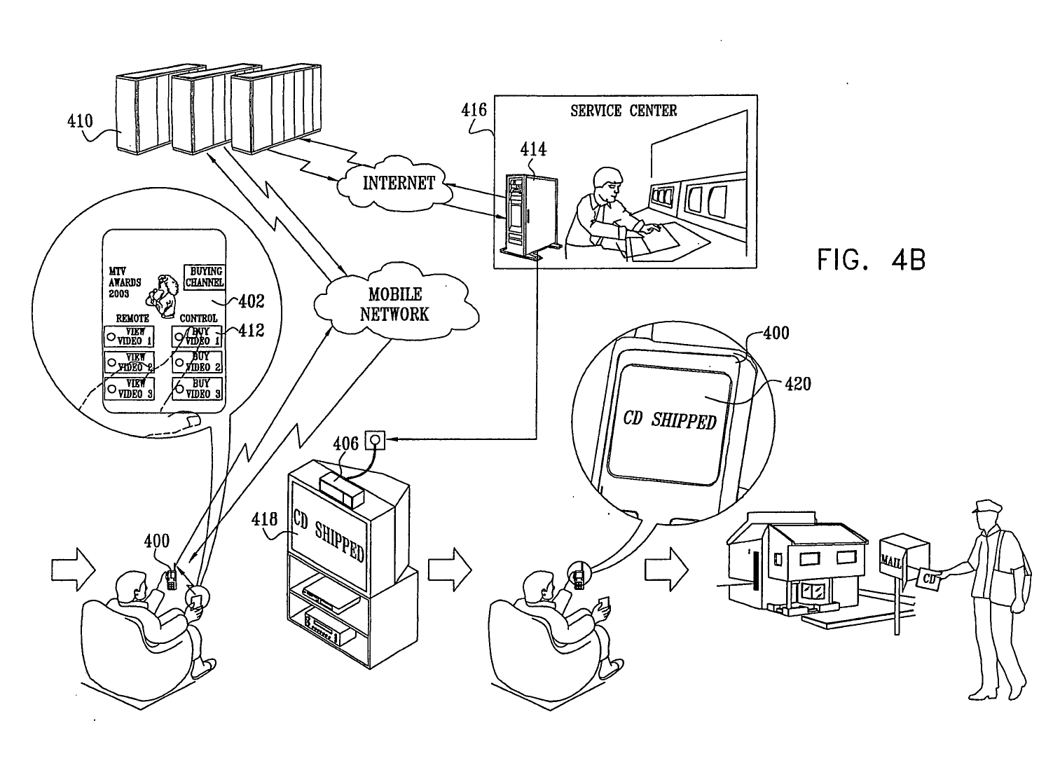

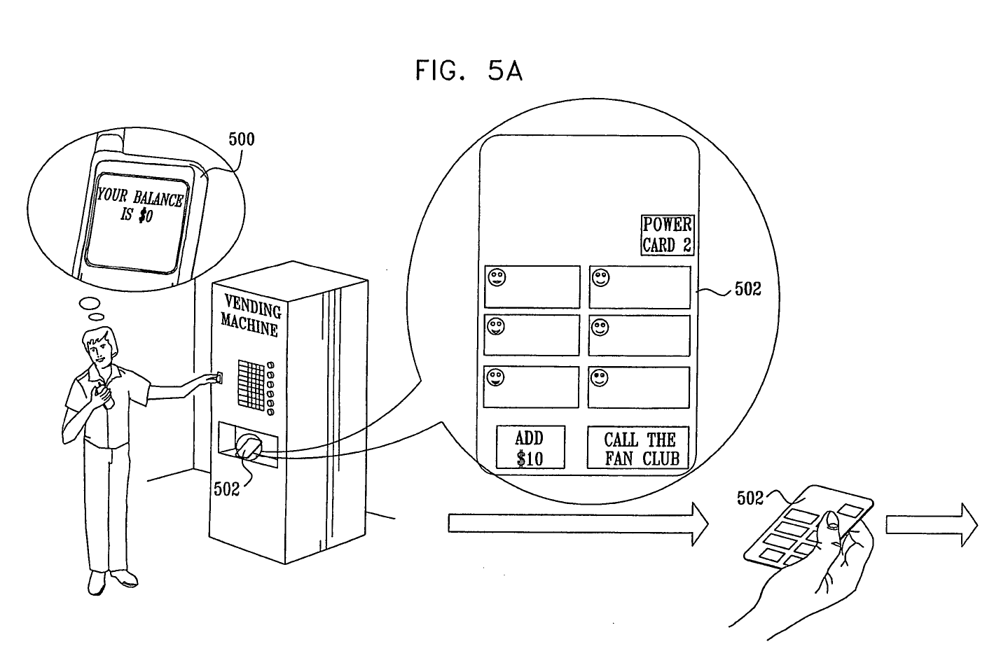

Reference is now made to FIGS. 4A and 4B, which are, taken together, a simplified pictorial illustration of operation of a selectable functionality mobile communication system constructed and operative in accordance with still another preferred embodiment of the present invention. As seen in FIG. 4A, a typical scenario begins with a consumer, typically having a mobile telephone 400, receiving an IR and/or sound communication enabled mobile communication system user interface card 402, via mail or any other means of delivery. It is appreciated that card 402 is preferably programmed to contain all appropriate identification of the user, based on pre-registration of the user, normally at the user's request.

At any appropriate time thereafter, such as while watching a television program, the consumer may select an application, via an interactive television functionality, such as a set top box 406. As shown in FIG. 4A, the consumer may employ the card 402 in an infra-red communications mode vis a vis the set top box 406 to select a buying channel, as by pressing a “BUYING CHANNEL” button 408 on card 402. At this stage, the consumer may proceed, for example in a sound communications mode, in one of a number of different functional contexts, one example of which is described hereinbelow with reference to FIG. 4B.

FIG. 4B shows use of the card 402 and mobile telephone 400 to order a music video compact disk. The consumer initially uses the mobile telephone 400 to provide back channel functionality, in this case to dial to a server 410, via a mobile network. The server 410 provides a voice prompt to the consumer instructing the consumer to press a button on the card 402. By pressing on a “BUY VIDEO 1” button 412 on the card 402, the consumer utilizes back channel functionality of the card, typically by causing an information module containing a “BUY VIDEO 1” request to be communicated from the card 402, via mobile telephone 400. The mobile telephone 400 communicates the request, via a mobile network, to the server 410. In the illustrated embodiment, sound communication is employed at this stage for communication between the card 402 and the server 410, via the mobile telephone 400, it being understood that any other suitable type of communication between the card 402 and the server 410 may be employed.

The server 410, in turn, typically communicates, via Internet, with a TV cable network server 414, typically located at a service center 416. A confirmation of the order receipt is displayed on a television screen, designated by reference numeral 418. When prompted by server 414 a service center representative arranges for the music video compact disk to be delivered to the consumer. A confirmation of the order receipt may be displayed on a mobile telephone display, designated by reference numeral 420.

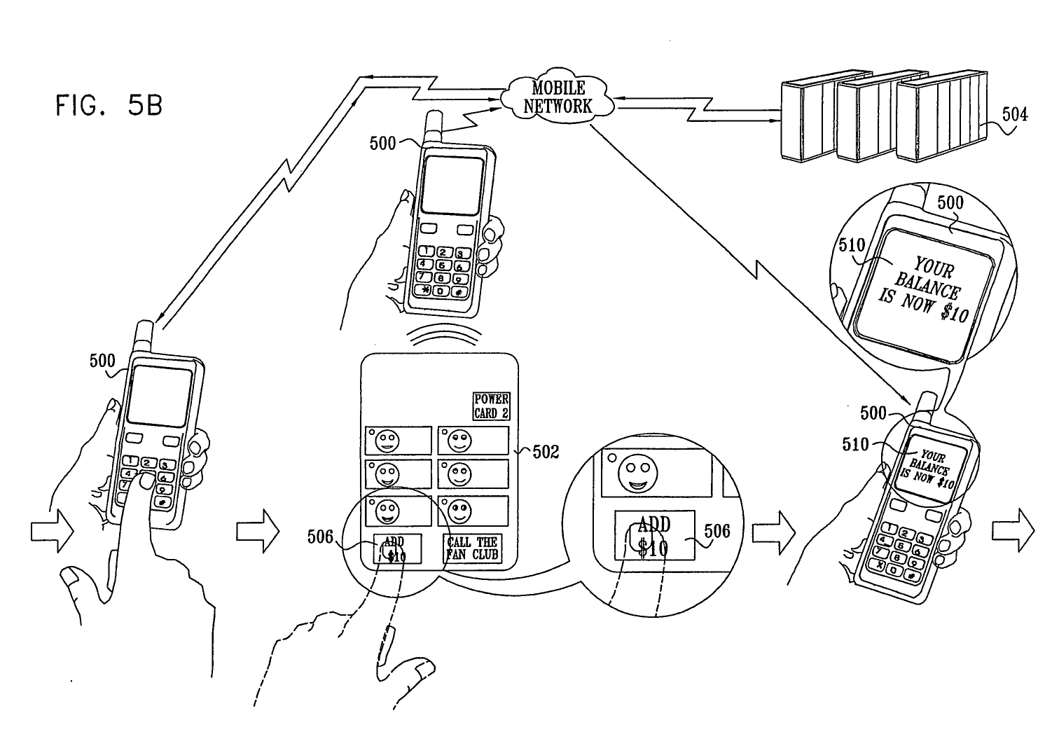

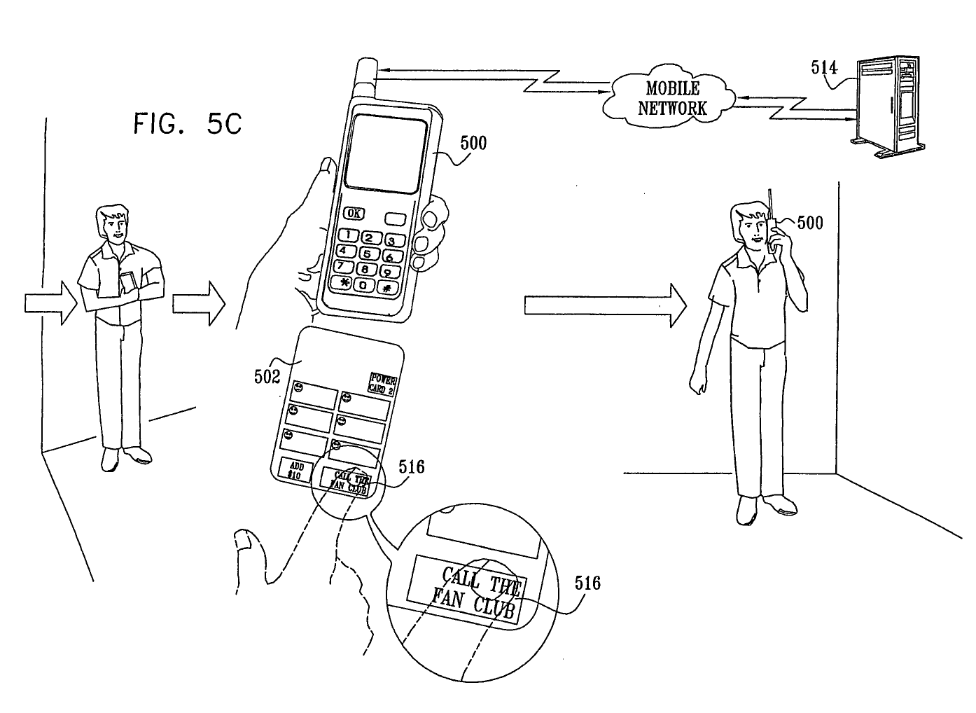

Reference is now made to FIGS. 5A, 5B and 5C, which are, taken together, a simplified pictorial illustration of operation of a selectable functionality mobile communication system constructed and operative in accordance with a further preferred embodiment of the present invention. As seen in FIG. 5A, a typical scenario begins with a member of a fan club, carrying a mobile telephone 500, purchasing a sound communication enabled user interface card 502, here functioning as a mobile communication system refill card, at a vending machine or other retail outlet.

At any appropriate time thereafter, the fan club member may employ the card 502 in one of a number of different functional contexts, two examples of which are described hereinbelow with reference to FIGS. 5B and 5C, respectively.

In FIG. 5B, it is seen that the fan club member, or any other user, may increase the balance of his pre-paid account by initially employing the mobile telephone 500 to dial to a server 504, via a mobile network. The server 504 provides a voice prompt to the fan club member instructing the fan club member to press a button on the card 502. By pressing on an “ADD $10” button 506 on card 502, the fan club member causes an “ADD $10” information module containing a unique secret number to be communicated from card 502 to the mobile telephone 500. The mobile telephone 500 communicates the request to increase balance, via a mobile network, to the server 504. Increase of balance confirmation is displayed on a mobile telephone display, designated by reference numeral 510.

Turning to FIG. 5C, it is seen that the fan club member, or any other user, may initiate a mobile telephone call from the mobile telephone 500 by initially employing the mobile telephone 500 to dial to a server 514, via a mobile network. The server 514 provides a voice prompt to the fan club member instructing the fan club member to press a button on the card 502. By pressing on a “CALL THE FAN CLUB” button 516 on the card 502, the fan club member causes a “CALL THE FAN CLUB” information module containing the request to call the fan club to be communicated from the card 502 to the mobile telephone 500. The server 514 in turn dials a mobile telephone number to call the fan club.

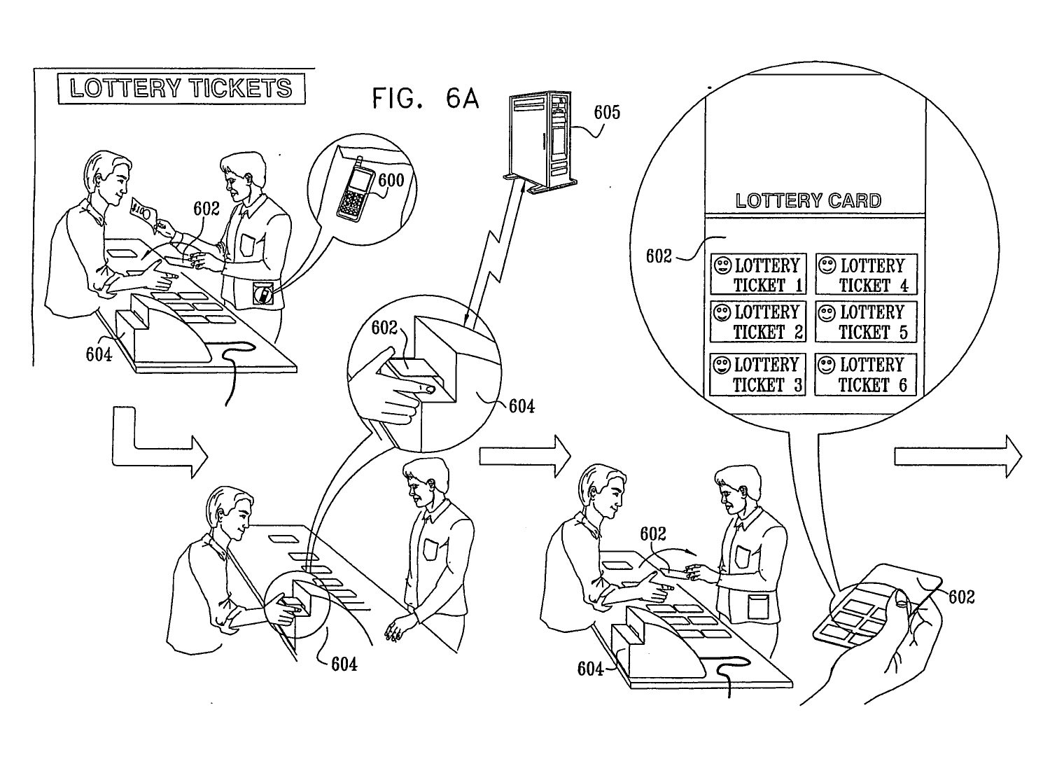

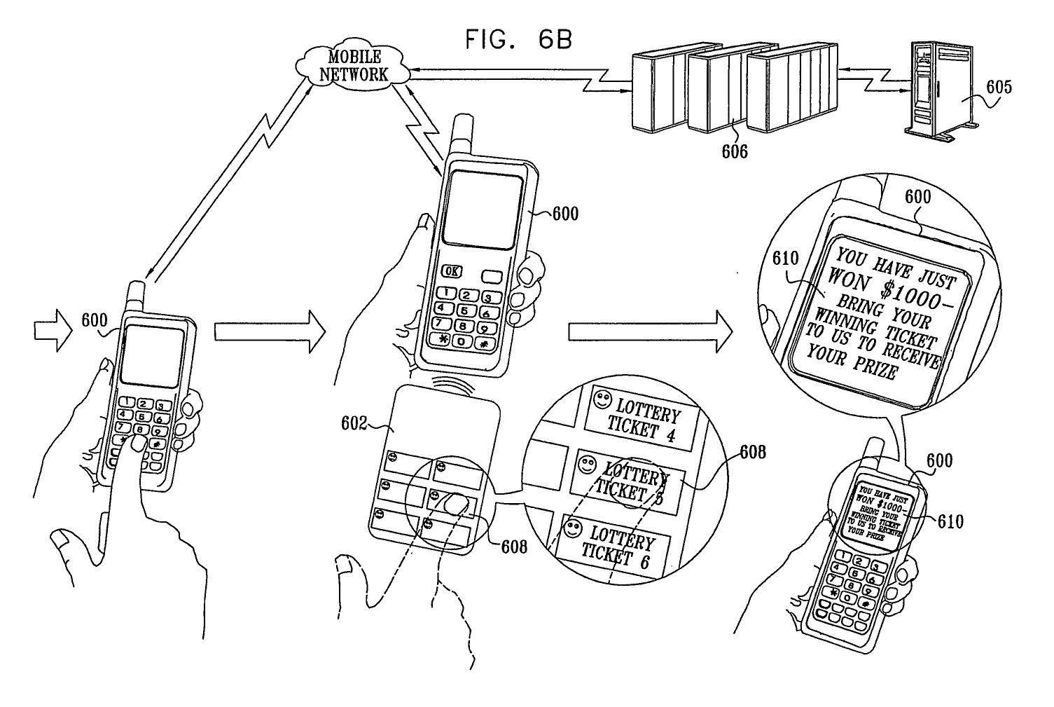

Reference is now made to FIGS. 6A and 6B, which are, taken together, a simplified pictorial illustration of operation of a selectable functionality mobile communication system constructed and operative in accordance with a yet further preferred embodiment of the present invention. As seen in FIG. 6A, a typical scenario begins with a lottery player, typically having a mobile telephone 600, purchasing a point-of-sale programmable sound communication enabled mobile communication system user interface card 602, here functioning as a lottery card, at a lottery ticket booth or other retail outlet. At the lottery ticket booth the lottery ticket card 602 is issued a secret number by a point-of-sale terminal 604, which communicates with a lottery server 605.

At any appropriate time thereafter, the lottery player may employ the card 602 in a number of different functional contexts, one of which is described hereinbelow with reference to FIG. 6B.

Turning to FIG. 6B, it is seen that the lottery player, or any other user, may select a given lottery entry ticket by initially employing the mobile telephone 600 to dial to a server 606, via a mobile network. The server 606 provides a voice prompt to the lottery player instructing the lottery player to press a button on the card 602. By pressing on a “LOTTERY TICKET” button 608 on card 602, the lottery player causes a “LOTTERY TICKET” information module containing a lottery entry request including a unique secret lottery number to be communicated from the card 602 to mobile telephone 600. The mobile telephone 600 communicates the lottery entry request, via a mobile network, to server 606, which, in turn, communicates the lottery entry request to lottery server 605. The lottery results are displayed on a mobile telephone display, designated by reference numeral 610, or as an audio transmission, via the mobile telephone 600.

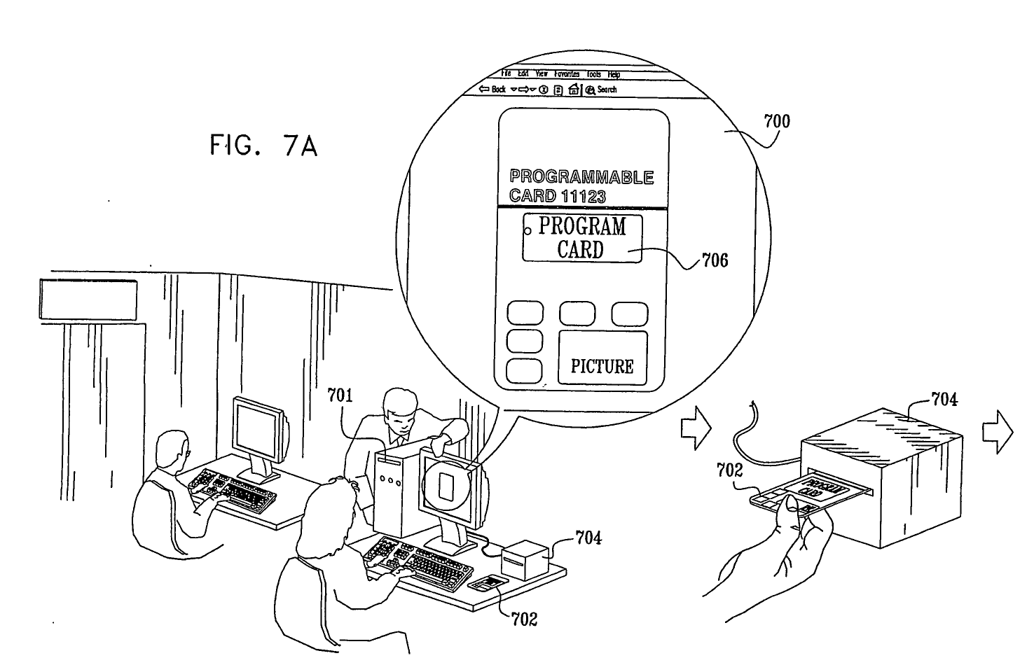

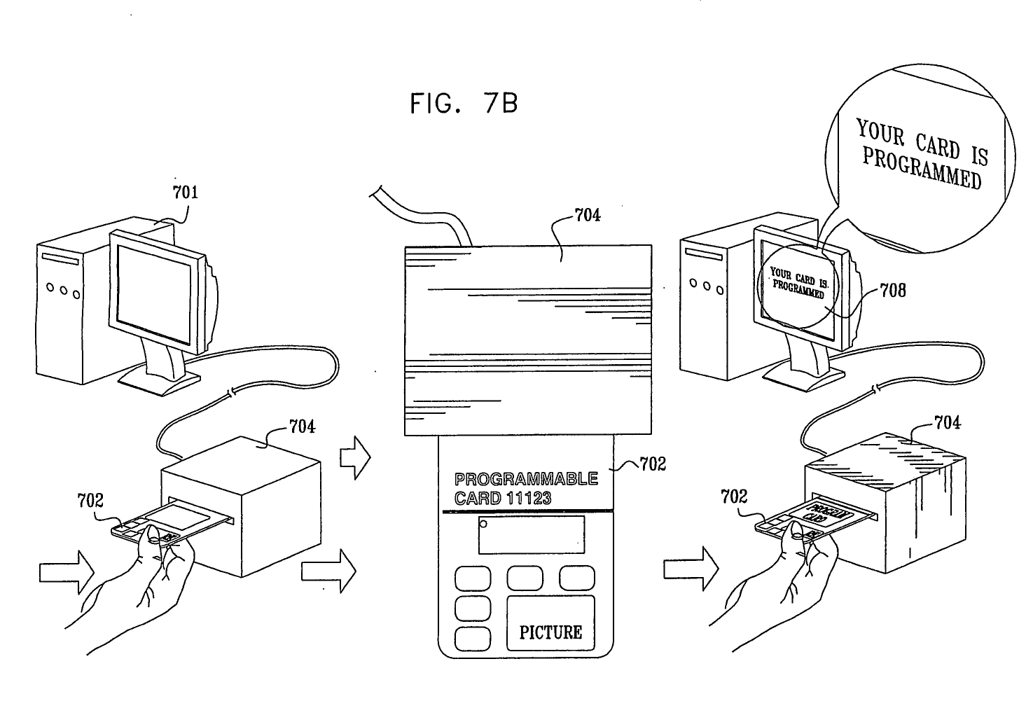

Reference is now made to FIGS. 7A and 7B, which are, taken together, a simplified pictorial illustration of operation of a selectable functionality communication system constructed and operative in accordance with a still further preferred embodiment of the present invention. As seen in FIG. 7A, a typical scenario begins with a PC user browsing through an Internet site 700, displayed on a screen of a computer 701, which screen displays simulated programmable cards that can be downloaded to a customizable user interface card 702.

At any appropriate time thereafter, the PC user may program the user interface card 702 by inserting the user interface card 702 into a card programmer 704, which is connected to the computer 701. As seen in FIG. 7B, the PC user may download selected information modules to the card 702 by clicking on a “PROGRAM CARD” location 706 (FIG. 7A) on site 700, causing a desired information module to be programmed into card 702 by computer 701. A confirmation is displayed on the computer screen, designated by reference numeral 708.

It is to be appreciated that the foregoing description and drawings present various examples of various features of systems and subsystems constructed and operative in accordance with a preferred embodiment of the present invention. Novel combinations of the features described hereinabove in various different contexts are within the scope of the present invention.

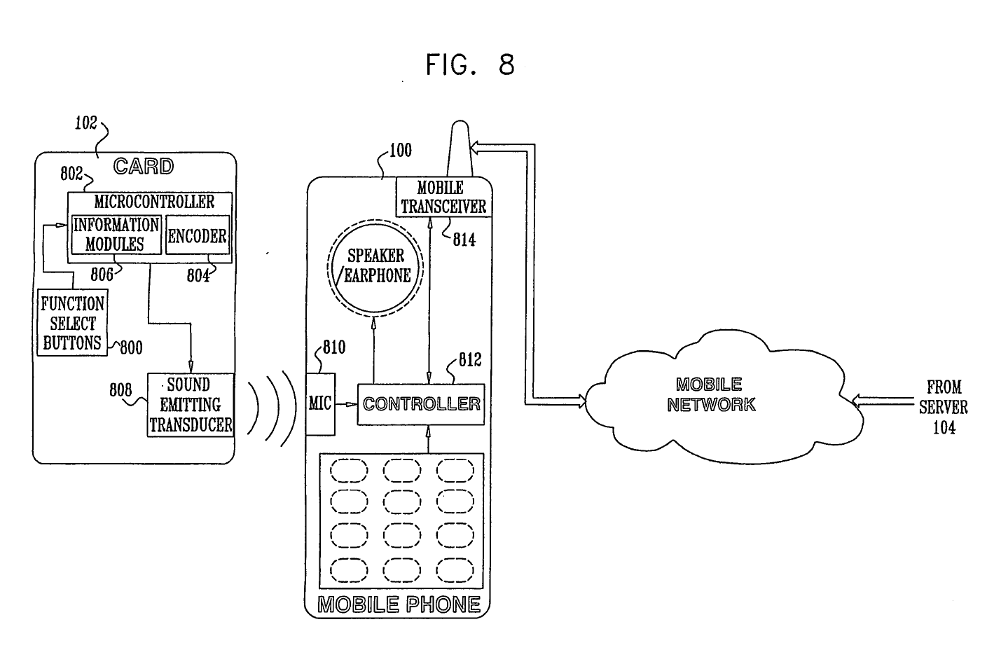

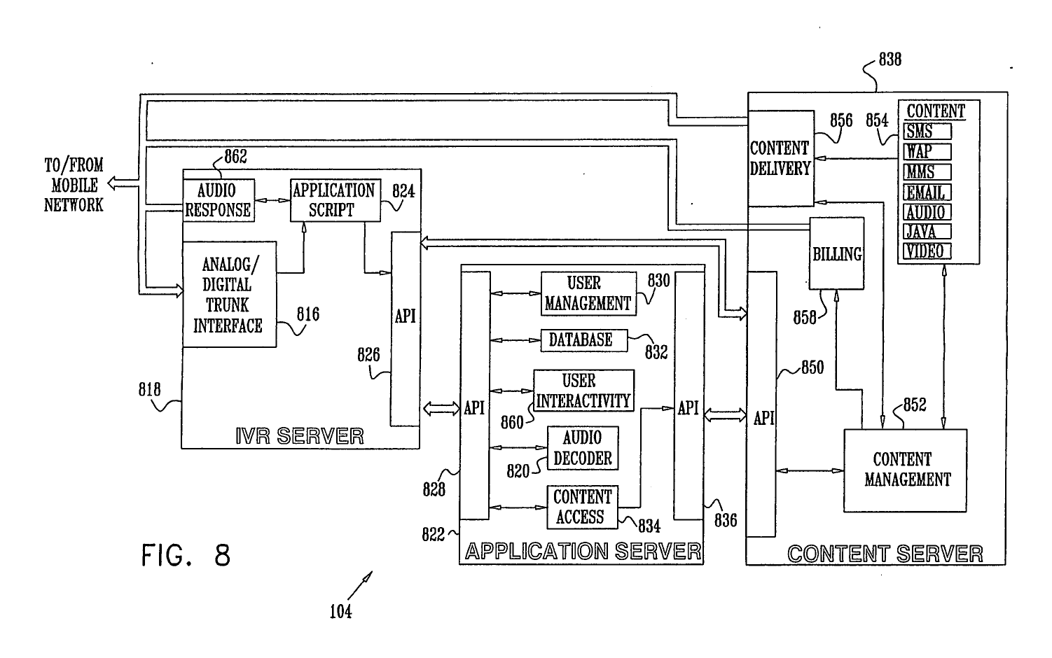

Reference is now made to FIGS. 8/1 and 8/2, which, together, are a simplified generalized functional block diagram illustration of operation of the selectable functionality mobile communication system of FIGS. 1A, 1B, 1C and 1D. As seen in FIGS. 8/1 and 8/2, which correspond to FIG. 1B, sound communication enabled mobile communication system user interface card 102 preferably comprises function select buttons 800 which communicate with a microcontroller 802, preferably including an encoder 804 and containing in its memory space a plurality of application actuation information modules 806. Each information module 806 preferably contains a function select button identifier and a unique identifier corresponding to each individual card 102.

As seen in FIGS. 8/1 and 8/2, following a dialup connection between the mobile telephone 100 and the server 104, in response to a user's pressing on the ringtone button 106 (FIG. 1B), which is one of the function select buttons 800 (FIG. 8/1), microcontroller 802 identifies a selected information module 806, which corresponds to the ringtone button 106, which was pressed by the user. The microcontroller 802 retrieves the selected information module 806 and encodes it by employing encoder 804, preferably using FSK or DTMF coding and transmits it, via a sound emitting transducer 808, to a microphone 810 in mobile telephone 100, preferably as a sequence of tones.

The sequence of tones received by microphone 810 is transmitted to a controller 812 of mobile telephone 100. Controller 812 transmits the sequence of tones, via a mobile transceiver 814 and via the mobile network, to an analog/digital trunk interface 816 of an IVR server 818, forming part of server 104. The received sequence of tones is supplied by the trunk interface 816 to an audio decoder 820, forming part of an application server 822, which may be integral with IVR server 818 or may, as shown, be separate therefrom, and forms part of server 104.

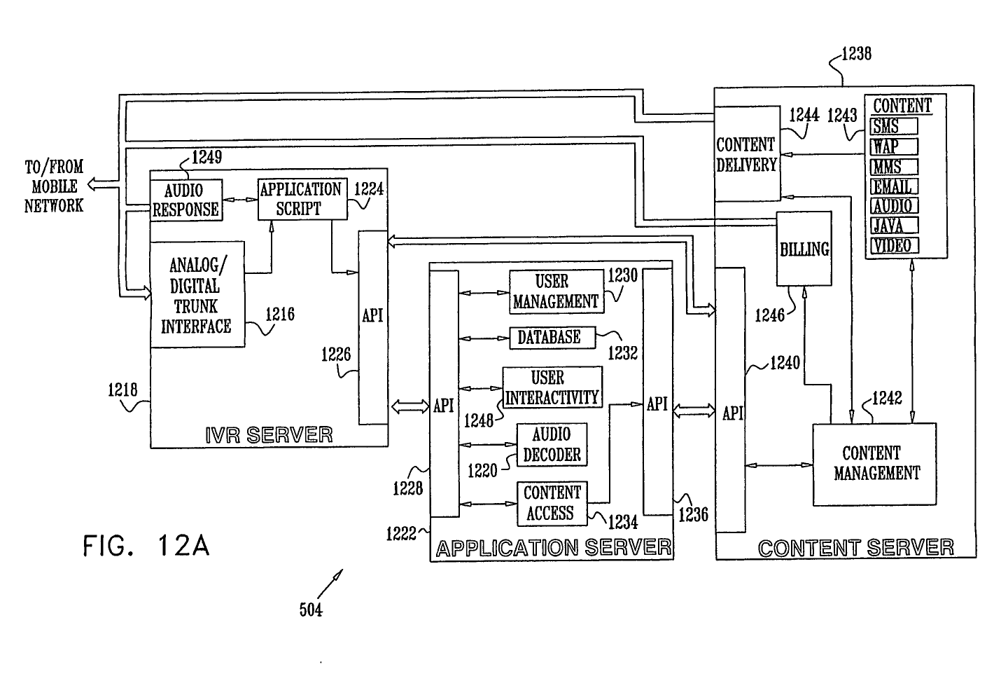

An application script 824, whose functionality is described hereinbelow in greater detail with reference to FIGS. 14-21, is operative to facilitate the communication of the sequence of tones from the trunk interface 816 to the audio decoder 820. Preferably, as shown in the illustrated embodiment, a pair of communicating application programming interfaces (APIs) 826 and 828, respectively resident in the IVR server 818 and the application server 822, participates in this communication. The APIs 826 and 828 may communicate in any suitable manner, such as via the Internet. It is appreciated that the IVR server 818 may also be employed for providing voice prompts to the user during dialup as described hereinabove with reference to FIGS. 1B-1D.

Audio decoder 820 decodes the sequence of tones and transmits the decoded information modules, via API 828, typically to a user management module 830 and a database 832 in application server 822, for determining user entitlement. Upon validation of user entitlement, the user management module 830 sends a request, via a content access module 834 and an API 836, to a content server 838, which also forms part of server 104.

The request is received, via an API 850, by a content management module 852. The content management module 852 retrieves an appropriate ringtone in an appropriate format from a content store 854 and sends it from the content store 854, via a content delivery module 856, via the mobile network, to the mobile telephone 100. Content store 854 may be updatable in real time, so as to provide, for example, access to real-time video, as in the embodiment of FIG. 1C. The ringtone can be sent to the mobile telephone 100 in one of a number of possible formats, such as, for example, SMS, WAP and MMS.

Where card 102 is not a pre-paid card, the content management module 852 may also provide a billing instruction to a billing module 858. Billing module 858 may reside in the content server 838, as shown, or may be remote therefrom. Billing module 858 may communicate, via the mobile network or via any other suitable network, with a remote billing server, as appropriate.

The user management module 830 in the application server 822 may provide various user prompts or other user communications as determined by a user interactivity module 860. These user communications may, for example, inform the user, that the selected ringtone has been sent to mobile telephone 100 or inform the user of the card's current entitlement status. As another example, a user communication may request that the user listen to the requested ringtone prior to sending it to the user's mobile telephone. The user communications are preferably transmitted, via an audio response module 862 in the IVR server 818. Audio response module 862 is preferably also employed for providing user communications during dialup.

In the embodiment of FIGS. 1A and 1C, actuation of the button 114 (FIG. 1C) causes a selected video clip to be downloaded to the mobile telephone 100 from remote server 112. In the embodiment of FIGS. 1A and 1D, actuation of the button 120 (FIG. 1D) causes a selected sports information clip to be downloaded to the mobile telephone 100 from remote server 118. The functionality described hereinabove with reference to FIGS. 8/1 and 8/2 is applicable to these embodiments as well.

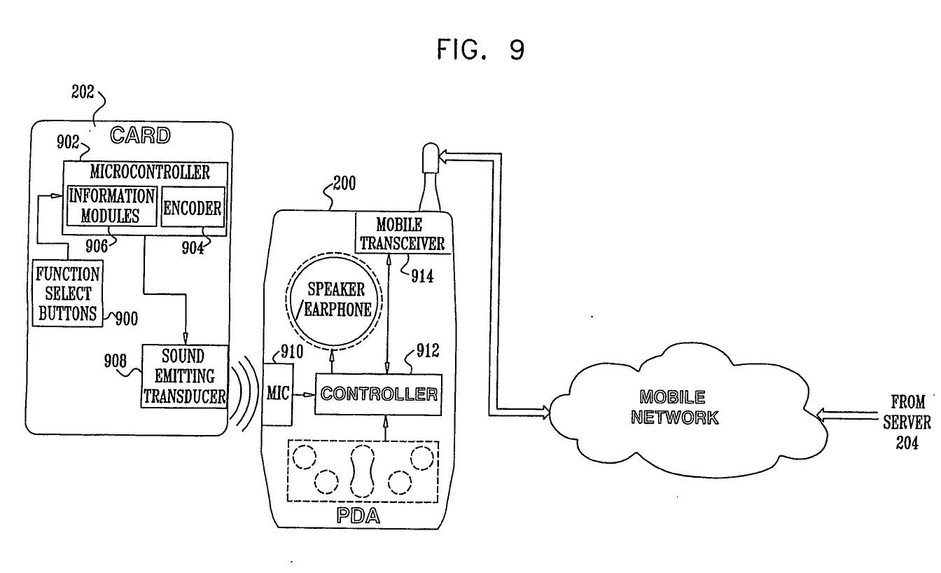

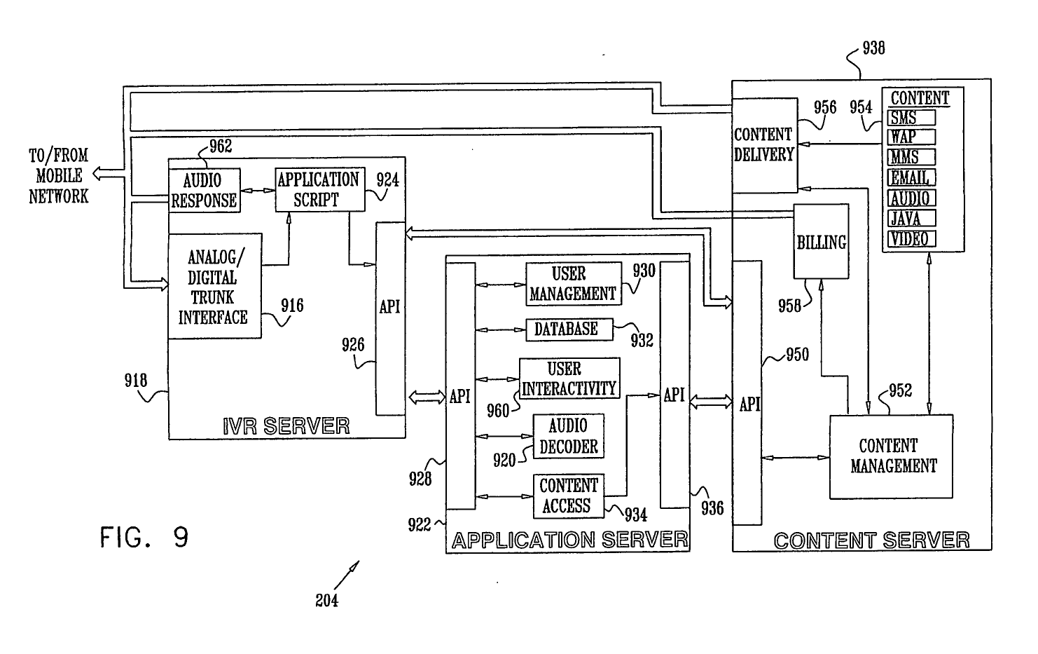

Reference is now made to FIGS. 9/1 and 9/2, which, together, are a simplified generalized functional block diagram illustration of operation of the selectable functionality mobile communication system of FIGS. 2A and 2B. As seen in FIGS. 9/1 and 9/2, which correspond to FIG. 2B, sound communication enabled mobile communication system user interface card 202 preferably comprises function select buttons 900 which communicate with a microcontroller 902, preferably including an encoder 904 and containing in its memory space a plurality of application actuation information modules 906. Each information module 906 preferably contains a function select button identifier and a unique identifier corresponding to each individual card 202.

As seen in FIGS. 9/1 and 9/2, following a dialup connection between the mobile communications enabled PDA 200 and the server 204, in response to a user's pressing on the “PLAY GAME” button 206 (FIG. 2B), which is one of the function select buttons 900 (FIG. 9/1), microcontroller 902 identifies a selected information module 906, which corresponds to the “PLAY GAME” button 206, which was pressed by the user. The microcontroller 902 retrieves the selected information module 906 and encodes it by employing encoder 904, preferably using FSK or DTMF coding and transmits it, via a sound emitting transducer 908, to a microphone 910 in PDA 200, preferably as a sequence of tones.

The sequence of tones received by microphone 910 is transmitted to a controller 912 of PDA 200. Controller 912 transmits the sequence of tones, via a mobile transceiver 914 and via the mobile network, to an analog/digital trunk interface 916 of an IVR server 918, forming part of server 204. The received sequence of tones is supplied by the trunk interface 916 to an audio decoder 920, forming part of an application server 922, which may be integral with IVR server 918 or, may, as shown, be separate therefrom, and forms part of server 204.

An application script 924, whose functionality is described hereinbelow in greater detail with reference to FIGS. 14-21, is operative to facilitate the communication of the sequence of tones from the trunk interface 916 to the audio decoder 920. Preferably, as shown in the illustrated embodiment, a pair of communicating APIs (application programming interfaces) 926 and 928, respectively resident in the IVR server 918 and the application server 922, participates in this communication. The APIs 926 and 928 may communicate in any suitable manner, such as via the Internet. It is appreciated that the IVR server 918 is also employed for providing voice prompts to the user during dialup as described hereinabove with reference to FIG. 2B.

Audio decoder 920 decodes the sequence of tones and transmits the decoded information modules, via API 928, typically to a user management module 930 and a database 932 in application server 922, for determining user entitlement. Upon validation of user entitlement, the user management module 930 sends a request, via a content access module 934 and an API 936, to a content server 938, which also forms part of server 204.

The request is received, via an API 950, by a content management module 952. The content management module 952 retrieves an appropriate game, such as a JAVA or BREW game, in an appropriate format from a content store 954 and sends it from the content store 954, via a content delivery module 956, via the mobile network, to the PDA 200. Content store 954 may be updatable in real time, so as to provide, for example, access to real-time games. The game can be sent to the PDA 200 in one of a number of possible formats, such as, for example, SMS, WAP and MMS.

Where card 202 is not a pre-paid card, the content management module 952 may also provide a billing instruction to a billing module 958. Billing module 958 may reside in the content server 938, as shown, or may be remote therefrom. Billing module 958 may communicate, via the mobile network or via any other suitable network, with a remote billing server, as appropriate.

The user management module 930 in the application server 922 may provide various user prompts or other user communications as determined by a user interactivity module 960. These user communications may, for example, inform the user, that the selected game has been sent to PDA 200 or inform the user of the card's current entitlement status. An audio response module 962 is preferably also employed for providing user communications during dialup. As a further example, the game can be provided in interactive form in the context of a WAP session initiated by the content delivery module 956.

Reference is now made to FIGS. 10/1 and 10/2, which, together, are a simplified generalized functional block diagram illustration of operation of the selectable functionality mobile communication system of FIGS. 3A and 3B. As seen in FIGS. 10/1 and 10/2, which correspond to FIG. 3B, sound communication enabled mobile communication system user interface card 302 preferably comprises function select buttons 1000 which communicate with a microcontroller 1002, preferably including an encoder 1004 and containing in its memory space a plurality of application actuation information modules 1006. Each information module 1006 preferably contains a function select button identifier and a unique identifier corresponding to each individual card 302.

As seen in FIGS. 10/1 and 10/2, following a dialup connection between the mobile telephone 300 and the server 304, in response to a user's pressing on the “SPRING COLLECTION” button 306 (FIG. 3B), which is one of the function select buttons 1000 (FIG. 10/1), microcontroller 1002 identifies a selected information module 1006, which corresponds to the “SPRING COLLECTION” button 306, which was pressed by the user. The microcontroller 1002 retrieves the selected information module 1006 and encodes it by employing encoder 1004, preferably using FSK or DTF coding and transmits it, via a sound emitting transducer 1008, to a microphone 1010 in mobile telephone 300, preferably as a sequence of tones.

The sequence of tones received by microphone 1010 is transmitted to a controller 1012 of mobile telephone 300. Controller 1012 transmits the sequence of tones, via a mobile transceiver 1014 and via the mobile network, to an analog/digital trunk interface 1016 of an IVR server 1018, forming part of server 304. The received sequence of tones is supplied by the trunk interface 1016 to an audio decoder 1020, forming part of an application server 1022, which may be integral with IVR server 1018 or may, as shown, be separate therefrom, and forms part of server 304.

An application script 1024, whose functionality is described hereinbelow in greater detail with reference to FIGS. 14-21, is operative to facilitate the communication of the sequence of tones from the trunk interface 1016 to the audio decoder 1020. Preferably, as shown in the illustrated embodiment, a pair of communicating APIs (application programming interfaces) 1026 and 1028, respectively resident in the IVR server 1018 and the application server 1022, participates in this communication. The APIs 1026 and 1028 may communicate in any suitable manner, such as via the Internet. It is appreciated that the IVR server 1018 is also employed for providing voice prompts to the user during dialup as described hereinabove with reference to FIG. 3B.

Audio decoder 1020 decodes the sequence of tones and transmits the decoded information modules, via API 1028, typically to a user management module 1030 and a database 1032 in application server 1022, for determining user entitlement. Upon validation of user entitlement, the user management module 1030 sends a request, via a content access module 1034 and an API 1036, to a content server 1038, which also forms part of server 304.

The request is received, via an API 1050, by a content management module 1052. The content management module 1052 retrieves an appropriate image in an appropriate format from a content store 1054 and sends it from the content store 1054, via a content delivery module 1056, via the mobile network, to the mobile telephone 300. Content store 1054 may be updatable in real time, so as to provide, for example, access to real-time image updates which may be sent to the mobile telephone 300 in one of a number of possible formats, such as, for example, SMS, WAP and MMS.

Where card 302 is not a pre-paid card, the content management module 1052 may also provide a billing instruction to a billing module 1058. Billing module 1058 may reside in the content server 1038, as shown, or may be remote therefrom. Billing module 1058 may communicate, via the mobile network or via any other suitable network, with a remote billing server, as appropriate.

The user management module 1030 in the application server 1022 may provide various user prompts or other user communications as determined by a user interactivity module 1060. These user communications may, for example, inform the user, that the selected image has been sent to mobile telephone 300 or inform the user of the card's current entitlement status. An audio response module 1062 is preferably also employed for providing user communications during dialup. As a further example, the image can be provided in interactive form in the context of a WAP session initiated by the content delivery module 1056.

With particular reference to the embodiment of FIG. 3C, server 312 (FIG. 3C) may also include a sweepstakes server 1070. Sweepstakes server 1070 preferably includes an entry registry 1072 which stores a register of all unique secret numbers assigned to each of the individual cards 302. In this embodiment, typically the cards 302 each include a secret number information module 1074, which is communicated by the functionality described hereinabove, via the mobile network and the application server 1022, to the entry registry 1072 of the sweepstakes server 1070. The secret number of each card is supplied to a random selection module 1076 of the sweepstakes server 1070, which determines whether that secret number is a winner.

With particular reference to the embodiment of FIG. 3D, server 320 (FIG. 3D) may be embodied in content server 1038 (FIG. 10/2). In this embodiment, typically the entitlement code is provided in SMS or email format in the content store 1054.

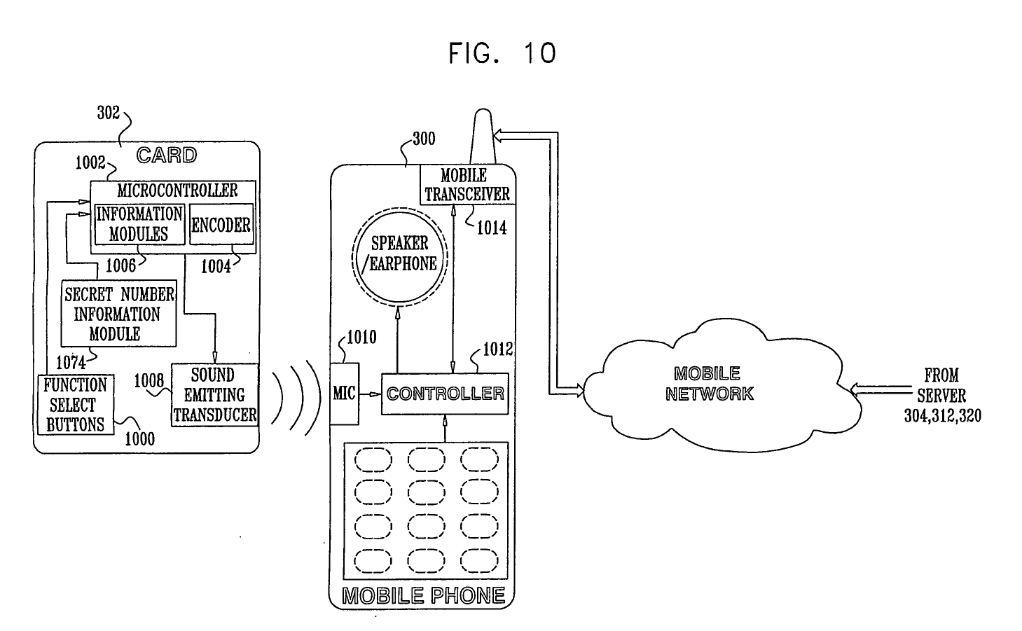

Reference is now made to FIGS. 11/1 and 11/2, which, together, are a simplified generalized functional block diagram illustration of operation of the selectable functionality mobile communication system of FIGS. 4A and 4B. As seen in FIGS. 11/1 and 11/2, which correspond to FIG. 4B, IR and sound communication enabled mobile communication system user interface card 402 preferably comprises function select buttons 1100 which communicate with a microcontroller 1102, preferably including an encoder 1104 and containing in its memory space a plurality of application actuation information modules 1106. Each information module 1106 preferably contains a function select button identifier and a unique identifier corresponding to each individual card 402.

As seen in FIGS. 11/1 and 11/2, following selection of an appropriate cable/TV channel, such as a buying channel, as by IR communication with set top box 406 (FIGS. 4A & 4B) or by any suitable type of communication with set top box 406, via a set top box controller 1107 and an IR communicator 1108, following pressing of the “BUYING CHANNEL” button 408 (FIG. 4A), which is one of the function select buttons 1100, a visual prompt is provided to the user, via television screen 418 (FIG. 4B).

The user initiates a dialup connection between the mobile telephone 400 and the server 410. In response to a user's pressing on the “BUY VIDEO 1” button 412 (FIG. 4B), which is also one of the function select buttons 1100 (FIG. 11/1), microcontroller 1102 identifies a selected information module 1106 which corresponds to the “BUY VIDEO 1” button 412 which was pressed by the user. The microcontroller 1102 retrieves the selected information module 1106 and encodes it by employing encoder 1104, preferably using FSK or DTMF coding and transmits it, via a sound emitting transducer 1109, to a microphone 1110 in mobile telephone 400, preferably as a sequence of tones.

The sequence of tones received by microphone 1110 is transmitted to a controller 1112 of mobile telephone 400. Controller 1112 transmits the sequence of tones, via a mobile transceiver 1114 and via the mobile network, to an analog/digital trunk interface 1116 of an IVR server 1118, forming part of server 410 (FIG. 4B). The received sequence of tones is supplied by the trunk interface 1116 to an audio decoder 1120, forming part of an application server 1122, which may be integral with IVR server 1118 or may, as shown, be separate therefrom, and forms part of server 410.

An application script 1124, whose functionality is described hereinbelow in greater detail with reference to FIGS. 14-21, is operative to facilitate the communication of the sequence of tones from the trunk interface 1116 to the audio decoder 1120. Preferably, as shown in the illustrated embodiment, a pair of communicating APIs (application programming interfaces) 1126 and 1128, respectively resident in the IVR server 1118 and the application server 1122, participates in this communication. The APIs 1126 and 1128 may communicate in any suitable manner, such as via the Internet. It is appreciated that the IVR server 1118 is also employed for providing voice prompts to the user during dialup as described hereinabove with reference to FIG. 4B.

Audio decoder 1120 decodes the sequence of tones and transmits the decoded information modules, via API 1128, typically to a user management module 1130 and a database 1132 in application server 1122, for determining user entitlement. Upon validation of user entitlement, the user management module 1130 sends a request, via a content access module 1134 and an API 1136, to a TV/CABLE server 1138, which also forms part of server 410.

The request is received, via an API 1150, by an order management module 1152. The order management module transmits a request to a content store 1154 to transmit an order for an appropriate video cartridge to be sent to the user, such as by mail or courier. Content store 1154 then transmits the request, via a content delivery module 1156, to the TV cable network server 414 (FIG. 4B), typically located at service center 416 (FIG. 4B). As described hereinabove in reference to FIG. 4B, server 414 typically prompts a service center representative to arrange for the music video compact disk to be delivered.

Alternatively, order management module 1152 transmits a request to provide an appropriate video to be displayed on the TV of the user. The order management module 1152 then orders the appropriate video to be sent from the content store 1154, via the content delivery module 1156 and the TV cable network server 414, to the display 418 (FIG. 4B).

Content store 1154 may be updatable in real time, so as to provide, for example, access to real-time video.

Where card 402 is not a pre-paid card, the order management module 1152 may also provide a billing instruction to a billing module 1158. Billing module 1158 may reside in the TV/CABLE server 1138, as shown, or may be remote therefrom. Billing module 1158 may communicate, via the mobile network or via any other suitable network, with a remote billing server, as appropriate.

The user management module 1130 in the application server 1122 may provide various user prompts or other user communications as determined by a user interactivity module 1160. These user communications may, for example, inform the user, that the selected video has been sent to the user or inform the user of the card's current entitlement status. Audio response module 1162 is preferably also employed for providing user communications during dialup.

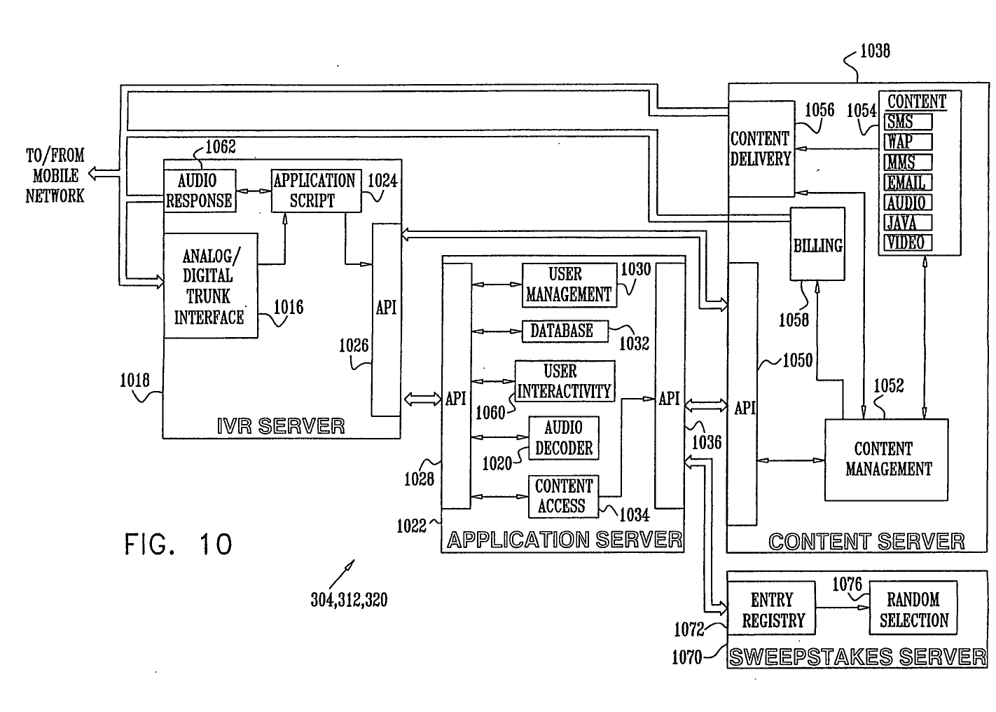

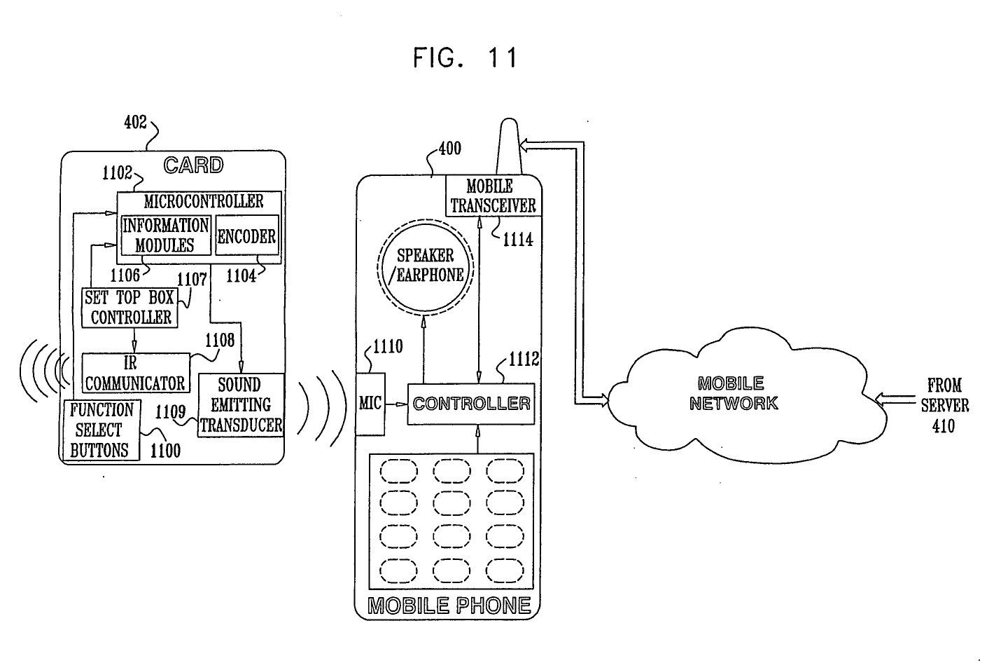

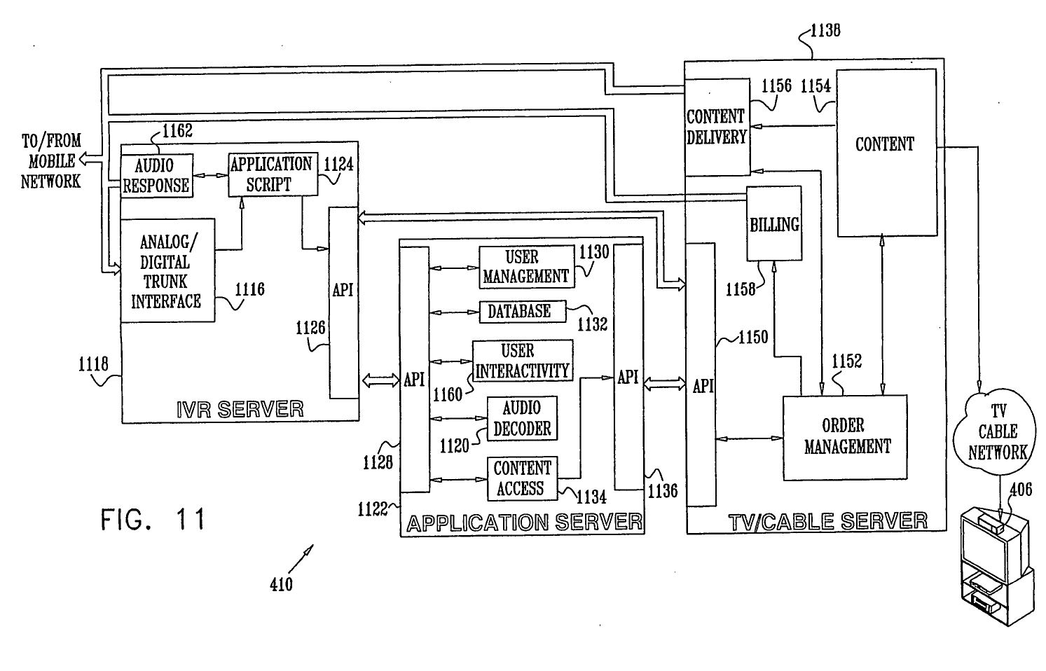

Reference is now made to FIGS. 12A/1 and 12A/2, which, together, are a simplified generalized functional block diagram illustration of operation of the selectable functionality mobile communication system of FIGS. 5A and 5B. As seen in FIGS. 12A/1 and 12A/2, which correspond to FIG. 5B, sound communication enabled mobile communication system user interface card 502 preferably comprises function select buttons 1200 which communicate with a microcontroller 1202, preferably including an encoder 1204 and containing in its memory space a plurality of application actuation information modules 1206. Each information module 1206 preferably contains a function select button identifier and a unique identifier corresponding to each individual card 502.

As seen in FIG. 12A/1, card 502 may be programmed, as by a point-of-sale programmer 1207, via a programming port 1208 which communicates with microcontroller 1202. In the embodiment of FIGS. 5A & 5B and 12A/1 & 12A/2, value or entitlements may be readily added to card 502 at a point of sale, using programmer 1207. Programmer 1207 may be embodied in an automatic vending machine.

As seen in FIGS. 12A/1 and 12A/2, following a dialup connection between the mobile communications enabled mobile telephone 500 and the server 504, in response to a user's pressing on the “ADD $10” button 506 (FIG. 5B), which is one of the function select buttons 1200 (FIG. 12A/1), microcontroller 1202 identifies a selected information module 1206 which corresponds to the “ADD $10” button 506 which was pressed by the user. The microcontroller 1202 retrieves the selected information module 1206 and encodes it by employing encoder 1204, preferably using FSK or DTMF coding and transmits it, via a sound emitting transducer 1209, to a microphone 1210 in mobile telephone 500, preferably as a sequence of tones.

The sequence of tones received by microphone 1210 is transmitted to a controller 1212 of mobile telephone 500. Controller 1212 transmits the sequence of tones, via a mobile transceiver 1214 and via the mobile network, to an analog/digital trunk interface 1216 of an IVR server 1218, forming part of server 504. The received sequence of tones is supplied by the trunk interface 1216 to an audio decoder 1220, forming part of an application server 1222, which may be integral with IVR server 1218 or may, as shown, be separate therefrom, and forms part of server 504.

An application script 1224, whose functionality is described hereinbelow in greater detail with reference to FIGS. 14-21, is operative to facilitate the communication of the sequence of tones from the trunk interface 1216 to the audio decoder 1220. Preferably, as shown in the illustrated embodiment, a pair of communicating APIs (application programming interfaces) 1226 and 1228, respectively resident in the IVR server 1218 and the application server 1222, participates in this communication. The APIs 1226 and 1228 may communicate in any suitable manner, such as via the Internet. It is appreciated that the IVR server 1218 is also employed for providing voice prompts to the user during dialup as described hereinabove with reference to FIG. 5B.

Audio decoder 1220 decodes the sequence of tones and transmits the decoded information modules, via API 1228, typically to a user management module 1230 and a database 1232 in application server 1222, for determining user entitlement. Upon validation of user entitlement, the user management module 1230 sends a request, via a content access module 1234 and an API 1236, to a content server 1238, which also forms part of server 504.

The request is received, via an API 1240, by a content management module 1242. The content management module 1242 retrieves an appropriate message, such as an SMS message, from a content store 1243 and transmits the message, via a content delivery module 1244, via the mobile network, to the mobile telephone 500, indicating the updated balance of the user. The content management module 1242 also provides a credit update instruction to a billing module 1246. Billing module 1246 may reside in the content server 1238, as shown, or may be remote therefrom. Billing module 1246 may communicate, via the mobile network or via any other suitable network, with a remote billing server, as appropriate.

The user management module 1230 in the application server 1222 may provide various user prompts or other user communications as determined by a user interactivity module 1248. These user communications may, for example, inform the user of the card's current entitlement status. Audio response module 1249 is preferably also employed for providing user communications during dialup.

Reference is now made to FIGS. 12B/1 and 12B/2, which, together, are a simplified generalized functional block diagram illustration of operation of the selectable functionality mobile communication system of FIGS. 5A and 5C. As seen in FIGS. 12B/1 and 12B/2, which correspond to FIG. 5C, sound communication enabled mobile communication system user interface card 502 preferably comprises function select buttons 1250 which communicate with a microcontroller 1252, preferably including an encoder 1254 and containing in its memory space a plurality of information modules 1256. Each information module 1256 preferably contains a function select button identifier and a unique identifier corresponding to each individual card 502.

As seen in FIGS. 12B/1 and 12B/2, following a dialup connection between the mobile communications enabled mobile telephone 500 and the server 514, in response to a user's pressing on the “CALL THE FAN CLUB” button 516 (FIG. 5C), which is one of the function select buttons 1250 (FIG. 12B/1), microcontroller 1252 identifies a selected information module 1256 which corresponds to the “CALL THE FAN CLUB” button 516 which was pressed by the user. The microcontroller 1252 retrieves the selected information module 1256 and encodes it by employing encoder 1254, preferably using FSK or DTMF coding and transmits it, via a sound emitting transducer 1258, to a microphone 1260 in mobile telephone 500, preferably as a sequence of tones.

The sequence of tones received by microphone 1260 is transmitted to a controller 1262 of mobile telephone 500. Controller 1262 transmits the sequence of tones, via a mobile transceiver 1264 and via the mobile network, to an analog/digital trunk interface 1266 of an IVR server 1268, forming part of server 514. The received sequence of tones is supplied by the trunk interface 1266 to an audio decoder 1270, forming part of an application server 1272, which may be integral with IVR server 1268 or may, as shown, be separate therefrom, and forms part of server 514.

An application script 1274, whose functionality is described hereinbelow in greater detail with reference to FIGS. 14-21, is operative to facilitate the communication of the sequence of tones from the trunk interface 1266 to the audio decoder 1270. Preferably, as shown in the illustrated embodiment, a pair of communicating APIs (application programming interfaces) 1276 and 1278, respectively resident in the IVR server 1268 and the application server 1272, participates in this communication. The APIs 1276 and 1278 may communicate in any suitable manner, such as via the Internet. It is appreciated that the IVR server 1268 is also employed for providing voice prompts to the user during dialup as described hereinabove with reference to FIG. 5C.

Audio decoder 1270 decodes the sequence of tones and transmits the decoded information modules, via API 1278, typically to a user management module 1280 and a database 1282 in application server 1272, for determining user entitlement. Upon validation of user entitlement, the user management module 1280 sends a request, via a content access module 1283, to a dialer module 1284, which typically resides in IVR server 1268 and which dials to a fan club phone center.

The user management module 1280 in the application server 1272 may provide various user prompts or other user communications as determined by a user interactivity module 1286. These user communications may, for example, inform the user of the card's current entitlement status. Audio response module 1288 is preferably also employed for providing user communications during dialup.

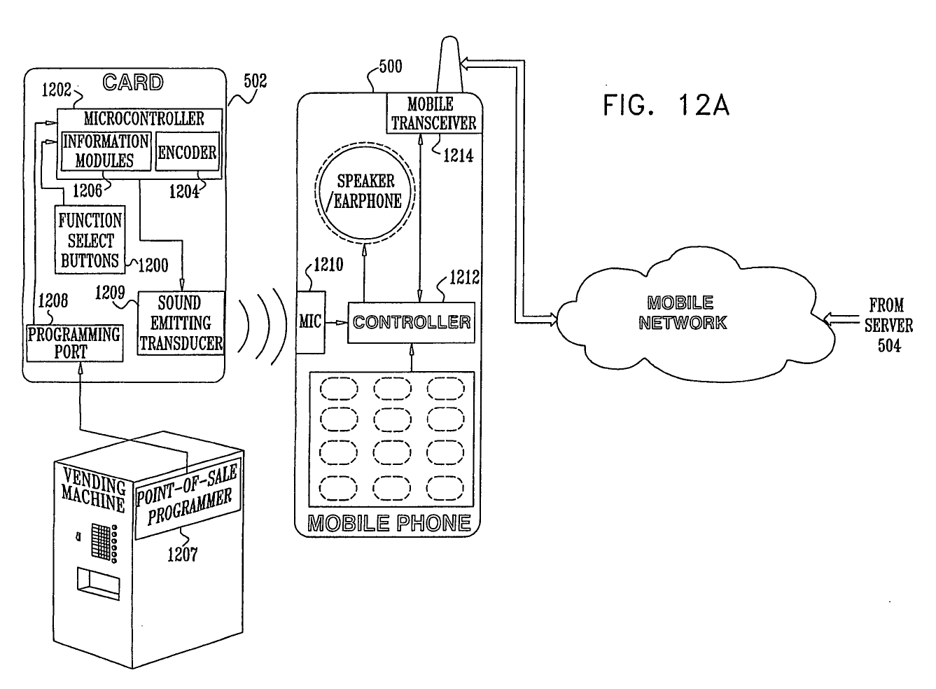

Reference is now made to FIGS. 13/1 and 13/2, which, together, are a simplified generalized functional block diagram illustration of operation of the selectable functionality mobile communication system of FIGS. 6A and 6B. As seen in FIGS. 13/1 and 13/2, which correspond to FIG. 6B, point-of-sale programmable sound communication enabled mobile communication system user interface card 602 preferably comprises function select buttons 1300 which communicate with a microcontroller 1302, preferably including an encoder 1304 and containing in its memory space a plurality of information modules 1306. Each information module 1306 preferably contains a function select button identifier and a unique identifier corresponding to each individual card 602.

Additionally, point-of-sale programmable card 602 preferably includes a point-of-sale programmable information module 1308, which may receive a secret identification number, preferably via a programming port 1310, which preferably includes one or more electrical contacts. The card, which may be reusable, typically has no value until it is programmed at the point of sale, by conventional point-of-sale card programming apparatus, and then is enabled in accordance with predetermined criteria.

As seen in FIGS. 13/1 and 13/2, following a dialup connection between the mobile communications enabled mobile telephone 600 and the server 606, in response to a user's pressing on the “LOTTERY TICKET” button 608 (FIG. 6B), which is one of the function select buttons 1300 (FIG. 13/1), microcontroller 1302 identifies a selected information module 1306 which corresponds to the “LOTTERY TICKET” button 608 which was pressed by the user. The microcontroller 1302 retrieves the selected information module 1306 and encodes it by employing encoder 1304, preferably using FSK or DTMF coding and transmits it, via a sound emitting transducer 1312, to a microphone 1314 in mobile telephone 600, preferably as a sequence of tones.

The sequence of tones received by microphone 1314 is transmitted to a controller 1316 of mobile telephone 600. Controller 1316 transmits the sequence of tones, via a mobile transceiver 1318 and via the mobile network, to an analog/digital trunk interface 1320 of an IVR server 1322, forming part of server 606. The received sequence of tones is supplied by the trunk interface 1320 to an audio decoder 1324, forming part of an application server 1326, which may be integral with IVR server 1322 or may, as shown, be separate therefrom, and forms part of server 606.

An application script 1328, whose functionality is described hereinbelow in greater detail with reference to FIGS. 14-21, is operative to facilitate the communication of the sequence of tones from the trunk interface 1320 to the audio decoder 1324. Preferably, as shown in the illustrated embodiment, a pair of communicating APIs (application programming interfaces) 1336 and 1338, respectively resident in the IVR server 1322 and the application server 1326, participates in this communication. The APIs 1336 and 1338 may communicate in any suitable manner, such as via the Internet. It is appreciated that the IVR server 1322 is also employed for providing voice prompts to the user during dialup as described hereinabove with reference to FIG. 6B.

Audio decoder 1324 decodes the sequence of tones and transmits the decoded information modules, via API 1338, typically to a user management module 1340 and a database 1342 in application server 1326, for determining user entitlement. Upon validation of user entitlement, the user management module 1340 sends a request, via a content access module 1344 and an API 1346, to a content server 1348, which also forms part of server 606.

The request is received, via an API 1360, by a content management module 1362. The content management module 1362 retrieves an appropriate response in an appropriate format from a content store 1364 and sends it from the content store 1364, via a content delivery module 1366, via the mobile network, to the mobile telephone 600.

Where card 602 is not a pre-paid card, the content management module 1362 may also provide a billing instruction to a billing module 1368. Billing module 1368 may reside in the content server 1348, as shown, or may be remote therefrom. Billing module 1368 may communicate, via the mobile network or via any other suitable network, with a remote billing server, as appropriate.

The user management module 1340 in the application server 1326 may provide various user prompts or other user communications as determined by a user interactivity module 1370. These user communications may, for example, inform the user of the card's current entitlement status. An audio response module 1372 is preferably also employed for providing user communications during dialup.

The lottery server 605 preferably includes an entry registry 1382 which stores a register of all secret numbers assigned to each of the individual cards 602. In this embodiment, a secret number information module 1384 typically resides in the point-of-sale terminal 604 and assigns a secret number to the programmable information module 1308 of card 602 through the programming port 1310. Point-of-sale terminal 604 also includes information module interface software 1390 and secret number management software 1392.

The secret number information module 1384 is communicated by the functionality described hereinabove, via API 1394, the application server 1326 and the mobile network, to the entry registry 1382 of the lottery server 605. The secret number information module 1384 may be updatable in real time, so as to assign, for example, secret numbers to each of the individual cards 602.

The secret number of each card is supplied to a random selection module 1396 of the lottery server 605, which determines whether that secret number is a winner.

Reference is now made to FIG. 14, which is a simplified flowchart of initial steps in the operation of the system of FIGS. 1-13/2. As seen in FIG. 14, the user employs his mobile communicator, such as a cellular telephone or mobile communication enabled PDA, to call the system server, such as server 104 (FIG. 1B), which, as shown in FIG. 8/2, is preferably an IVR enabled server.

The server provides a voice response to the user, via the user's mobile communicator, and provides an audio prompt to the user, requesting that the user press one of the buttons on the sound communication enabled mobile communication system user interface card, such as card 102 (FIGS. 1A-1D).

The user then presses a selected button on the user interface card, causing transmission of a selected information module contained in the user interface card, via the mobile communicator, to the server. The server preferably provides a voice acknowledgement of the selected card button press to the user, via the mobile communicator.

The server decodes the received information module and preferably extracts therefrom a unique card ID and an indication of which button was pressed by the user.

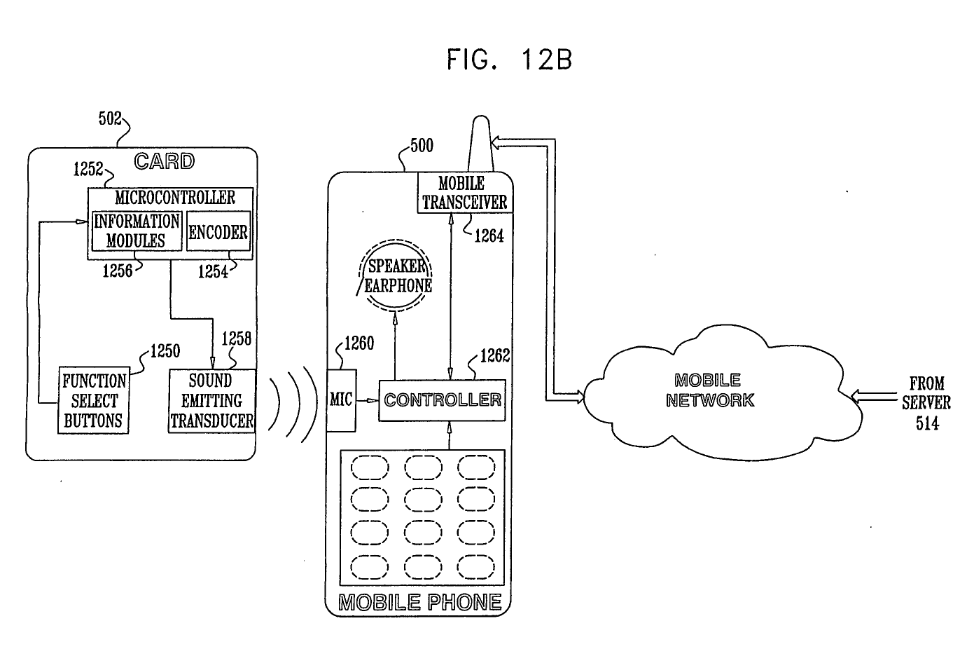

Reference is now made to FIG. 15, which is a simplified flowchart of further steps in the operation of the system of FIGS. 1-13/2. As seen in FIG. 15, following the decoding step of FIG. 14, the server, being aware of the application embodied in the information module received from the user interface card, inquires as to whether an ID is required. If the application requires such an ID, the server determines whether a caller ID, which identifies the mobile communicator, is available. If not the user is prompted, as by a voice prompt provided, via the mobile communicator, to enter a user or communicator ID. Such entry may be effected via the mobile communicator, such as by using voice or, alternatively, DTMF keypad engagements on the mobile communicator.

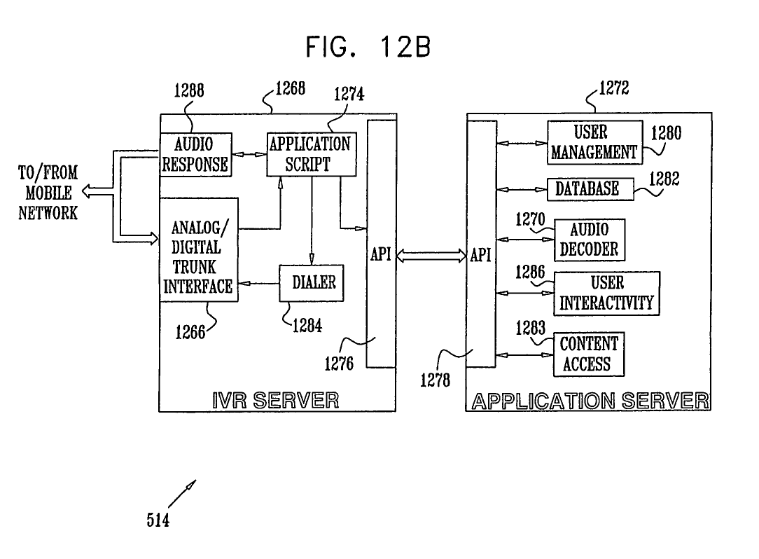

Reference is now made to FIG. 16, which is a simplified flowchart of additional steps in the operation of the system of FIGS. 1-13/2. As seen in FIG. 16, if the application selected by the user button press is subject to charge, a determination is made as to whether sufficient value is currently present on the user interface card, if so, the value is decremented by an amount appropriate to the selected application. If sufficient value is not currently available on the user interface card, telephone billing may be employed by providing a suitable voice prompt to the user, via his mobile communicator. The user indicates his approval, for example, by voice or alternatively by DTMF keypad engagements on the mobile communicator. Additionally or alternatively credit/debit card billing may be employed in a similar manner, by providing a suitable voice prompt to the user, via his mobile communicator. The user indicates his approval, for example, by voice or alternatively by DTMF keypad engagements on the mobile communicator.

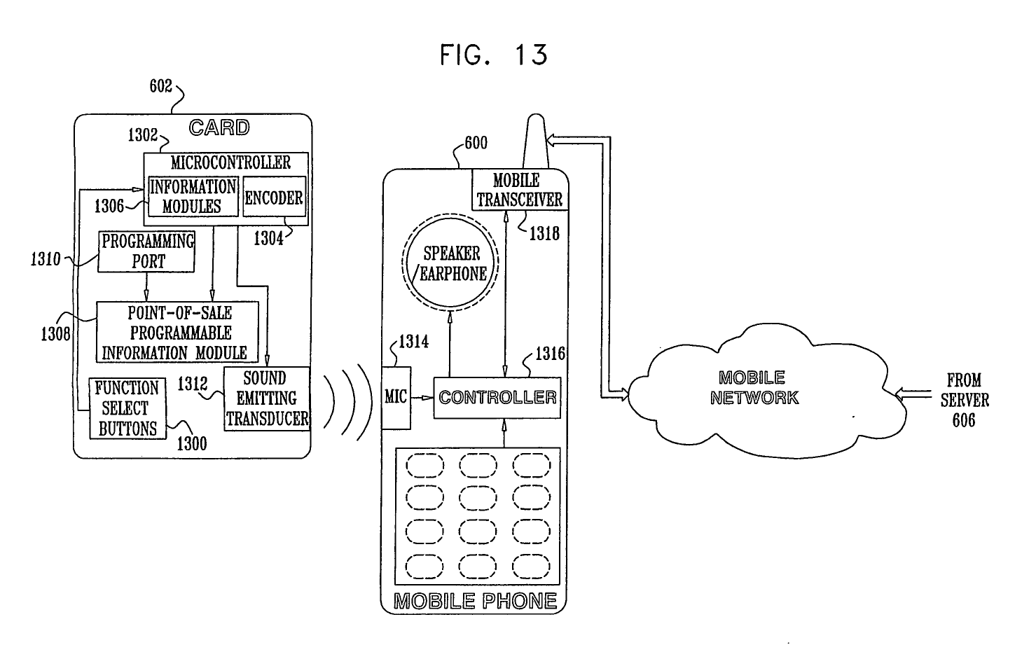

Reference is now made to FIG. 17, which is a simplified flowchart of optional steps in the operation of the system of FIGS. 1-13/2. In certain applications, content may be sought to be sent to a recipient, via that recipient's mobile communicator or any other suitable communicator. In such a case, for example, as described hereinabove with reference to FIG. 3B, prior to transmitting an image from a server to another recipient for display on their mobile telephone, a voice prompt is provided to the user, requesting the communication contact particulars of the intended recipient.

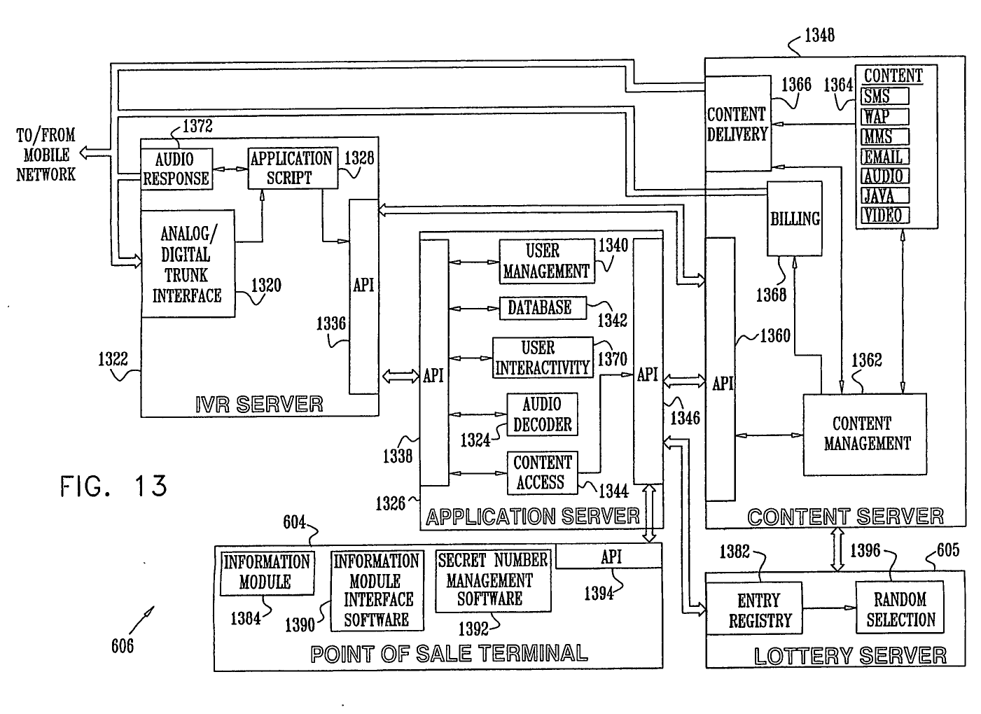

Reference is now made to FIG. 18, which is a simplified flowchart of additional optional steps in the operation of the system of FIGS. 1-13/2. As seen in FIG. 18, certain applications may be dependent on the type of mobile communicator employed by the user. In such a case, archived mobile communicator type identification information may be retrieved, if available, by using the caller ID received by the server. If such information cannot be automatically retrieved by the server, the server may provide a voice prompt to the user, instructing the user to enter mobile communicator type identification information. Such entry may be effected, for example, by voice or alternatively by DTMF keypad engagements on the mobile communicator.

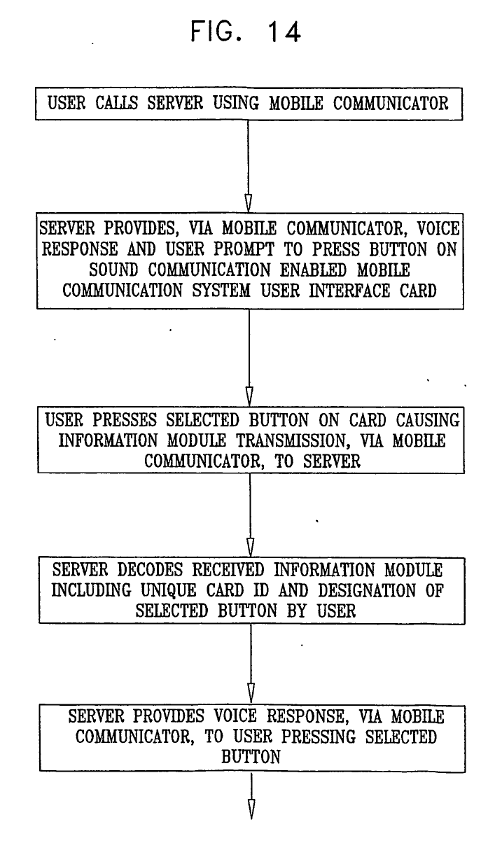

Reference is now made to FIG. 19, which is a simplified flowchart of further optional steps in the operation of the system of FIGS. 1-13/2. As seen in FIG. 19, certain applications may be dependent on the identity of the service provider employed by the user. In such a case, archived service provider identification information may be retrieved, if available, by using the caller ID received by the server. If such information cannot be automatically retrieved by the server, the server may provide a voice prompt to the user, instructing the user to enter service provider identification information. Such entry may be effected for example by voice or alternatively by DTMF keypad engagements on the mobile communicator.

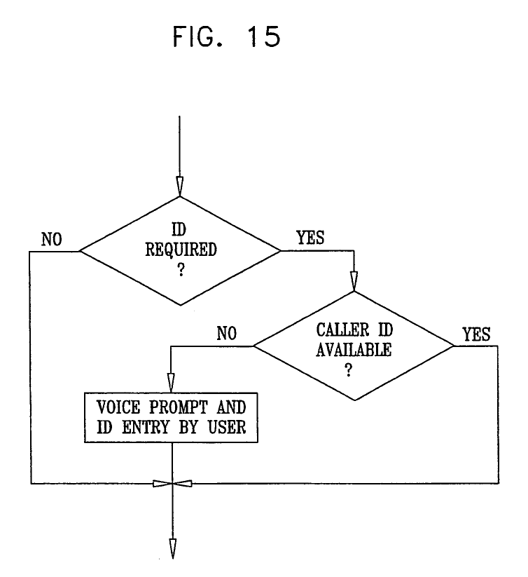

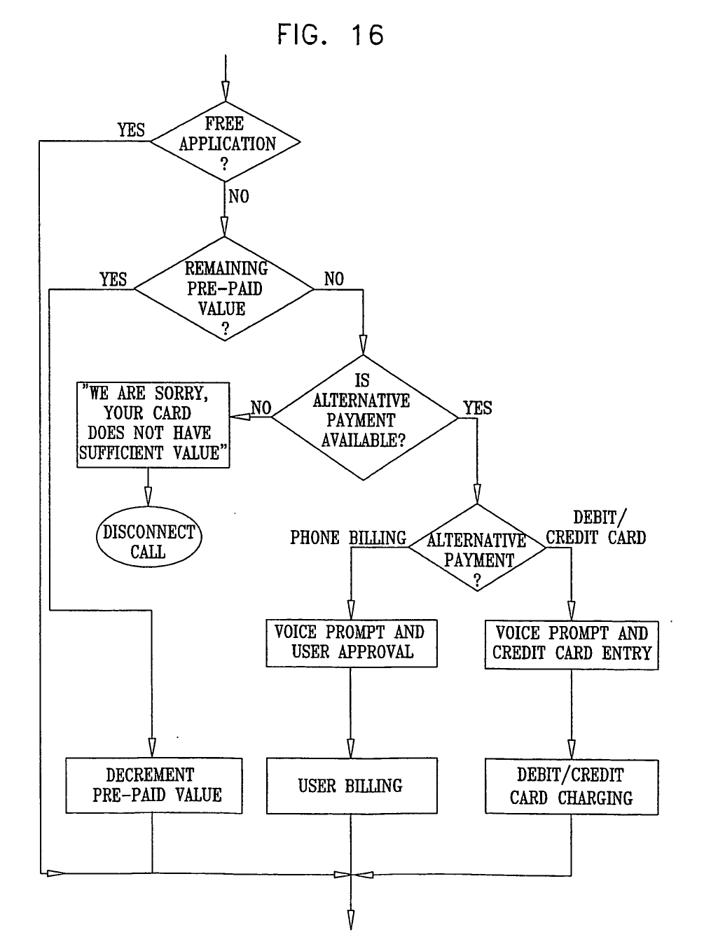

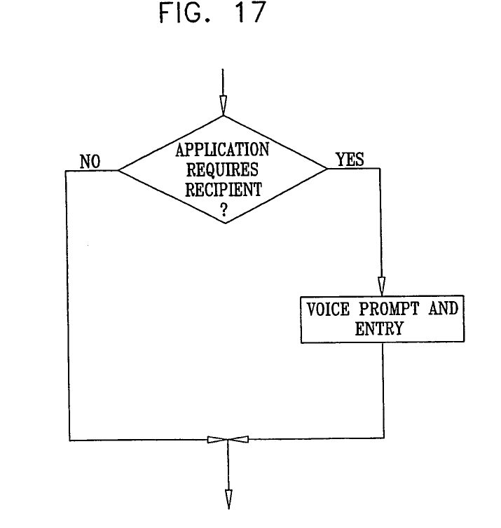

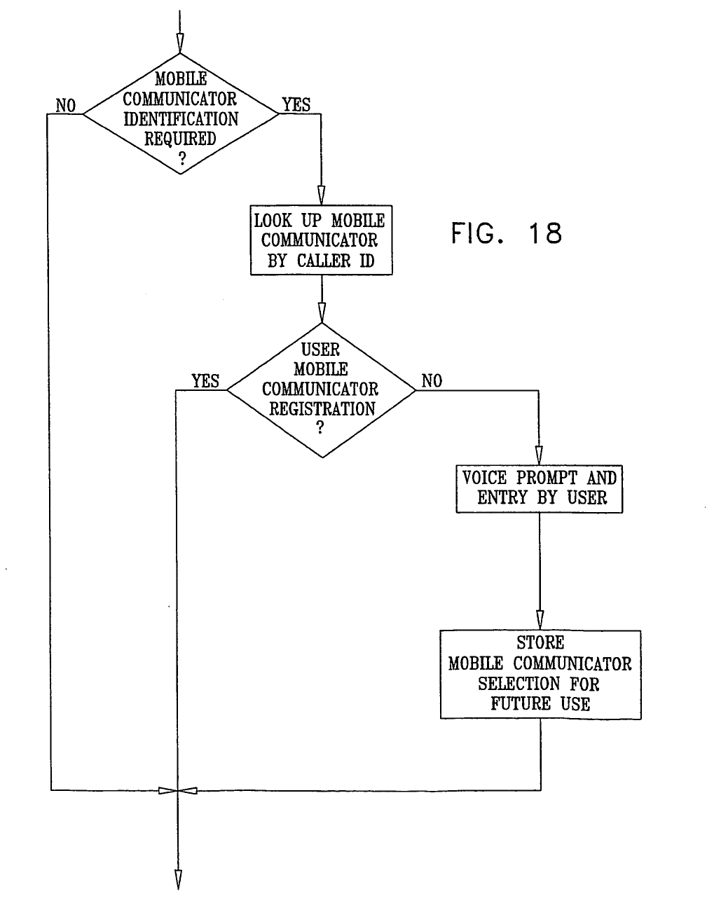

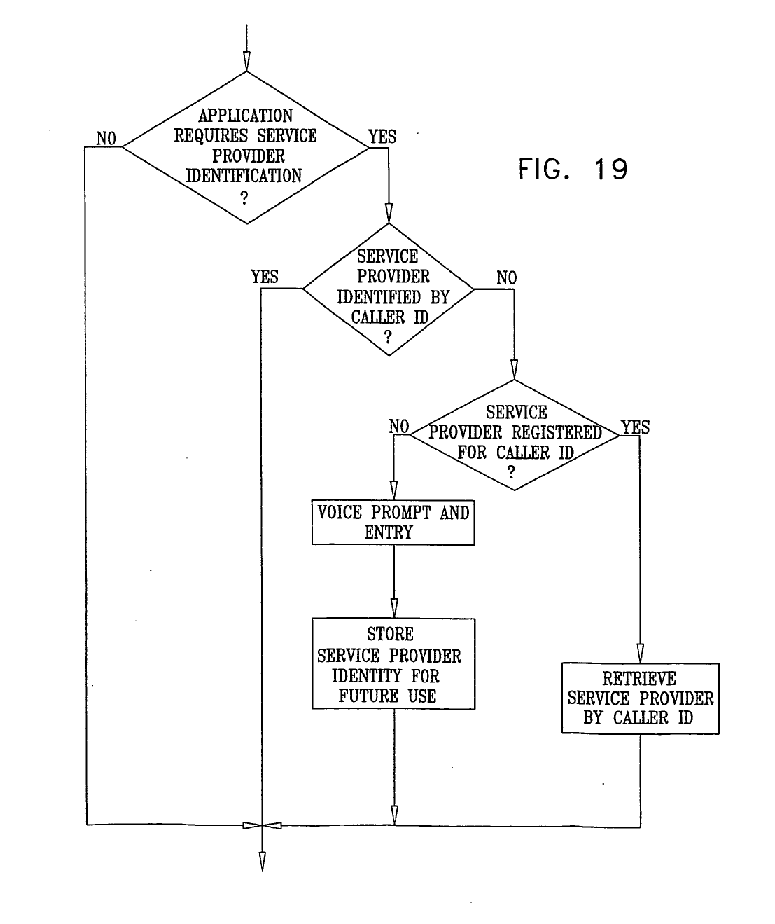

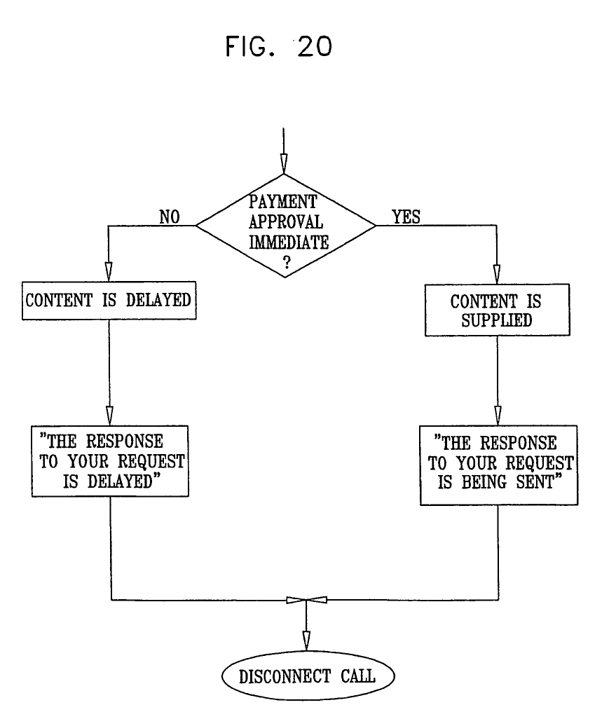

Reference is now made to FIG. 20, which is a simplified flowchart of still further optional steps in the operation of the system of FIGS. 1-13/2. As seen in FIG. 20, it may be desired to withhold certain content from a user until payment approval has been obtained. In such a case, if immediate payment approval is obtained, the content specified in the application is immediately supplied to the user and an appropriate voice notification is provided to the user, via the user's mobile communicator. If, however, payment approval is not immediate, the supply of the content is delayed until payment approval is obtained and an appropriate voice notification is provided to the user.

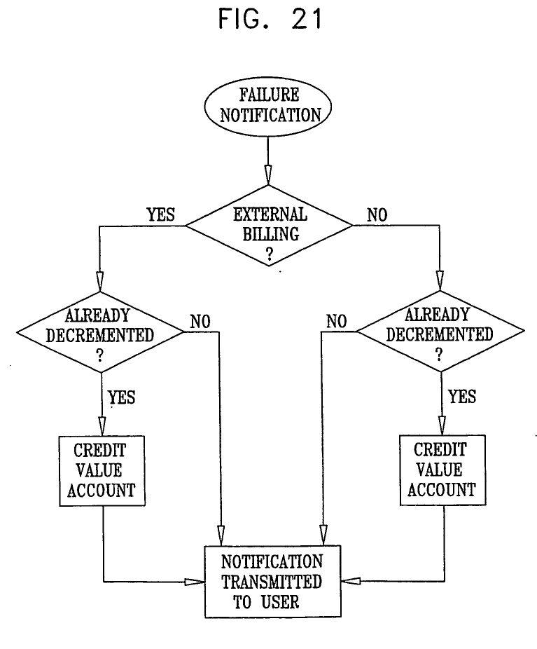

Reference is now made to FIG. 21, which is a simplified flowchart of additional steps in the operation of the system of FIGS. 1-13/2. As seen in FIG. 21, when a user selected application cannot be run, a message is provided to the user to fully inform the user of the situation. If the value on the user interface card was already decremented, a user interface card value increment is provided by the server on the value accounts maintained by the server. If the user was earlier billed on his credit/debit card, telephone bill or other external billing mechanism, an appropriate credit is ordered by the server.

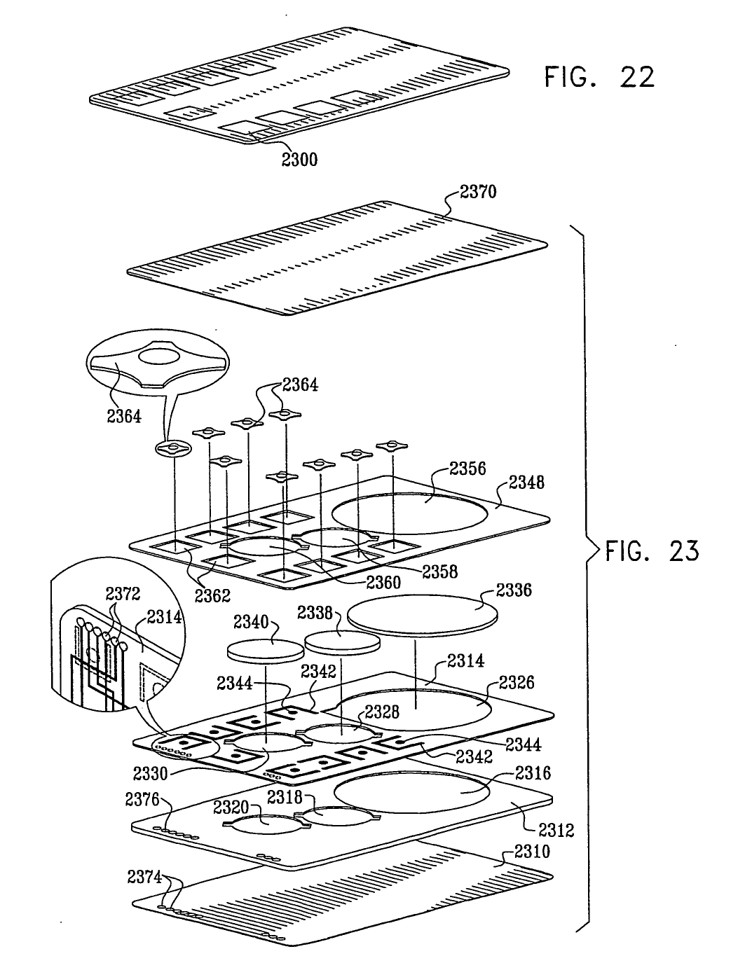

Reference is now made to FIGS. 22 & 23, which are illustrations of a user interface card constructed and operative in accordance with a preferred embodiment of the present invention. As seen in FIGS. 22 and 23, the user interface card is generally characterized in that it includes a number of user-actuable contact locations, preferably in the form of buttons 2300.

Turning particularly to FIG. 23, it is seen that a bottom surface is preferably defined by a substrate 2310, preferably formed of transparent polycarbonate. Substrate 2310 is preferably printed on an inside surface thereof to present advertising or other user information on the outside surface thereof. Disposed above substrate 2310 there is preferably provided a stiffening layer 2312, preferably formed of PVC, and thereabove a PCB 2314. Both stiffening layer 2312 and PCB 2314 are formed with apertures, respectively designated 2316, 2318 and 2320 on layer 2312 and 2326, 2328 and 2330 on the PCB 2314, in order to accommodate a piezoelectric sound transducer 2336, which corresponds, for example, to sound emitting transducer 808 (FIG. 8/1), and batteries 2338 and 2340 respectively.

PCB 2314 preferably defines a plurality of user-actuable contact locations by defining a plurality of perimeter contacts 2342 and a plurality of inner contacts 2344. Each cooperating pair of one perimeter contact 2342 and an inner contact 2344 disposed therewithin defines electrical connections to a single button 2300.

Disposed over PCB 2314 there is preferably provided a spacer 2348, typically formed of polyester and having apertures 2356, 2358 and 2360 corresponding in position to apertures 2326, 2328 and 2330, respectively, and configured to accommodate piezoelectric sound transducer 2336 and batteries 2338 and 2340, respectively.

Spacer 2348 also preferably includes apertures 2362, which are configured to accommodate conductive button contacts 2364, which are in electrical contact with contacts 2342 and 2344. Conductive button contacts are operative, while depressed by a finger of a user, to establish electric contact between a perimeter contact 2342 and its corresponding inner contact 2344. Conductive button contacts 2364 are preferably formed as resilient metal domes, which return to their original, non-contact, orientation in the absence of user engagement therewith. Conductive button contacts 2364 provide desired tactile feedback to a user of pressing each given button 2300.

Disposed above spacer 2348 and conductive button contacts 2364 is a top substrate 2370, which is preferably formed of transparent polycarbonate. Top substrate 2370 is preferably printed on an inside surface thereof to present advertising or other user information on the outside surface thereof.

Regions of top substrate 2370 which overlie conductive button contacts 2364 may be designated as user-actuable contact locations by suitable graphics printing thereon.

In accordance with a preferred embodiment of the present invention, a plurality of electrical contacts 2372 are formed on PCB 2314 and interconnected with circuitry thereon to permit programming of the cards, such as by download of selected information modules to the card, designated by reference numeral 702 in FIG. 7A, causing a desired information module to be programmed into card 702 by computer, designated by reference numeral 701 in FIG. 7A. Contacts 2372 are accessible, preferably, via apertures 2374 formed in substrate 2310 and via apertures 2376 formed in stiffening layer 2312.

The various layers of the card described above are preferably secured together by means of a suitable adhesive.

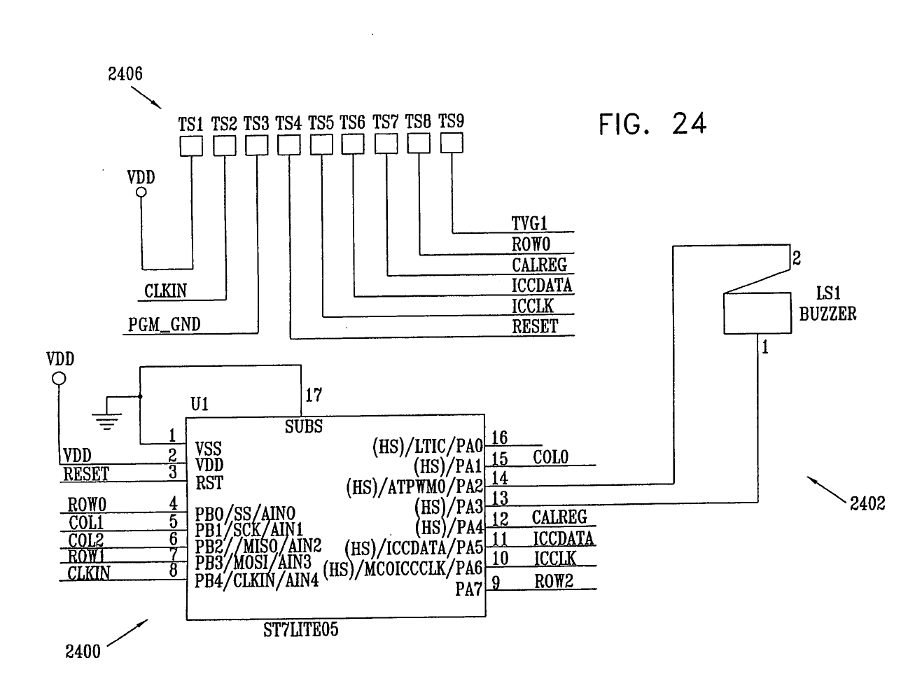

Reference is now made to FIGS. 24 and 25, which are drawings of the electrical circuitry in the card of FIGS. 22 & 23.

In FIG. 24 it is seen that the electrical circuitry in the card is comprised of microcontroller circuitry 2400 of microcontroller, such as microcontroller 802 in FIG. 8/1. Microcontrollor 802 transmits information, such as information retrieved from a selected information module, such as information module 806 in FIG. 8/1, to a communicator, such as a mobile communicator, via sound emitting transducer, such as sound emitting transducer 808 in FIG. 8/1. The sound emitting transducer circuitry 2402 is also illustrated in FIG. 24.

Programmable pad circuitry 2406 of electrical contacts 2372, shown in 5 FIG. 23, is shown in FIG. 24. Electrical contacts 2372 are provided to permit programming of the cards, such as downloading selected information modules to the card, as described hereinabove in reference to FIGS. 7A & 7B.

In FIG. 25 function select button circuitry 2410 of function select buttons, designated by reference numeral 800 in FIG. 8/1, is shown. Pressing on a button, such as ringtone button 106 in FIG. 1B, which corresponds to function select buttons 800, cause the microcontroller 802 to identify the information module 806 and transmit information retrieved from a selected information module to a communicator, as described hereinabove.

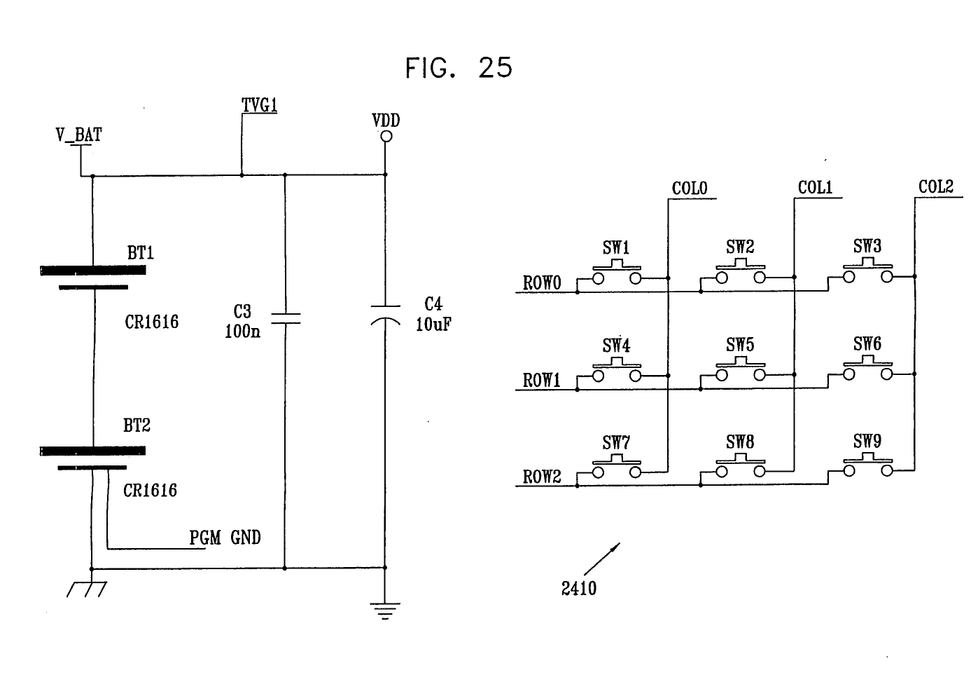

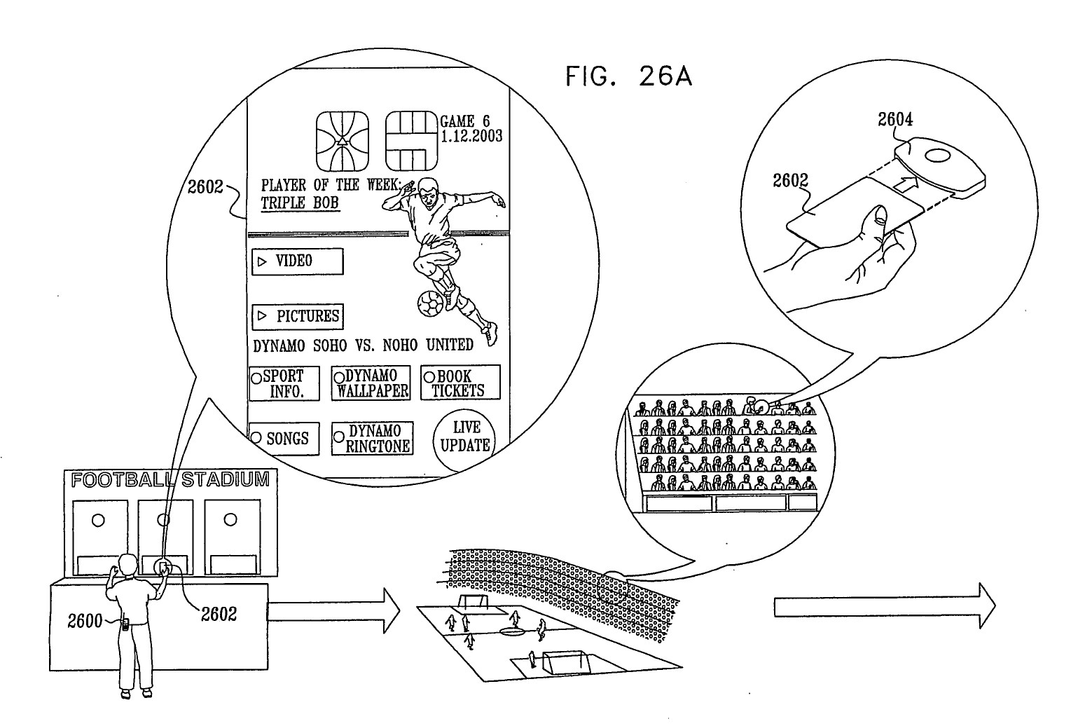

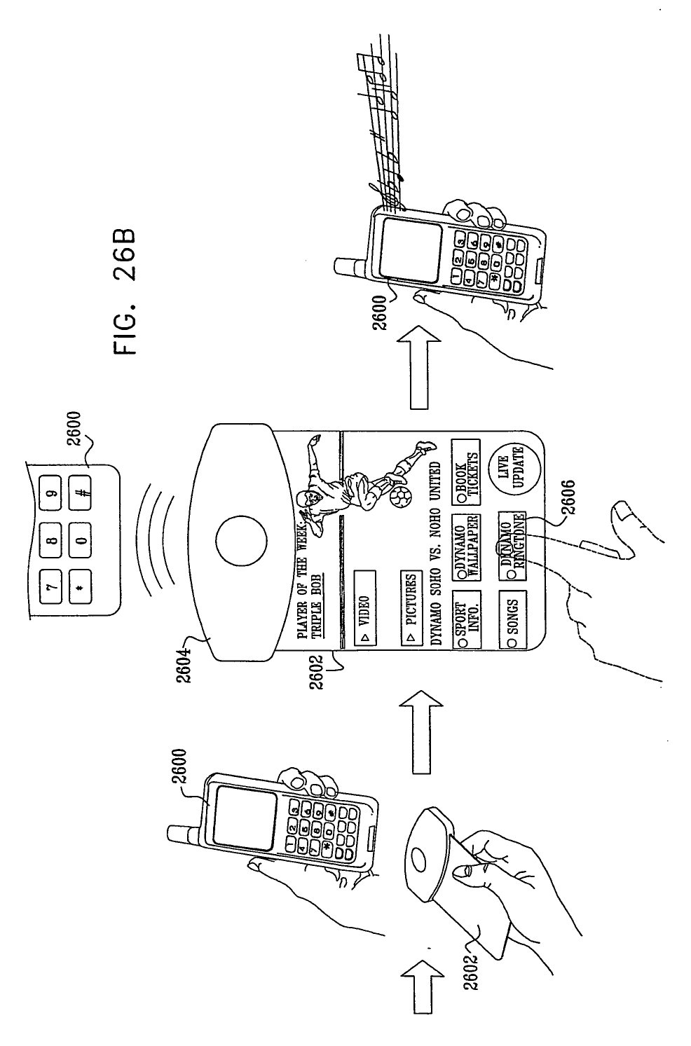

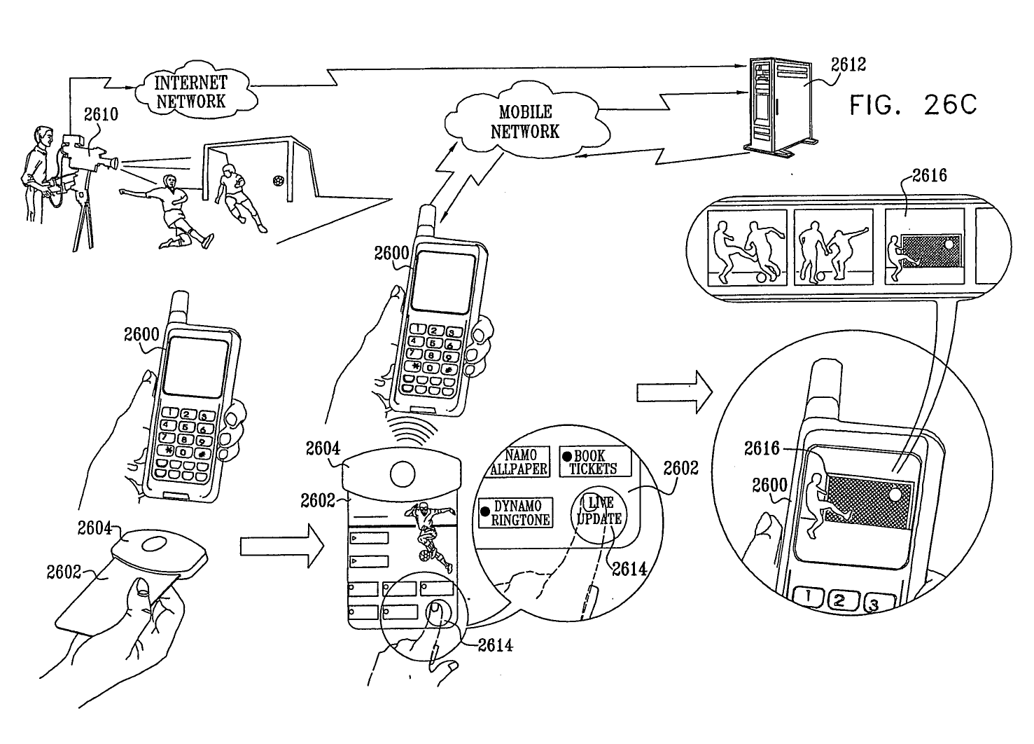

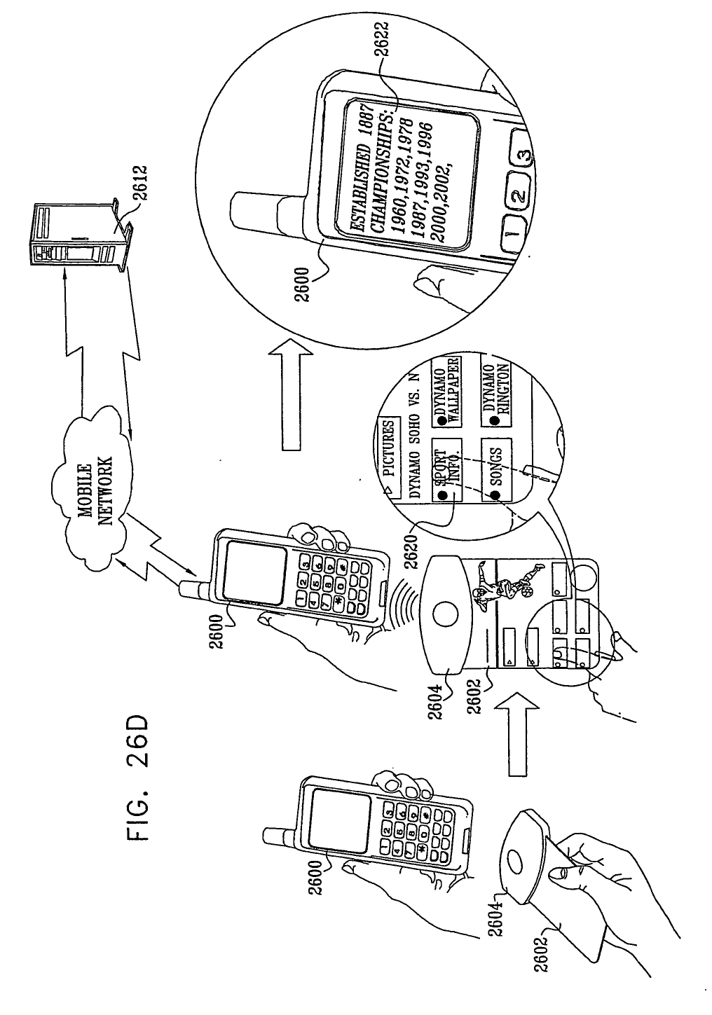

Reference is now made to FIGS. 26A, 26B, 26C and 26D, which are, taken together, a simplified pictorial illustration of operation of a selectable functionality mobile communication system constructed and operative in accordance with a preferred embodiment of the present invention. As seen in FIG. 26A, a typical scenario begins with a sports fan, carrying a mobile telephone 2600, purchasing a mobile communication system user interface card 2602, at a ticket window or other retail outlet.

Although the illustrated embodiments show a generally rectangular, two-dimensional, user interface card 2602, it is appreciated that the user interface card 2602 may be of any shape, such as circular or a geometrically irregular shape, such as a beverage bottle or car. It is further appreciated that the user interface cards described in all of the embodiments contained hereinbelow may also be of any shape.

At any appropriate time thereafter, such as during a game, while seated in the stands, the sports fan may insert the card 2602 into an interface card/mobile telephone communication facilitator 2604, a suitably equipped computer or mobile communicator, or any other suitable user-interface card intermediary. The sports fan may employ the card 2602 and the facilitator 2604 in one of a number of different functional contexts, three examples of which are described hereinbelow with reference to FIGS. 26B, 26C and 26D respectively.

Turning to FIG. 26B, it is seen that the sports fan, or any other user, may upload a selected ring tone onto his telephone 2600 by pressing on a “RINGTONE” button 2606 on card 2602, causing a ring tone information module to be communicated from card 2602 to or through facilitator 2604 and enabling facilitator 2604 to communicate the ring tone to the telephone 2600, typically in a wireless manner, as shown, in order to enable playing of the ring tone. In the illustrated embodiment, IR communication is employed, it being understood that any other suitable type of communication between the card 2602 and the telephone 2600 may be employed.

FIG. 26C shows use of the card 2602, the facilitator 2604 and the telephone 2600 to download a real-time video clip of sports action to the sport fan's telephone. The sports action is photographed, typically in real time, by a camera 2610, such as a webcam, and is transmitted, typically via the Internet, to a server 2612. The sports fan presses on a “LIVE UPDATES” button 2614 on card 2602, typically causing an information module containing a live update request to be communicated from card 2602 to or through facilitator 2604 and enabling facilitator 2604 to communicate the request to the telephone 2600. The telephone 2600, in turn, communicates, via a mobile network, with server 2612 and obtains the requested live update, which is displayed on a telephone display, designated by reference numeral 2616.

Turning to FIG. 26D, it is seen that card 2602, facilitator 2604 and telephone 2600 may be employed to download sports information to the sport fan's telephone 2600. The sports information may be stored in server 2612 in a real-time accessible manner. The sports fan presses on a “SPORTS INFO.” button 2620 on card 2602, typically causing an information module containing a sports information request to be communicated from card 2602 to or through facilitator 2604 and enabling facilitator 2604 to communicate the request to the telephone 2600. The telephone 2600, in turn, communicates, via a mobile network, with server 2612 and obtains the requested sports information, which is displayed on a telephone display, designated by reference numeral 2622.

It is noted that in an environment wherein an external server is involved, such as in the embodiments of FIGS. 26C and 26D and other embodiments described hereinbelow, the interaction with the server may be employed additionally to effect payment for functionalities actuated via the function actuation card of the present invention. Thus, for example, in such an environment, the card could be distributed for free or a nominal cost and some or all of the user actuable functionalities could be billable through a network-based billing system, preferably a mobile operator or television satellite or cable operator billing system.

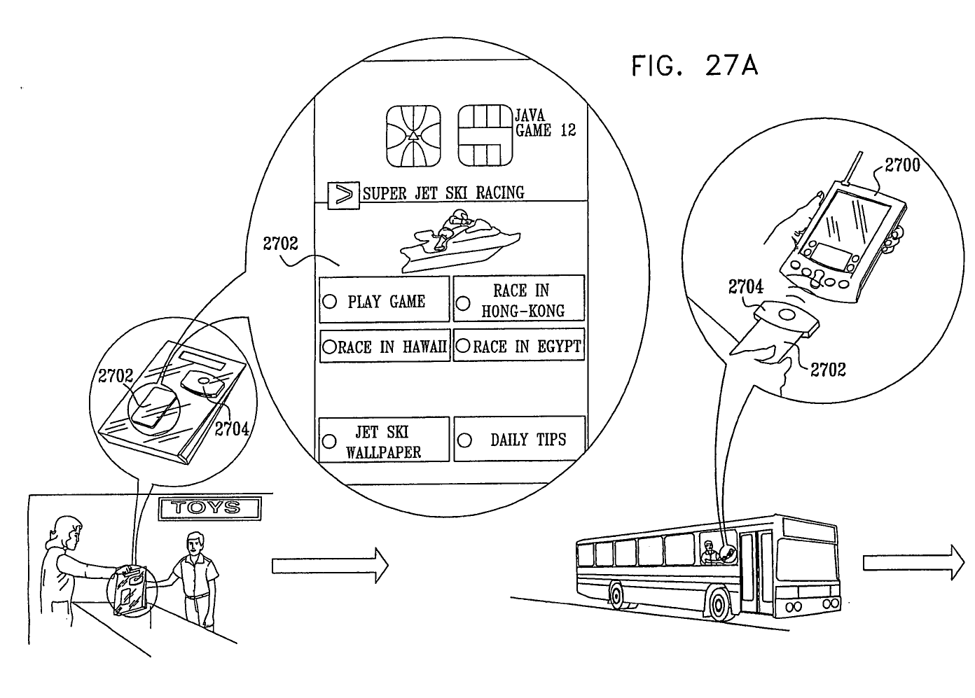

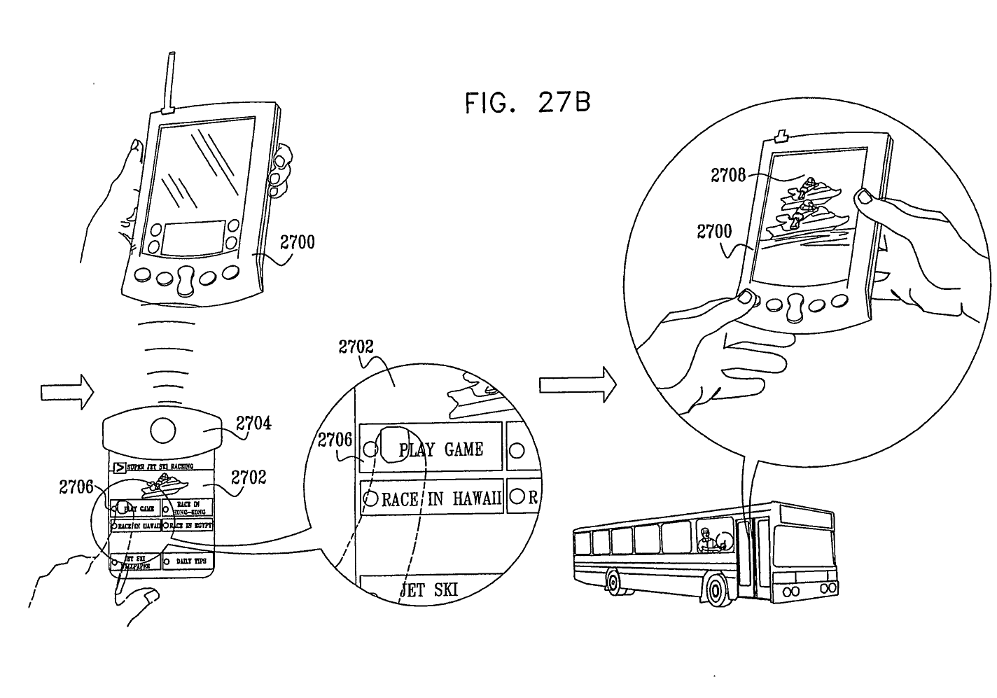

Reference is now made to FIGS. 27A and 27B, which are, taken together, a simplified pictorial illustration of operation of a selectable functionality mobile communication system constructed and operative in accordance with a preferred embodiment of the present invention. As seen in FIG. 27A, a typical scenario begins with a child purchasing a mobile communication system kit for use with a PDA (Personal Digital Assistant) 2700, which kit preferably includes a user interface card 2702 and an interface card/mobile telephone communication facilitator 2704 or any other suitable user-interface card intermediary at a toy shop or other retail outlet.

At any appropriate time thereafter, such as during a bus ride, the child may insert the card 2702 into an interface card/mobile telephone communication facilitator 2704 or any other suitable user-interface card intermediary. The child may employ the card 2702 and the facilitator 2704 to communicate with his PDA 2700 in a number of different functional contexts, one of which is described hereinbelow with reference to FIG. 27B.

Turning to FIG. 27B, it is seen that the child, or any other user, may upload a selected game onto his PDA 2700 by pressing on a “PLAY GAME” button 2706 on card 2702, causing a game information module to be communicated from card 2702 to or through facilitator 2704 and enabling facilitator 2704 to communicate the request to the PDA 2700, typically in a wireless manner, as shown, in order to play the requested game. In the illustrated embodiment, RF communication, or more specifically, a BlueTooth wireless data communication system is employed, it being understood that any other suitable type of communication between the card 2702 and the PDA 2700 may be employed. The requested game is displayed on the PDA screen, designated by reference numeral 2708.

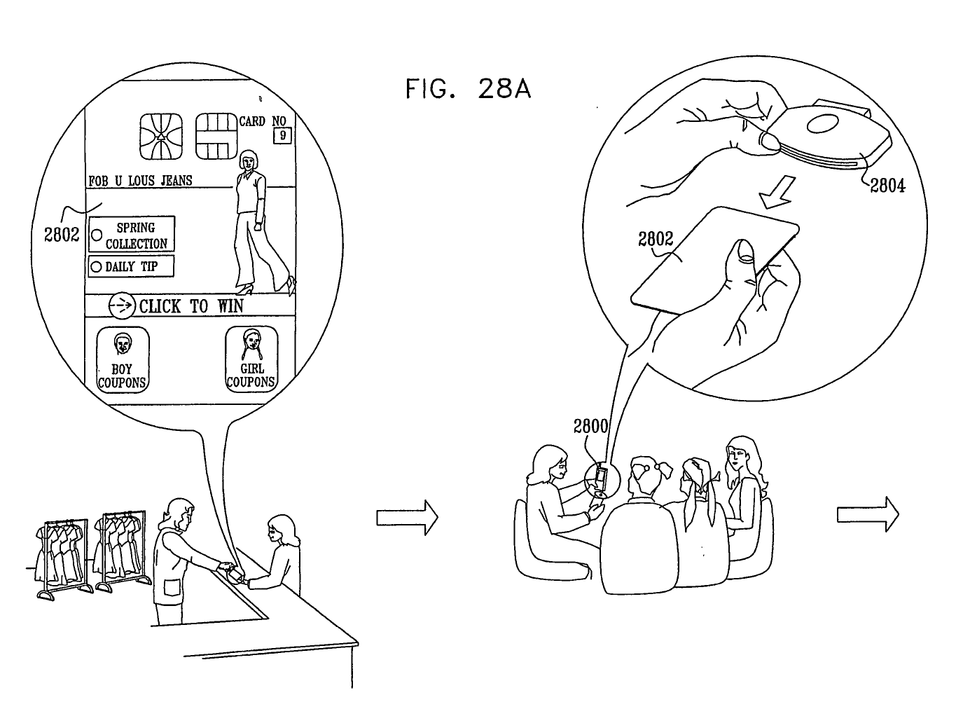

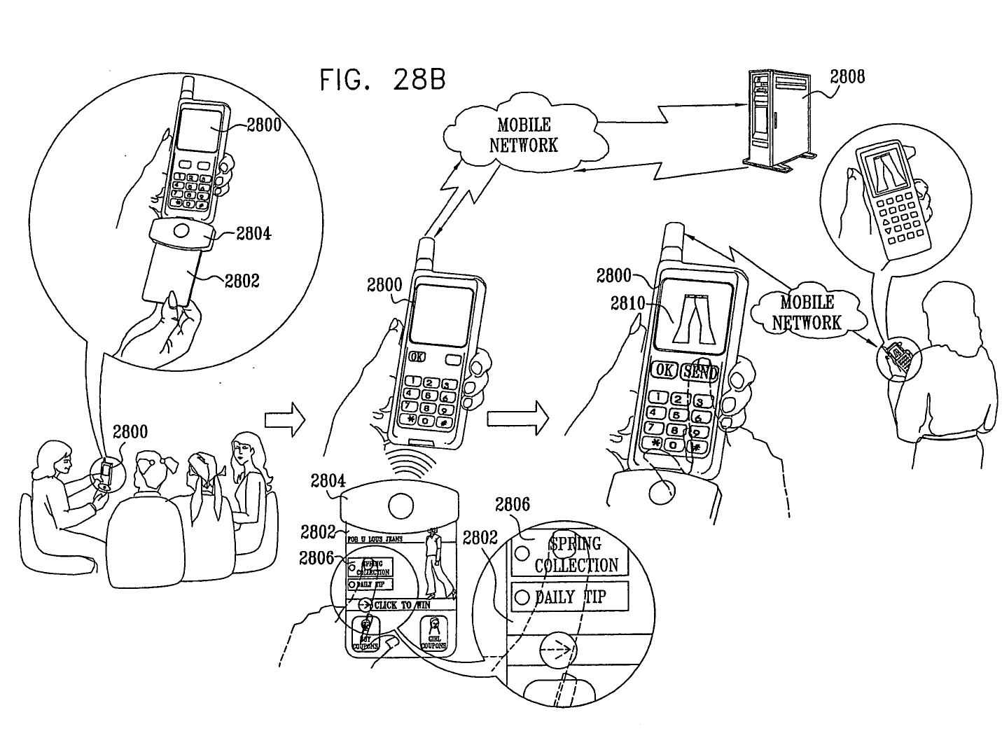

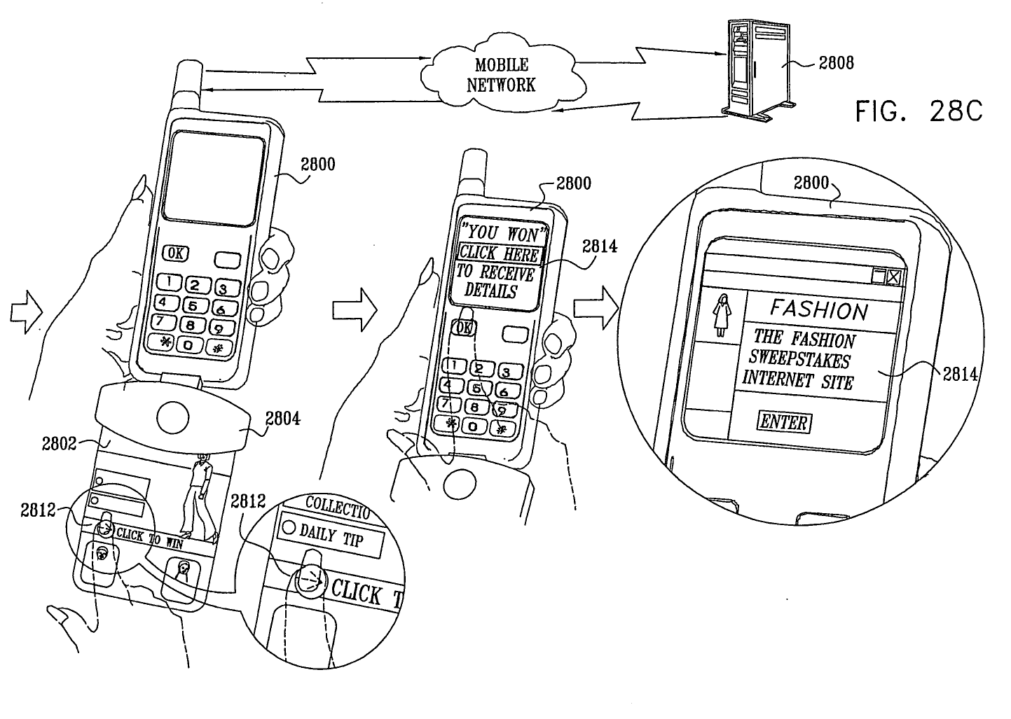

Reference is now made to FIGS. 28A, 28B and 28C which are, taken together, a simplified pictorial illustration of operation of a selectable functionality mobile communication system constructed and operative in accordance with yet another preferred embodiment of the present invention. As seen in FIG. 28A, a typical scenario begins with a teenage girl, owning a mobile telephone 2800, purchasing a mobile communication system user interface card 2802 at a clothing store or other retail outlet for use with the mobile telephone 2800.

At any appropriate time thereafter, such as during a get-together with girlfriends, the teenage girl may insert the card 2802 into an interface card/mobile telephone communication facilitator 2804 or any other suitable user-interface card intermediary to upload a selected feature onto her telephone 2800. The teenage girl may employ the card 2802 and the facilitator 2804 in one of a number of different functional contexts, two examples of which are described hereinbelow with reference to FIGS. 28B and 28C respectively.

In FIG. 28B, it is seen that the teenage girl, or any other user, may view a selected display of fashion apparel, such as an item from the latest spring collection, on her telephone 2800 by pressing on a “SPRING COLLECTION” button 2806 on the card 2802, causing a “SPRING COLLECTION” request information module to be communicated from the card 2802 to or through the facilitator 2804 and enabling the facilitator 2804 to communicate the “SPRING COLLECTION” request to the telephone 2800. The telephone 2800, in turn, communicates, via a mobile network, with a server 2808 and obtains a requested spring collection image, which is displayed on a telephone display, designated by reference numeral 2810. As seen in FIG. 28B, the image may then be transmitted, via the mobile network, to another user for display, for example, on their mobile telephone.

Turning to FIG. 28C, it is seen that the card 2802, the facilitator 2804 and the telephone 2800 may be employed to enter a fashion sweepstakes and link up to a fashion sweepstakes internet site. The sweepstakes internet site is linked to a server 2808. The teenage girl presses on a “CLICK TO WIN” button 2812 on the card 2802, typically causing an information module containing a “CLICK TO WIN” request to be communicated from the card 2802 to or through the facilitator 2804 and enables the facilitator 2804 to communicate the request to the telephone 2800. The telephone 2800, in turn, communicates, via a mobile network, with the server 2808 and obtains the fashion sweepstakes entry response, which is displayed on a telephone display, designated by reference numeral 2814 and enables further browsing of the fashion sweepstakes internet site displayed on the telephone display 2816.

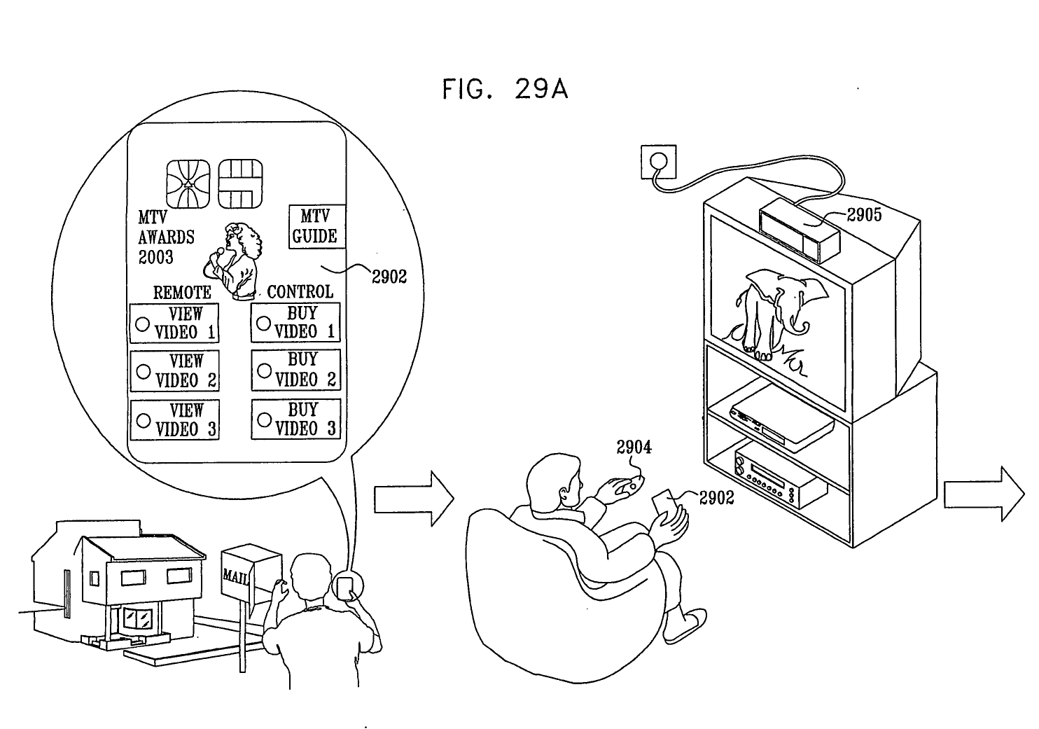

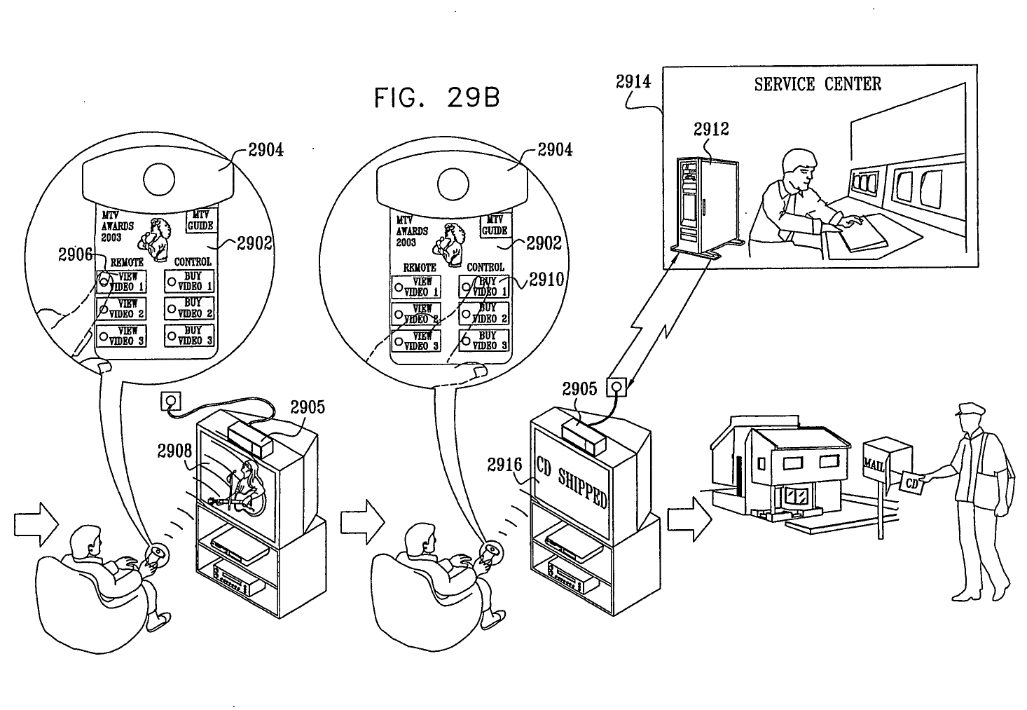

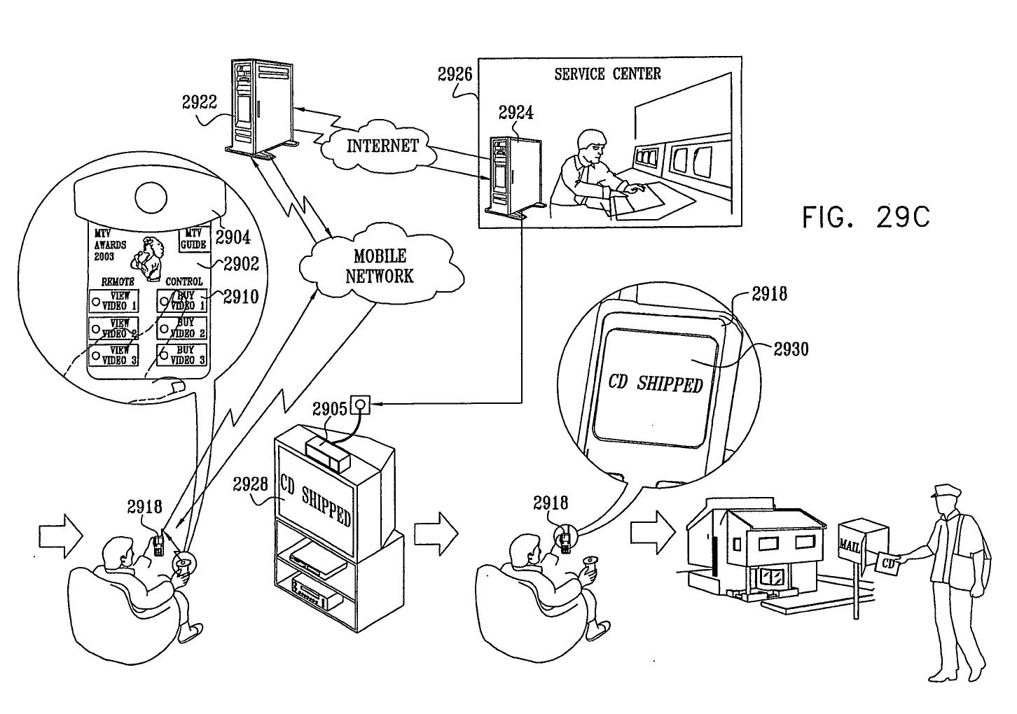

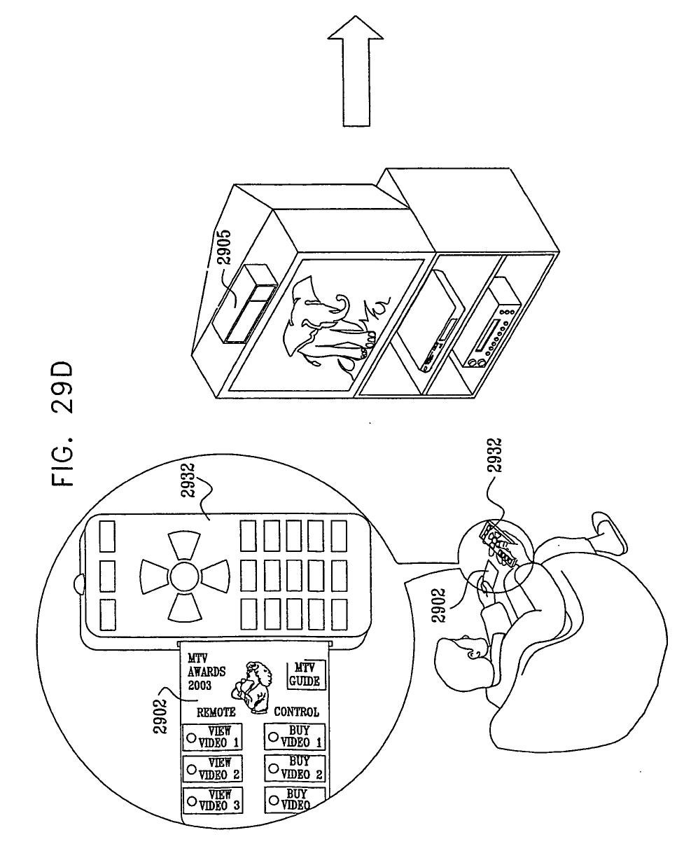

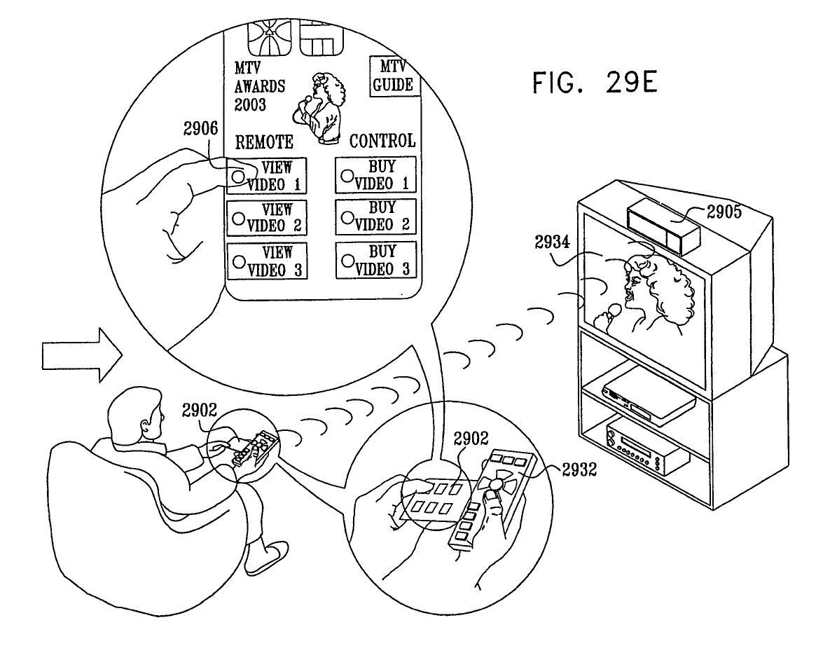

Reference is now made to FIGS. 29A, 29B and 29C which are, taken together, a simplified pictorial illustration of operation of a selectable functionality mobile communication system constructed and operative in accordance with still another preferred embodiment of the present invention. As seen in FIG. 29A, a typical scenario begins with a consumer receiving a mobile communication system user interface card 2902, via mail or any other means of delivery.

At any appropriate time thereafter, such as while watching a television program, the consumer may insert the card 2902 into an interface card/mobile telephone communication facilitator 2904 or any other suitable user-interface card intermediary to upload a selected feature onto his television set via an interactive television application, such as a set top box 2905. The consumer may employ the card 2902 and the facilitator 2904 in one of a number of different functional contexts, three examples of which are described hereinbelow with reference to FIGS. 29B-29C.

In FIG. 29B, it is seen that the consumer, or any other user, may upload a selected music video clip to be displayed on his TV screen, by pressing on a “VIEW VIDEO 1” button 2906 on the card 2902 causing a “VIEW VIDEO 1” information module to be communicated from the card 2902 to or through the facilitator 2904 and enabling the facilitator 2904 to communicate the music video clip request to the set top box 2905, typically in a wireless manner as shown. In the illustrated embodiment, infrared or RF communication is employed, it being understood that any other suitable type of communication between the card 2902 and the set top box 2905 may be employed. The set top box 2905, in turn, switches to another broadcasting channel to display the requested music video clip on the television screen, designated by reference numeral 2908.

If the consumer wishes to purchase a compact disk of the music video clip, he orders a selected music video clip pressing on a “BUY VIDEO 1” button 2910 on the card 2902, causing a “BUY VIDEO 1” information module to be communicated from the card 2902 to or through the facilitator 2904 and enabling the facilitator 2904 to communicate the music video clip compact disk purchase order to the set top box 2905. The set top box 2905, in turn, communicates, via a return channel network such as a cable network, with a TV network server 2912, typically located at a service center 2914. A confirmation of the order receipt may be displayed on the television screen, designated by reference numeral 2916. In response to a prompt from the TV network server 2912 a service center representative arranges for the requested music video clip compact disk to be delivered to the consumer.

FIG. 29C shows use of the card 2902, the facilitator 2904 and a mobile telephone 2918 to order a music video compact disk. The consumer presses on a “BUY VIDEO 1” button 2910 on the card 2902, typically causing an information module containing a “BUY VIDEO 1” request to be communicated from the card 2902 to or through the facilitator 2904 and enabling the facilitator 2904 to communicate the request to mobile telephone 2918, typically in a wireless manner as shown. In the illustrated embodiment, infrared communication is employed, it being understood that any other suitable type of communication between the card 2902 and the telephone 2918 may be employed. The telephone 2918, in turn, communicates, via a mobile network, with a mobile server 2922 and transmits the “BUY VIDEO 1” request. The mobile server 2922, in turn, communicates, via Internet, with a TV network server 2924, typically located at a service center 2926. A confirmation of the order receipt is displayed on the television screen, here designated by reference numeral 2928. When prompted by server 2924 a service center representative arranges for the music video compact disk to be delivered to the consumer.

A confirmation of the order receipt may be displayed on a telephone display, designated by reference numeral 2930.

Reference is now made to FIGS. 29D and 29E, which are, taken together, a simplified pictorial illustration of operation of a selectable functionality mobile communication system constructed and operative in accordance with still another preferred embodiment of the present invention. As seen in FIG. 29D, a typical scenario begins with a consumer watching a television program.

At any appropriate time thereafter, the consumer may insert the mobile communication system user interface card 2902 into a card enabled set top box remote controller 2932 or any other suitable user-interface card intermediary to upload a selected feature onto his television set via the interactive set top box 2905. The consumer may employ the card 2902 in a number of different functional contexts, one examples of which is described hereinbelow with reference to FIG. 29E.

In FIG. 29E, it is seen that the consumer may upload a selected music video to be displayed on his TV screen by pressing on the “VIEW VIDEO 1” button 2906 on the card 2902 causing a “VIEW VIDEO 1” information module to be communicated from the card 2902 to the set top box 2905, typically in a wireless manner as shown. In the illustrated embodiment, infrared or RF communication is employed, it being understood that any other suitable type of communication between the card 2902 and the set top box 2905 may be employed. The set top box 2905, in turn, displays the requested music video clip on the television screen, here designated by reference numeral 2934.

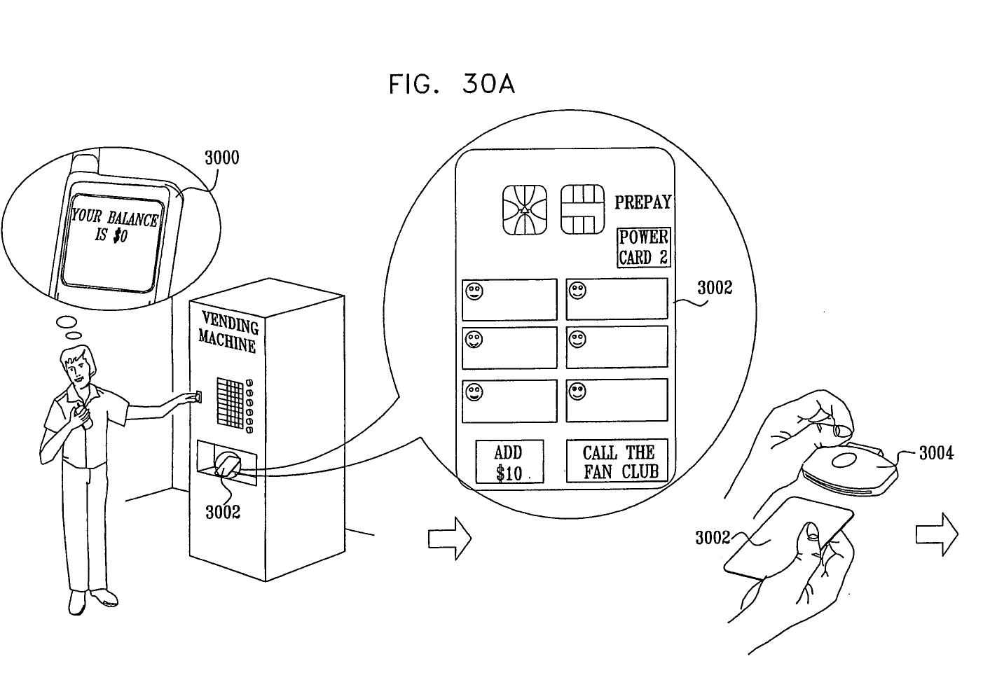

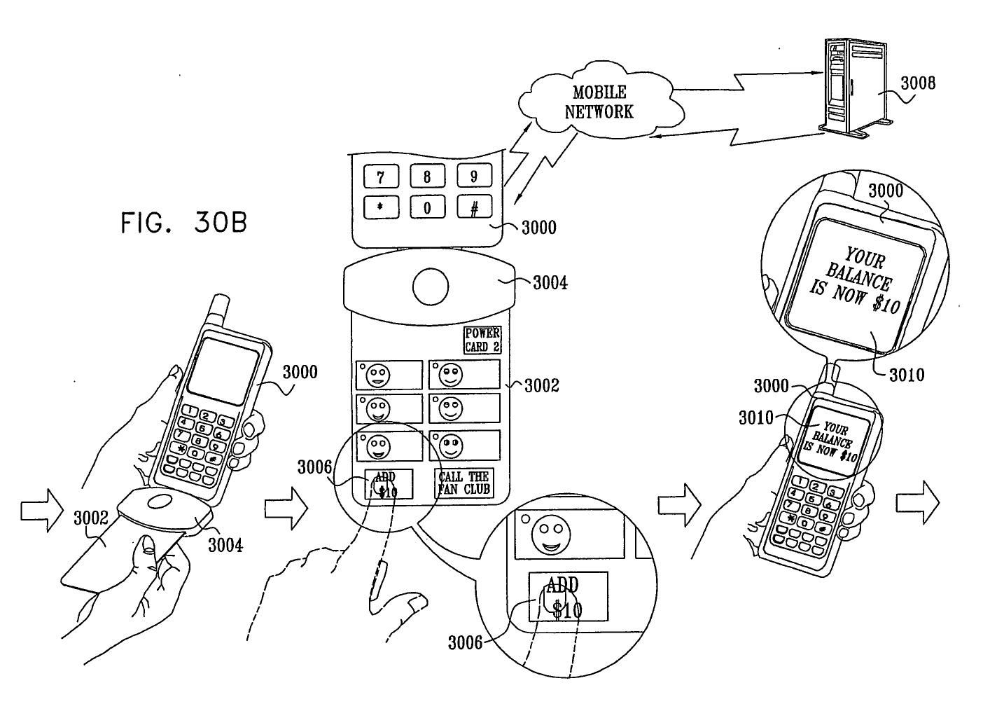

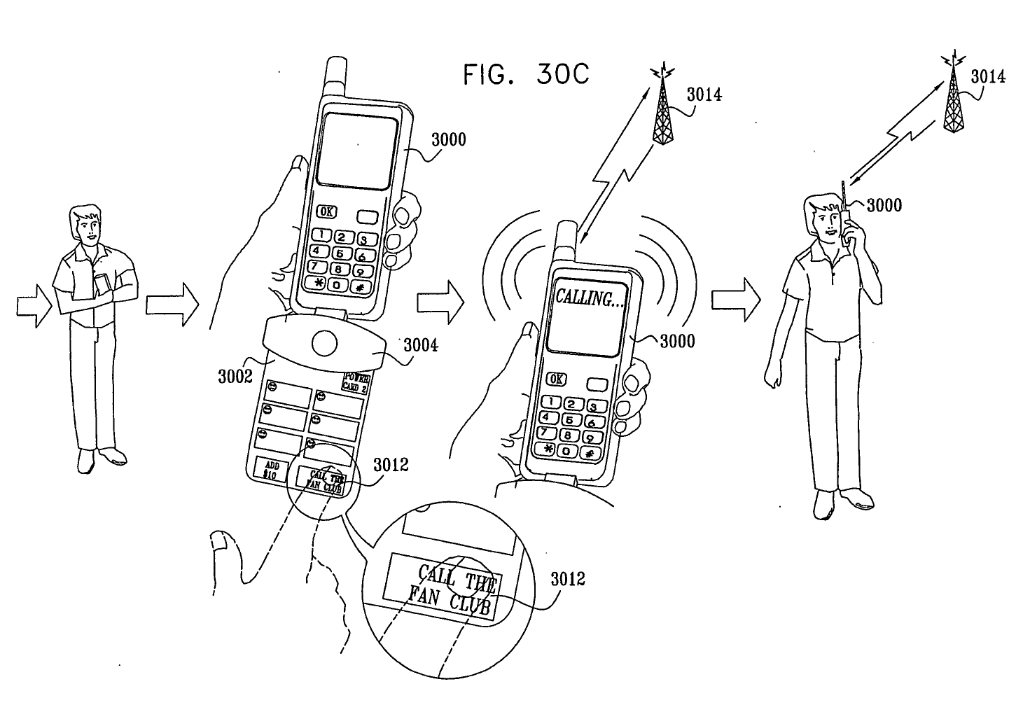

Reference is now made to FIGS. 30A, 30B and 30C, which are, taken together, a simplified pictorial illustration of operation of a selectable functionality mobile communication system constructed and operative in accordance with a preferred embodiment of the present invention. As seen in FIG. 30A, a typical scenario begins with a member of a fan club, carrying a mobile telephone 3000, purchasing a user interface card 3002, here functioning as a mobile communication system refill card, at a vending machine or other retail outlet.

At any appropriate time thereafter, the fan club member may insert the card 3002 into an interface card/mobile telephone communication facilitator 3004 or any other suitable user-interface card intermediary. The fan club member may employ the card 3002 and the facilitator 3004 in one of a number of different functional contexts, two examples of which are described hereinbelow with reference to FIGS. 30B and 30C, respectively.

In FIG. 30B, it is seen that the fan club member, or any other user, may increase the balance of his prepaid account by pressing on a “ADD $10” button 3006 on card 3002, causing an “ADD $10” information module containing a secret PIN number to be communicated from card 3002 to or through facilitator 3004 and enabling facilitator 3004 to communicate the “ADD $10” request containing a secret PIN number to the telephone 3000. In the illustrated embodiment, a wired connection is employed, it being understood that any other suitable type of communication between the card 3002 and the telephone 3000 may be employed. The telephone 3000, in turn, communicates, via a mobile network, with a server 3008 and transmits the request. Increase of balance confirmation is displayed on a telephone display, designated by reference numeral 3010.

Turning to FIG. 30C, it is seen that the fan club member, or any other user, may initiate a telephone call from the mobile telephone 3000 by pressing on a “CALL THE FAN CLUB” button 3012 on the card 3002, causing a “CALL THE FAN CLUB” information module to be communicated from the card 3002 to or through the facilitator 3004 and enabling the facilitator 3004 to communicate the “CALL THE FAN CLUB” request to the telephone 3000. In the illustrated embodiment, a wired connection is employed, it being understood that any other suitable type of communication between the card 3002 and the telephone 3000 may be employed. The telephone 3000, in turn, via a mobile network 3014, dials a telephone number to call the fan club.

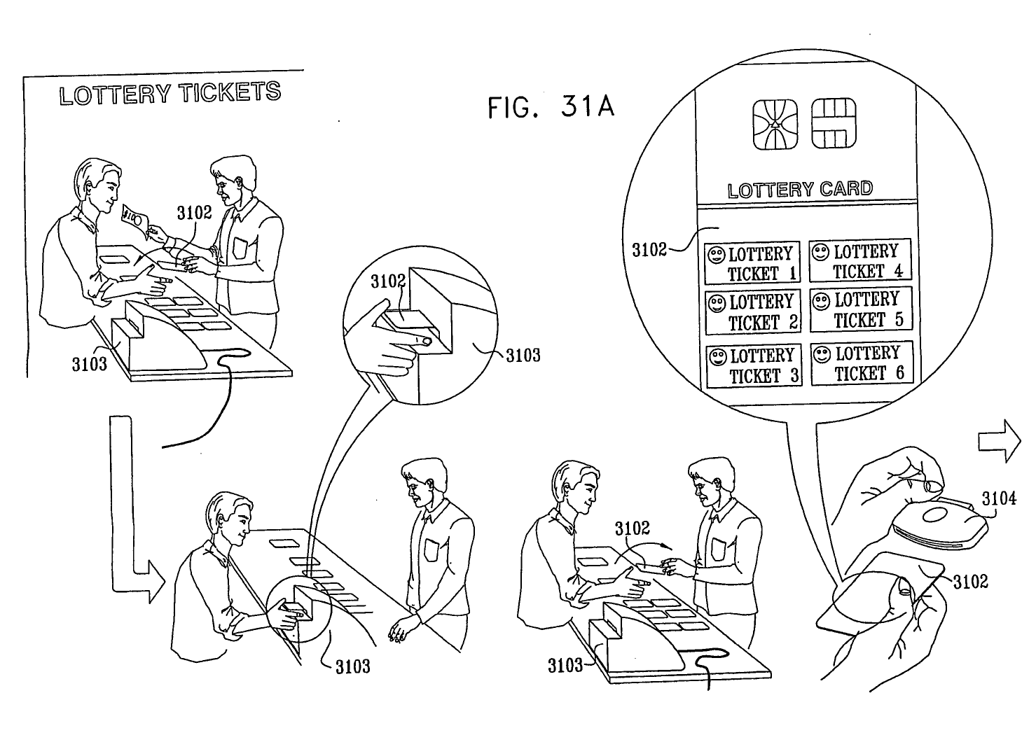

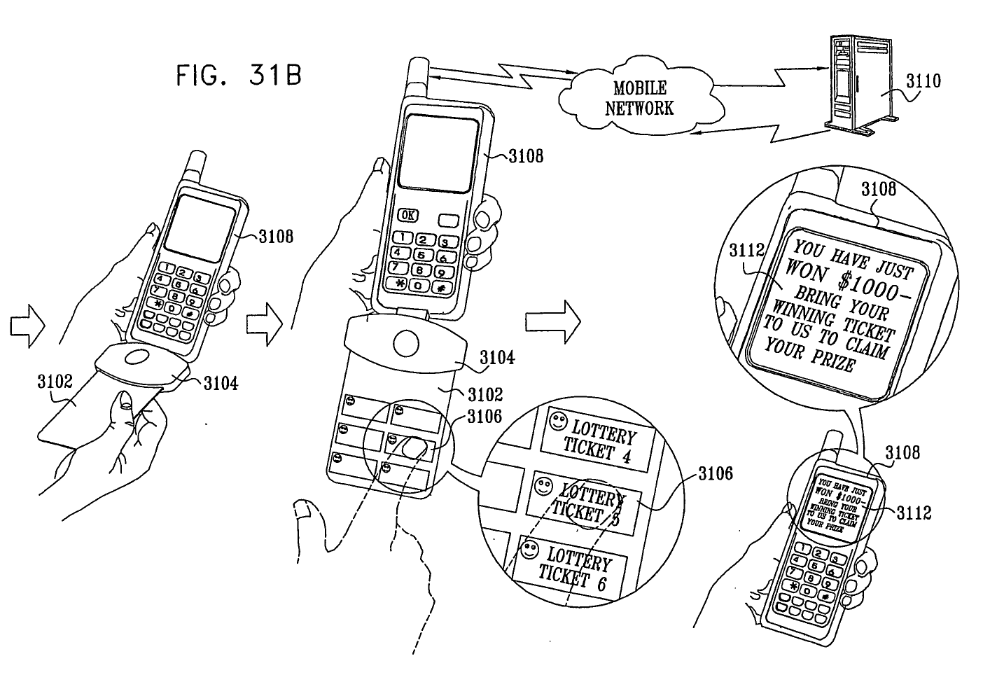

Reference is now made to FIGS. 31A and 31B, which are, taken together, a simplified pictorial illustration of operation of a selectable functionality mobile communication system constructed and operative in accordance with a preferred embodiment of the present invention. As seen in FIG. 31A, a typical scenario begins with a lottery player, purchasing a mobile communication system user interface card 3102, here functioning as a lottery card, at a lottery ticket booth or other retail outlet. At the lottery ticket booth the lottery ticket card 3102 is issued a secret number by a point-of-sale terminal 3103.

At any appropriate time thereafter, the lottery player may insert the card 3102 into an interface card/mobile telephone communication facilitator 3104 or any other suitable user-interface card intermediary. The lottery player may employ the card 3102 and the facilitator 3104 in a number of different functional contexts, one of them described hereinbelow with reference to FIG. 31B.

Turning to FIG. 31B, it is seen that the lottery player, or any other user, may select a given lottery entry ticket by pressing on a “LOTTERY TICKET” button 3106 on card 3102, causing a “LOTTERY TICKET” information module containing a secret lottery number to be communicated from the card 3102 to or through the facilitator 3104 and enabling the facilitator 3104 to communicate the lottery entry request containing a secret lottery number to a telephone 3108. In the illustrated embodiment, a wired connection is employed, it being understood that any other suitable type of communication between the card 3102 and the telephone 3108 may be employed. The telephone 3108, in turn, communicates, via a mobile network, with a server 3110 and obtains the lottery entry request. The lottery results are displayed on a. telephone display, designated by reference numeral 3112.

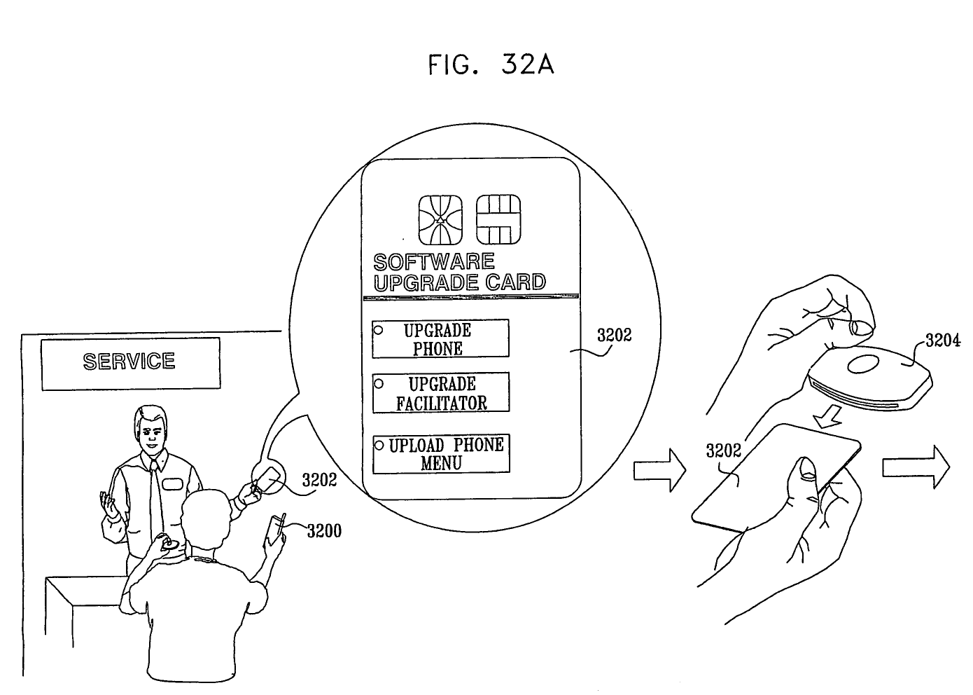

Reference is now made to FIGS. 32A, 32B, and 32C, which are, taken together, a simplified pictorial illustration of operation of a selectable functionality mobile communication system constructed and operative in accordance with a preferred embodiment of the present invention. As seen in FIG. 32A, a typical scenario begins with a customer, carrying a mobile telephone 3200, purchasing a mobile communication system user interface card 3202, at a facilitator sales/service location or other retail outlet.

At any appropriate time thereafter, the customer may insert the card 3202 into an interface card/mobile telephone communication facilitator 3204 or any other suitable user-interface card intermediary. The customer may employ the card 3202 and the facilitator 3204 in one of a number of different functional contexts, two examples of which are described hereinbelow with reference to FIGS. 32B and 32C, respectively.

Turning to FIG. 32B, it is seen that once a notice of required phone software upgrade is displayed on the telephone screen, the customer, or any other user, may upload a telephone software upgrade onto his telephone 3200 by pressing on a “UPGRADE PHONE” button 3206 on card 3202 causing a telephone software upgrade information module to be communicated from card 3202 to or through facilitator 3204 and enabling facilitator 3204 to communicate the selected telephone software upgrade to the telephone 3200. In the illustrated embodiment, infrared communication is employed, it being understood that any other suitable type of communication between the card 3202 and the telephone 3200 may be employed. A confirmation of phone software upgrade is displayed on the telephone screen, designated by reference numeral 3208.

In FIG. 32C, it is seen that once a notice of required facilitator software upgrade is displayed on the telephone screen, the customer, or any other user may upload facilitator upgrade software, stored in the card 3202, by pressing on an “UPGRADE FACILITATOR” button 3210 on card 3202, causing a facilitator software upgrade information module to be communicated from the card 3202 to the facilitator 3204. Upon completion of the facilitator software upgrade a facilitator upgrade confirmation is communicated from the card 3202 to or through the facilitator 3204 enabling communication of the facilitator upgrade confirmation to the telephone 3200. The facilitator software upgrade confirmation is displayed on the telephone screen, designated by reference numeral 3212.

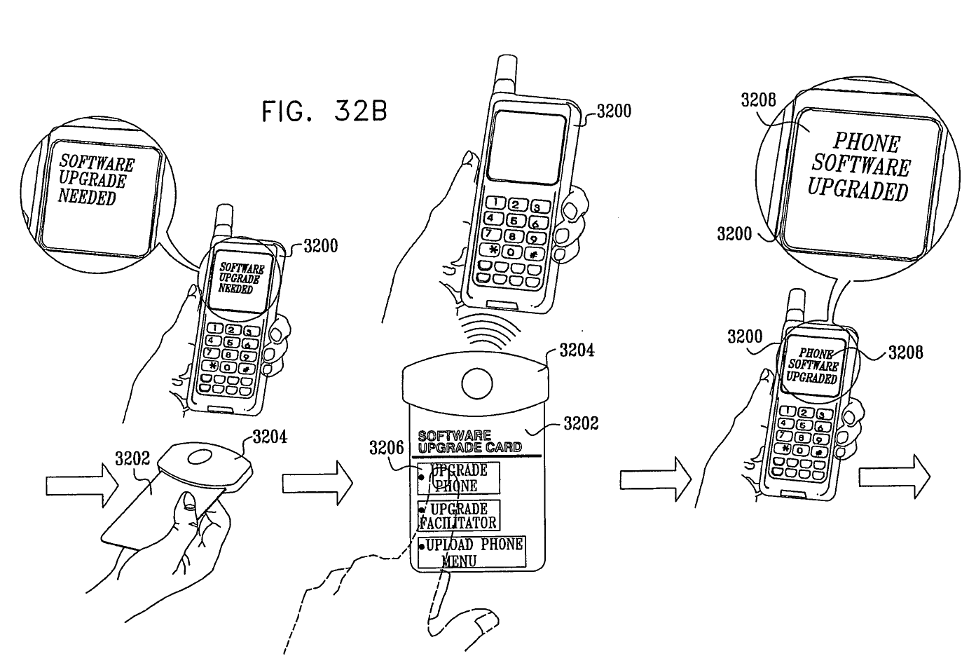

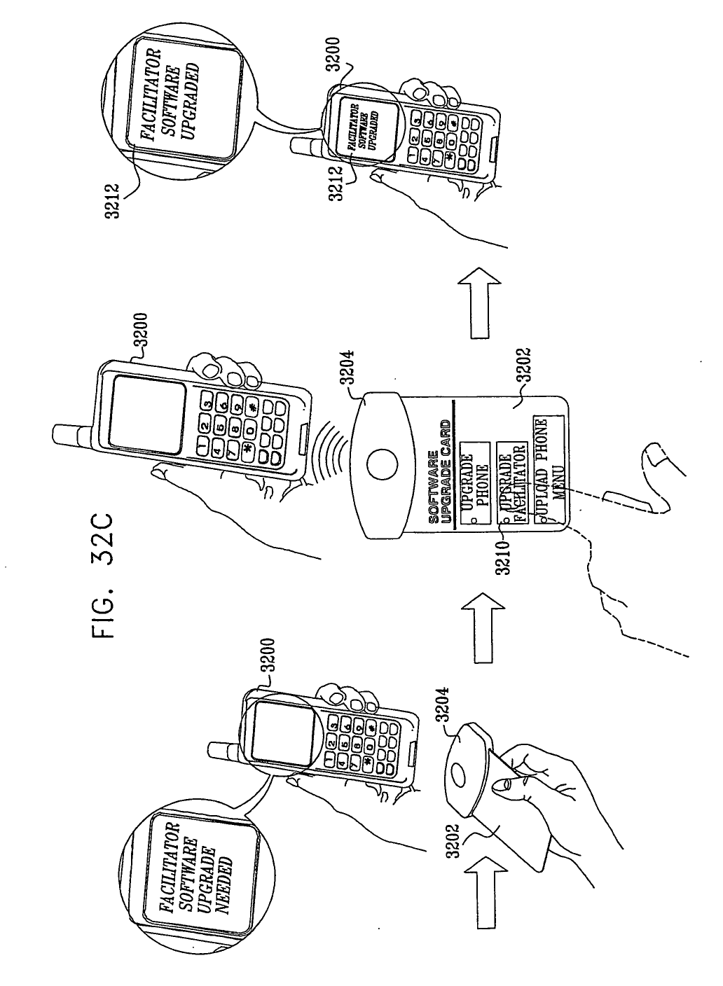

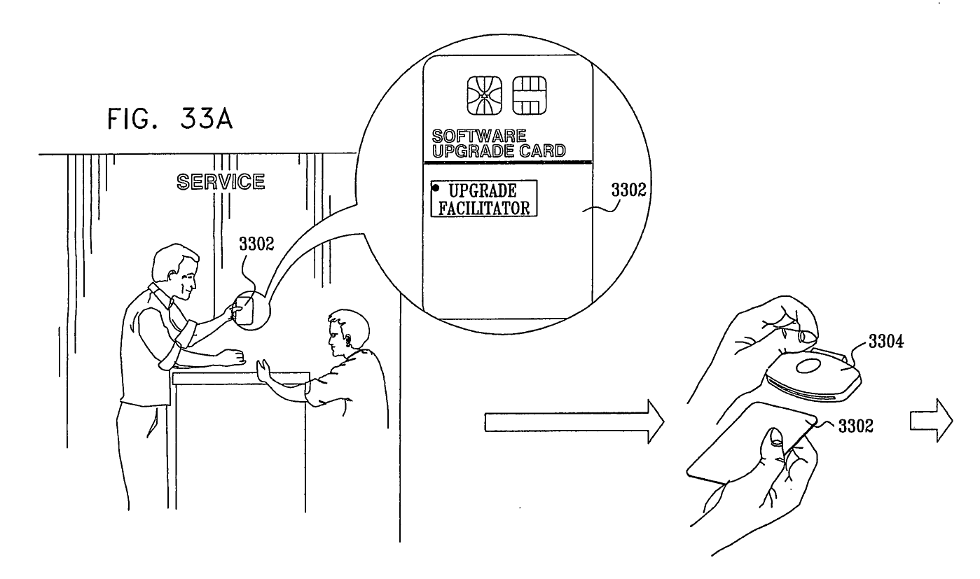

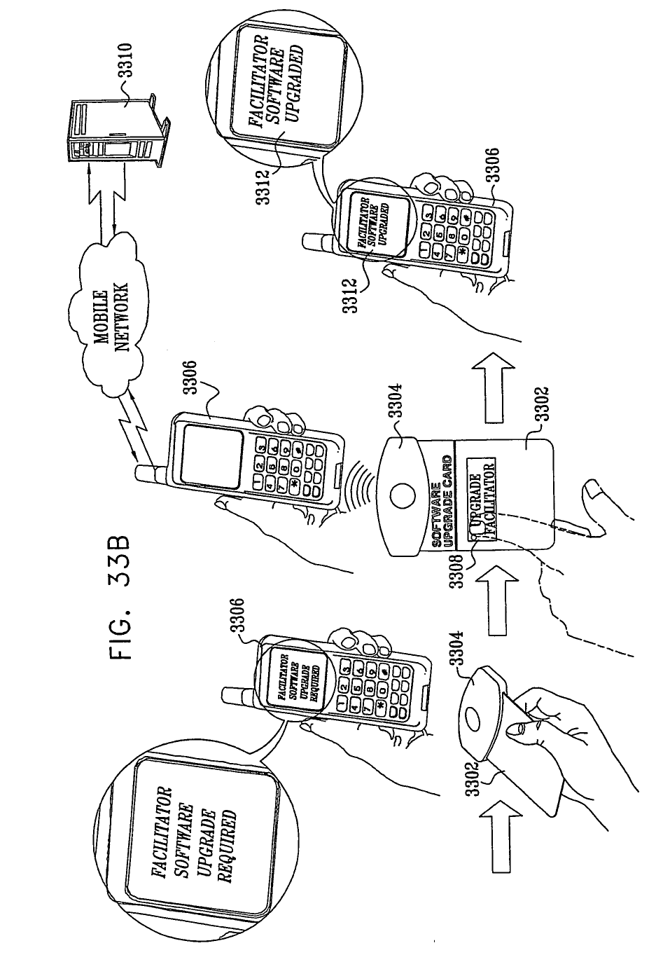

Reference is now made to FIGS. 33A and 33B, which are, taken together, a simplified pictorial illustration of operation of a selectable functionality mobile communication system constructed and operative in accordance with yet another preferred embodiment of the present invention. As seen in FIG. 33A, a typical scenario begins with a young customer, purchasing a mobile communication system user interface card 3302 at a facilitator sales/service location or other retail outlet.

At any appropriate time thereafter, the young customer may insert the card 3302 into an interface card/mobile telephone communication facilitator 3304 or any other suitable user-interface card intermediary. The customer may employ the card 3302 and the facilitator 3304 in a number of different functional contexts, one of which is described hereinbelow with reference to FIG. 33B.

In FIG. 33B, it is seen that once a notice of required facilitator software upgrade is displayed on a screen of a telephone 3306, the young customer, or any other user may upload a facilitator upgrade software onto the facilitator 3304 by pressing on an “UPGRADE FACILITATOR” button 3308 on the card 3302, causing a facilitator upgrade information module to be communicated from the card 3302 to the facilitator 3304 and enables the facilitator 3304 to communicate the selected facilitator upgrade software to the telephone 3306. In the illustrated embodiment, infrared communication is employed, it being understood that any other suitable type of communication between the card 3302 and the telephone 3306 may be employed. The telephone 3306, in turn, communicates, via a mobile network, with a server 3310 and obtains the “UPGRADE FACILITATOR” request. Upon completion of the facilitator software upgrade a facilitator upgrade confirmation is communicated from the card 3302 to or through the facilitator 3304 enabling the facilitator 3304 to communicate the facilitator upgrade confirmation to the telephone 3306.

In the illustrated embodiment, infrared communication is employed, it being understood that any other suitable type of communication between the card 3302 and the telephone 3306 may be employed. A facilitator software upgrade confirmation is displayed on the telephone screen, designated by reference numeral 3312.

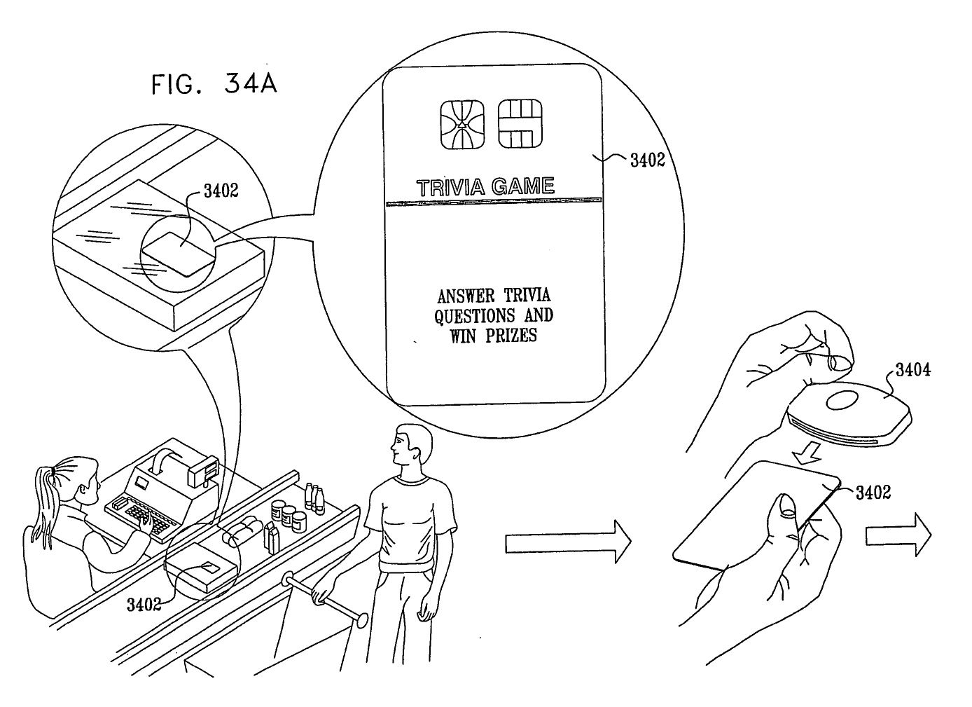

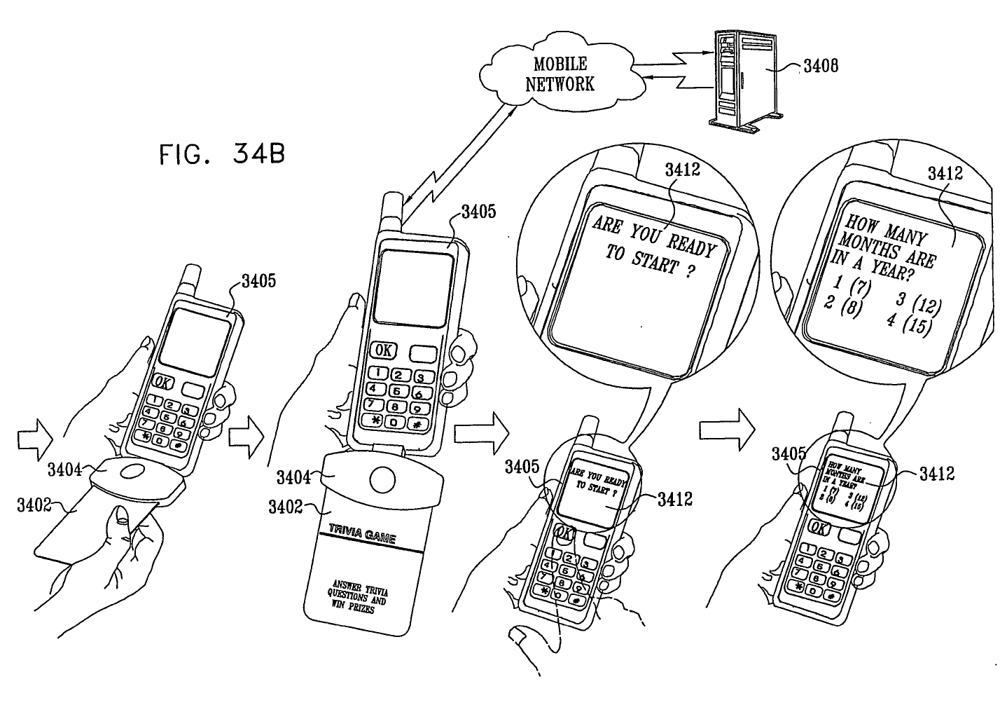

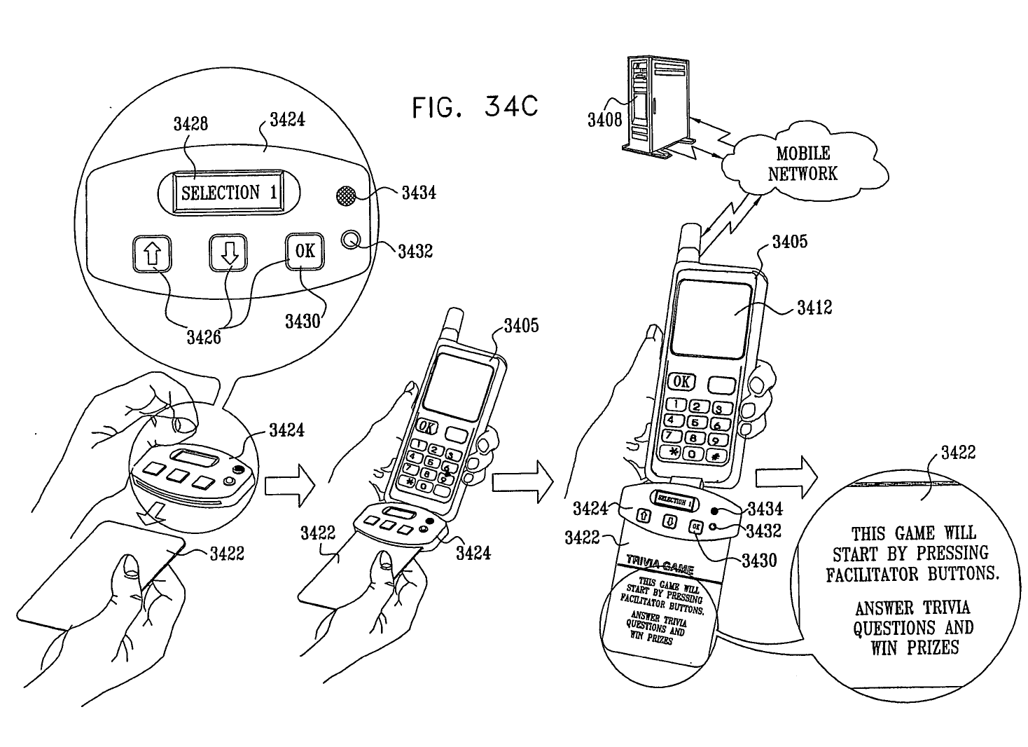

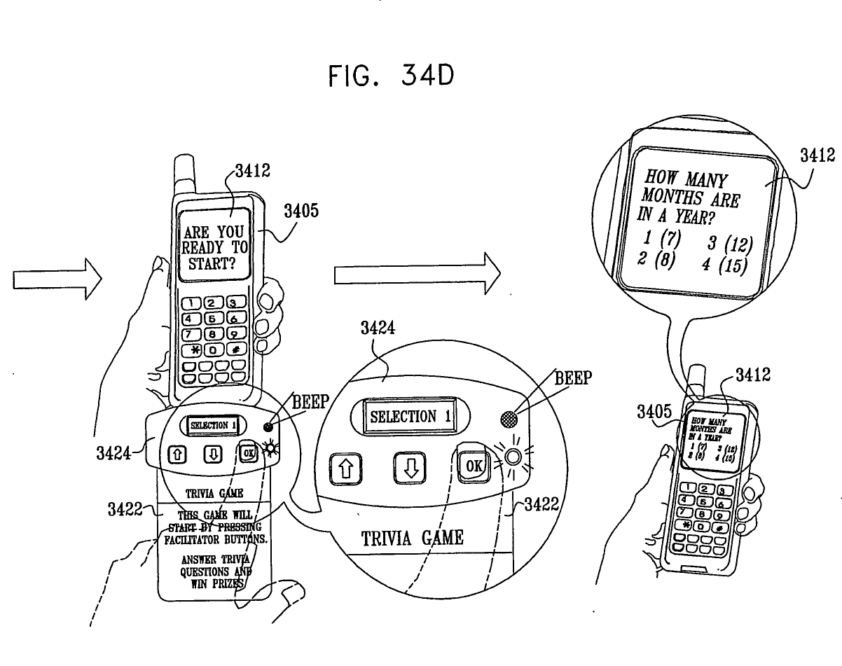

Reference is now made to FIGS. 34A, 34B, 34C and 34D, which are, taken together, a simplified pictorial illustration of operation of a selectable functionality mobile communication system constructed and operative in accordance with yet another preferred embodiment of the present invention. As seen in FIG. 34A, a typical scenario begins with a teenage boy, purchasing a mobile communication system user interface card 3402, at a supermarket or other retail outlet.

At any appropriate time thereafter, the teenage boy may insert the card 3402 into an interface card/mobile telephone communication facilitator 3404 or any other suitable user-interface card intermediary. The teenage boy may employ the card 3402 and the facilitator 3404 in a number of different functional contexts, two of which are described hereinbelow with reference to FIGS. 34B, 34C and 34D.

In FIG. 34B, it is seen that the teenage boy, or any other user, may cause a trivia game to be downloaded to his mobile telephone 3405 by inserting the card 3402 into the facilitator 3404 causing a “TRIVIA GAME” request information module to automatically be communicated from card 3402 to or through facilitator 3404 and enabling facilitator 3404 to communicate the game request to the telephone 3405. The telephone 3405, in turn, communicates, via a mobile network, with server 3408 and displays a subsequent message on a display 3412 of the telephone 3405 to start the game. By pressing the keypad of the telephone 3405, the telephone 3405 communicates, via a mobile network, with server 3408 and enables playing of the requested game, which is displayed on the telephone display 3412.

FIGS. 34C & 34D together show use of a card 3422, a facilitator 3424 and the telephone 3405 to cause a trivia game to be downloaded to telephone 3405. The teenage boy presses on selection buttons 3426 on the facilitator 3424. The buttons 3426 are used to select from options that can be viewed on a display screen 3428 on the facilitator 3424. Pressing a select button 3430 causes an information module containing a game request to be communicated from card 3422 to facilitator 3424 and enables facilitator 3424 to communicate the request to the telephone 3405.

The telephone 3405, in turn, communicates, via a mobile network, with server 3408, downloads the requested game from server 3408 and displays the introduction of requested game on the telephone display 3412. Facilitator 3424 may also include a LED 3432 and/or a ringer 3434, typically to provide confirmation to the user that his request is being processed. The user then receives a subsequent message on the telephone display 3412 to start the game. By a user pressing the selection buttons on the facilitator 3424, the facilitator 3424, communicates, via a mobile network, with server 3408 and enables playing of the requested game, which is displayed on the telephone display 3412.

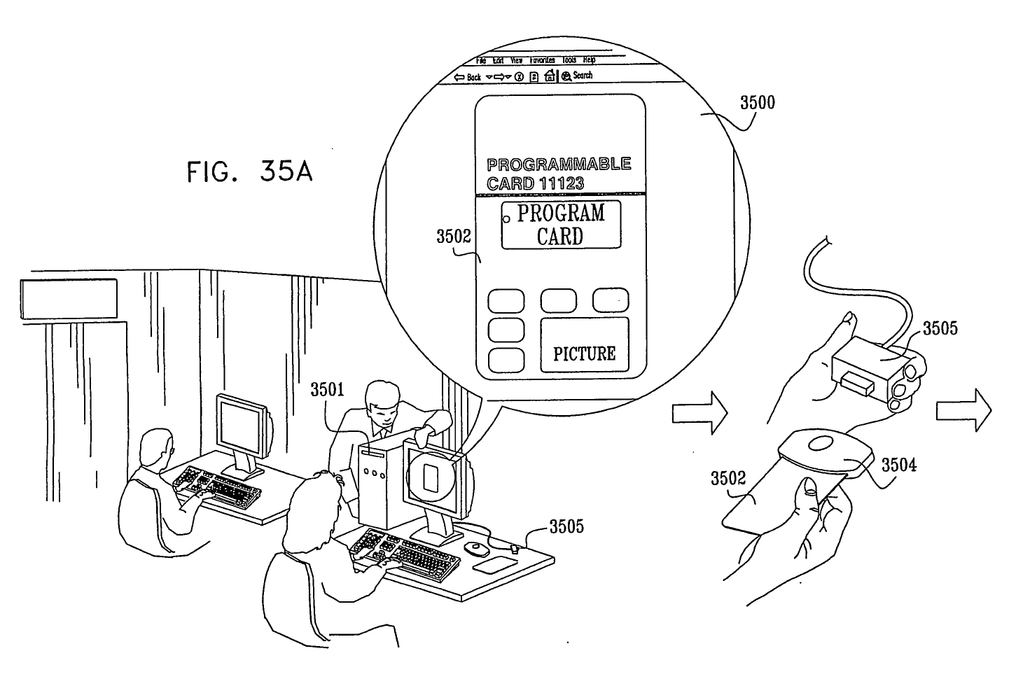

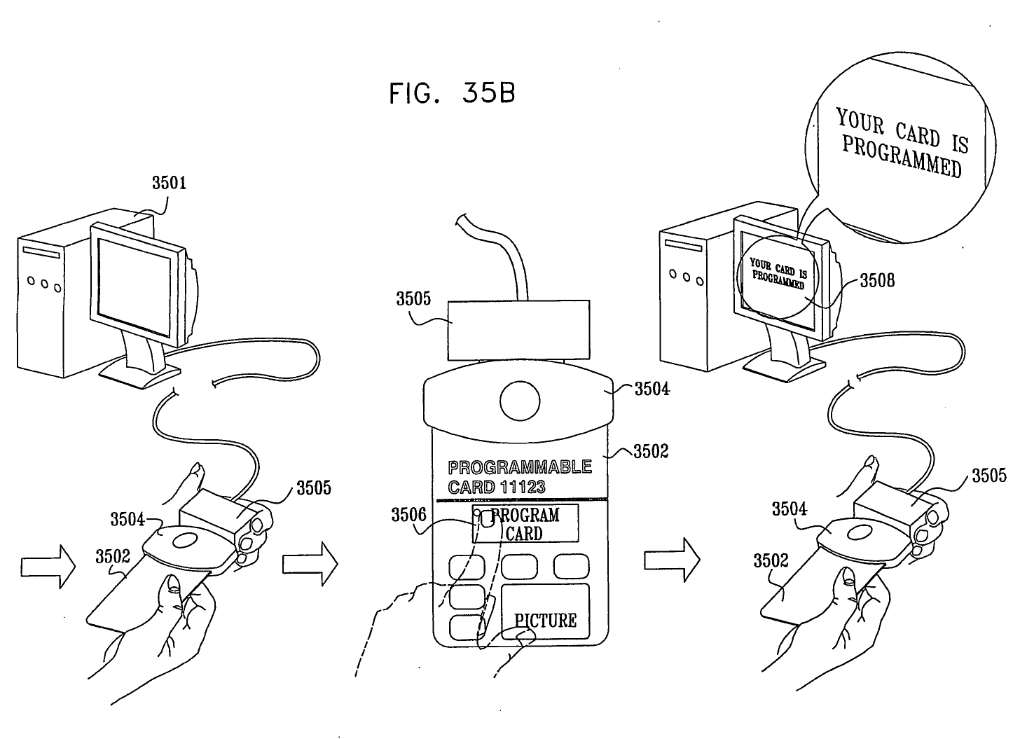

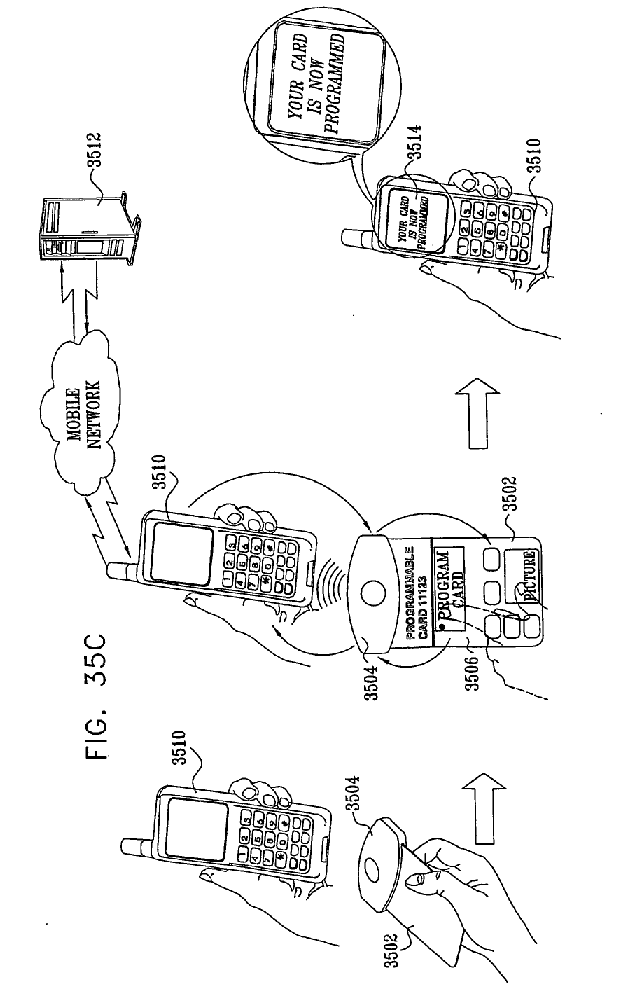

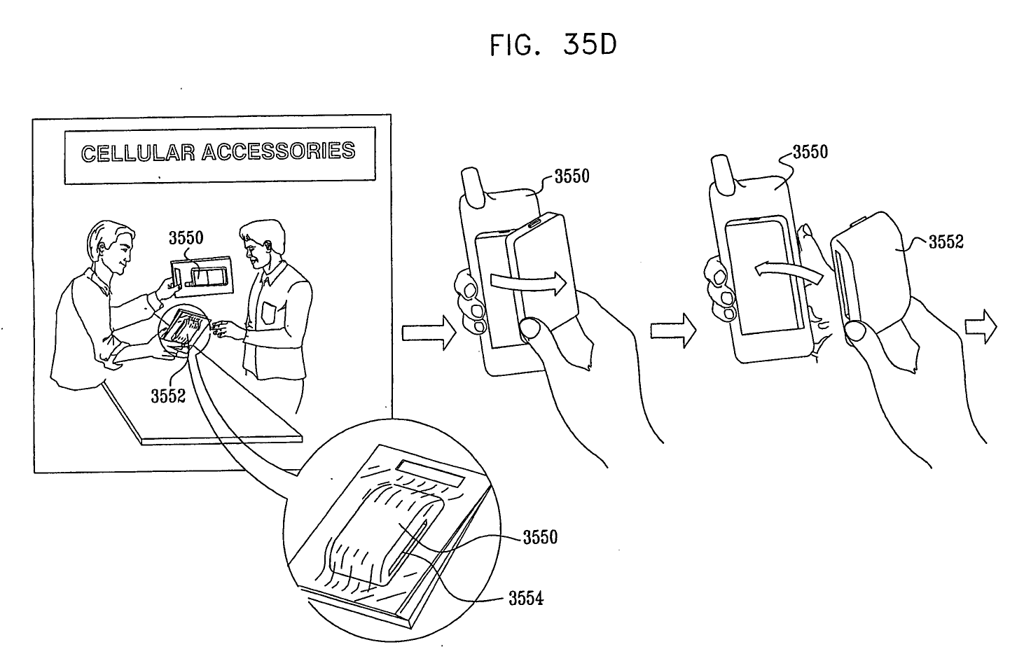

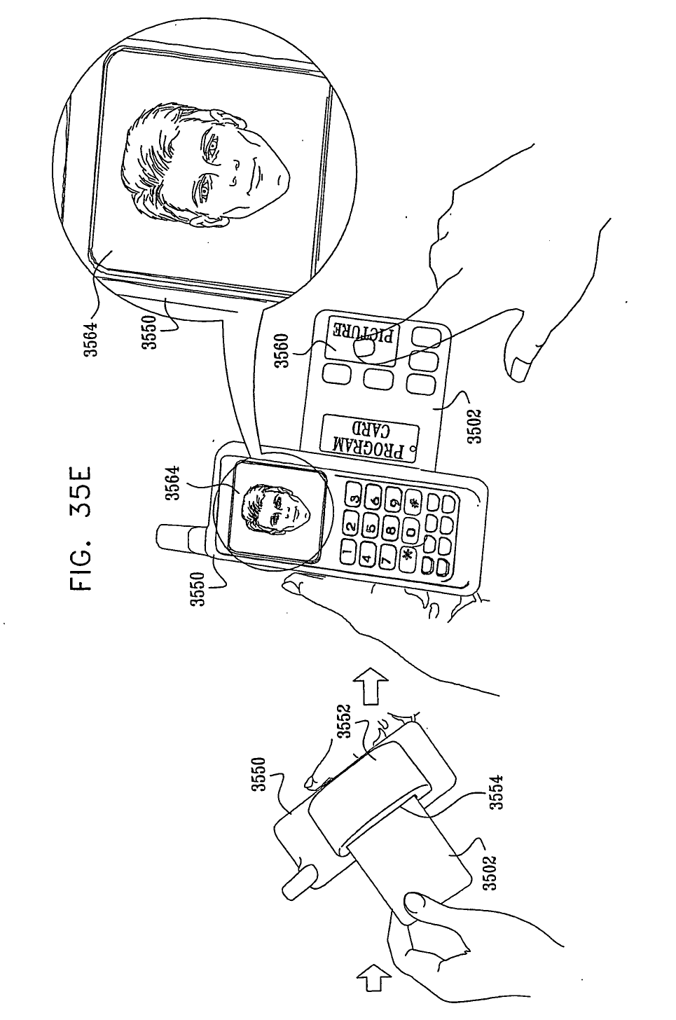

Reference is now made to FIGS. 35A, 35B and 35C, which are, taken together, a simplified pictorial illustration of operation of a selectable functionality communication system constructed and operative in accordance with a preferred embodiment of the present invention. As seen in FIG. 35A, a typical scenario begins with a PC user browsing through an Internet site 3500, displayed on a screen of a computer 3501, which screen displays simulated programmable cards that can be downloaded to a user interface card 3502.

At any appropriate time thereafter, the PC user may effect the download by inserting the user interface card 3502 into an interface card/mobile telephone communication facilitator 3504 or any other suitable user-interface card intermediary and connecting facilitator to connect with computer 3501, via a connector 3505, which is connected to the computer 3501.

As seen in FIG. 35B, the PC user may download selected information modules to the card 3502 by pressing on a “PROGRAM CARD” button 3506 on card 3502, causing a “PROGRAM CARD” request information module to be communicated from card 3502 to or through facilitator 3504 and enabling facilitator 3504 to communicate the request to the computer 3501. In the illustrated embodiment, connector 3505 is a wired connector, it being understood that any other suitable type of communication connector between the facilitator 3504 and the computer 3501 may be employed. In response to the “PROGRAM CARD” request, the computer 3501 downloads the desired information module to card 3502. A confirmation is displayed on the computer screen, designated by reference numeral 3508.

FIG. 35C shows use of the card 3502, the facilitator 3504 and a telephone 3510 to program card 3502 with new information modules. The PC user presses on the “PROGRAM CARD” button 3506 on card 3502, typically causing an information module containing a “PROGRAM CARD” request to be communicated from the card 3502 to or through facilitator 3504 and enabling facilitator 3504 to communicate the request to the telephone 3510. The telephone 3510 in turn communicates, via a mobile network, with a server 3512 and obtains the requested new information modules, via the Internet. A confirmation that the card 3502 has been programmed is displayed on a telephone screen, designated by reference numeral 3514.

Reference is now made to FIGS. 35D and 35E, which together are a simplified pictorial illustration of operation of a selectable functionality mobile communication system constructed and operative in accordance with a preferred embodiment of the present invention. As seen in FIG. 35D, a typical scenario begins with a consumer purchasing a telephone 3550 having integral facilitator or other intermediary functionality. One example of such a telephone could be a Nokia Model 3510i of Nokia, U.S.A. having a removable back cover, which has been replaced by a replacement back cover 3552 incorporating the functionality of a facilitator or other intermediary of the type described herein, as well as a battery. The facilitator functionality/telephone communication link is preferably hard wired inside the telephone.

The consumer may employ the telephone 3550 having facilitator functionality in a number of different functional contexts, one of which is described hereinbelow with reference to FIG. 35E.

Turning to FIG. 35E, it is seen that the consumer may upload a selected image onto their telephone 3550 by pressing on a “PICTURE” button 3560 on card 3502, causing an image information module to be communicated from card 3502 to the telephone 3550, typically by inserting card 3502 into a slot 3554 formed in the replacement back cover 3552, as shown, in order to display the image on the telephone screen, designated by reference numeral 3564. In the illustrated embodiment, the card 3501 is inserted directly into the back cover of the telephone 3550, it being understood that any other suitable type of operative engagement between the card 3502 and the telephone 3550 may be employed.

It is to be appreciated that the foregoing description and drawings present various examples of various features of systems and subsystems constructed and operative in accordance with a preferred embodiment of the present invention. Novel combinations of the features described hereinabove in various different contexts are within the scope of the present invention.

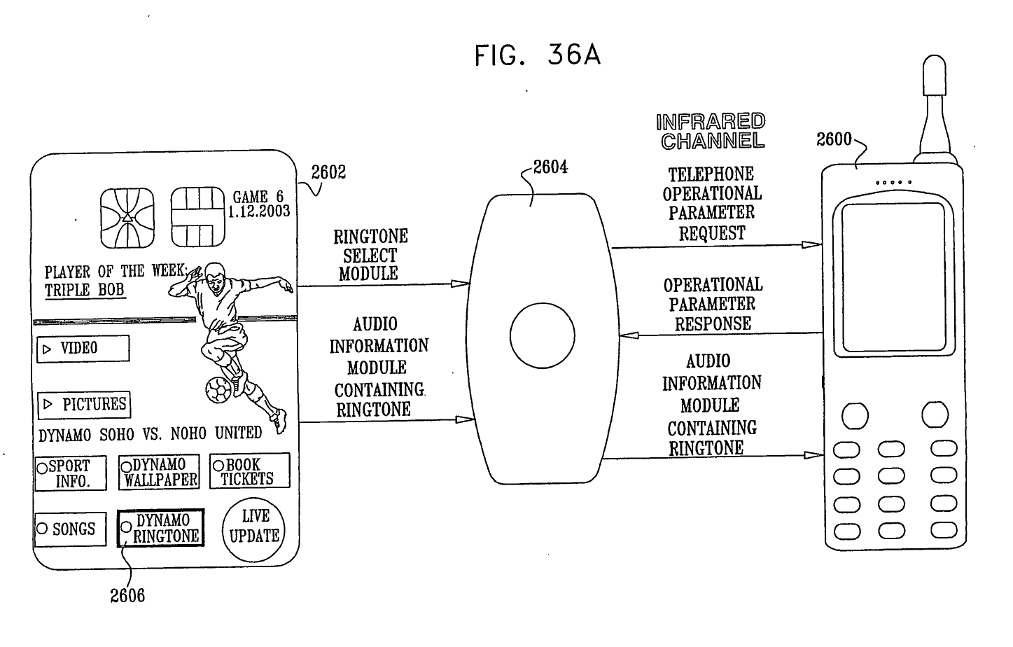

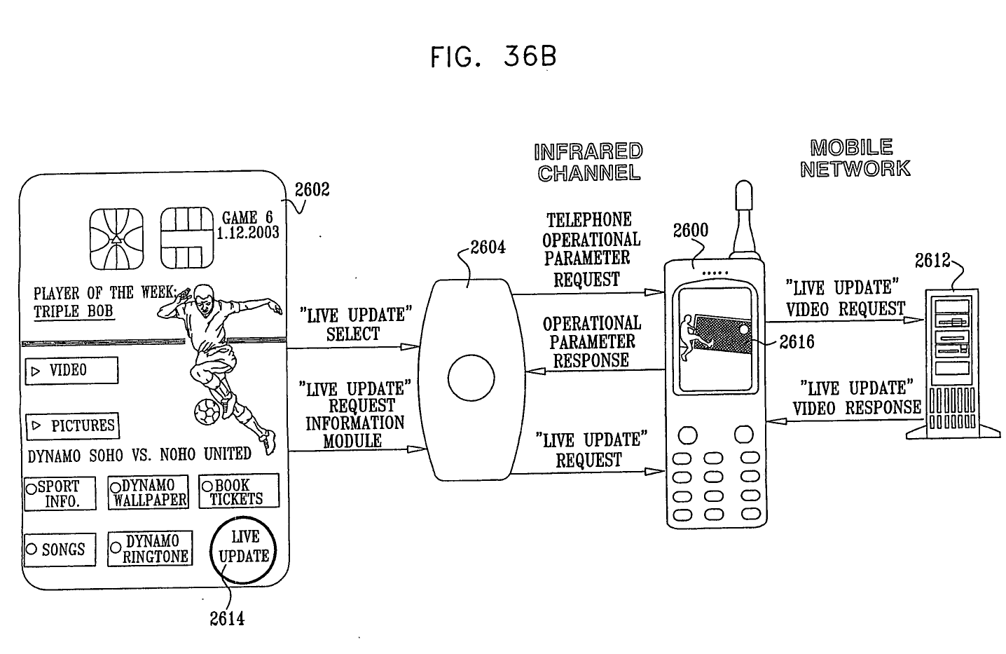

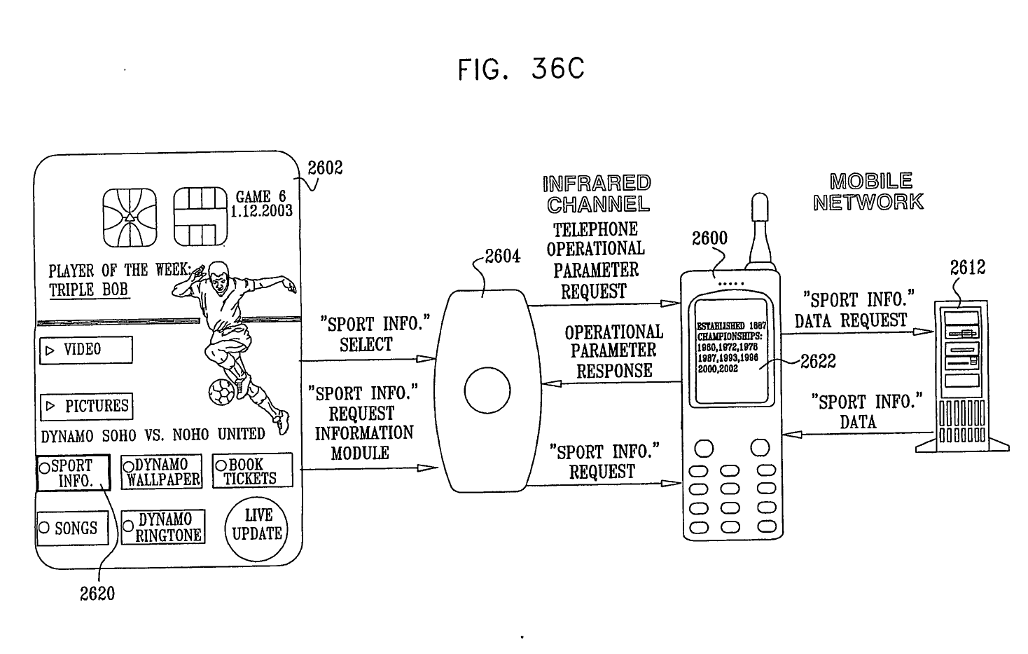

Reference is now made to FIGS. 36A, 36B and 36C, which are, taken together, a simplified generalized information flow diagram illustration of operation of the selectable functionality mobile communication system of FIGS. 26A-26D. As seen in FIG. 36A, which corresponds to FIG. 26B, in response to a user's pressing on the ringtone button 2606, a ringtone select information module is transmitted from the card 2602 to the facilitator 2604, causing the facilitator 2604 to pull from card 2602, an audio information module containing the selected ringtone.

The facilitator 2604, preferably communicating via an infrared channel with telephone 2600, requests certain operational parameters regarding the telephone and receives suitable responses. Upon receipt of these responses, the facilitator 2604 transmits audio information containing the selected ringtone in a format suitable for use by telephone 2600. This audio information may be identical to that received from card 2602 or may have undergone processing in the facilitator 2604 in order to adapt it to telephone 2600.

Turning to FIG. 36B, which corresponds to FIG. 26C, it is seen that in response to a user's pressing on the “LIVE UPDATE” button 2614, a “LIVE UPDATE” select information module is transmitted from the card 2602 to the facilitator 2604, causing the facilitator 2604 to pull from card 2602, a “LIVE UPDATE” request information module.

The facilitator 2604, preferably communicating via an infrared channel with telephone 2600, requests certain operational parameters regarding the telephone and receives suitable responses. Upon receipt of these responses, the facilitator 2604 transmits a “LIVE UPDATE” request to the telephone 2600 in a format suitable for the telephone, causing the telephone 2600, in turn, to communicate via a mobile network, a “LIVE UPDATE” video stream request to server 2612. The server provides a requested “LIVE UPDATE” video stream, which is displayed on the telephone display, designated by reference numeral 2616.

FIG. 36C, which corresponds to FIG. 26D, illustrates that in response to a user's pressing on the “SPORTS INFO” button 2620, a “SPORTS INFO” select information module is transmitted from the card 2602 to the facilitator 2604, causing the facilitator 2604 to pull from card 2602, a “SPORTS INFO” request information module.

The facilitator 2604, preferably communicating via an infrared channel with telephone 2600, requests certain operational parameters regarding the telephone and receives suitable responses. Upon receipt of these responses, the facilitator 2604 transmits a “SPORTS INFO” request to the telephone 2600 in a format suitable for the telephone, causing the telephone 2600, in turn, to communicate via a mobile network, “SPORTS INFO” data request to server 2612. The server provides the requested “SPORTS INFO” data, which is displayed on the telephone display, designated by reference numeral 2622.

Reference is now made to FIG. 37, which is a simplified generalized information flow diagram illustration of operation of the selectable functionality mobile communication system of FIGS. 27A and 27B. As seen in FIG. 37, which corresponds to FIG. 27B, in response to a user's pressing on the “PLAY GAME” button 2706, a game select information module is transmitted from the card 2702 to the facilitator 2704, causing the facilitator 2704 to pull from card 2702, an “PLAY GAME” information module containing the selected game.

The facilitator 2704, preferably communicating, via a RF channel or more specifically a BlueTooth channel, with the PDA 2700, requests certain operational parameters regarding the PDA 2700 and receives suitable responses. Upon receipt of these responses, the facilitator 2704 transmits software information containing the selected game in a format suitable for use by the PDA 2700. This information may be identical to that received from card 2702 or may have undergone processing in the facilitator 2704 in order to adapt it to the PDA 2700.

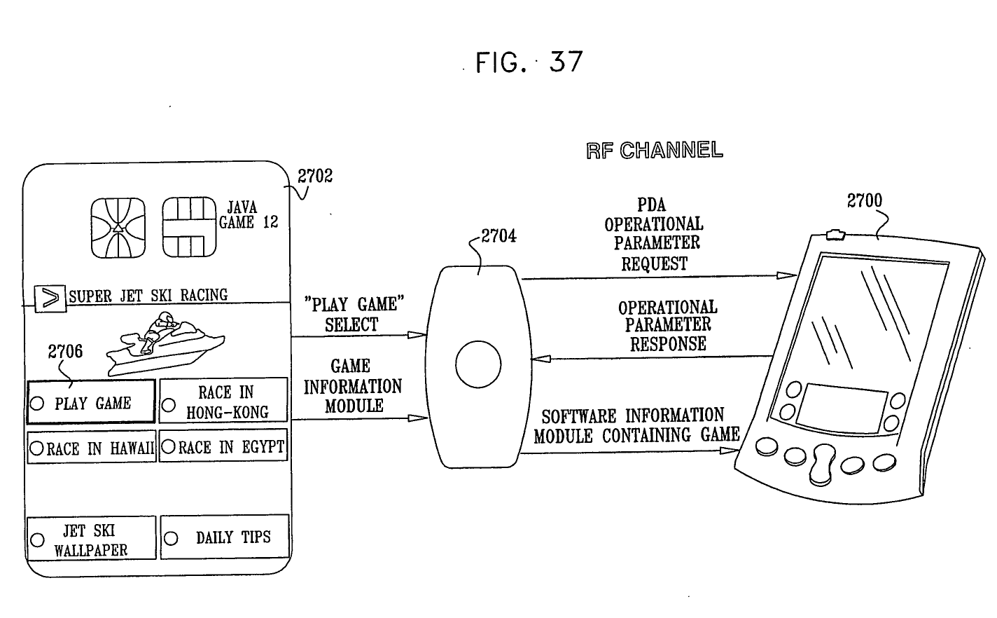

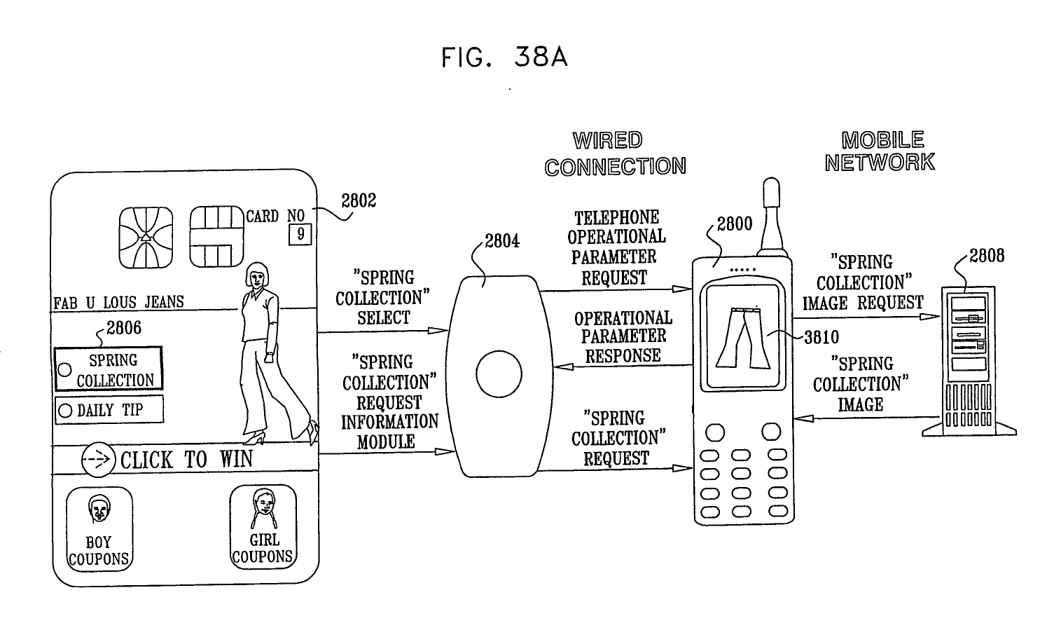

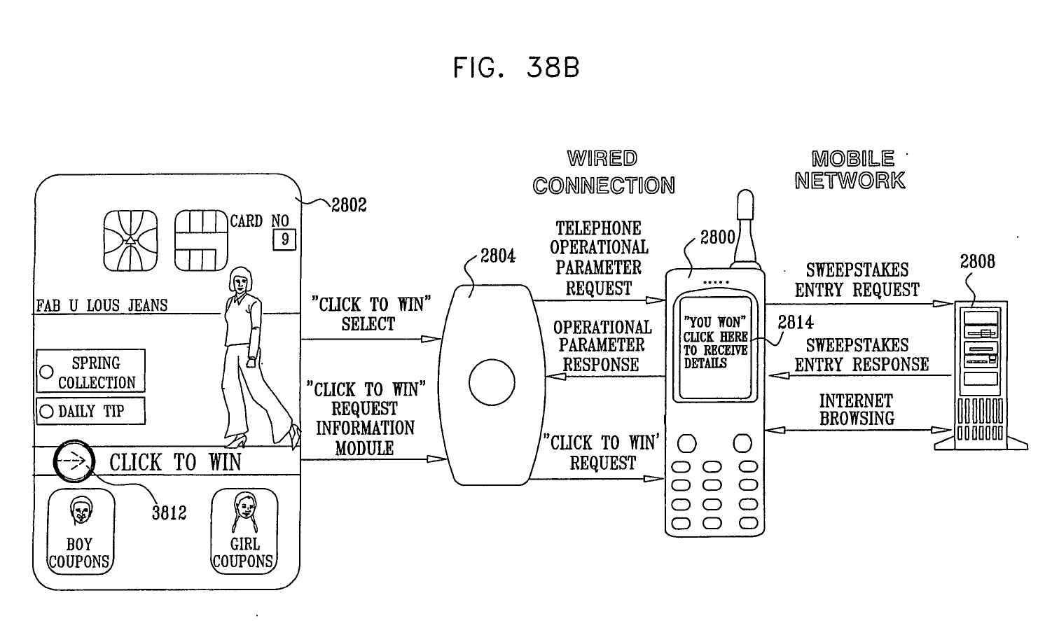

Reference is now made to FIGS. 38A and 38B, which are, taken together, a simplified generalized information flow diagram illustration of operation of the selectable functionality mobile communication system of FIGS. 28A-28C. Turning to FIG. 38A, which corresponds to FIG. 28B, it is seen that in response to a user's pressing on the “SPRING COLLECTION” image button 2806, a “SPRING COLLECTION” select information module is transmitted from the card 2802 to the facilitator 2804, causing the facilitator 2804 to pull from card 2802, a “SPRING COLLECTION” request information module.

The facilitator 2804, preferably communicating via a wired connection with telephone 2800, requests certain operational parameters regarding the telephone and receives suitable responses. Upon receipt of these responses, the facilitator 2804 transmits a “SPRING COLLECTION” request to the telephone 2800 in a format suitable for the telephone 2800, causing the telephone 2800, in turn, to communicate, via a mobile network, a “SPRING COLLECTION ” image request to server 2808. The server 2808 provides the requested “SPRING COLLECTION” image, which is displayed on the telephone display, designated by reference numeral 2810.

In FIG. 38B, which corresponds to FIG. 28C, it is seen that in response to a user's pressing on the “CLICK TO WIN” button 2812, a “CLICK TO WIN” select information module is transmitted from the card 2802 to the facilitator 2804, causing the facilitator 2804 to pull from card 2802, a “CLICK TO WIN” request information module.

The facilitator 2804, preferably communicating via wired connection with telephone 2800, requests certain operational parameters regarding the telephone 2800 and receives suitable responses. Upon receipt of these responses, the facilitator 2804 transmits a “CLICK TO WIN” draw entry request to the telephone 2800 in a format suitable for the telephone 2800, causing the telephone 2800, in turn, to communicate via a mobile network, a “CLICK TO WIN” request to server 2808. The server provides the requested “CLICK TO WIN” draw results, which are displayed on the telephone display, designated by reference number 2814, and enables further browsing of the fashion sweepstakes internet site.

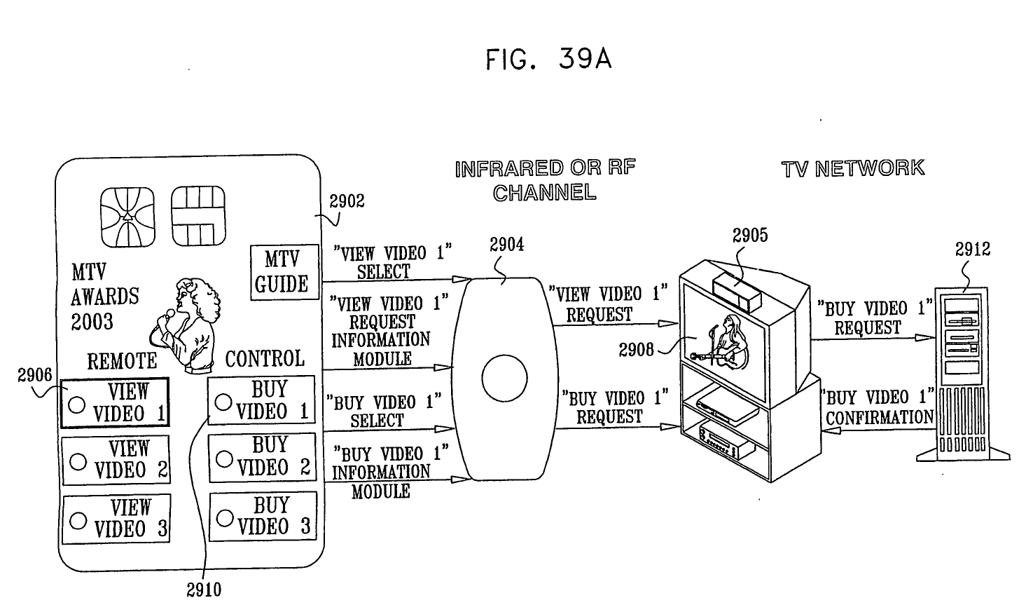

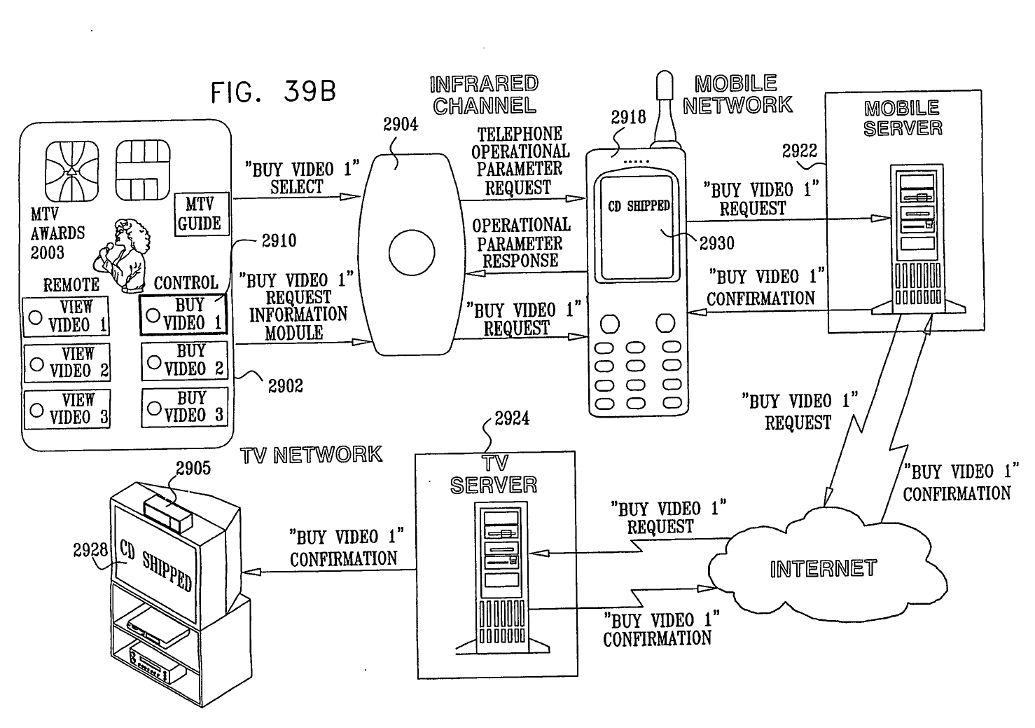

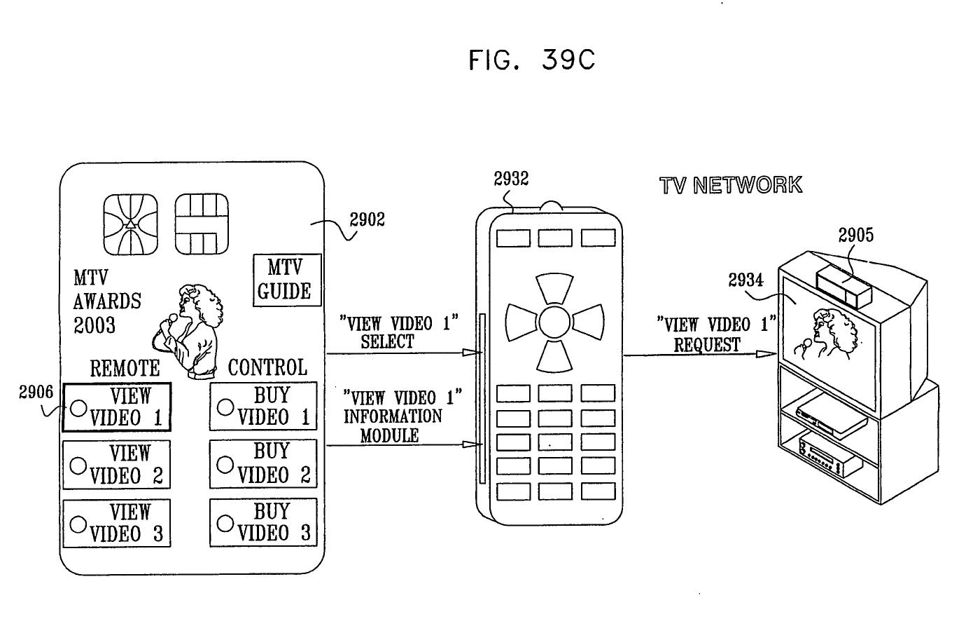

Reference is now made to FIGS. 39A and 39B, which are, taken together, a simplified generalized information flow diagram illustration of operation of the selectable functionality communication system of FIGS. 29A-29C. Turning to FIG. 39A, which corresponds to FIG. 29B, it is seen that in response to a user's pressing on the “VIEW VIDEO 1” button 2906, a “VIEW VIDEO 1” select information module is transmitted from the card 2902 to the facilitator 2904, causing the facilitator 2904 to pull from card 2902 a “VIEW VIDEO 1” request information module.

The facilitator 2904 preferably communicates via an infrared or RF channel with an interactive television device such as a set top box 2905, which transmits a “VIEW VIDEO 1” request to a set top box 2905. The set top box 2905 displays the requested music video clip on the television screen, designated by reference numeral 2908.

It is also seen that in response to a user's pressing on the “BUY VIDEO 1” button 2910 a “BUY VIDEO 1” select information module is transmitted from the card 2902 to the facilitator 2904, causing the facilitator 2904 to pull from card 2902 a “BUY VIDEO 1” request information module.

The facilitator 2904, preferably communicating via infrared or RF channel with the set top box 2905, transmits a “BUY VIDEO 1” video request to set top box 2905. The set top box 2905, in turn, communicates via a cable or satellite TV network or any other suitable return channel, the “BUY VIDEO 1” request to TV network server 2912, which in turn, transmits an order receipt confirmation that is displayed on the TV screen 2908. A service center representative responds to the “BUY VIDEO 1” request, transmitted by the server 2912, and arranges for delivery of the music clip compact disk.

In FIG. 39B, which corresponds to FIG. 29C, it is seen that in response to a user's pressing on the “BUY VIDEO 1” button 2910, a “BUY VIDEO 1” select information module is transmitted from the card 2902 to the facilitator 2904, causing the facilitator 2904 to pull from card 2902, a “BUY VIDEO 1” request information module.

The facilitator 2904, preferably communicating via an infrared channel with telephone 2918, requests certain operational parameters regarding the telephone and receives suitable responses. Upon receipt of these responses, the facilitator 2904 transmits a “BUY VIDEO 1” request to the telephone 2918 in a format suitable for the telephone, causing the telephone 2918, in turn, to communicate via a mobile network, the “BUY VIDEO 1” request to mobile communications server 2922 which communicates, via the Internet, with TV network server 2924. Server 2924 communicates, via a cable or satellite TV network or any other return channel network with set top box 2905 to communicate a “BUY VIDEO 1” video response. A request acknowledgement is displayed on the TV screen, here designated by reference numeral 2928.

The mobile communications server provides a “BUY VIDEO 1” request acknowledgement, which is displayed on the telephone display, designated by reference numeral 2930.

Reference is now made to FIG. 39C, which is a simplified generalized information flow diagram illustration of operation of the selectable functionality communication system of FIGS. 29D and 29E. Turning to FIG. 39C, which corresponds to FIG. 29E, it is seen that in response to a user's pressing on the “VIEW VIDEO 1” button 2906, a “VIEW VIDEO 1” select information module is transmitted from the card 2902 to the television's card enabled set top box remote controller 2932, causing the remote controller 2932 to pull from card 2902 a “VIEW VIDEO 1” information module.

The remote controller 2932, preferably communicating via an infrared or RF channel with set top box 2905 transmits a “VIEW VIDEO 1” video request to set top box 2905. The requested video clip is then displayed on the television screen, here designated by reference numeral 2934.

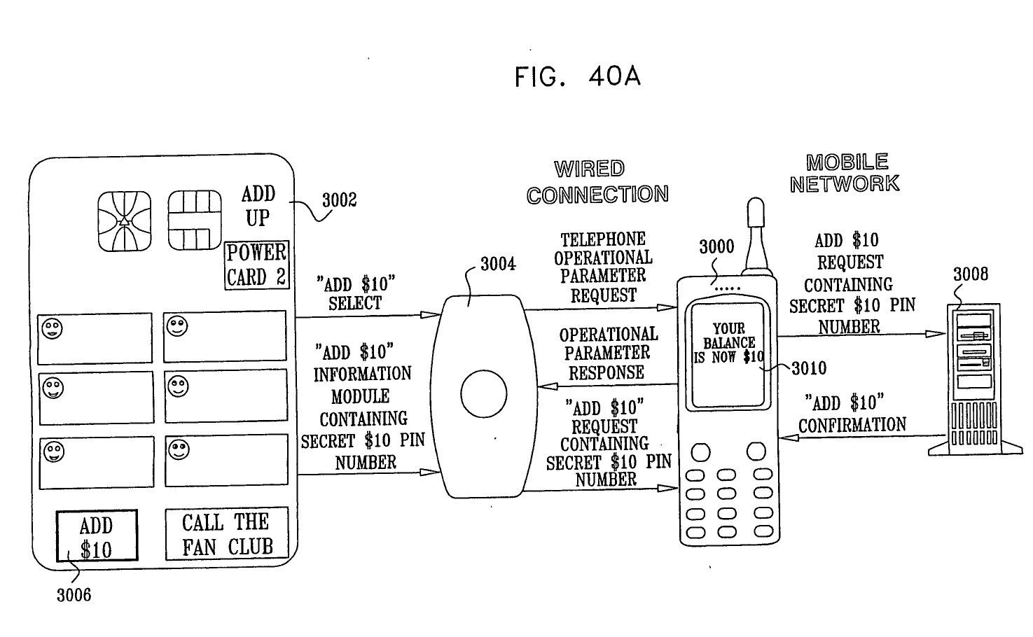

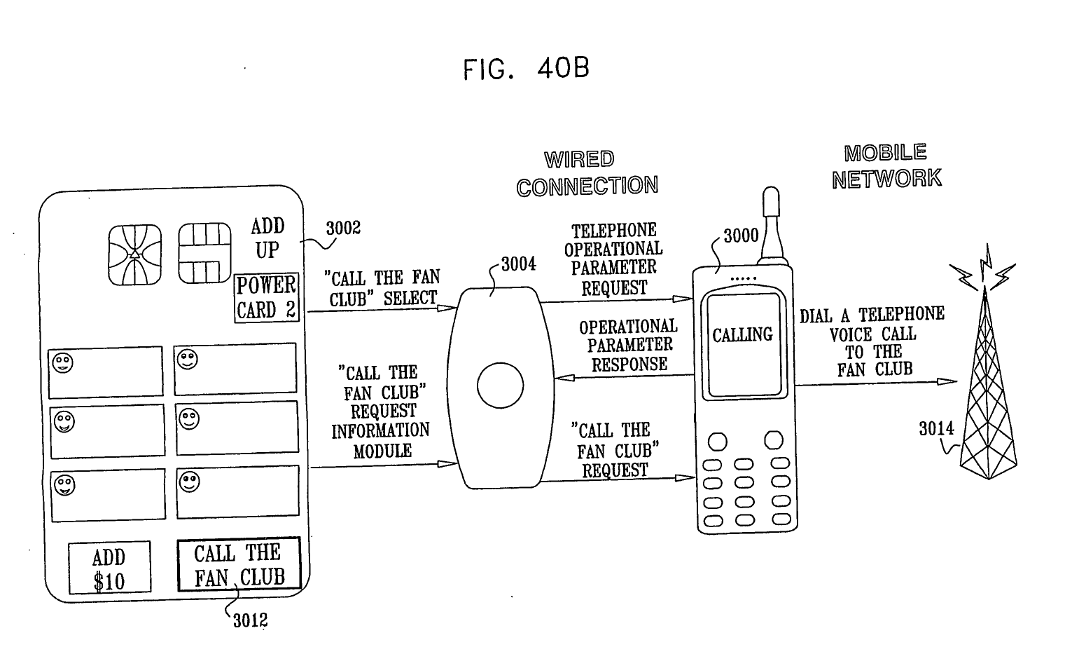

Reference is now made to FIGS. 40A and 40B, which are, taken together, a simplified generalized information flow diagram illustration of operation of the selectable functionality mobile communication system of FIGS. 30A-30C. Turning to FIG. 40A, which corresponds to FIG. 30B, it is seen that in response to a user's pressing on the “ADD $10” request button 3006, an “ADD $10” request containing a secret PIN (Personal Identification Number) select information module is transmitted from the card 3002 to the facilitator 3004, causing the facilitator 3004 to pull from card 3002, an “ADD $10” information module containing the appropriate PIN.

The facilitator 3004, preferably communicating via a wired connection with telephone 3000, requests certain operational parameters regarding the telephone and receives suitable responses. Upon receipt of these responses, the facilitator 3004 transmits an “ADD $10” request containing the corresponding secret “ADD $10” PIN number to the telephone 3000 in a format suitable for the telephone 3000, causing the telephone 3000, in turn, to communicate via a mobile network, an “ADD $10” request and a corresponding “ADD $10” secret PIN number to server 3008. The server credits the requested “ADD $10” crediting confirmation, which is displayed on the telephone display, designated by reference numeral 3010.

In FIG. 40B, which corresponds to FIG. 30C, it is seen that in response to a user's pressing on the “CALL TIE FAN CLUB” request button 3012, a “CALL THE FAN CLUB” select information module is transmitted from the card 3002 to the facilitator 3004, causing the facilitator 3004 to pull from card 3002 a “CALL THE FAN CLUB” information module.

The facilitator 3004, preferably communicating via wired connection with telephone 3000, requests certain operational parameters regarding the telephone and receives suitable responses. Upon receipt of these responses, the facilitator 3004 transmits a “CALL THE FAN CLUB” request to the telephone 3000 in a format suitable for the telephone, causing the telephone 3000, in turn, via the mobile network 3014, to dial a voice call to the fan club destination.

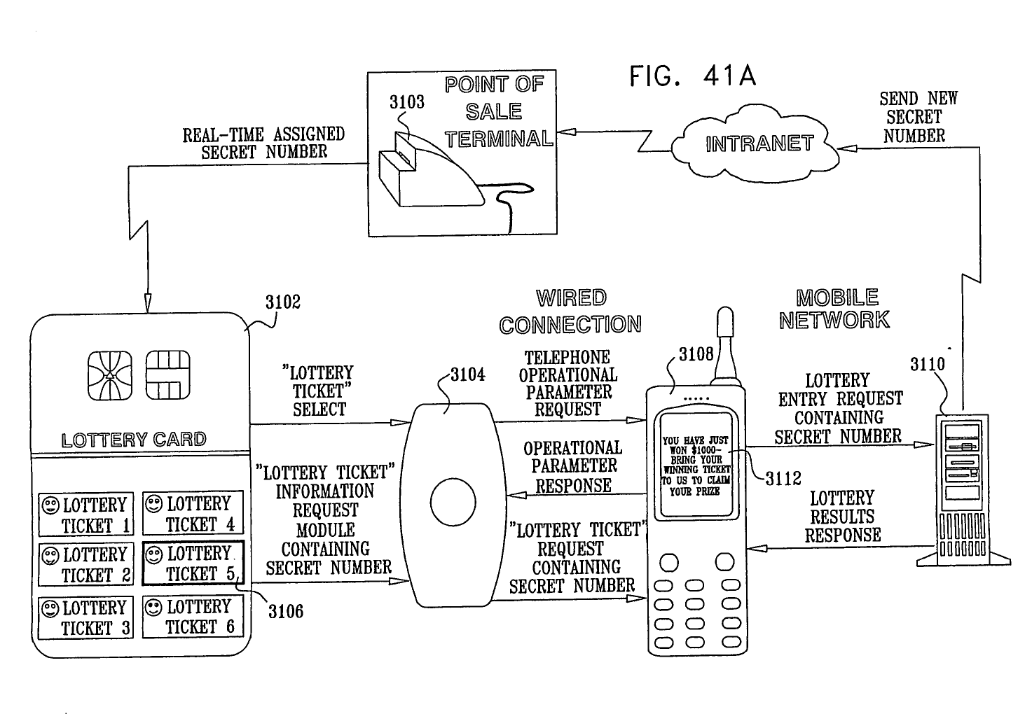

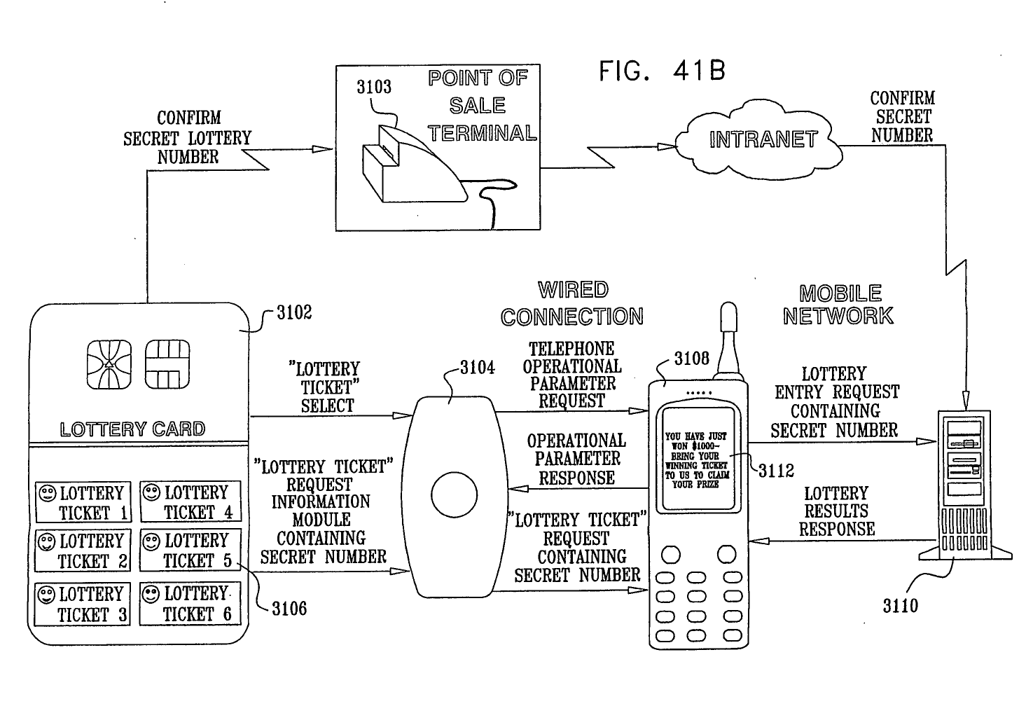

Reference is now made to FIGS. 41A and 41B which are together a simplified generalized information flow diagram illustration of operation of the selectable functionality mobile communication system of FIGS. 31A and 31B. Turning to FIG. 41A, which corresponds to FIG. 31B, it is seen that the lottery ticket card 3102 is issued a secret lottery number at the point-of-sale terminal 3103. In response to a user's pressing on the “LOTTERY TICKET” button 3106, a lottery ticket draw entry request select information module, containing a secret lottery number is transmitted from the card 3102 to the facilitator 3104, causing the facilitator 3104 to pull from card 3102, a lottery ticket draw entry request information module containing a secret lottery number.

The facilitator 3104, preferably communicating via a wired connection, with telephone 3108, requests certain operational parameters regarding the telephone 3108 and receives suitable responses. Upon receipt of these responses, the facilitator 3104 transmits a lottery ticket draw entry request containing a secret lottery number to the telephone 3108 in a format suitable for the telephone 3108, causing the telephone 3108, in turn, to communicate via a mobile network, a lottery ticket draw entry request containing a secret lottery number to server 3110. The server 3110 provides the requested lottery results, which are displayed on the telephone display, designated by reference numeral 3112.The server 3110 transmits a new secret lottery number to the point-of-sale terminal 3103, via the intranet.

FIG. 41B is an alternative simplified generalized information flow diagram illustration of operation of the selectable functionality mobile communication system of FIGS. 31A and 31B. In FIG. 41B it is seen that a lottery ticket, already containing a secret lottery number is confirmed and activated at the point-of-sale terminal 3103. In response to a user, pressing on the “LOTTERY TICKET” button 3106, a lottery ticket, which already contains a secret lottery number entry request select information module, containing a secret lottery number is transmitted from the card 3102 to the facilitator 3104, causing the facilitator 3104 to pull from card 3102, a lottery ticket draw entry request information module containing a secret lottery number.

The facilitator 3104, preferably communicating via a wired connection with telephone 3108, requests certain operational parameters regarding the telephone 3108 and receives suitable responses. Upon receipt of these responses, the facilitator 3104 transmits a lottery ticket draw entry request containing a secret lottery number to the telephone 3108 in a format suitable for the telephone 3108, causing the telephone 3108, in turn, to communicate via a mobile network, a lottery ticket entry request containing a secret lottery number to server 3110. The server provides the requested lottery results, which are displayed on the telephone display, designated by reference number 3112.The point-of-sale 3103 activates a new secret lottery number at the server 3110.

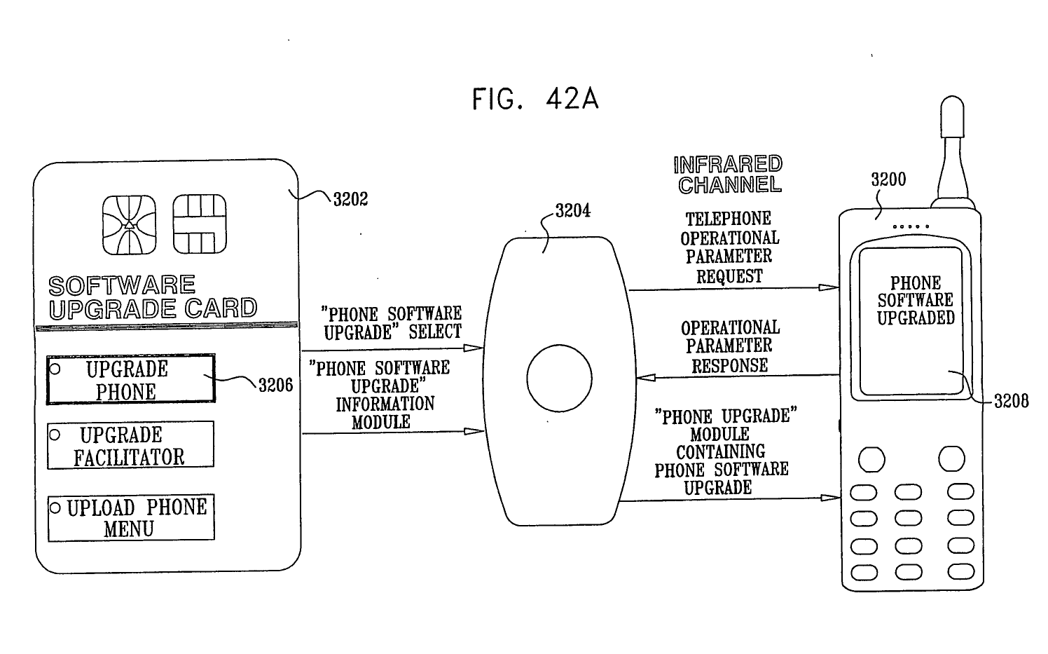

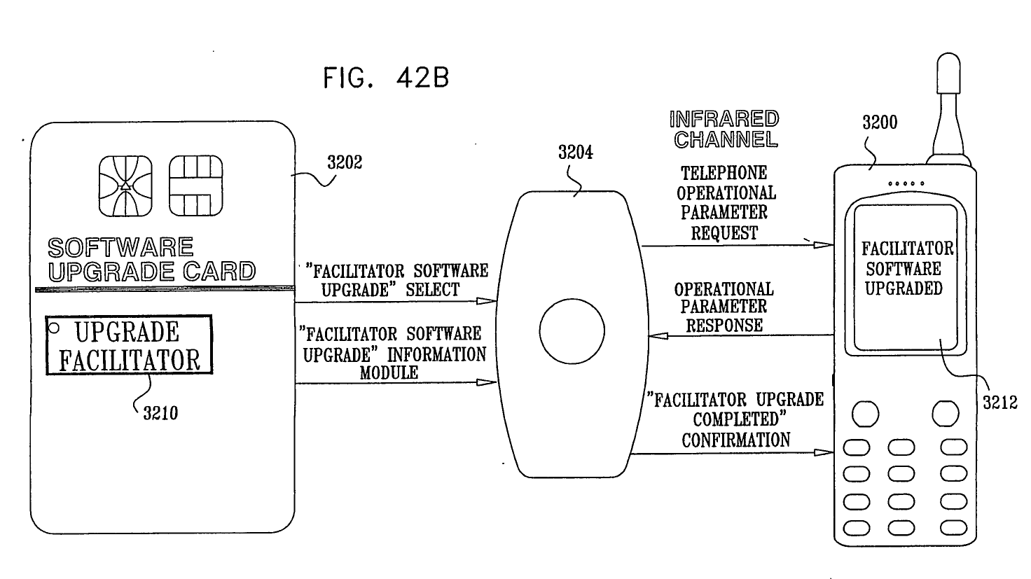

Reference is now made to FIGS. 42A and 42B, which are together a simplified generalized information flow diagram illustration of operation of the selectable functionality mobile communication system of FIGS. 32A-32C. As seen in FIG. 42A, which corresponds to FIG. 32B, in response to a user pressing a “UPGRADE PHONE” button 3206, a selected phone upgrade software information module is transmitted from the card 3202 to the facilitator 3204, causing the facilitator 3204 to pull from card 3202, a phone upgrade information module containing the selected phone upgrade software.

The facilitator 3204, preferably communicating via an infrared channel with telephone 3200, requests certain operational parameters regarding the telephone and receives suitable responses. Upon receipt of these responses, the facilitator 3204 transmits phone upgrade software information containing the selected phone upgrade in a format suitable for use by telephone 3200. This phone upgrade information may be identical to that received from card 3202 or may have undergone processing in the facilitator 3204 in order to adapt it to telephone 3200.

Turning to FIG. 42B, which corresponds to FIG. 32C, in response to a user's pressing on the “UPGRADE FACILITATOR” button 3210, a selected facilitator upgrade software information module is transmitted from the card 3202 to the facilitator 3204, causing the facilitator 3204 to pull from card 3202, a facilitator upgrade information module containing the selected facilitator upgrade software.

The facilitator 3204, preferably communicating via an infrared channel with telephone 3200, requests certain operational parameters regarding the telephone and receives suitable responses. Upon receipt of these responses, the card 3202 transmits facilitator upgrade software information containing the selected facilitator upgrade in a format suitable for use by the facilitator 3204. Upon completion of the facilitator software upgrade, the facilitator 3204 transmits a confirmation of completion of facilitator software upgrade to the telephone 3200. A facilitator software upgrade confirmation is displayed on the telephone display, designated by reference numeral 3212.

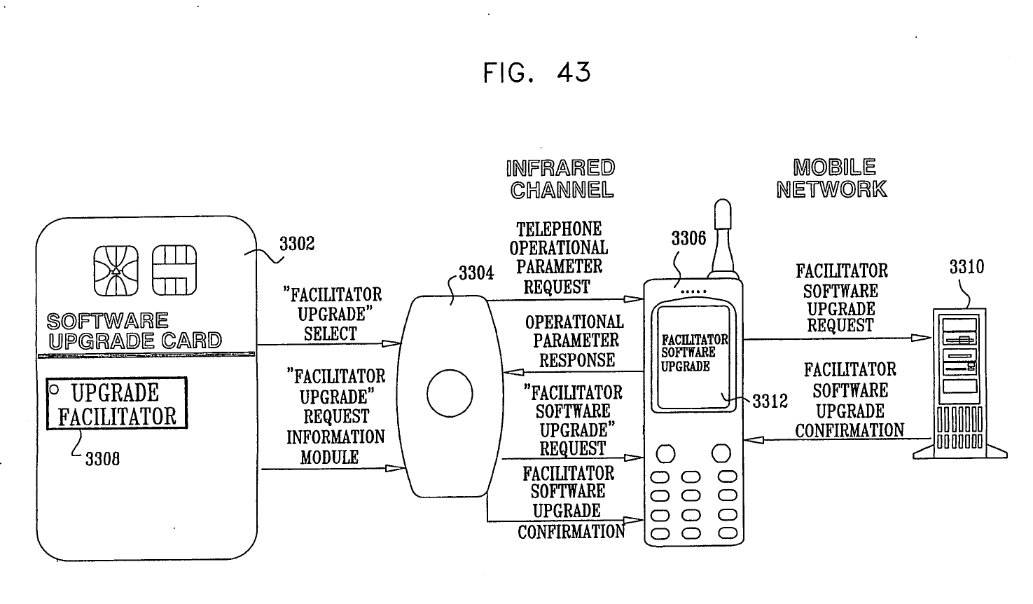

Reference is now made to FIG. 43, which is a simplified generalized information flow diagram illustration of operation of the selectable functionality mobile communication system of FIGS. 33A & 33B and corresponds to FIG. 33B. In response to a user pressing on the “UPGRADE FACILITATOR” button 3308, a selected facilitator software upgrade information module is transmitted from the card 3302 to the facilitator 3304, causing the facilitator 3304 to pull from card 3302, a facilitator software upgrade request information module containing the selected facilitator upgrade software.

The facilitator 3304, preferably communicating via an infrared channel with telephone 3306, requests certain operational parameters regarding the telephone and receives suitable responses. Upon receipt of these responses, the facilitator 3304 transmits facilitator software upgrade information containing the selected facilitator software upgrade request in a format suitable for use by telephone 3306, causing the telephone 3306, in turn, to communicate via a mobile network a facilitator software upgrade request to server 3310. The server 3310 provides the requested facilitator software upgrade via a mobile network to the telephone 3306.The telephone, in turn, transmits to the facilitator 3304 the facilitator software upgrade software information in a format suitable for use by the facilitator 3304. Upon completion of the facilitator software upgrade, the facilitator 3304 transmits a confirmation of completion of facilitator software upgrade to the telephone 3306. A facilitator software upgrade confirmation is displayed on the telephone display, designated by reference numeral 3312.

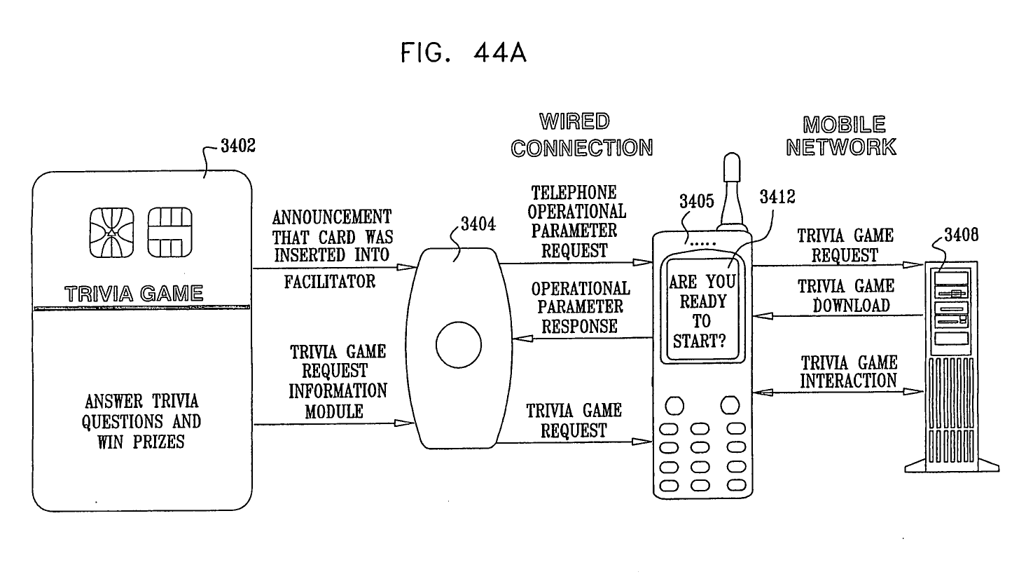

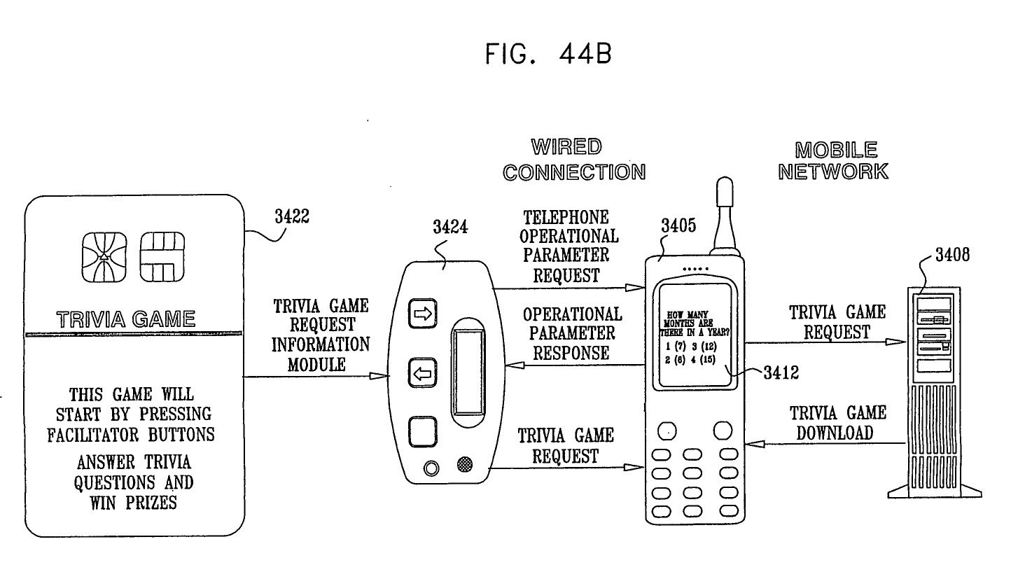

Reference is now made to FIG. 44A, which is a simplified generalized information flow diagram illustration of operation of the selectable functionality mobile communication system of FIGS. 34A and 34B and corresponds to FIG. 34B. It is seen that in response to a user inserting a trivia game card 3402 into a facilitator 3404 a selected information module is transmitted from the card 3402 to the facilitator 3404, causing the facilitator 3404 to pull from card 3402, a “TRIVIA GAME” request information module and notification that the card 3402 was inserted into the interface card/mobile telephone communication facilitator 3404.

The facilitator 3404, preferably communicating via wired connection with telephone 3405, requests certain operational parameters regarding the telephone 3405 and receives suitable responses. Upon receipt of these responses, the facilitator 3404 transmits a “TRIVIA GAME” request to the telephone 3405 in a format suitable for the telephone, causing the telephone 3405, in turn, to communicates via a mobile network, a “TRIVIA GAME ” request to server 3408. The server downloads the requested “TRIVIA GAME”. In response to a user's input via the telephone 3405, the trivia game may be played interactively as indicated by reference number 3412.

Reference is now made to FIGS. 44B which is a simplified generalized information flow diagram illustration of operation of the selectable functionality mobile communication system of FIGS. 34A, 34C and 34D and which corresponds to FIGS. 34C and 34D. It is seen that in response to a user pressing a button on facilitator 3424, a selected information module is transmitted from the card 3422 to the facilitator 3424, causing the facilitator 3424 to pull from card 3422, a “TRIVIA GAME” request information module.

The facilitator 3424, preferably communicating via a wired connection with telephone 3405, requests certain operational parameters regarding the telephone and receives suitable responses. Upon receipt of these responses, the facilitator 3424 transmits a “TRIVIA GAME” request to the telephone 3405 in a format suitable for the telephone, causing the telephone 3405, in turn, to communicates via a mobile network, a “TRIVIA GAME” request to server 3408. The server downloads the requested “TRIVIA GAME”.

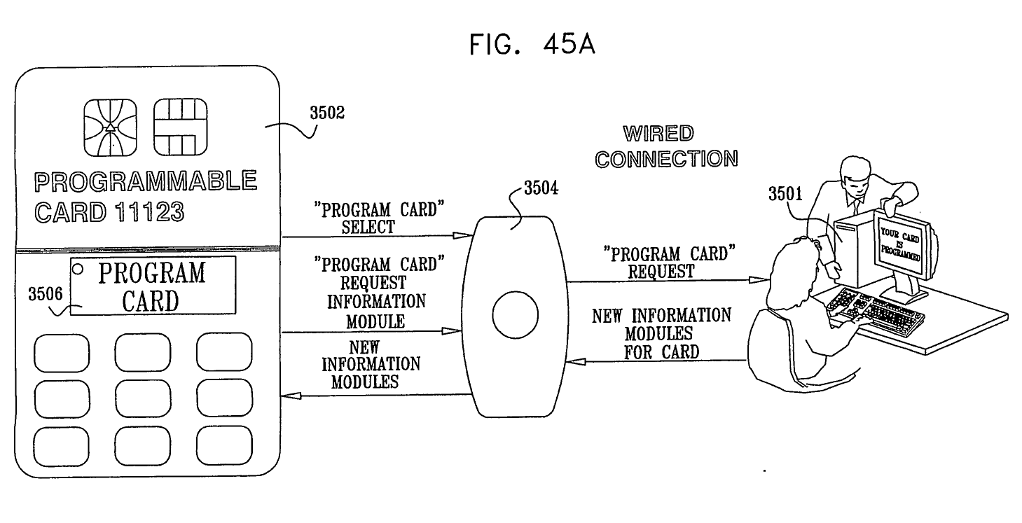

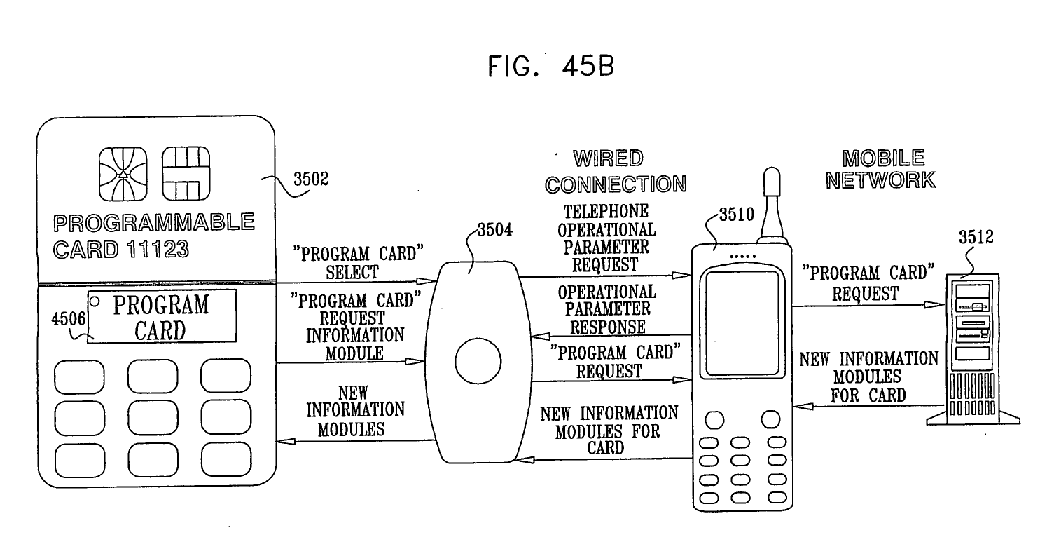

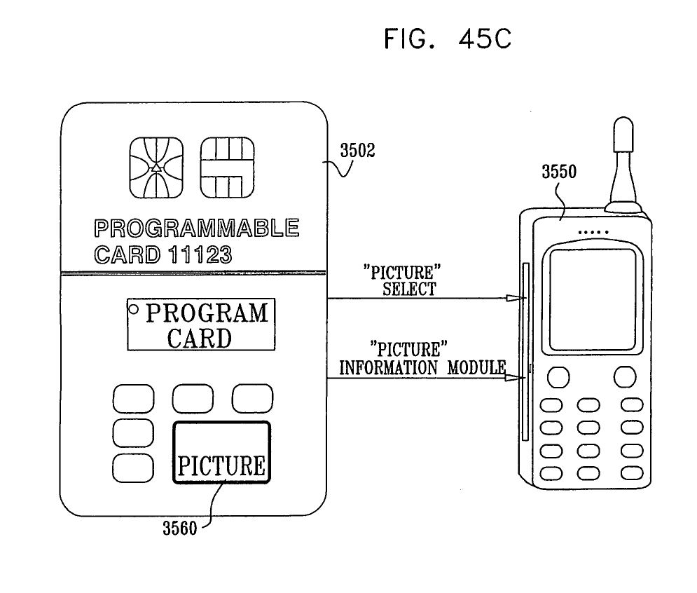

Reference is now made to FIGS. 45A and 45B, which are a simplified generalized information flow diagram illustrations of operation of the selectable functionality communication system of FIGS. 35A-35C. As seen in FIG. 45A, which corresponds to FIG. 35B, in response to a user's pressing on the “PROGRAM CARD” button 3506, a PROGRAM CARD request information module is transmitted from the card 3502 to the facilitator 3504, causing the facilitator 3504 to pull from card 3502, a “PROGRAM CARD” request information module specifying one or more selected information modules.

The facilitator 3504, preferably communicating via a physical connection with the computer 3501, requests programming of the card 3502 with one or more new information modules. Upon receipt of this request, the computer 3501 transmits software information containing the selected information modules, in a format suitable for use by the card 3502. Upon completion of the programming of new information modules the a confirmation of completion of the card programming is displayed on the computer 3501, designated by reference numeral 3508.

Turning to FIG. 45B, which corresponds to FIG. 35C, in response to a user's pressing on the PROGRAM CARD button 3506, a PROGRAM CARD request information module is transmitted from the card 3502 to the facilitator 3504, causing the facilitator 3504 to pull from card 3502, a “PROGRAM CARD” request information module specifying one or more selected information modules.

The facilitator 3504, preferably communicating via a wired connection with telephone 3510, requests certain operational parameters regarding the telephone and receives suitable responses. Upon receipt of these responses, the facilitator 3504 transmits the “PROGRAM CARD” request information module in a format suitable for use by telephone 3510, causing the telephone 3510, in turn, to communicate via a mobile network a card programming request to the server 3512. The server 3512 provides the requested new information modules, which may be downloaded to or via server 3512 from the Internet site that has simulated programmable cards. The server 3512 transmits the new information modules via a mobile network to the telephone 3510 The telephone, in turn, transmits the requested new information modules in a format suitable for use by card 3502. Upon completion of the card programming, the card 3502 transmits a confirmation of completion of card programming to the telephone 3510. A card programming confirmation is displayed on the telephone display, designated by reference number 3514 (FIG. 35C).

Reference is now made to FIG. 45C, which is a simplified generalized information flow diagram illustration of operation of the selectable functionality mobile communication system of FIGS. 35D and 35E. As seen in FIG. 45C, which corresponds to FIG. 35E, in response to a user's pressing on the “PICTURE” button 3560, a image select information module is transmitted from the card 3502 to the telephone 3550, causing the telephone to pull from card 3502, an image information module containing the selected image.

The card 3502 transmits visual information containing the selected image in a format suitable for use by telephone 3550, such as enabling the display of the image and further transmission of the image.

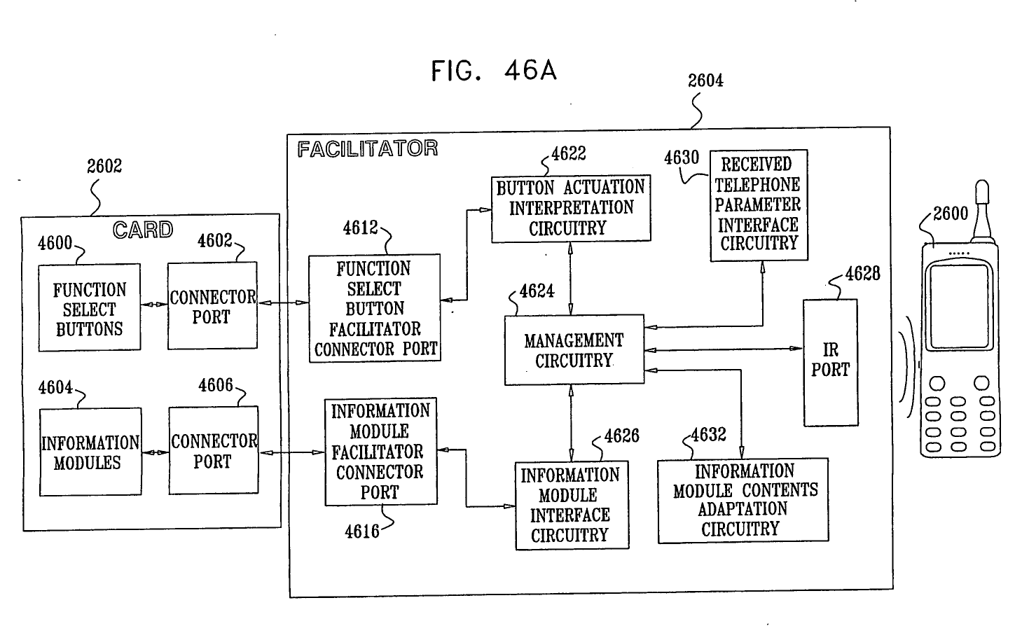

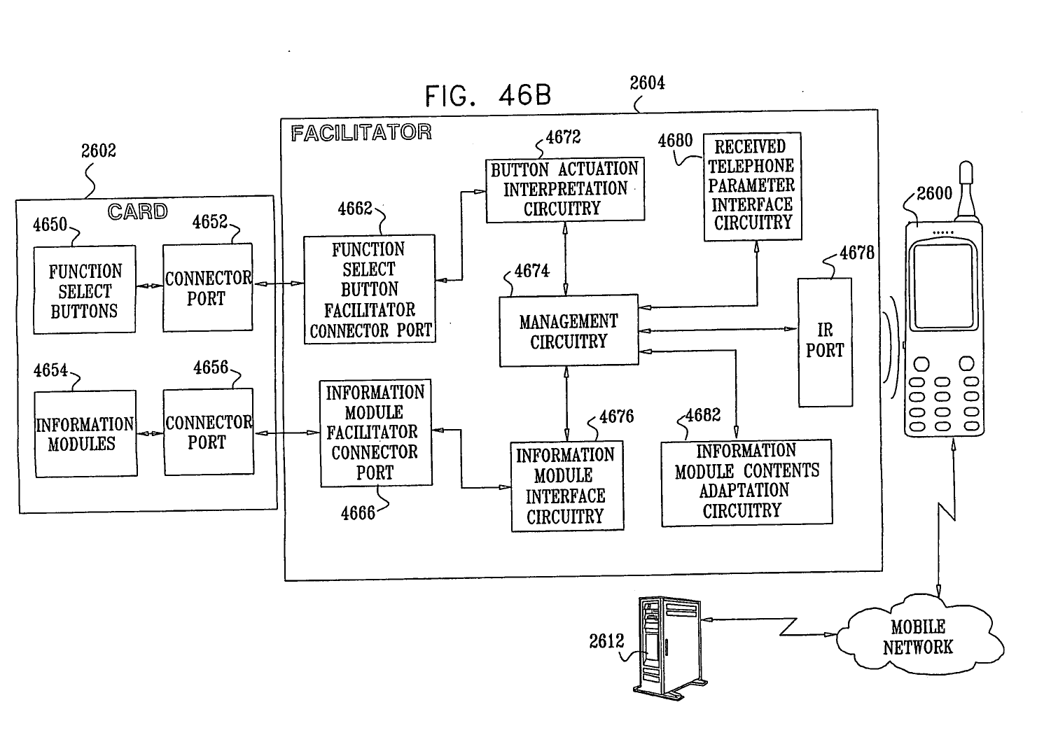

Reference is now made to FIG. 46A, which is a simplified generalized functional block diagram illustration of operation of the selectable functionality mobile communication system of FIGS. 26A, 26B and 36A. As seen in FIG. 46A, which corresponds to FIG. 26B, card 2602 preferably comprises function select buttons 4600 which communicate with a connector port 4602 and a plurality of information modules 4604, which separately communicate with a connector port 4606.

Facilitator 2604 correspondingly includes a function select button facilitator connector port 4612 and an information module facilitator connector port 4616. Port 4612 communicates with connector port 4602 on card 2602 and with button actuation interpretation circuitry 4622, which in turn communicates with management circuitry 4624. A preferred functionality of facilitator 2604 is for management circuitry 4624 to intermittently trigger button actuation interpretation circuitry 4622 to intermittently inquire as to whether any button has been actuated. In practice, where electrical connections between the function select buttons 4600 and the connector port 4602 in the card 2602 are arranged in a matrix, this may be achieved by applying voltage to one or more of the electrical contacts in connector port 4602 and sensing the voltage on one or more other electrical contacts in connector port 4602, thereby indicating which button was actuated. Button actuation interpretation circuitry 4622 also typically applies long and short duration thresholds to valid button actuation When a valid button actuation takes place, button actuation interpretation circuitry 4622 informs management circuitry 4624 of the identity of the actuated button. Management circuitry 4624, in turn, instructs information module interface circuitry 4626 to retrieve a corresponding information module from information modules 4604 in card 2602, via ports 4606 and 4616. The retrieved information module is typically decompressed and appropriately formatted by information module interface circuitry 4626, which typically also verifies authenticity of the card 2602.

Management circuitry 4624 communicates with telephone 2600 via an IR port 4628 and requests and receives information relating to specific telephone parameters, which affect the form of information uploaded to the telephone. Management circuitry 4624 communicates the received specific telephone parameters to received telephone parameter interface circuitry 4630, which employs the received specific telephone parameters to provide instructions for adaptation of the contents of the retrieved information module to the given telephone.

Circuitry 4630 preferably outputs to management circuitry 4624, which provides appropriate instructions to information module contents adaptation circuitry 4632, enabling circuitry 4632 to adapt the contents of the retrieved information module for upload to specific telephone 2600.

The output of circuitry 4632 is supplied to management circuitry 4624 which uploads it to telephone 2600 via IR port 4628.

In the embodiment of FIGS. 26A, 26B and 36A, actuation of the button 2606 causes a selected ringtone to be uploaded to the telephone 2600.

Reference is now made to FIG. 46B, which is a simplified generalized functional block diagram illustration of operation of the selectable functionality mobile communication system of FIGS. 26A, 26C, 26D, 36B and 36C. As seen in FIG. 46B, which corresponds to FIGS. 26C & 26D, card 2602 preferably comprises function select buttons 4650 which communicate with a connector port 4652 and a plurality of information modules 4654, which separately communicate with a connector port 4656.

Facilitator 2604 correspondingly includes a function select button facilitator connector port 4662 and an information module facilitator connector port 4666. Port 4662 communicates with connector port 4652 on card 2602 and with button actuation interpretation circuitry 4672, which in turn communicates with management circuitry 4674. A preferred functionality of facilitator 2604 is for management circuitry 4674 to intermittently trigger button actuation interpretation circuitry 4672 to intermittently inquire as to whether any button has been actuated. In practice, where electrical connections between the function select buttons 4650 and the connector port 4652 in the card 2602 are arranged in a matrix, this may be achieved by applying voltage to one or more of the electrical contacts in connector port 4652 and sensing the voltage on one or more other electrical contacts in connector port 4652, thereby indicating which button was actuated. Button actuation interpretation circuitry 4672 also typically applies long and short duration thresholds to valid button actuation.

When a valid button actuation takes place, button actuation interpretation circuitry 4672 informs management circuitry 4674 of the identity of the actuated button. Management circuitry 4674, in turn, instructs information module interface circuitry 4676 to retrieve a corresponding information module from information modules 4654 in card 2602, via ports 4656 and 4666. The retrieved information module is typically decompressed and appropriately formatted by information module interface circuitry 4676, which typically also verifies authenticity of the card 2602.

Management circuitry 4674 communicates with telephone 2600 via an IR port 4678 and requests and receives information relating to specific telephone parameters which affect the form of information uploaded to the telephone. Management circuitry 4674 communicates the received specific telephone parameters to received telephone parameter interface circuitry 4680, which employs the received specific telephone parameters to provide instructions for adaptation of the contents of the retrieved information module to the given telephone. Circuitry 4680 preferably outputs to management circuitry 4674, which provides appropriate instructions to information module contents adaptation circuitry 4682, enabling circuitry 4682 to adapt the contents of the retrieved information module for upload to specific telephone 2600 in the form of a request to be communicated via the telephone 2600 to a remote server 2662.The request is intended to cause the remote server 2612 to download content to telephone 2600. The output of circuitry 4682 is supplied to management circuitry 4674, which uploads it to telephone 2600 via IR port 4678.

In the embodiment of FIGS. 26A, 26C and 36B, actuation of the button 2614 causes a selected video clip to be downloaded to the telephone 2600 from remote server 2612.

In the embodiment of FIGS. 26A & 26D and 261C, actuation of the button 2620 causes selected sports information clip to be downloaded to the telephone 2600 from remote server 2612.

It is a particular feature of this embodiment of the present invention that only a relatively small amount of information need be stored in an information module on the card 2602 in order to produce download of a potentially large amount of information from a remote server. It is appreciated that the content to be downloaded to the telephone from the remote server may thus be dynamic and need not even exist at the time that the card is distributed to users.

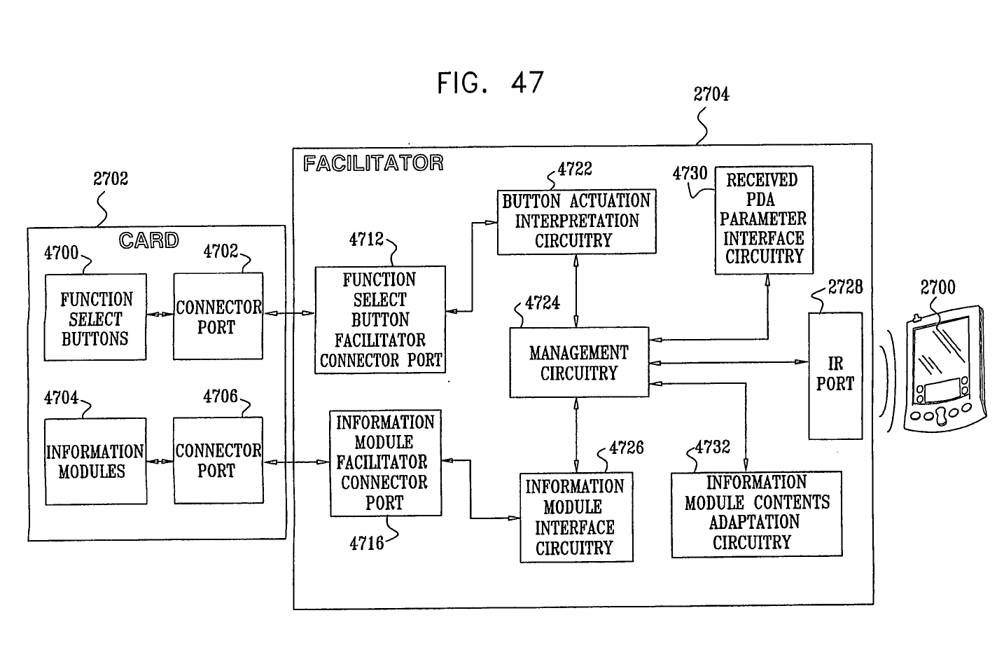

Reference is now made to FIG. 47, which is a simplified generalized functional block diagram illustration of operation of the selectable functionality mobile communication system of FIGS. 27A & 27B and 37. As seen in FIG. 47, which corresponds to FIG. 27B, card 2702 preferably comprises function select buttons 4700 which communicate with a connector port 4702 and a plurality of information modules 4704, which separately communicate with a connector port 4706.

Facilitator 2704 correspondingly includes a function select button facilitator connector port 4712 and an information module facilitator connector port 4716. Port 4712 communicates with connector port 4702 on card 2702 and with button actuation interpretation circuitry 4722, which in turn communicates with management circuitry 4724. A preferred functionality of facilitator 2704 is for management circuitry 4724 to intermittently trigger button actuation interpretation circuitry 4722 to intermittently inquire as to whether any button has been actuated. In practice, where electrical connections between the function select buttons 4700 and the connector port 4702 in the card 2702 are arranged in a matrix, this may be achieved by applying voltage to one or more of the electrical contacts in connector port 4702 and sensing the voltage on one or more other electrical contacts in connector port 4702, thereby indicating which button was actuated. Button actuation interpretation circuitry 4722 also typically applies long and short duration thresholds to valid button actuation When a valid button actuation takes place, button actuation interpretation circuitry 4722 informs management circuitry 4724 of the identity of the actuated button. Management circuitry 4724, in turn, instructs information module interface circuitry 4726 to retrieve a corresponding information module from information modules 4704 in card 2702, via ports 4706 and 4716. The retrieved information module is typically decompressed and appropriately formatted by information module interface circuitry 4726, which typically also verifies authenticity of the card 2702.

Management circuitry 4724 communicates with PDA 2700 via an RF port, or a BlueTooth port 4728 and requests and receives information relating to specific PDA parameters which affect the form of information uploaded to the telephone. Management circuitry 4724 communicates the received specific PDA parameters to received telephone parameter interface circuitry 4730, which employs the received specific telephone parameters to provide instructions for adaptation of the contents of the retrieved information module to the given PDA. Circuitry 4730 preferably outputs to management circuitry 4724, which provides appropriate instructions to information module contents adaptation circuitry 4732, enabling circuitry 4732 to adapt the contents of the retrieved information module for upload to specific PDA 2700.

The output of circuitry 4732 is supplied to management circuitry 4724 which uploads it to PDA 2700 via RF port 4728.

In the embodiment of FIGS. 27A & 27B and 37, actuation of the button 2706 causes a selected game to be uploaded to the telephone 2700.

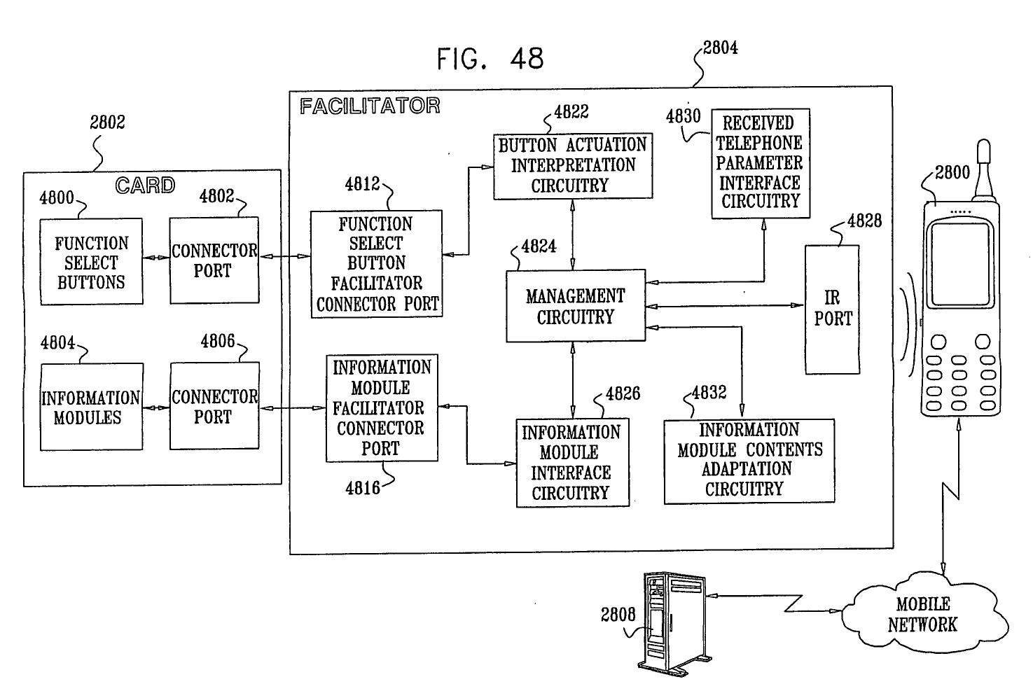

Reference is now made to FIG. 48, which is a simplified generalized functional block diagram illustration of operation of the selectable functionality mobile communication system of FIGS. 28A, 28B,28C,38A &38B. As seen in FIG. 48, which corresponds to FIGS. 28B & 28C, card 2802 preferably comprises function select buttons 4800 which communicate with a connector port 4802 and a plurality of information modules 4804, which separately communicate with a connector port 4806.

Facilitator 2804 correspondingly includes a function select button facilitator connector port 4812 and an information module facilitator connector port 4816. Port 4812 communicates with connector port 4802 on card 2802 and with button actuation interpretation circuitry 4822, which in turn communicates with management circuitry 4824. A preferred functionality of facilitator 2804 is for management circuitry 4824 to intermittently trigger button actuation interpretation circuitry 4822 to intermittently inquire as to whether any button has been actuated. In practice, where electrical connections between the function select buttons 4800 and the connector port 4802 in the card 2802 are arranged in a matrix, this may be achieved by applying voltage to one or more of the electrical contacts in connector port 4802 and sensing the voltage on one or more other electrical contacts in connector port 4802, thereby indicating which button was actuated. Button actuation interpretation circuitry 4822 also typically applies long and short duration thresholds to valid button actuation

When a valid button actuation takes place, button actuation interpretation circuitry 4822 informs management circuitry 4824 of the identity of the actuated button. Management circuitry 4824, in turn, instructs information module interface circuitry 4826 to retrieve a corresponding information module from information modules 4804 in card 2802, via ports 4806 and 4816. The retrieved information module is typically decompressed and appropriately formatted by information module interface circuitry 4826, which typically also verifies authenticity of the card 2802.

Management circuitry 4824 communicates with telephone 2800 via a wired connection 4828 and requests and receives information relating to specific telephone parameters which affect the form of information uploaded to the telephone. Management circuitry 4824 communicates the received specific telephone parameters to received telephone parameter interface circuitry 4830, which employs the received specific telephone parameters to provide instructions for adaptation of the contents of the retrieved information module to the given telephone. Circuitry 4830 preferably outputs to management circuitry 4824, which provides appropriate instructions to information module contents adaptation circuitry 4832, enabling circuitry 4832 to adapt the contents of the retrieved information module for upload to specific telephone 2800 in the form of a request to be communicated via the telephone 2800 to a remote server 2808 The request is intended to cause the remote server 2808 to download content to telephone 2800. The output of circuitry 4832 is supplied to management circuitry 4824 which uploads it to telephone 2800 via wired connection 4828.

In the embodiment of FIGS. 28A, 28B and 38A, actuation of the button 2806 causes a selected image to be downloaded to the telephone 2800 from remote server 2808.

In the embodiment of FIGS. 28A, 28C and 38B, actuation of the button 2812 causes information to be downloaded to the telephone 2800 from remote server 2808.

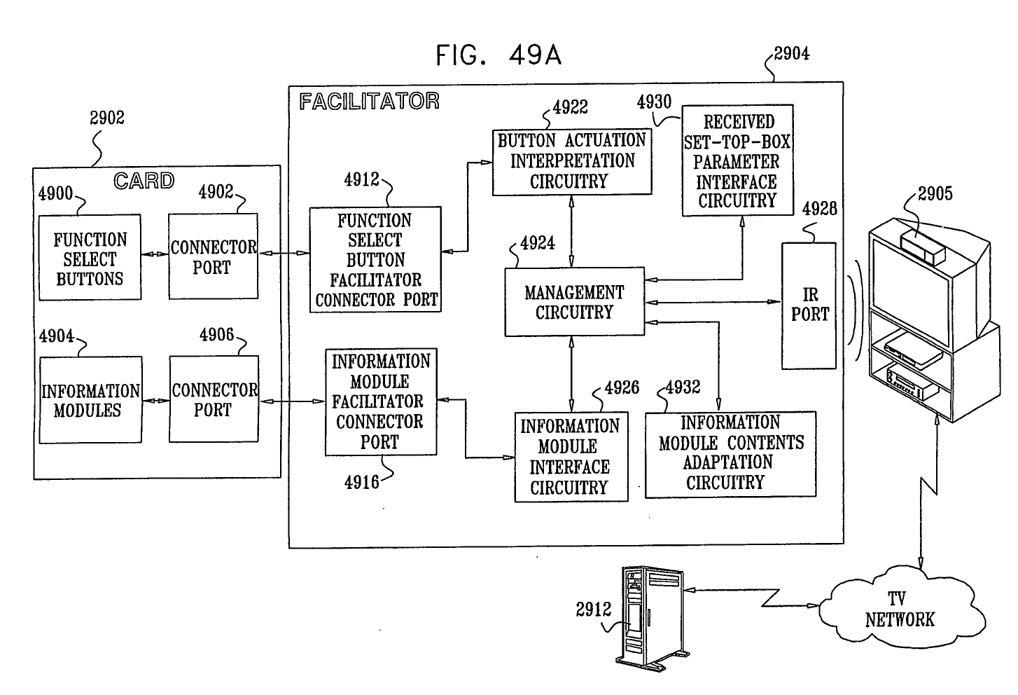

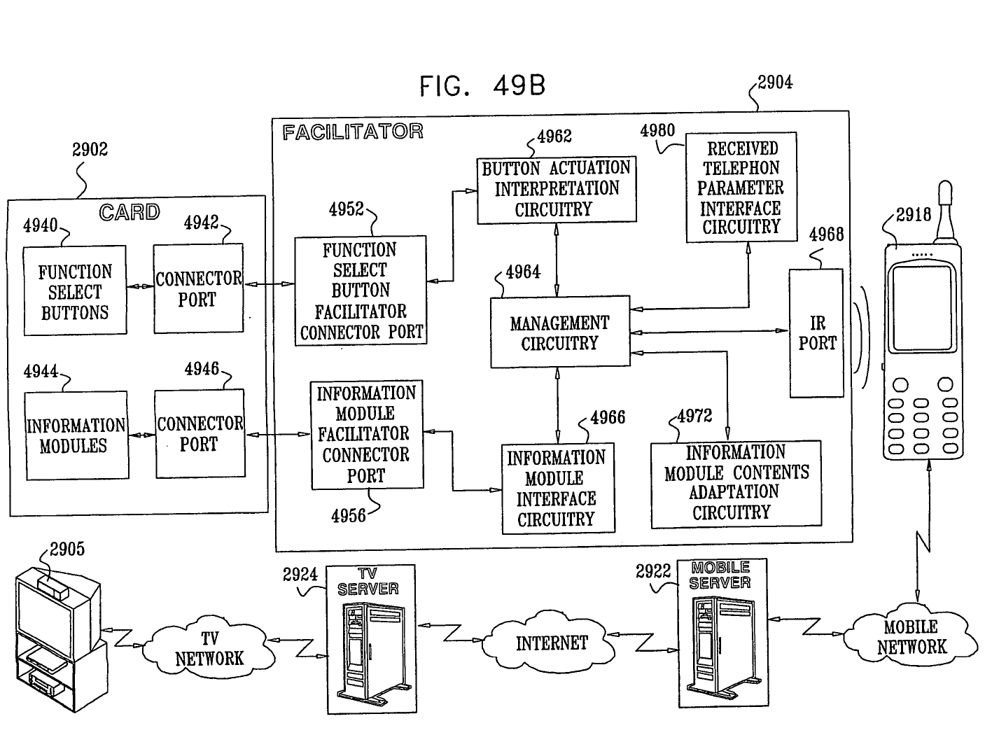

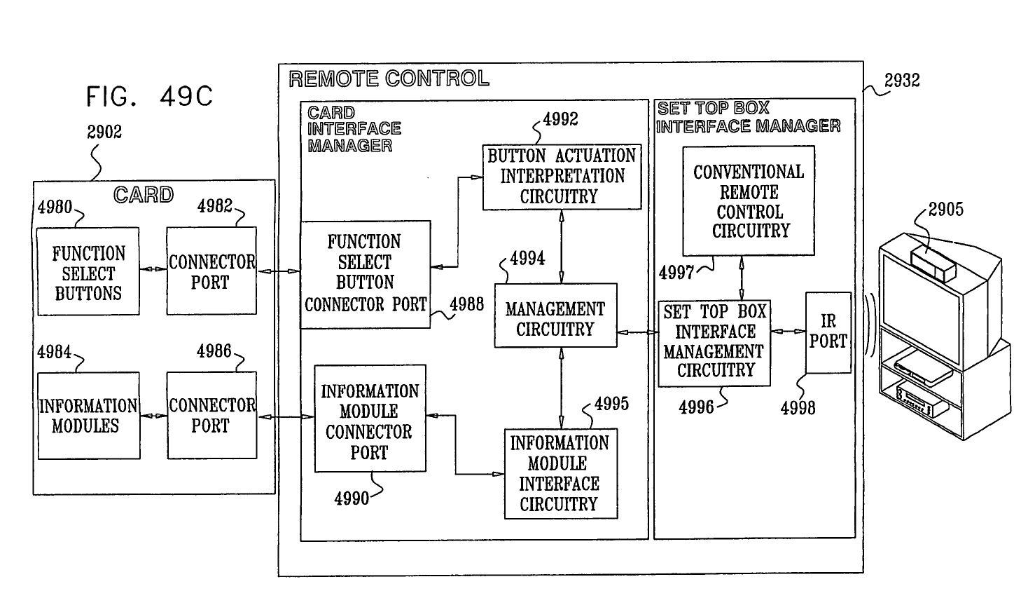

Reference is now made to FIG. 49A, which is a simplified generalized functional block diagram illustration of operation of the selectable functionality mobile communication system of FIGS. 29A, 29B, & 39A. As seen in FIG. 49A, which corresponds to FIG. 29B, card 2902 preferably comprises function select buttons 4900 which communicate with a connector port 4902 and a plurality of information modules 4904, which separately communicate with a connector port 4906.

Facilitator 2904 correspondingly includes a function select button facilitator connector port 4912 and an information module facilitator connector port 4916. Port 4912 communicates with connector port 4902 on card 2902 and with button actuation interpretation circuitry 4922, which in turn communicates with management circuitry 4924. A preferred functionality of facilitator 2904 is for management circuitry 4924 to intermittently trigger button actuation interpretation circuitry 4922 to intermittently inquire as to whether any button has been actuated. In practice, where electrical connections between the function select buttons 4900 and the connector port 4902 in the card 2902 are arranged in a matrix, this may be achieved by applying voltage to one or more of the electrical contacts in connector port 4902 and sensing the voltage on one or more other electrical contacts in connector port 4902, thereby indicating which button was actuated. Button actuation interpretation circuitry 4922 also typically applies long and short duration thresholds to valid button actuation.

When a valid button actuation takes place, button actuation interpretation circuitry 4922 informs management circuitry 4924 of the identity of the actuated button. Management circuitry 4924, in turn, instructs information module interface circuitry 4926 to retrieve a corresponding information module from information modules 4904 in card 2902, via ports 4906 and 4916. The retrieved information module is typically decompressed and appropriately formatted by information module interface circuitry 4926, which typically also verifies authenticity of the card 2902.

Management circuitry 4924 communicates with set top box 2905 via an IR port 4928 and requests and receives information relating to specific set top box parameters which affect the form of information uploaded to the set top box. Management circuitry 4924 communicates the received specific set top box parameters to received set top box parameter interface circuitry 4930, which employs the received specific set top box parameters to provide instructions for adaptation of the contents of the retrieved information module to the given set top box. Circuitry 4930 preferably outputs to management circuitry 4924, which provides appropriate instructions to information module contents adaptation circuitry 4932, enabling circuitry 4932 to adapt the contents of the retrieved information module for upload to specific set top box 2905 in the form of a request to be communicated via the set top box 2905 to a remote server 2912. The request is intended to cause the remote server 2912 to download content to set top box 2905. The output of circuitry 4932 is supplied to management circuitry 4924, which uploads it to set top box 2905 via IR or RF port 4928.

In the embodiment of FIGS. 29A & 29B and 39A, actuation of the button 2906 causes a selected video clip to be displayed on the television screen, via the set top box 2905 from remote server 2912.

In the embodiment of FIGS. 29A & 29B and 39A, actuation of the button 2910 causes a selected video clip purchase order to be placed, via the set top box 2905 from remote server 2912.

Reference is now made to FIG. 49B, which is a simplified generalized functional block diagram illustration of operation of the selectable functionality mobile communication system of FIGS. 29A, 29C & 39B. As seen in FIG. 49B, which corresponds to FIG. 29C, card 2902 preferably comprises function select buttons 4940 which communicate with a connector port 4942 and a plurality of information modules 4944, which separately communicate with a connector port 4946.

Facilitator 2904 correspondingly includes a function select button facilitator connector port 4952 and an information module facilitator connector port 4946. Port 4952 communicates with connector port 4942 on card 2902 and with button actuation interpretation circuitry 4962, which in turn communicates with management circuitry 4964. A preferred functionality of facilitator 2904 is for management circuitry 4964 to intermittently trigger button actuation interpretation circuitry 4962 to intermittently inquire as to whether any button has been actuated. In practice, where electrical connections between the function select buttons 4940 and the connector port 4942 in the card 2902 are arranged in a matrix, this may be achieved by applying voltage to one or more of the electrical contacts in connector port 4942 and sensing the voltage on one or more other electrical contacts in connector port 4942, thereby indicating which button was actuated. Button actuation interpretation circuitry 4962 also typically applies long and short duration thresholds to valid button actuation When a valid button actuation takes place, button actuation interpretation circuitry 4962 informs management circuitry 4964 of the identity of the actuated button. Management circuitry 4964, in turn, instructs information module interface circuitry 4966 to retrieve a corresponding information module from information modules 4944 in card 2902, via ports 4946 and 4956. The retrieved information module is typically decompressed and appropriately formatted by information module interface circuitry 4966, which typically also verifies authenticity of the card 2902.

Management circuitry 4964 communicates with telephone 2918 via an IR port 4968 and requests and receives information relating to specific telephone parameters which affect the form of information uploaded to the set top box. Management circuitry 4964 communicates the received specific telephone parameters to received telephone parameter interface circuitry 4970, which employs the received specific telephone parameters to provide instructions for adaptation of the contents of the retrieved information module to the given telephone. Circuitry 4970 preferably outputs to management circuitry 4964, which provides appropriate instructions to information module contents adaptation circuitry 4972, enabling circuitry 4972 to adapt the contents of the retrieved information module for upload to specific telephone 2918 in the form of a request to be communicated via telephone to a remote server 2922. The request is intended to cause the remote server 2922 to download content to the telephone 2918. The output of circuitry 4972 is supplied to management circuitry 4964 which uploads it to the telephone 2918 via IR or RF port 4968.

In the embodiment of FIGS. 29A & 29C and 39B, actuation of the button 2920 causes a selected video CD purchase order to be placed and a confirmation of the purchase order to be displayed on the television screen, via the set top box 2905 which communicates with a TV server 2924 that receives the information from a telephone 2918,via a mobile server 2922.

Reference is now made to FIG. 49C, which is a simplified generalized functional block diagram illustration of operation of the selectable functionality mobile communication system of FIGS. 29D, 29E & 39C. As seen in FIG. 49C, which corresponds to FIGS. 29D and 29E, card 2902 preferably comprises function select buttons 4980 which communicate with a connector port 4982 and a plurality of information modules 4984, which separately communicate with a connector port 4986.

Remote control 2932 correspondingly includes a function select button connector port 4988 and an information module facilitator connector port 4990. Port 4988 communicates with connector port 4986 on card 2902 and with button actuation interpretation circuitry 4992, which in turn communicates with management circuitry 4994. A preferred functionality of the remote control 2932 is for management circuitry 4994 to intermittently trigger button actuation interpretation circuitry 4992 to intermittently inquire as to whether any button has been actuated.

In practice, where electrical connections between the function select buttons 4900 and the connector port 4902 in the card 2902 are arranged in a matrix, this may be achieved by applying voltage to one or more of the electrical contacts in connector port 4982 and sensing the voltage oh one or more other electrical contacts in connector port 4982, thereby indicating which button was actuated. Button actuation interpretation circuitry 4992 also typically applies long and short duration thresholds to valid button actuation.

When a valid button actuation takes place, button actuation interpretation circuitry 4992 informs card management circuitry 4994 of the identity of the actuated button. Management circuitry 4994, in turn, instructs information module interface circuitry 4995 to retrieve a corresponding information module from information modules 4984 in card 2902, via ports 4986 and 4990. The retrieved information module is typically decompressed and appropriately formatted by information module interface circuitry 4995, which typically also verifies authenticity of the card 2902.

Management circuitry 4994 of the card interface manager communicates the information containing the information modules with set top box interface manager via set top box management circuitry 4996 on the set top box interface manager. Conventional remote control circuitry 4997 typically also forms part of the set top box interface manager. The information modules received by the set top box interface management circuitry 4996 are transmitted to set top box 2905 via IR transmitter 4998 and cause the set top box to display the music video clip on the display screen 2934. The output of management circuitry 4996 is transmitted to set top box 2905 via IR transmitter 4998.

In the embodiment of FIGS. 29E & 29D and 39B, actuation of the button 2916 causes a selected video clip to be displayed on the television screen 2934, via the set top box 2905.

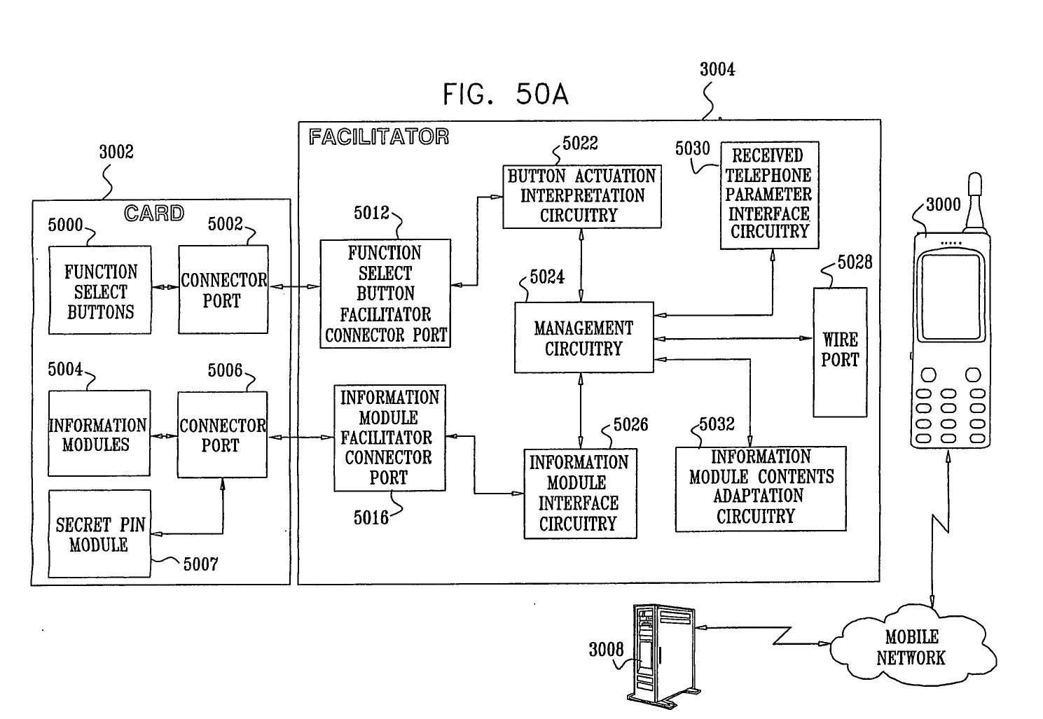

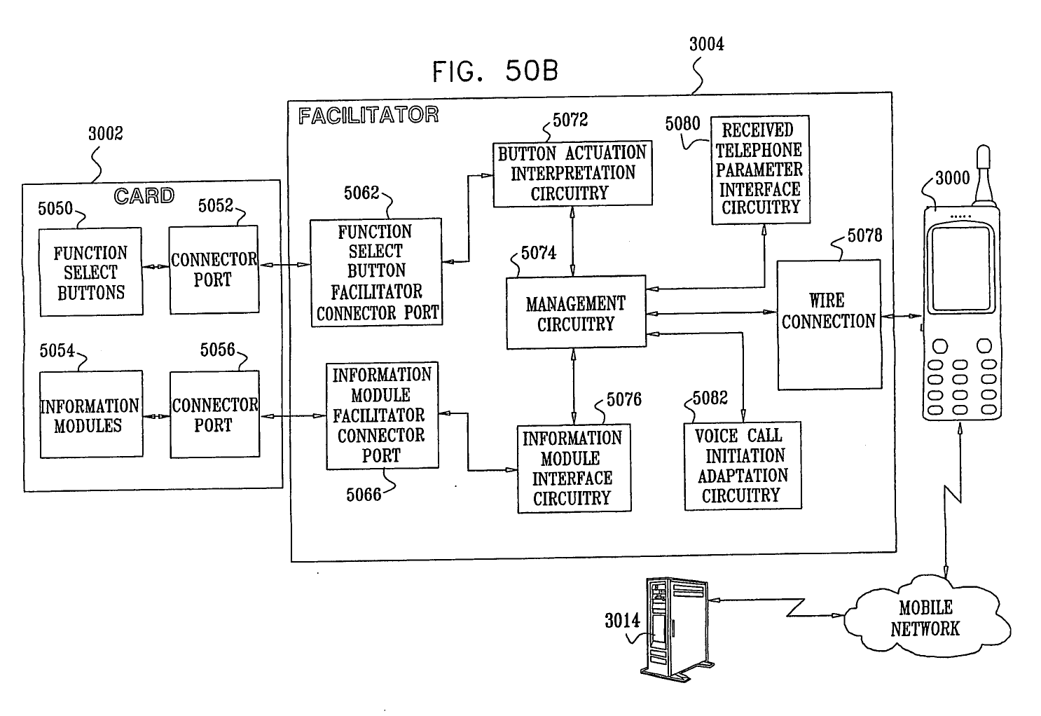

Reference is now made to FIG. 50A, which is a simplified generalized functional block diagram illustration of operation of the selectable functionality mobile communication system of FIGS. 30A, 30B& 40A. As seen in FIG. 50A, which corresponds to FIGS. 30B, card 3002 preferably comprises function select buttons 5000 which communicate with a connector port 5002, a plurality of information modules 5004, which separately communicate with a connector port 5006 and a secret PIN module 5007 which communicates with the connector port 5006.

Facilitator 3004 correspondingly includes a function select button facilitator connector port 5012 and an information module facilitator connector port 5016. Port 5012 communicates with connector port 5002 on card 3002 and with button actuation interpretation circuitry 5022, which in turn communicates with management circuitry 5024. A preferred functionality of facilitator 3004 is for management circuitry 5024 to intermittently trigger button actuation interpretation circuitry 5022 to intermittently inquire as to whether any button has been actuated. In practice, where electrical connections between the function select buttons 5000 and the connector port 5002 in the card 3002 are arranged in a matrix, this may be achieved by applying voltage to one or more of the electrical contacts in connector port 5002 and sensing the voltage on one or more other electrical contacts in connector port 5002, thereby indicating which button was actuated. Button actuation interpretation circuitry 5022 also typically applies long and short duration thresholds to valid button actuation When a valid button actuation takes place, button actuation interpretation circuitry 5022 informs management circuitry 5024 of the identity of the actuated button. Management circuitry 5024, in turn, instructs information module interface circuitry 5026 to retrieve a corresponding information module from information modules 5004 in card 3002, via ports 5006 and 5016. The retrieved information module is typically decompressed and appropriately formatted by information module interface circuitry 5026, which typically also verifies authenticity of the card 3002.

Management circuitry 5024 communicates with telephone 3000 via a wired connection 5028 and requests and receives information relating to specific telephone parameters which affect the form of information uploaded to the telephone. Management circuitry 5024 communicates the received specific telephone parameters to received telephone parameter interface circuitry 5030, which employs the received specific telephone parameters to provide instructions for adaptation of the contents of the retrieved information module to the given telephone. Circuitry 5030 preferably outputs to management circuitry 5024, which provides appropriate instructions to information module contents adaptation circuitry 5032, enabling circuitry 5032 to adapt the contents of the retrieved information module for upload to specific telephone 3000 in the form of a request to be communicated via the telephone 3000 to a remote server 3008. The request is intended to cause the remote server 3008 to download content to telephone 3000. The output of circuitry 5032 is supplied to management circuitry 5024 which uploads it to telephone 3000 via wired connection 5028.

In the embodiment of FIGS. 30A & 30B and 40A, actuation of the button 3006 causes a balance increase in a prepaid account and a confirmation to be displayed on the telephone screen.

Reference is now made to FIG. 50B, which is a simplified generalized functional block diagram illustration of operation of the selectable functionality mobile communication system of FIGS. 30A, 30C& 40B. As seen in FIG. 50B, which corresponds to FIGS. 30C, card 3002 preferably comprises function select buttons 5050 which communicate with a connector port 5052 and a plurality of information modules 5054, which separately communicate with a connector port 5056.

Facilitator 3004 correspondingly includes a function select button facilitator connector port 5062 and an information module facilitator connector port 5066. Port 5062 communicates with connector port 5052 on card 3002 and with button actuation interpretation circuitry 5072, which in turn communicates with management circuitry 5074. A preferred functionality of facilitator 3004 is for management circuitry 5074 to intermittently trigger button actuation interpretation circuitry 5072 to intermittently inquire as to whether any button has been actuated. In practice, where electrical connections between the function select buttons 5050 and the connector port 5052 in the card 3002 are arranged in a matrix, this may be achieved by applying voltage to one or more of the electrical contacts in connector port 5052 and sensing the voltage on one or more other electrical contacts in connector port 5052, thereby indicating which button was actuated. Button actuation interpretation circuitry 5072 also typically applies long and short duration thresholds to valid button actuation.

When a valid button actuation takes place, button actuation interpretation circuitry 5072 informs management circuitry 5074 of the identity of the actuated button. Management circuitry 5074, in turn, instructs information module interface circuitry 5076 to retrieve a corresponding information module from information modules 5054 in card 3002, via ports 5056 and 5066. The retrieved information module is typically decompressed and appropriately formatted by information module interface circuitry 5076, which typically also verifies authenticity of the card 3002.

Management circuitry 5074 communicates with telephone 3000 via a wired connection 5078 and requests and receives information relating to specific telephone parameters which affect the form of information uploaded to the telephone. Management circuitry 5074 communicates the received specific telephone parameters to received telephone parameter interface circuitry 5080, which employs the received specific telephone parameters to provide instructions for adaptation of the contents of the retrieved information module to the given telephone. Circuitry 5080 preferably outputs to management circuitry 5074, which provides appropriate instructions to telephone voice call initiation adaptation circuitry 5082, enabling circuitry 5082 to adapt the contents of the retrieved information module for upload to specific telephone 3000 in the form of a request to be communicated via the telephone 3000 to a remote server 3014. The request is intended to cause the remote server 3014 to download content to telephone 3000. The output of circuitry 5082 is supplied to management circuitry 5074 which uploads it to telephone 3000 via wired connection 5078.

In the embodiment of FIGS. 30A & 30B and 40A, actuation of the button 3012 causes a telephone voice call to be placed from telephone 3000, via remote server 3014.

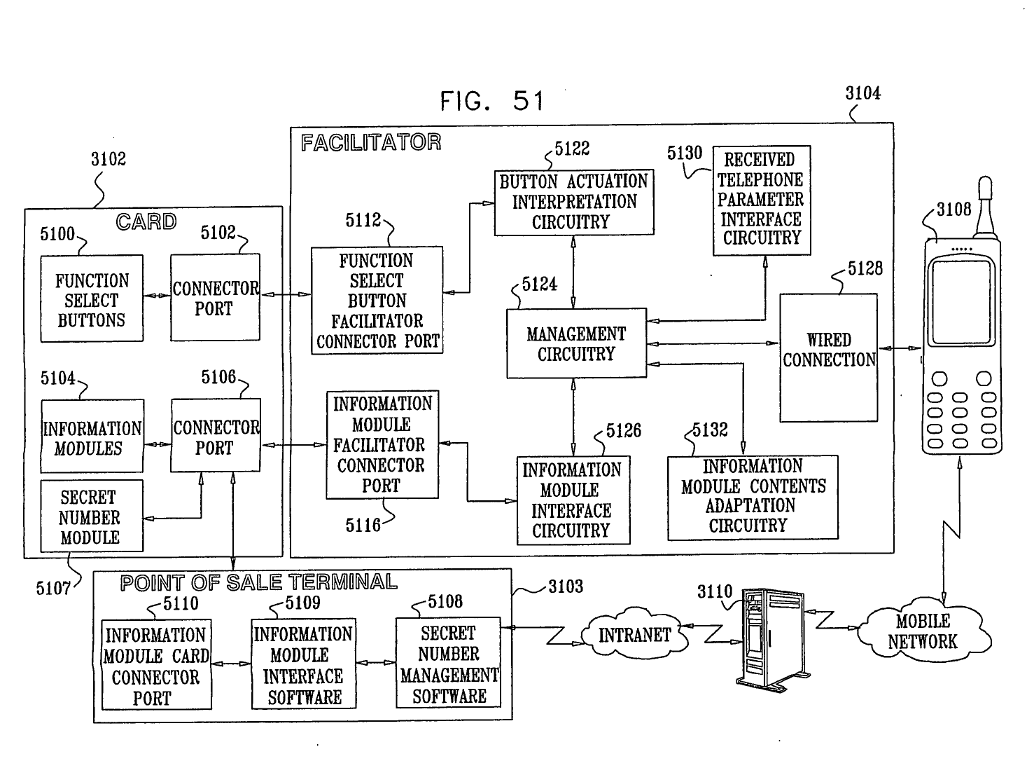

Reference is now made to FIG. 51, which is a simplified generalized functional block diagram illustration of operation of the selectable functionality mobile communication system of FIGS. 31A, 31B, 41A& 41B. As seen in FIG. 51, which corresponds to FIGS. 41A & 41B, card 3102 preferably comprises function select buttons 5100 which communicate with a connector port 5102, a plurality of information modules 5104, a connector port 5106 and a secret number module 5107, which separately communicate with connector port 5106.

Point-of-sale terminal 3103 correspondingly comprises secret number management software 5108 which communicate with information module interface software 5109 which communicate, in turn, with a information module card connector port 5110. Information module card connector port 5110 communicates with connector port 5106 on card 3102.

Facilitator 3104 correspondingly includes a function select button facilitator connector port 5112 and an information module facilitator connector port 5116. Port 5112 communicates with connector port 5102 on card 3102 and with button actuation interpretation circuitry 5122, which in turn communicates with management circuitry 5124. A preferred functionality of facilitator 3104 is for management circuitry 5124 to intermittently trigger button actuation interpretation circuitry 5122 to intermittently inquire as to whether any button has been actuated. In practice, where electrical connections between the function select buttons 5100 and the connector port 5102 in the card 3102 are arranged in a matrix, this may be achieved by applying voltage to one or more of the electrical contacts in connector port 5102 and sensing the voltage on one or more other electrical contacts in connector port 5102, thereby indicating which button was actuated. Button actuation interpretation circuitry 5122 also typically applies long and short duration thresholds to valid button actuation.

When a valid button actuation takes place, button actuation interpretation circuitry 5122 informs management circuitry 5124 of the identity of the actuated button. Management circuitry 5124, in turn, instructs information module interface circuitry 5126 to retrieve a corresponding information module from information modules 5104 in card 3102, via ports 5106 and 5116. The retrieved information module is typically decompressed and appropriately formatted by information module interface circuitry 5126, which typically also verifies authenticity of the card 3102.

Management circuitry 5124 communicates with telephone 3108 via wired port 5128 and requests and receives information relating to specific telephone parameters which affect the form of information uploaded to the telephone. Management circuitry 5124 communicates the received specific telephone parameters to received telephone parameter interface circuitry 5130, which employs the received specific telephone parameters to provide instructions for adaptation of the contents of the retrieved information module to the given telephone. Circuitry 5130 preferably outputs to management circuitry 5124, which provides appropriate instructions to information module contents adaptation circuitry 5132, enabling circuitry 5132 to adapt the contents of the retrieved information module for upload to specific telephone 3108 in the form of a request to be communicated via the telephone 3108 to remote server 3110. The request is intended to cause the remote server 3110 to issue the request and display request results on the telephone screen 3112 (FIG. 3 1B). The output of circuitry 5132 is supplied to management circuitry 5124 which uploads it to telephone 3108 via wired port 5128.

In the embodiment of FIGS. 31A & 31B and 41B, actuation of the button 3106 enables entrance to a lottery game, causes the lottery results to be displayed on the telephone screen 3112 and causes the point-of-sale 3103 to activate a new secret lottery number at the remote server 3110.

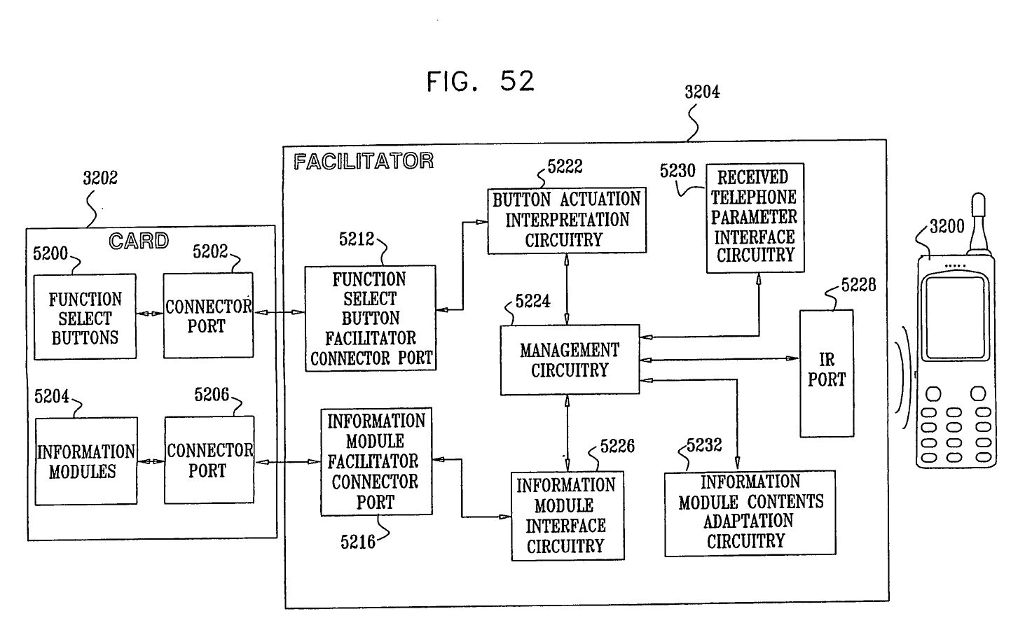

Reference is now made to FIG. 52 which is a simplified generalized functional block diagram illustration of operation of the selectable functionality mobile communication system of FIGS. 32A, 32B, 32C and 42A&42B. As seen in FIG. 52, which corresponds to FIG. 32B&32C, card 3202 preferably comprises function select buttons 5200 which communicate with a connector port 5202 and a plurality of information modules 5204, which separately communicate with a connector port 5206.

Facilitator 3204 correspondingly includes a function select button facilitator connector port 5212 and an information module facilitator connector port 5216. Port 5212 communicates with connector port 5202 on card 3202 and with button actuation interpretation circuitry 5222, which in turn communicates with management circuitry 5224. A preferred functionality of facilitator 3204 is for management circuitry 5224 to intermittently trigger button actuation interpretation circuitry 5222 to intermittently inquire as to whether any button has been actuated. In practice, where electrical connections between the function select buttons 5200 and the connector port 5202 in the card 3202 are arranged in a matrix, this may be achieved by applying voltage to one or more of the electrical contacts in connector port 5202 and sensing the voltage on one or more other electrical contacts in connector port 5202, thereby indicating which button was actuated. Button actuation interpretation circuitry 5222 also typically applies long and short duration thresholds to valid button actuation When a valid button actuation takes place, button actuation interpretation circuitry 5222 informs management circuitry 5224 of the identity of the actuated button. Management circuitry 5224, in turn, instructs information module interface circuitry 5226 to retrieve a corresponding information module from information modules 5204 in card 3202, via ports 5206 and 5216. The retrieved information module is typically decompressed and appropriately formatted by information module interface circuitry 5226, which typically also verifies authenticity of the card 3202.

Management circuitry 5224 communicates with telephone 3200 via an IR port 5228 and requests and receives information relating to specific telephone parameters which affect the form of information uploaded to the telephone. Management circuitry 5224 communicates the received specific telephone parameters to received telephone parameter interface circuitry 5230, which employs the received specific telephone parameters to provide instructions for adaptation of the contents of the retrieved information module to the given telephone. Circuitry 5230 preferably outputs to management circuitry 5224, which provides appropriate instructions to information module contents adaptation circuitry 5232, enabling circuitry 5232 to adapt the contents of the retrieved information module for upload to specific telephone 3200.

The output of circuitry 5232 is supplied to management circuitry 5224 which uploads it to telephone 3200 via IR port 5228.

In the embodiment of FIGS. 32A & 32B and 42A, actuation of the button 3206 causes a selected phone software upgrade to be uploaded to the telephone 3200.

In the embodiment of FIGS. 32A & 32C and 42B, actuation of the button 3210 causes a selected facilitator software upgrade to be uploaded to the facilitator 3204.

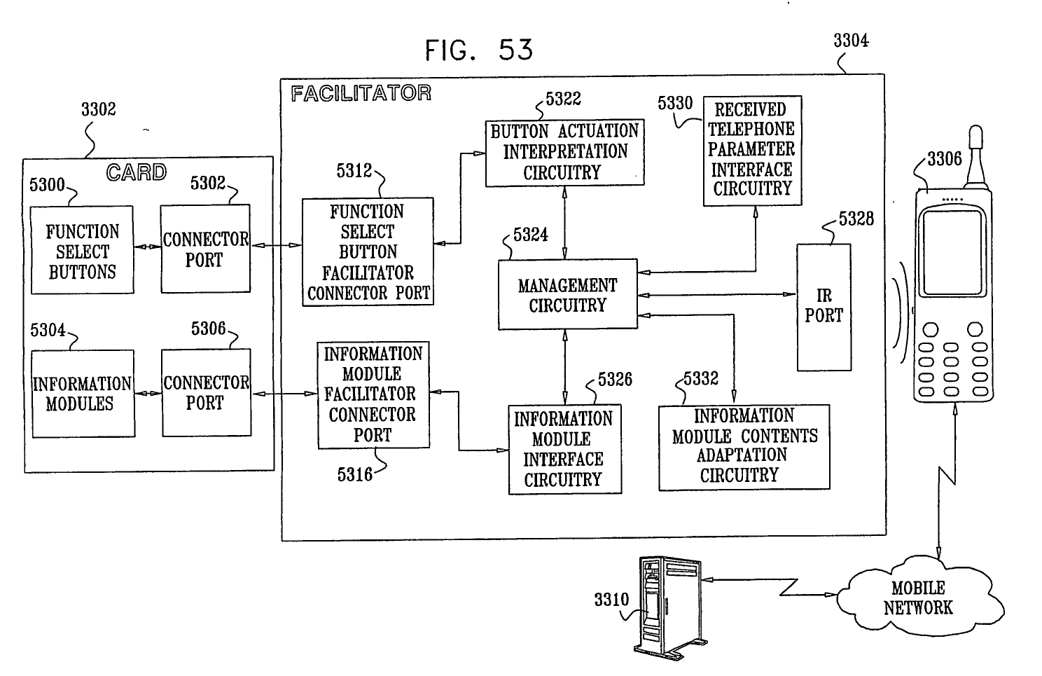

Reference is now made to FIG. 53A, which is a simplified generalized functional block diagram illustration of operation of the selectable functionality mobile communication system of FIGS. 33A, 33B and 43. As seen in FIG. 53B, which corresponds to FIG. 33B, card 3302 preferably comprises function select buttons 5300 which communicate with a connector port 5302 and a plurality of information modules 5304, which separately communicate with a connector port 5306.

Facilitator 3304 correspondingly includes a function select button facilitator connector port 5312 and an information module facilitator connector port 5316. Port 5312 communicates with connector port 5302 on card 3302 and with button actuation interpretation circuitry 5322, which in turn communicates with management circuitry 5324. A preferred functionality of facilitator 3304 is for management circuitry 5324 to intermittently trigger button actuation interpretation circuitry 5322 to intermittently inquire as to whether any button has been actuated. In practice, where electrical connections between the function select buttons 5300 and the connector port 5302 in the card 3302 are arranged in a matrix, this may be achieved by applying voltage to one or more of the electrical contacts in connector port 5302 and sensing the voltage on one or more other electrical contacts in connector port 5302, thereby indicating which button was actuated. Button actuation interpretation circuitry 5322 also typically applies long and short duration thresholds to valid button actuation.

When a valid button actuation takes place, button actuation interpretation circuitry 5322 informs management circuitry 5324 of the identity of the actuated button. Management circuitry 5324, in turn, instructs information module interface circuitry 5326 to retrieve a corresponding information module from information modules 5304 in card 3302, via ports 5306 and 5316. The retrieved information module is typically decompressed and appropriately formatted by information module interface circuitry 5326, which typically also verifies authenticity of the card 3302.

Management circuitry 5324 communicates with telephone 3306 via an IR port 5328 and requests and receives information relating to specific telephone parameters which affect the form of information uploaded to the telephone. Management circuitry 5324 communicates the received specific telephone parameters to received telephone parameter interface circuitry 5330, which employs the received specific telephone parameters to provide instructions for adaptation of the contents of the retrieved information module to the given telephone. Circuitry 5330 preferably outputs to management circuitry 5324, which provides appropriate instructions to information module contents adaptation circuitry 5332, enabling circuitry 5332 to adapt the contents of the retrieved information module for upload to specific telephone 3306 in the form of a request to be communicated via the telephone 3306 to a remote server 331 0.The request is intended to cause the remote server 3310 to download content to telephone 3306. The output of circuitry 5332 is supplied to management circuitry 5324 which uploads it to telephone 3306 via IR port 5328.

In the embodiment of FIGS. 33A & 33B and 43, actuation of the button 3308 causes facilitator software upgrade to be downloaded from remote server 3310.

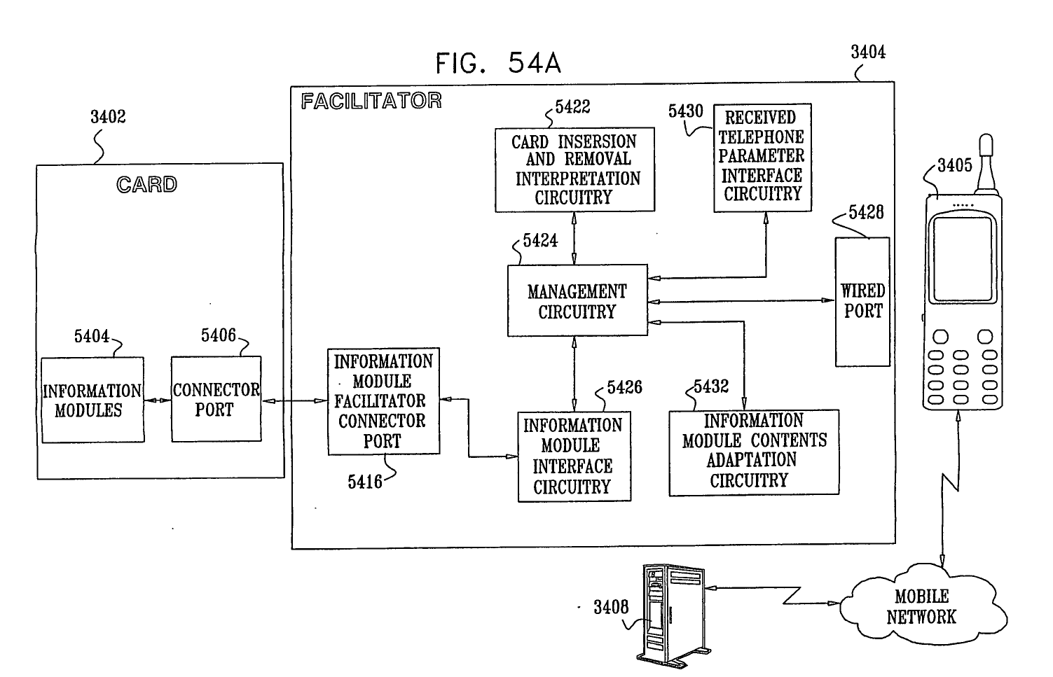

Reference is now made to FIG. 54A, which is a simplified generalized functional block diagram illustration of operation of the selectable functionality mobile communication system of FIGS. 34A, 34B and 44A. As seen in FIG. 54A, which corresponds to FIG. 34B, card 3402 preferably comprises a plurality of information modules 5404, which separately communicate with a connector port 5406.

Facilitator 3404 correspondingly includes an information module facilitator connector port 5416. Card insertion and removal interpretation circuitry 5422 communicates with management circuitry 5424. A preferred functionality of facilitator 3404 is for management circuitry 5424 to intermittently trigger card insertion and removal interpretation circuitry 5422 to intermittently inquire as to whether any card has been inserted or removed. Card insertion and removal interpretation circuitry 5422 also typically applies long and short duration thresholds to valid button actuation When a the card is inserted, card insertion and removal interpretation circuitry 5422 informs management circuitry 5424 of the identity of the inserted card. Management circuitry 5424, in turn, instructs information module interface circuitry 5426 to retrieve a corresponding information module from information modules 5404 in card 3402, via ports 5406 and 5416. The retrieved information module is typically decompressed and appropriately formatted by information module interface circuitry 5426, which typically also verifies authenticity of the card 3402.

Management circuitry 5424 communicates with telephone 3405 via a wired port 5428 and requests and receives information relating to specific telephone parameters which affect the form of information uploaded to the telephone. Management circuitry 5424 communicates the received specific telephone parameters to received telephone parameter interface circuitry 5430, which employs the received specific telephone parameters to provide instructions for adaptation of the contents of the retrieved information module to the given telephone. Circuitry 5430 preferably outputs to management circuitry 5424, which provides appropriate instructions to information module contents adaptation circuitry 5432, enabling circuitry 5432 to adapt the contents of the retrieved information module for upload to specific telephone 3404 in the form of a request to be communicated via the telephone 3405 to a remote server 3408.The request is intended to cause the remote server 3408 to download content to telephone 3408. The output of circuitry 5432 is supplied to management circuitry 5424 which uploads it to telephone 3404 via IR port 5428.

In the embodiment of FIGS. 34A & 34B and 44A, insertion of card 3402 causes a game to be downloaded from remote server 3408 to telephone 3405.

Reference is now made to FIG. 54B, which is a simplified generalized functional block diagram illustration of operation of the selectable functionality mobile communication system of FIGS. 34A, 34C, 34D and 44B. As seen in FIG. 54B, which corresponds to FIG. 34C and 34D, card 3422 preferably comprises a plurality of information modules 5454, which separately communicate with a connector port 5456.

Facilitator 3424 correspondingly includes an information module facilitator connector port 5466. Function select buttons interpretation circuitry 5472 communicates with management circuitry 5474. A preferred functionality of facilitator 3424 is for management circuitry 5474 to intermittently trigger function select buttons 5472 to intermittently inquire as to whether any card has been inserted or removed. Function select buttons 5472 also typically applies long and short duration thresholds to valid button actuation.

When a valid button actuation takes place, button actuation interpretation circuitry 5472 informs management circuitry 5474 of the identity of the actuated button. Management circuitry 5474, in turn, instructs information module interface circuitry 5476 to retrieve a corresponding information module from information modules 5454 in card 3422, via ports 5456 and 5466. The retrieved information module is typically decompressed and appropriately formatted by information module interface circuitry 5476, which typically also verifies authenticity of the card 3422.

Management circuitry 5474 communicates with telephone 3405 via a wired port 5478 and requests and receives information relating to specific telephone parameters which affect the form of information uploaded to the telephone. Management circuitry 5474 communicates the received specific telephone parameters to received telephone parameter interface circuitry 5480, which employs the received specific telephone parameters to provide instructions for adaptation of the contents of the retrieved information module to the given telephone. Circuitry 5480 preferably outputs to management circuitry 5474, which provides appropriate instructions to information module contents adaptation circuitry 5482, enabling circuitry 5482 to adapt the contents of the retrieved information module for upload to specific telephone 3424 in the form of a request to be communicated via the telephone 3405 to a remote server 3408.The request is intended to cause the remote server 3408 to download content to telephone 3405. The output of circuitry 5482 is supplied to management circuitry 5474 which uploads it to telephone 3405 via IR port 5478. In the present embodiment which comprises a ringer and or a LED, once the telephone is uploaded management circuitry 5474 triggers the ringer circuitry 5490 and or the LED circuitry 5492.

In the embodiment of FIGS. 34A, 34C & 34D and 44B, actuation of the button 3430 causes a game to be downloaded from remote server 3408.

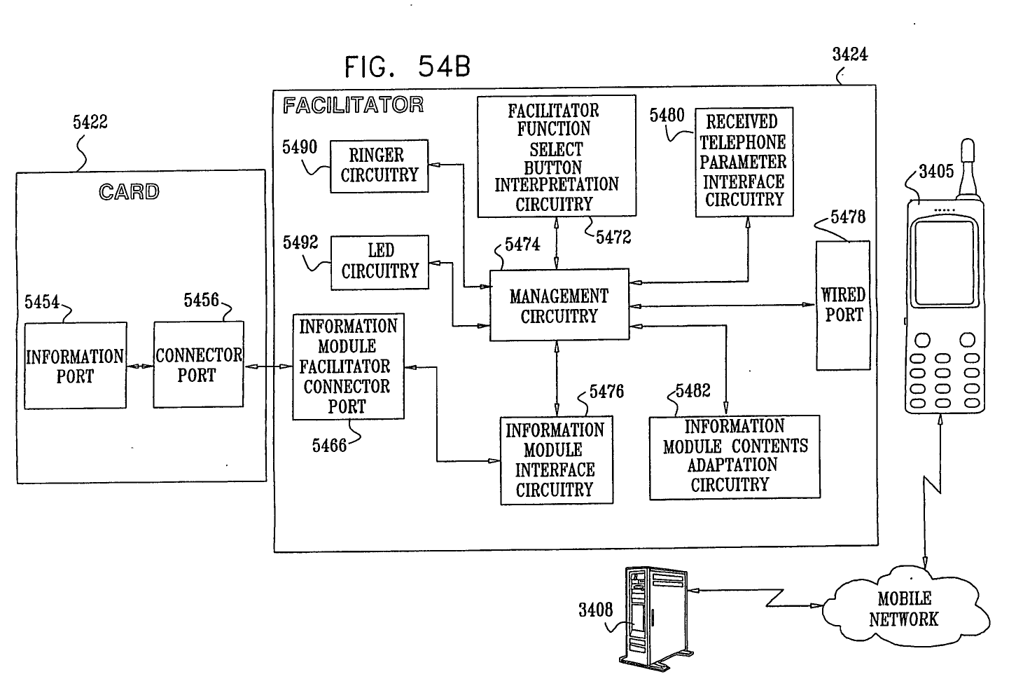

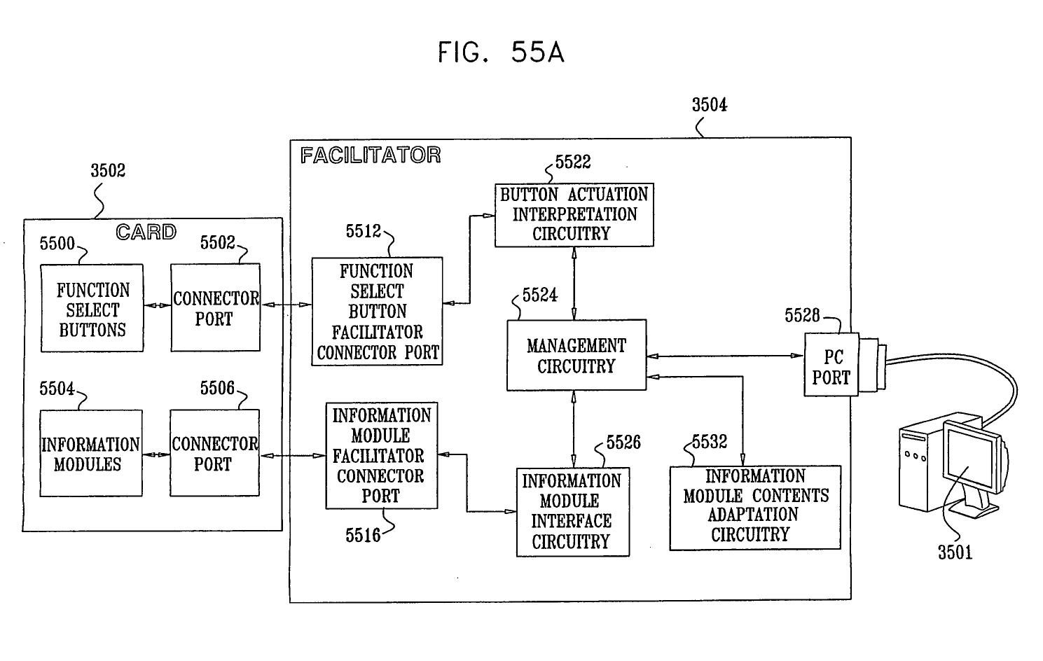

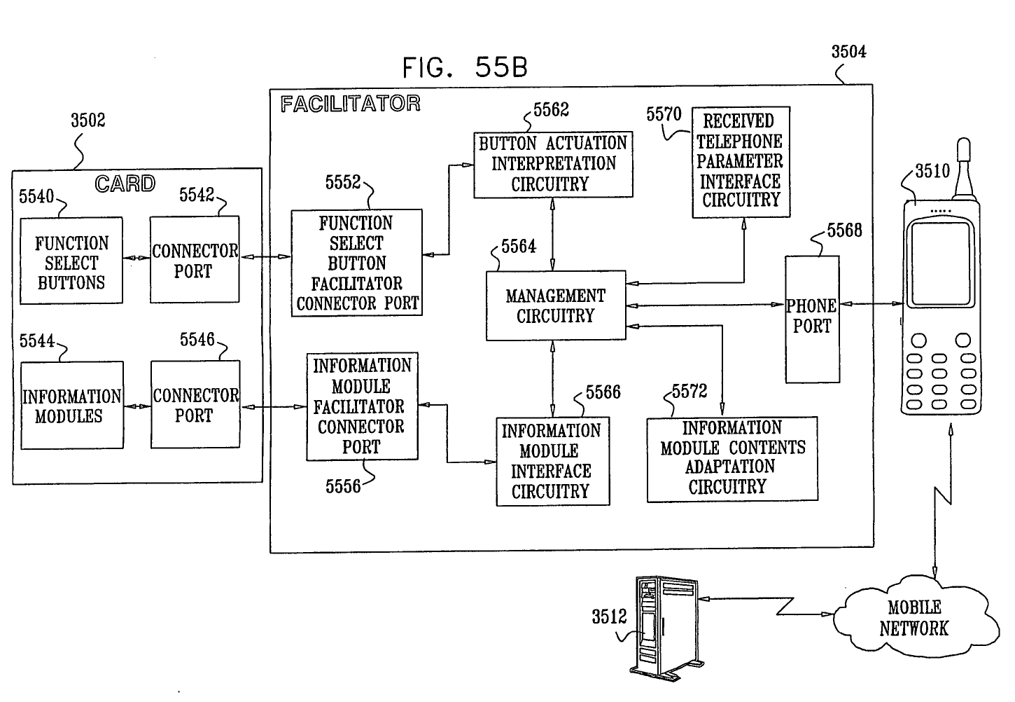

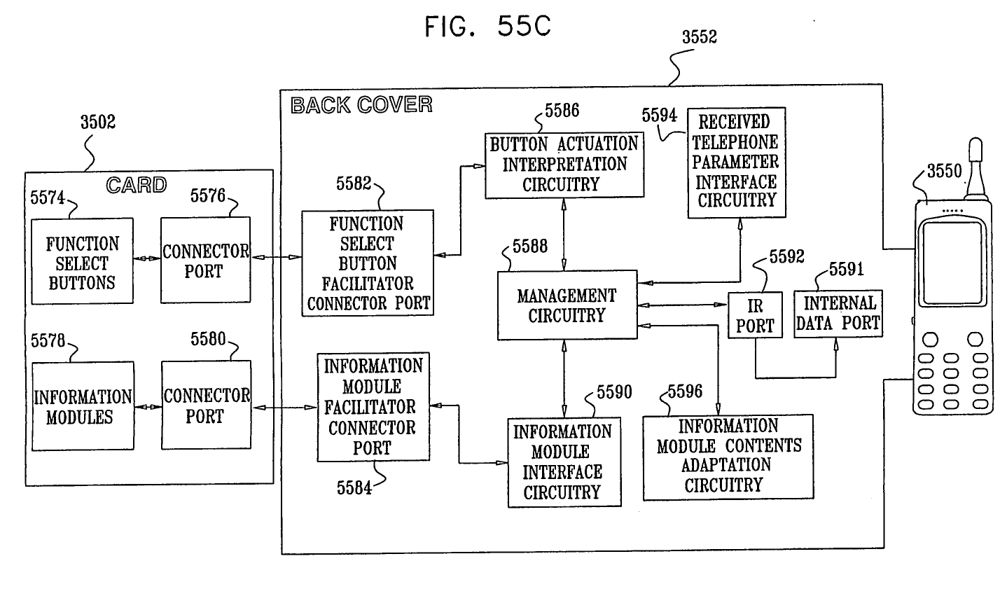

Reference is now made to FIG. 55A, which is a simplified generalized functional block diagram illustration of operation of the selectable functionality mobile communication system of FIGS. 35A, 35B and 45A. As seen in FIG. 55A, which corresponds to FIG. 35B, card 3502 preferably comprises function select buttons 5500 which communicate with a connector port 5502 and a plurality of information modules 5504, which separately communicate with a connector port 5506.

Facilitator 3504 correspondingly includes a function select button facilitator connector port 5512 and an information module facilitator connector port 5516. Port 5512 communicates with connector port 5502 on card 3502 and with button actuation interpretation circuitry 5522, which in turn communicates with management circuitry 5524. A preferred functionality of facilitator 3504 is for management circuitry 5524 to intermittently trigger button actuation interpretation circuitry 5522 to intermittently inquire as to whether any button has been actuated. In practice, where electrical connections between the function select buttons 5500 and the connector port 5502 in the card 3502 are arranged in a matrix, this may be achieved by applying voltage to one or more of the electrical contacts in connector port 5502 and sensing the voltage on one or more other electrical contacts in connector port 5502, thereby indicating which button was actuated. Button actuation interpretation circuitry 5522 also typically applies long and short duration thresholds to valid button actuation When a valid button actuation takes place, button actuation interpretation circuitry 5522 informs management circuitry 5524 of the identity of the actuated button. Management circuitry 5524, in turn, instructs information module interface circuitry 5526 to retrieve a corresponding information module from information modules 5504 in card 3502, via ports 5506 and 5516. The retrieved information module is typically decompressed and appropriately formatted by information module interface circuitry 5526, which typically also verifies authenticity of the card 3502.

Management circuitry 5524, which provides appropriate instructions to information module contents adaptation circuitry 5532, enabling circuitry 5532 to adapt the contents of the retrieved information module for upload to specific PC 3501.

The output of circuitry 5532 is supplied to management circuitry 5524 which uploads it to PC 3501 via PC port 5528.

In the embodiment of FIGS. 35A & 35B and 45A, actuation of the button 3506 causes an information module to be downloaded onto the card 3502.

Reference is now made to FIG. 55B, which is a simplified generalized functional block diagram illustration of operation of the selectable functionality mobile communication system of FIGS. 35A, 35C & 45B. As seen in FIG. 55B, which corresponds to FIGS. 35C, card 3502 preferably comprises function select buttons 5540 which communicate with a connector port 5542 and a plurality of information modules 5544, which separately communicate with a connector port 5546.

Facilitator 3504 correspondingly includes a function select button facilitator connector port 5552 and an information module facilitator connector port 5556. Port 5552 communicates with connector port 5546 on card 3502 and with button actuation interpretation circuitry 5562, which in turn communicates with management circuitry 5564. A preferred functionality of facilitator 3504 is for management circuitry 5564 to intermittently trigger button actuation interpretation circuitry 5562 to intermittently inquire as to whether any button has been actuated. In practice, where electrical connections between the function select buttons 5540 and the connector port 5542 in the card 3502 are arranged in a matrix, this may be achieved by applying voltage to one or more of the electrical contacts in connector port 5542 and sensing the voltage on one or more other electrical contacts in connector port 5542, thereby indicating which button was actuated. Button actuation interpretation circuitry 5552 also typically applies long and short duration thresholds to valid button actuation When a valid button actuation takes place, button actuation interpretation circuitry 5552 informs management circuitry 5564 of the identity of the actuated button. Management circuitry 5564, in turn, instructs information module interface circuitry 5566 to retrieve a corresponding information module from information modules 5504 in card 3502, via ports 5546 and 5556. The retrieved information module is typically decompressed and appropriately formatted by information module interface circuitry 5556, which typically also verifies authenticity of the card 3502.

Management circuitry 5564 communicates with telephone 3510 via a phone port 5568 and requests and receives information relating to specific telephone parameters which affect the form of information uploaded to the telephone. Management circuitry 5564 communicates the received specific telephone parameters to received telephone parameter interface circuitry 5570, which employs the received specific telephone parameters to provide instructions for adaptation of the contents of the retrieved information module to the given telephone. Circuitry 5570 preferably outputs to management circuitry 5564, which provides appropriate instructions to information module contents adaptation circuitry 5572, enabling circuitry 5572 to adapt the contents of the retrieved information module for upload to specific telephone 3510 in the form of a request to be communicated via the telephone 3510 to a remote server 3512. The request is intended to cause the remote server 3512 to download content to telephone 3510. The output of circuitry 5572 is supplied to management circuitry 5564 which uploads it to telephone 3510 via phone port 5568.

In the embodiment of FIGS. 35A & 35C and 45B, actuation of the button 3506 causes an information module to be downloaded to the telephone 3510 from remote server 3512.

Reference is now made to FIG. 55C, which is a simplified generalized functional block diagram illustration of operation of the selectable functionality mobile communication system of FIGS. 35A, 35D,35E & 45C. As seen in FIG. 55C, which corresponds to FIGS. 35E, card 3502 preferably comprises function select buttons 5574 which communicate with a connector port 5576 and a plurality of information modules 5578, which separately communicate with a connector port 5580.

Facilitator incorporated into the back cover 3552 correspondingly includes a function select button facilitator connector port 5582 and an information module facilitator connector port 5584. Port 5582 communicates with connector port 5576 on card 3502 and with button actuation interpretation circuitry 5586, which in turn communicates with management circuitry 5588. A preferred functionality of facilitator in back cover 3552 is for management circuitry 5588 to intermittently trigger button actuation interpretation circuitry 5586 to intermittently inquire as to whether any button has been actuated. In practice, where electrical connections between the function select buttons 5574 and the connector port 5576 in the card 3502 are arranged in a matrix, this may be achieved by applying voltage to one or more of the electrical contacts in connector port 5576 and sensing the voltage on one or more other electrical contacts in connector port 5576, thereby indicating which button was actuated. Button actuation interpretation circuitry 5582 also typically applies long and short duration thresholds to valid button actuation

When a valid button actuation takes place, button actuation interpretation circuitry 5586 informs management circuitry 5588 of the identity of the actuated button. Management circuitry 5588, in turn, instructs information module interface circuitry 5590 to retrieve a corresponding information module from information modules 5576 in card 3502, via ports 5576 and 5584. The retrieved information module is typically decompressed and appropriately formatted by information module interface circuitry 5584, which typically also verifies authenticity of the card 3502.

Management circuitry 5588 communicates with telephone 3550 via an Internal data port 5591 that receives the facilitator information modules from the IR port 5592 and requests and receives information relating to specific telephone parameters which affect the form of information uploaded to the telephone. Management circuitry 5588 communicates the received specific telephone parameters to received telephone parameter interface circuitry 5594, which employs the received specific telephone parameters to provide instructions for adaptation of the contents of the retrieved information module to the given telephone. Circuitry 5594 preferably outputs to management circuitry 5588, which provides appropriate instructions to information module contents adaptation circuitry 5596, enabling circuitry 5596 to adapt the contents of the retrieved information module for upload to specific telephone 3550 in the form of a request to be communicated via the telephone 3550 to download content to telephone 3550.

In the embodiment of FIGS. 35D & 35E and 45C, actuation of the button 3560 causes an information module to be downloaded to the telephone 3550.

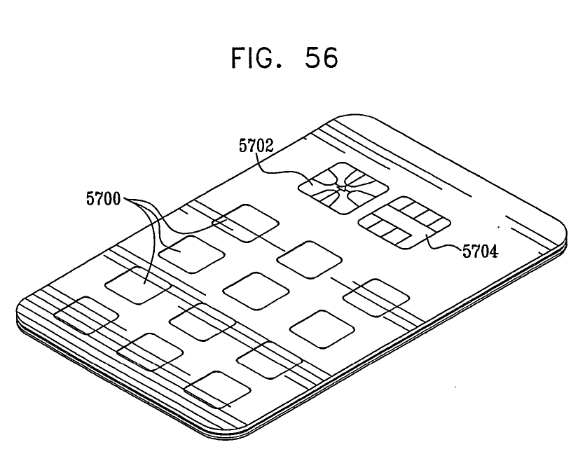

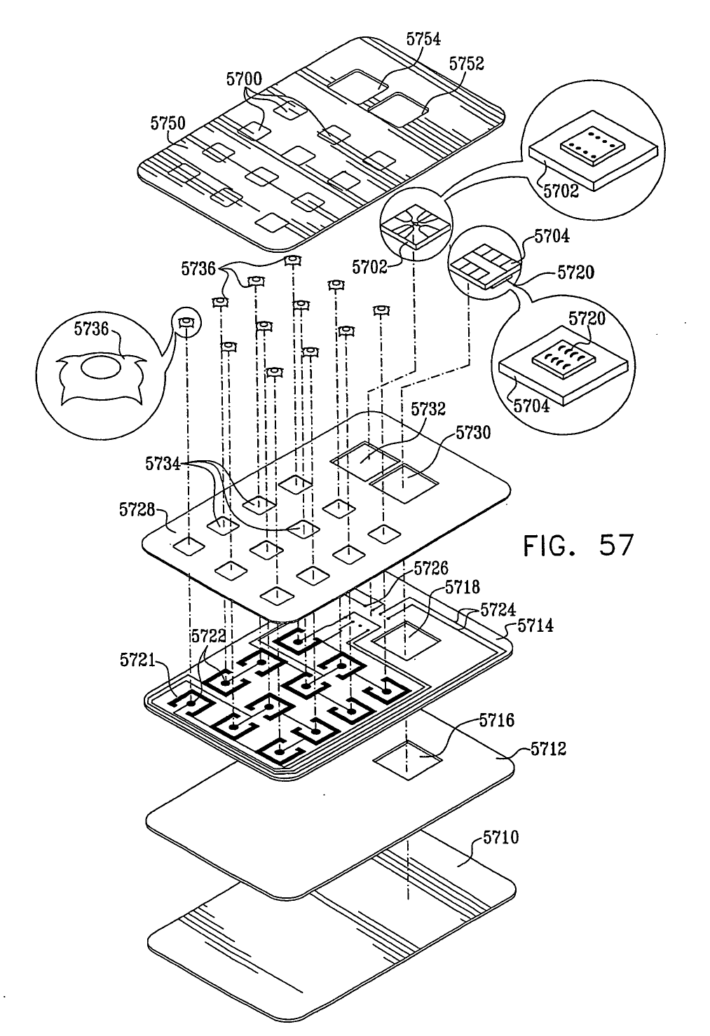

Reference is now made to FIGS. 56 & 57, which are illustrations of a user interface card constructed and operative in accordance with a preferred embodiment of the present invention. As seen in FIGS. 56 and 57, the user interface card is generally characterized in that it includes a number of user-actuable contact locations, preferably in the form of buttons 5700 and a plurality of ports, preferably in the form of a pair of contact assemblies 5702 and 5704.

Turning particularly to FIG. 57, it is seen that a bottom surface is preferably defined by a substrate 5710, preferably formed of transparent polycarbonate. Substrate 5710 is preferably printed on an inside surface thereof to present advertising or other user information on the outside surface thereof Disposed above substrate 5710 there is preferably provided a stiffener layer 5712, preferably formed of PVC, and thereabove a flexible PCB 5714. Both stiffener layer 5712 and PCB 5714 are formed with apertures, respectively designated 5716 and 5718, in order to accommodate a micromodule 5720 which includes contact assembly 5704. Micromodule 5720 preferably is a conventional micromodule such as that commercially available from Atmel Inc. of 2325 Orchard Parkway San Jose, Calif. 95131 under model number AT 24C045C.

PCB 5714 preferably defines the user-actuable contact locations by defining a plurality of perimeter contacts 5721 and a plurality of inner contacts 5722. Each cooperating pair of one perimeter contact 5721 and an inner contact 5722 disposed therewithin defines electrical connections to a single button 5700. A circuit comprising multiple PCB conductors 5724 interconnects the peripheral and inner contacts 5721 and 5722 of each button in a matrix arrangement to preferably seven electrical contact pads 5726.

Disposed over PCB 5714 there is preferably provided a spacer 5728, typically formed of polyester and having an aperture 5730 corresponding in position to apertures 5716 and 5718 and configured to accommodate micromodule 5720. Spacer 5728 also preferably includes an aperture 5732, which is configured to accommodate contact assembly 5702, which is in electrical contact with pads 5726. Spacer 5728 also comprises a plurality of apertures 5734 which overlie perimeter contacts 5721 and inner contacts 5722. Apertures 5734 are each configured to accommodate a conductive button contact 5736, which is operative, while depressed by a finger of a user, to establish electric contact between a perimeter contact 5721 and its corresponding inner contact 5722. Conductive button contacts 5736 are preferably formed as resilient metal domes, which return to their original, non-contact, orientation in the absence of user engagement therewith. Conductive button contacts 5736 provide desired tactile feedback to a user of pressing each given button 5700.

Disposed above spacer 5728 and conductive button contacts 5736 is a top substrate 5750, which is preferably formed of transparent polycarbonate. Top substrate 5750 is preferably printed on an inside surface thereof to present advertising or other user information on the outside surface thereof.

Top substrate 5750 is formed with an aperture 5752 which corresponds in position with apertures 5730, 5718 and 5716 and is somewhat smaller in size than those apertures, such that top substrate 5750 retains micro-module 5720 within the card, while permitting electrical contact with the contact assembly 5704. Top substrate 5750 also includes an aperture 5754, which corresponds in position with aperture 5732 and is somewhat smaller in size than that aperture, such that top substrate 5750 retains contact assembly 5702 within the card, while permitting electrical contact therewith.

Regions of top substrate 5750 which overlie conductive button contacts 5736 are designated as user-actuable contact locations by suitable graphics printing thereon.

The various layers of the card described above are preferably secured together by means of a suitable adhesive, such as double-stick tapes commercially available from 3M.

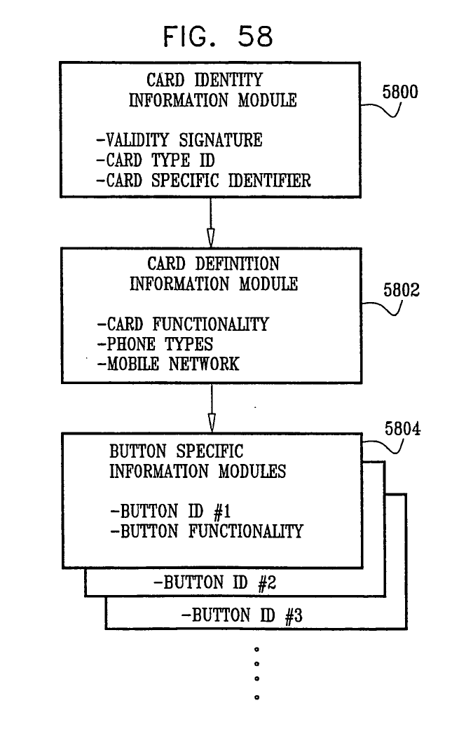

Reference is now made to FIG. 58, which is a diagram illustrating the organization of information in the card of FIGS. 56 & 57. As noted above, information contained in the card of FIGS. 56 & 57 is preferably organized into information modules, which may be read from the card into or through a facilitator and thence to a wireless communicator. FIG. 58 illustrates three types of information modules, it being appreciated that any other suitable number of different types of information modules may be provided.

Initially, upon operative engagement of the card with a facilitator, either automatically or via a button press, a card identity information module 5800 is read from the card. This module preferably contains a non card-specific card validity signature, a card type-specific ID and a protected card-specific identifier. Typically thereafter, a card definition information module 5802 is read. This module preferably contains information regarding card functionalities and possible interfaces, such as lists of types of mobile communicators and mobile networks with which it operates.

The card preferably also includes a plurality of button specific or button combination specific information modules 5804, each of which preferably contains a distinct and complete functionality, such as, for example, a specific ring tone, a video clip and a greeting. The button or button combination specific information modules may contain all data required to enable a mobile communicator to carry out the desired functionality or may contain instructions enabling the facilitator and/or the mobile communicator to download from a remote source some or all of the data required for the indicated functionality.

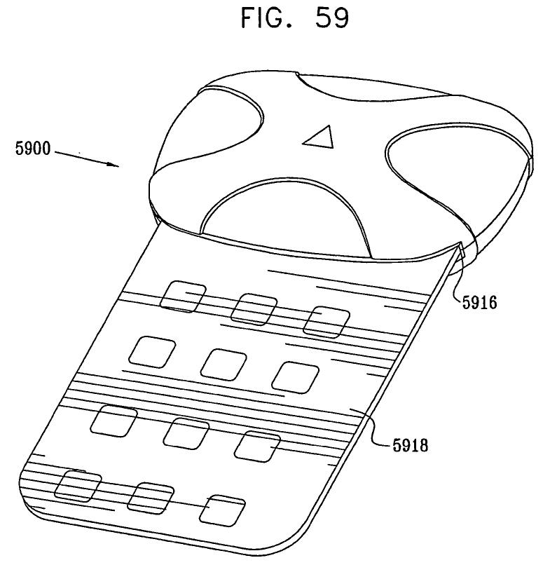

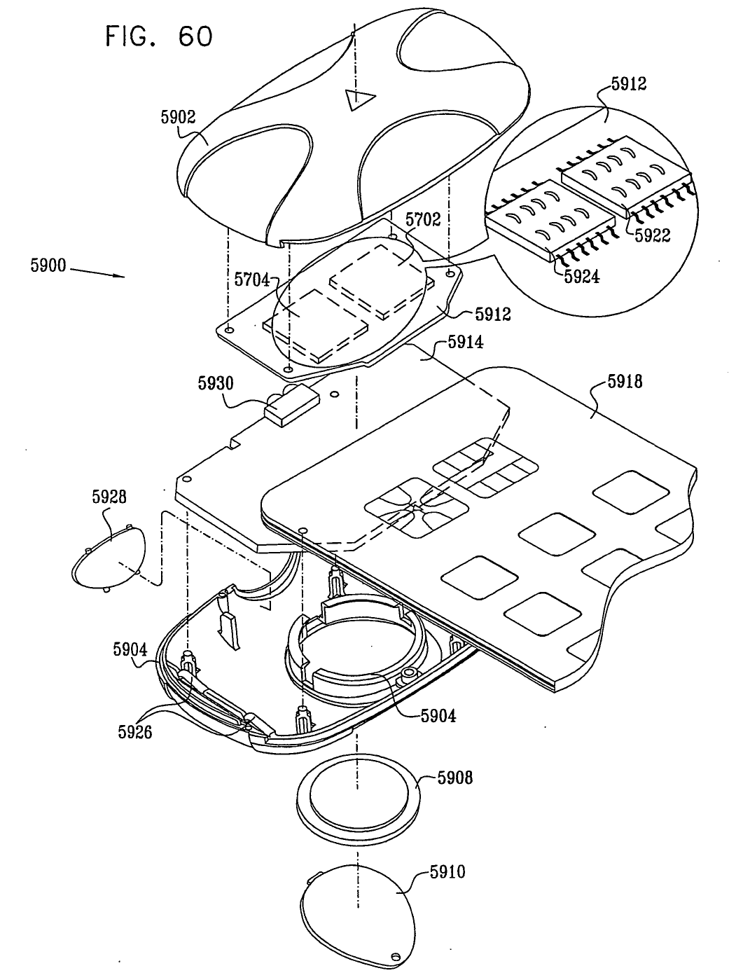

Reference is now made to FIGS. 59 and 60, which are simplified illustrations of a user-interface card intermediary constructed and operative in accordance with a preferred embodiment of the present invention in association with a card of the type described hereinabove. As seen in FIGS. 59 and 60, the intermediary, here shown in the form of a card-receiving facilitator 5900 includes a housing which comprises top and bottom portions 5902 and 5904, typically molded of plastic and ultrasonically welded together. The bottom portion 5902 is formed with a battery receiving recess 5906 in which a conventional disk-type battery 5908 may be retained behind a removable cover 5910.

A pair of spaced PCBs 5912 and 5914 are disposed within the housing and define therebetween a slot 5916 into which a card 5918 may be inserted. When the card 5918 is properly inserted into slot 5916, contact assemblies 5702 and 5704 (FIGS. 56 and 57) of card 5918 are in mechanical and electrical connection with corresponding facilitator contact arrays 5922 and 5924 on PCB 5912. The card 5918, which is typically somewhat wider than PCBs 5912 and 5914 is preferably urged against PCB 5912 by side springs 5926 preferably integrally formed with bottom housing portion 5904. An IR window 5928 is provided between portions of top and bottom housing portions 5902 and 5904 to permit IR communication with an external mobile communicator, by means of an IR transceiver 5930, typically mounted on PCB 5914.

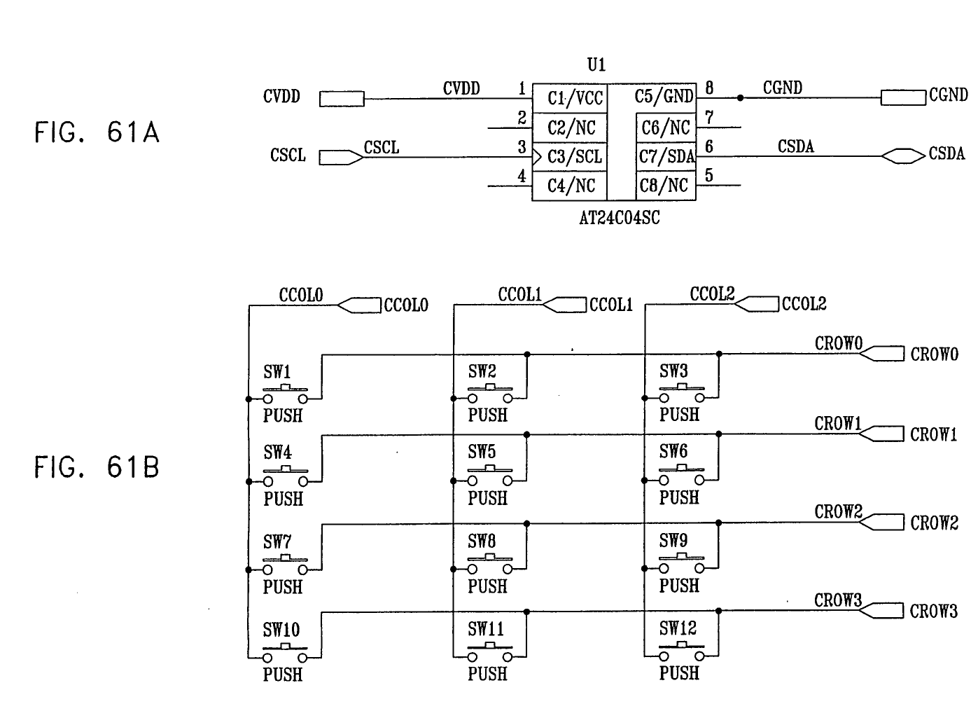

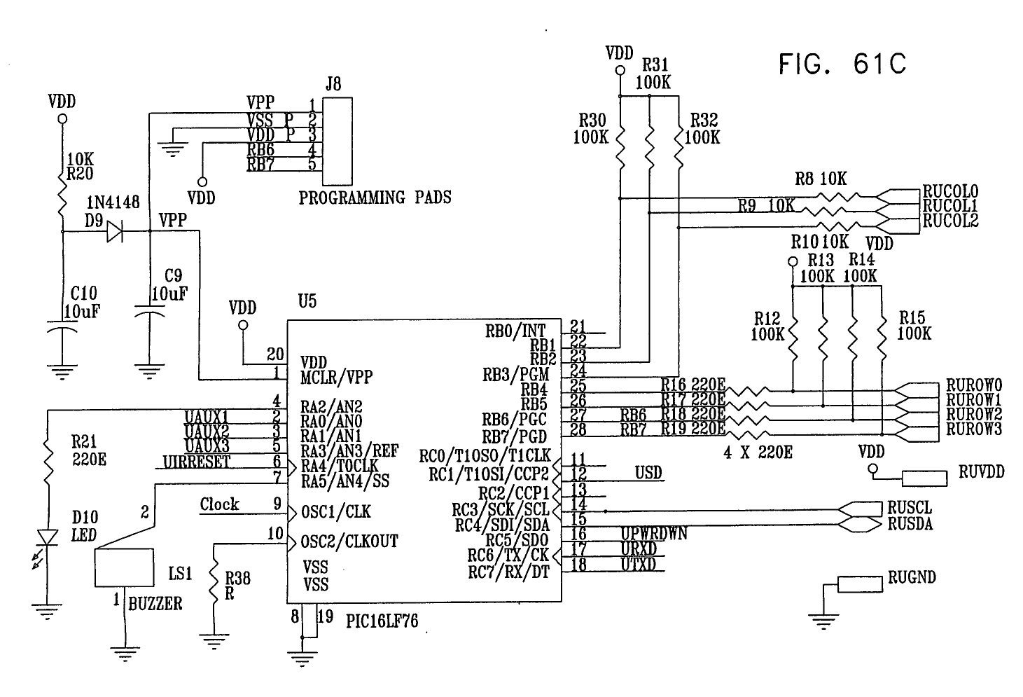

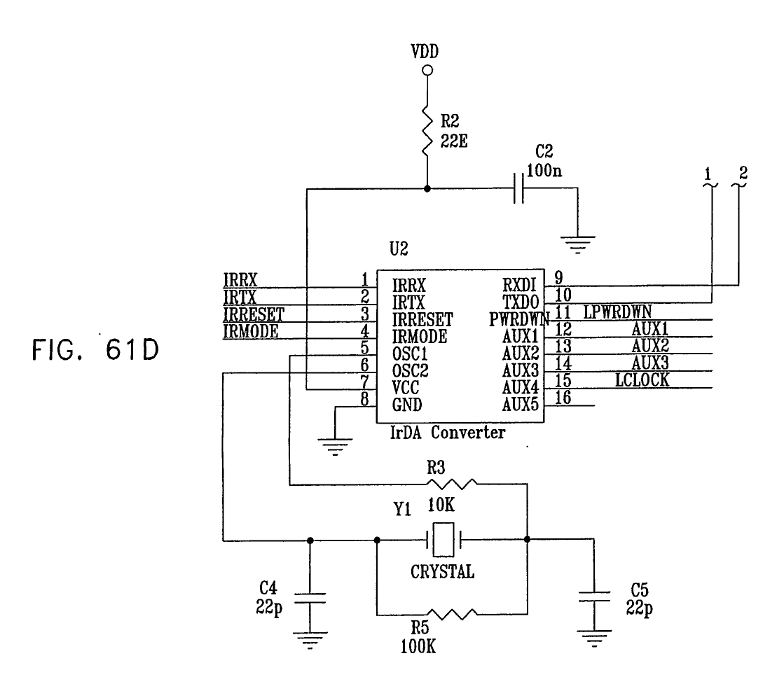

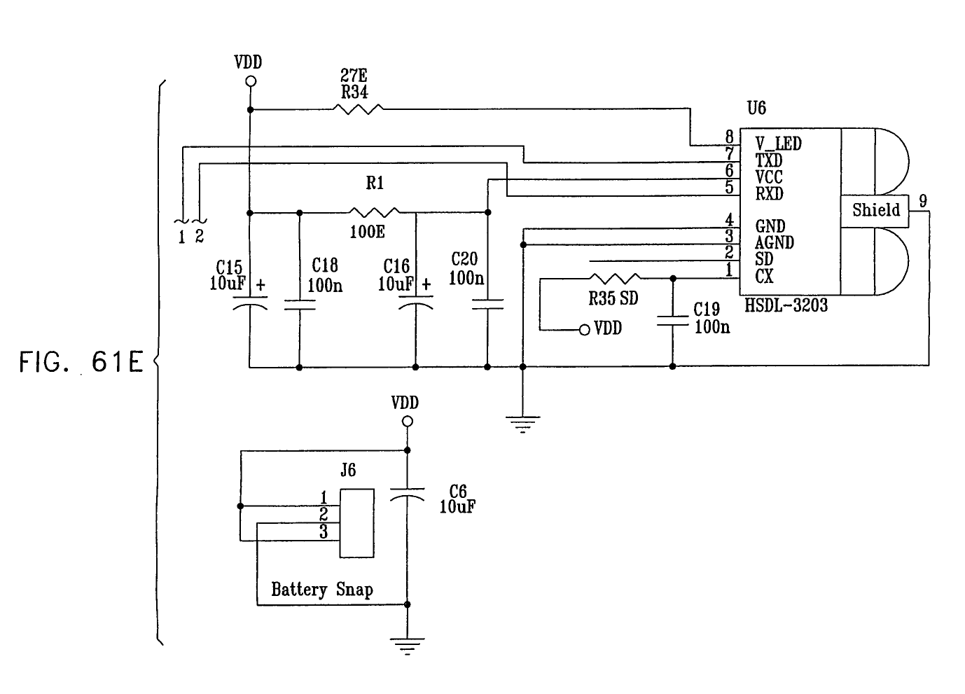

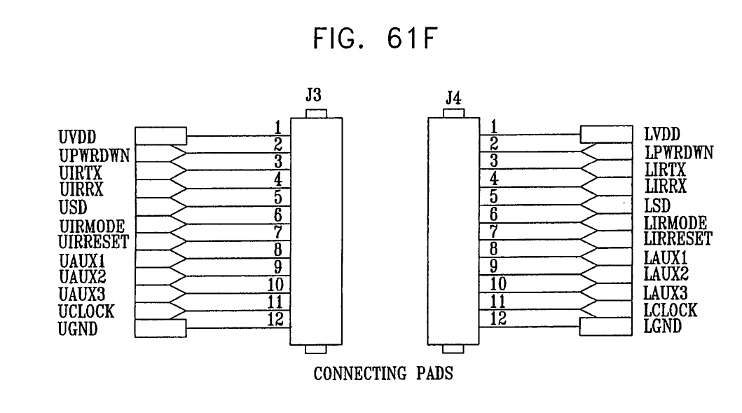

A self-explanatory electrical schematic illustration of the circuitry found on PCBs 5912 and 5914 appears in FIGS. 61A-61F.

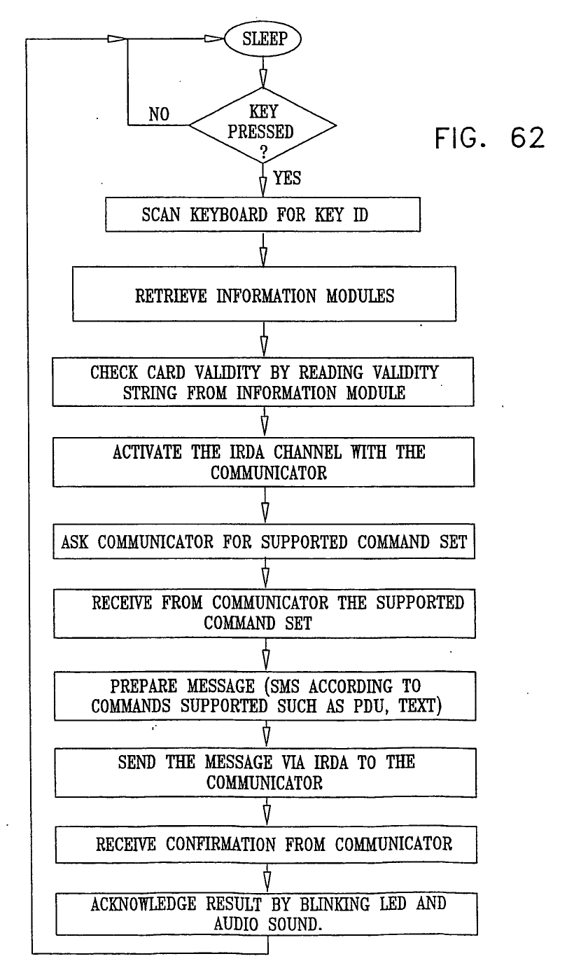

Reference is now made to FIGS. 61A, 61B, 61C, 61D, 61E and 61F, which are drawings of the electrical circuitry in the card of FIGS. 56 & 57 and the intermediary of FIGS. 59 & 60 and to FIG. 62 is a simplified flow chart illustrating the functionality of software incorporated in the circuitry of FIGS. 61A-61F.

The circuitry of FIGS. 61A-61F is believed to be self-explanatory. It is to be appreciated that although in the preferred embodiment, the circuitry of FIGS. 61A and 61B are embodied in the card, and the circuitry of FIGS. 61C-61F is embodied either in the facilitator or in a communicator, alternatively some of the circuitry of FIGS. 61C-61F may be included in the card and all of the circuitry of FIGS. 61C-61F may be included in the communicator, thus obviating the need for the facilitator.

Reference is now made to FIG. 62, which describes the functionality of software embodied in a U5 Microcontroller PIC 16LF76 appearing in FIG. 61C. As seen in FIG. 62, the circuitry of FIGS. 61A-61F is in a sleep mode until a key is pressed. When a key is pressed, the software scans the keyboard in order to identify which key was pressed and retrieves one or more information modules.

Thereafter, the software checks validity of the user interface card by reading a validity string from the retrieved information module and activates a communication channel, such as an IRDA communication channel for communication with a communicator. The supported command set of the communicator is requested and received and a message is prepared in an appropriate format, such as SMS and communicated, such as via IRDA to the communicator. A confirmation is received from the communicator and appropriate user feedback, such as visual or audio feedback is provided.

It will be appreciated by persons skilled in the art that the present invention is not limited by what has been particularly shown and described hereinabove. Rather the scope of the present invention includes both combinations and subcombinations of the various features described hereinabove as well as variations and modifications which would occur to persons skilled in the art upon reading the specification and which are not in the prior art.

1-613. (canceled)

614. A user-interface for triggering a server to effect a selected transaction via an intermediary communications device for relaying information relating to the selected transaction to the server, said transaction being one of a plurality of transactions, said user-interface comprising:
a plurality of information modules each relating to a subset of said plurality of transactions and displaying visual information uniquely depicting a respective transaction in said subset, each information module being operative to actuate a respective transaction on said server;
an encoder coupled to each of the information modules for generating a signal encoding information uniquely identifying the user interface and an actuated information module thereof so as to identify to the server which of said plurality of transactions is selected; and
a transmitter coupled to the encoder for transmitting said signal to the intermediary communications device.

615. The user-interface card according to claim 614, wherein the intermediary communications device is a voice communications device.

616. The user-interface according to claim 614, wherein the transmitter is coupled to an appropriate transducer for transmitting said signal to said intermediary communications device as sound or IR or RF, respectively.

617. The user-interface according to claim 614, comprising a card having an circuit board defining a plurality of user-actuable contact locations and housed within a pair of substrates at least one of which is printed on a surface thereof so as to present application specific visual graphics each depicting a respective transaction in said subset and each being proximate a respective one of the user-actuable contact locations.

618. The user-interface card according to claim 614, further including functionality which limits access to at least one of a plurality of information modules in response to user actuation of a corresponding at least one of said plurality of user-actuable contact locations according to a parameter associated with the user-interface card.

619. A server for effecting a selected transaction in response to a request triggered by a user-interface upon user-actuation of a selected one of a plurality of information modules each relating to a subset of a plurality of transactions and conveyed to the server via an intermediary communications device, said transaction being one of a plurality of transactions, said server comprising:
a first communications interface configured for establishing communication with the intermediary communications device and being adapted to receive therefrom a signal encoding information uniquely identifying the user interface and an actuated information module thereof so as to identify to the server which of said plurality of transactions is selected,
a decoder coupled to the first communications interface for decoding said signal conveyed by the intermediary communications device to determine the identity of the user interface and the selected information module,
a management module coupled to the decoder and being responsive to the identity of the user interface and the selected information module for accessing a database for determining user entitlement associated with the selected transaction, and
a second communications interface coupled to the management module for conveying data relating to a transaction to which the user is entitled.

620. The server according to claim 619, wherein the database stores data identifying the following:
all supported transactions,
each user interface,
the corresponding information modules of the user interface,
the respective subset of transactions supported by each user interface,
respective user entitlement associated with each supported transaction.

621. The server according to claim 619, including an audio response module for providing an Interactive Voice Response to the intermediary communications device for vocally informing a user on use of the user interface.

622. The server according to claim 619, wherein the first communications interface is configured for communicating with the intermediary communications device via any one of the group: sound, IR, RF, SMS, WAP, WEB, BlueTooth.

623. The server according to claim 619, wherein the data relating to a transaction to which the user is entitled includes content to be conveyed to or on behalf of the user.

624. The server according to claim 623, wherein the second communications interface is configured to download the content to the intermediary communications device.

625. A method for effecting a selected transaction in response to a request triggered by a user-interface upon user-actuation of a selected one of a plurality of information modules each relating to a subset of a plurality of transactions and conveyed to the server via an intermediary communications device, said transaction being one of a plurality of transactions, said method comprising:
receiving from the intermediary communications device a signal encoding information uniquely identifying the user interface and an actuated information module thereof so as to identify to the server which of said plurality of transactions is selected;
decoding said signal to determine an identity of the user interface and the selected information module, accessing a database for determining user entitlement associated with the selected transaction; and
conveying data relating to a transaction to which the user is entitled.

626. The method according to claim 625, including establishing communication with the intermediary communications device prior to user-actuation of the information module.

627. A program storage device readable by machine, tangibly embodying a program of instructions executable by the machine to perform a method for effecting a selected transaction in response to a request triggered by a user-interface upon user-actuation of a selected one of a plurality of information modules each relating to a subset of a plurality of transactions and conveyed to the server via an intermediary communications device, said transaction being one of a plurality of transactions, said method comprising:
receiving from the intermediary communications device a signal encoding information uniquely identifying the user interface and an actuated information module thereof so as to identify to the server which of said plurality of transactions is selected;
decoding said signal to determine an identity of the user interface and the selected information module;
accessing a database for determining user entitlement associated with the selected transaction; and
conveying data relating to a transaction to which the user is entitled.

628. A computer program product comprising a computer useable medium having computer readable program code embodied therein for effecting a selected transaction in response to a request triggered by a user-interface upon user-actuation of a selected one of a plurality of information modules each relating to a subset of a plurality of transactions and conveyed to the server via an intermediary communications device, said transaction being one of a plurality of transactions, said computer program product comprising:
computer readable program code for causing the computer to receive from the intermediary communications device a signal encoding information uniquely identifying the user interface and an actuated information module thereof so as to identify to the server which of said plurality of transactions is selected,
computer readable program code for causing the computer to decode said signal to determine an identity of the user interface and the selected information module,
computer readable program code for causing the computer to access a database for determining user entitlement associated with the selected transaction, and
computer readable program code for causing the computer to convey data relating to a transaction to which the user is entitled.
